(19) United States
(12) Patent Application Publication
(10) Pub. No.: US 2024/0022927 A1
(43) Pub. Date: Jan. 18, 2024

(54) SYSTEMS, METHODS, AND APPARATUS ON WIRELESS NETWORK ARCHITECTURE AND AIR INTERFACE

(71) Applicant: HUAWEI TECHNOLOGIES CO., LTD., SHENZHEN (CN)

(72) Inventors: WEN TONG, Kanata (CA); LIQING ZHANG, Kanata (CA); HAO TANG, Shenzhen (CN); JIANGLEI MA, Kanata (CA); PEIYING ZHU, Kanata (CA)

(21) Appl. No.: 18/474,247

(22) Filed: Sep. 26, 2023

Related U.S. Application Data
(63) Continuation of application No. PCT/CN2021/084211, filed on Mar. 31, 2021.

(51) Int. Cl. H04W 24/02

(52) U.S. Cl. CPC H04W 24/02; H04W 84/06

(57) ABSTRACT

Systems, methods, and apparatus on wireless network architecture and air interface are disclosed. In some embodiments, sensing agents communicate with user equipments (UEs) or nodes using one of multiple sensing modes through non-sensing-based or sensing-based links, and/or artificial intelligence (AI) agents communicate with UEs or nodes using one of multiple AI modes through non-AI-based or AI-based links. AI and sensing may work independently or together. For example, a sensing service request may be sent by an AI block to a sensing block to obtain sensing data from the sensing block, and the AI block may generate a configuration based on the sensing data. Various other features, related to example interfaces, channels, and other aspects of AI-enabled and/or sensing-enabled communications, for example, are also disclosed.

### CROSS-REFERENCE TO RELATED APPLICATION

This application is related to, and is a continuation of, International Application No. PCT/CN2021/084211, filed on Mar. 31, 2021, and entitled “SYSTEMS, METHODS, AND APPARATUS ON WIRELESS NETWORK ARCHITECTURE AND AIR INTERFACE”, the entire contents of which are incorporated herein by reference.

### FIELD

This application relates generally to communications, and in particular to architecture and air interfaces in wireless communication networks.

### BACKGROUND

Current artificial intelligence (AI) discussions encompass a high-level architecture with two machine learning (ML) pipeline modules located in a core network (CN) and an access network (or radio access network, RAN), respectively. In this type of architecture, user equipment (UE) data used for training is transferred to the RAN AI module, and the data used for training from the UE and RAN is transferred to the CN AI module. Both of these AI modules have training outputs into sinks where information is stored and may optionally be processed for further applications.

In current long term evolution (LTE) and new radio (NR) networks, positioning was proposed to deal with UE positioning measurement and reporting. A location management function (LMF) is located in the core network, and positioning is managed by the LMF via another network function, an access and mobility management function (AMF), to send positioning configuration to the RAN nodes. Specific positioning related configurations are made by the RAN nodes and corresponding UEs. UE measurements and/or RAN measurements for positioning are sent to the LMF, and the LMF may perform overall analysis to obtain positioning information of one or more UEs.

Electronic devices (EDs) in wireless communication networks, such as base stations (BSs), UEs, or the like, wirelessly communicate with each other to send or receive data between one another. Sensing is a process of obtaining information about a device's surroundings. Sensing can also be used to detect information about an object such as its location, speed, distance, orientation, shape, texture, etc. This information can be used to improve communications in the network, as well as for other application-specific purposes.

Sensing in communication networks has typically been limited to an active approach, which involves a device receiving and processing a radio frequency (RF) sensing signal. Other sensing approaches, such as passive sensing (e.g., radar) and non-RF sensing (e.g., video imaging and other sensors) can address some limitations of active sensing; however, these other approaches are typically standalone systems implemented separately from the communication network.

### SUMMARY

There are potential benefits of integrating communication and sensing in wireless communications networks. It is thus desirable to provide improved systems and methods for sensing and communication integration in wireless communications networks in some embodiments.

Current network architectures and designs do not consider such features as AI or sensing to be an integral part of the network, but rather separate functional blocks or elements. In future networks, supervised learning, reinforced learning, and/or autoencoder which is another type of artificial neural network in AI, may combine sensing information and can be effectively used in a network to significantly improve performance and, in some embodiments, form an integrated AI and sensing communication network.

It may be desirable for future networks to support flexible network architectures and/or functions, for example by integrating AI and/or sensing features in some embodiments. Such features may be integrated into a network that include different types of RAN nodes and diverse UEs. As a result, it may also be desirable to support flexible connectivity options between AI, sensing, RAN nodes and UEs.

In an integral or integrated design, wireless communication with different AI-based network architectures and flexible sensing functionalities are considered herein. An integral or integrated design, or integration as also referenced herein, may include, for example, integrating AI with sensing, integrating AI with communications, integrating sensing with communications, or integrating both sensing and AI with communications.

In the present disclosure, for future wireless communication networks, network architectures may support or include AI and/or sensing operations. Embodiments encompass individual AI, individual sensing, and integrated AI/sensing operations with wireless communication. Terrestrial network (TN) based and non-terrestrial network (NTN) based RAN functionalities may be considered, including third party NTN nodes and interfaces between TN node(s) and NTN node(s). Different air interfaces between RAN node(s) and UEs may also be considered, including AI-based Uu, sensing-based Uu, non-AI-based Uu, and non-sensing-based Uu. Different air interfaces between UEs are also considered herein, including AI-based sidelink (SL), sensing-based SL, non-AI-based SL, and non-sensing-based SL.

Air interface operation framework is considered to support such features as over the link, and potentially integrated, AI and sensing procedures, AI model configurations, AI model determination by NW with or without compression, and AI model determination by a network and UE such as distillation and federated learning. Also, framework and principle on design of AI and sensing-specific channels, separate AI and sensing channels for Uu and SL, and unified AI and sensing channels for Uu and SL are provided.

It should be noted embodiments disclosed herein are not limited only to Uu or SL, and may can also or instead be applied to other types of communication, such as transmission in unlicensed spectrum for example.

Disclosed embodiments are also not limited to terrestrial transmission or non-terrestrial transmission, in terrestrial networks or non-terrestrial networks for example, and may also or instead be applied to integrated terrestrial and non-terrestrial transmission.

According to an aspect of the present disclosure, a method involves communicating, by a first sensing agent, a first signal with a first user equipment (UE) using a first sensing mode through a first link; and communicating, by a first artificial intelligence (AI) agent, a second signal with a second UE using a first AI mode through a second link. The first sensing mode is one of multiple sensing modes, and the first AI mode is one of multiple AI modes. The first link is or includes one of: a non-sensing-based link and a sensing-based link, and the second link is or includes one of: a non-AI-based link and an AI-based link.

An apparatus according to another aspect of the present disclosure includes at least one processor and a non-transitory computer readable storage medium, coupled to the at least one processor, storing programming for execution by the at least one processor, to cause the apparatus to: communicate, by a first sensing agent, a first signal with a first UE using a first sensing mode through a first link; and communicate, by a first AI agent, a second signal with a second UE using a first AI mode through a second link. The first sensing mode is one of multiple sensing modes, and the first AI mode is one of multiple AI modes. The first link is or includes one of: a non-sensing-based link and a sensing-based link, and the second link is or includes one of: a non-AI-based link and an AI-based link.

A computer program product that includes a non-transitory computer readable storage medium is also disclosed. The non-transitory computer readable storage medium stores programming for execution by a processor to cause the processor to: communicate, by a first sensing agent, a first signal with a first UE using a first sensing mode through a first link; and communicate, by a first AI agent, a second signal with a second UE using a first AI mode through a second link. The first sensing mode is one of multiple sensing modes, and the first AI mode is one of multiple AI modes. The first link is or includes one of: a non-sensing-based link and a sensing-based link, and the second link is or includes one of: a non-AI-based link and an AI-based link.

According to a further aspect of the present disclosure, a method involves communicating, by a first sensing agent for a first UE, a first signal with a first node using a first sensing mode through a first link; and communicating, by a first AI agent for the first UE, a second signal with a second node using a first AI mode through a second link. The first sensing mode is one of multiple sensing modes, and the first AI mode is one of multiple AI modes. The first link is or includes one of: a non-sensing-based link and a sensing-based link, and the second link is or includes one of: a non-AI-based link and an AI-based link.

An apparatus according to another aspect of the present disclosure includes at least one processor and a non-transitory computer readable storage medium, coupled to the at least one processor, storing programming for execution by the at least one processor, to cause the apparatus to: communicate, by a first sensing agent for a first UE, a first signal with a first node using a first sensing mode through a first link; and communicate, by a first AI agent for the first UE, a second signal with a second node using a first AI mode through a second link. The first sensing mode is one of multiple sensing modes, and the first AI mode is one of multiple AI modes. The first link is or includes one of: a non-sensing-based link and a sensing-based link, and the second link is or includes one of: a non-AI-based link and an AI-based link.

In another aspect related to a computer program product that includes a non-transitory computer readable storage medium, the non-transitory computer readable storage medium stores programming for execution by a processor to cause the processor to: communicate, by a first sensing agent for a first UE, a first signal with a first node using a first sensing mode through a first link; and communicate, by a first AI agent for the first UE, a second signal with a second node using a first AI mode through a second link. The first sensing mode is one of multiple sensing modes, and the first AI mode is one of multiple AI modes. The first link is or includes one of: a non-sensing-based link and a sensing-based link, and the second link is or includes one of: a non-AI-based link and an AI-based link.

According to a further aspect of the present disclosure, a method involves: sending, by a first AI block, a sensing service request to a first sensing block; obtaining, by the first AI block, sensing data from the first sensing block; and generating, by the first AI block, an AI training configuration or an AI update configuration based on the sensing data. The first AI block connects with the first sensing block via one of the following: a connection based on an API that is common to the first AI block and the first sensing block; a specific AI-sensing interface; and a wireline or wireless connection interface.

An apparatus according to another aspect of the present disclosure includes at least one processor and a non-transitory computer readable storage medium, coupled to the at least one processor, storing programming for execution by the at least one processor, to cause the apparatus to: send, by a first AI block, a sensing service request to a first sensing block; obtain, by the first AI block, sensing data from the first sensing block; and generate, by the first AI block, an AI training configuration or an AI update configuration based on the sensing data. The first AI block connects with the first sensing block via one of the following: a connection based on an API that is common to the first AI block and the first sensing block; a specific AI-sensing interface; and a wireline or wireless connection interface.

In another aspect related to a computer program product that includes a non-transitory computer readable storage medium, the non-transitory computer readable storage medium stores programming for execution by a processor to cause the processor to: send, by a first AI block, a sensing service request to a first sensing block; obtain, by the first AI block, sensing data from the first sensing block; and generate, by the first AI block, an AI training configuration or an AI update configuration based on the sensing data. The first AI block connects with the first sensing block via one of the following: a connection based on an API that is common to the first AI block and the first sensing block; a specific AI-sensing interface; and a wireline or wireless connection interface.

According to other aspects of the disclosure, an apparatus including one or more units for implementing any of the method aspects as disclosed in this disclosure is provided. The term “units” is used in a broader sense and referred to by any of various names, including for example, modules, components, elements, means, etc. The units can implemented using hardware, software, firmware or any combination thereof.

Other aspects and features of embodiments of the present disclosure will become apparent to those ordinarily skilled in the art upon review of the following description.

### BRIEF DESCRIPTION OF THE DRAWINGS

For a more complete understanding of the present embodiments, and potential advantages thereof, reference is now made, by way of example, to the following descriptions taken in conjunction with the accompanying drawings, in which:

FIGS. 1 and 1A to 1F are block diagrams that provide simplified schematic illustrations of communication systems according to some embodiments;

FIG. 2 is a block diagram illustrating another example communication system;

FIG. 3 is a block diagram illustrating example electronic devices and network devices;

FIG. 4 is a block diagram illustrating units or modules in a device;

FIG. 5 is a block diagram of an LTE/NR architecture;

FIG. 6A is a block diagram illustrating a network architecture according to an embodiment;

FIG. 6B is a block diagram illustrating a network architecture according to another embodiment;

FIGS. 7A-7D illustrate examples of signaling between network entities over a logical layer, in accordance with examples of the present disclosure;

FIG. 8A is a block diagram illustrating an example dataflow in accordance with examples of the present disclosure;

FIGS. 8B and 8C are flowcharts illustrating example methods for AI-based configuration, in accordance with examples of the present disclosure;

FIG. 9 is a block diagram illustrating example protocol stacks according to an embodiment;

FIG. 10 is a block diagram illustrating example protocol stacks according to another embodiment;

FIG. 11 is a block diagram illustrating example protocol stacks according to a further embodiment;

FIG. 12 is a block diagram illustrating an example interface between a core network and a RAN;

FIG. 13 is a block diagram illustrating another example of protocol stacks according to an embodiment;

FIG. 14 includes block diagrams illustrating example sensing applications.

FIG. 15A is a schematic diagram illustrating a first example communication system implementing sensing according to aspects of the present disclosure;

FIG. 15B is a flowchart illustrating an example operation process of an electronic device for integrated sensing and communication, according to an embodiment of the present disclosure;

FIG. 16 is a block diagram illustrating example protocol stacks according to a further embodiment;

FIG. 17 is a block diagram illustrating an example interface between a core network and a RAN;

FIG. 18 is a block diagram illustrating another example of protocol stacks according to an embodiment;

FIG. 19 is a block diagram illustrating a network architecture according to a further embodiment, in which sensing is based in a core network and AI is based outside the core network;

FIG. 20 is a block diagram illustrating a network architecture according to a further embodiment, in which sensing is based outside a core network and AI is based inside the core network;

FIG. 21 is a block diagram illustrating a network architecture according to yet another embodiment, in which AI and sensing are both based outside a core network;

FIG. 22 is a block diagram illustrating a network architecture that enables AI to support operations such as resource allocation for RANs;

FIG. 23 is a block diagram illustrating a network architecture that enables AI and sensing to support operations such as resource allocation for RANs;

FIG. 24 is a signal flow diagram illustrating an example integrated AI and sensing procedure;

FIG. 25 is a block diagram illustrating another example communication system;

FIG. 26A is a block diagram illustrating how various components of an intelligent system may work together in some embodiments;

FIG. 26B is a block diagram illustrating an intelligent air interface according to one embodiment;

FIG. 27 is a block diagram illustrating an example intelligent air interface controller;

FIGS. 28-30 are block diagrams illustrating examples of how logical layers of a system node or UE may communicate with an AI agent;

FIGS. 31A and 31B are flow diagrams illustrating methods for AI mode adaptation/switching, according to various embodiments;

FIGS. 31C and 31D are flow diagrams illustrating methods for sensing mode adaptation/switching, according to various embodiments;

FIG. 32 is a block diagram illustrating a UE providing measurement feedback to a base station, according to one embodiment;

FIG. 33 illustrates a method performed by an apparatus and a device, according to one embodiment;

FIG. 34 illustrates a method performed by an apparatus and a device, according to another embodiment;

FIG. 35 is a block diagram illustrating AI model determination by a network device and indicating the determined AI model to a UE;

FIG. 36 is a block diagram illustrating AI model determination by a network device and indicating the determined AI model to a UE according to another embodiment;

FIG. 37 is a signal flow diagram illustrating a procedure for UE AI model determination by network indication;

FIG. 38 is a signal flow diagram illustrating a federated learning procedure according to another embodiment;

FIG. 39 illustrates an example air interface configuration for federated learning;

FIG. 40 is a signal flow diagram illustrating an example procedure for integrated AI/sensing for AI training;

FIG. 41 is a signal flow diagram illustrating an example procedure for integrated AI/sensing for AI update;

FIG. 42 is a block diagram illustrating a physical layer-based example AI-enabled downlink (DL) channel or protocol architecture according to an embodiment;

FIG. 43 is a block diagram illustrating a physical layer-based example AI-enabled uplink (UL) channel or protocol architecture according to an embodiment;

FIG. 44 is a block diagram illustrating a higher layer-based example AI-enabled DL channel or protocol architecture according to an embodiment;

FIG. 45 is a block diagram illustrating a higher layer-based example AI-enabled UL channel or protocol architecture according to an embodiment;

FIG. 46 is a block diagram illustrating a physical layer-based example sensing-enabled DL channel or protocol architecture according to an embodiment;

FIG. 47 is a block diagram illustrating a physical layer-based example sensing-enabled UL channel or protocol architecture according to an embodiment;

FIG. 48 is a block diagram illustrating a higher layer-based example sensing-enabled DL channel or protocol architecture according to an embodiment;

FIG. 49 is a block diagram illustrating a higher layer-based example sensing-enabled UL channel or protocol architecture according to an embodiment;

FIG. 50 is a block diagram illustrating a physical layer-based example unified AI and sensing-enabled DL channel or protocol architecture according to an embodiment;

FIG. 51 is a block diagram illustrating a physical layer-based example unified AI and sensing-enabled UL channel or protocol architecture according to an embodiment;

FIG. 52 is a block diagram illustrating a higher layer-based example unified AI and sensing-enabled DL channel or protocol architecture according to an embodiment;

FIG. 53 is a block diagram illustrating a higher layer-based example unified AI and sensing-enabled UL channel or protocol architecture according to an embodiment;

FIG. 54 is a block diagram illustrating physical layer-based examples of AI-enabled and sensing-enabled SL channel or protocol architectures according to an embodiment;

FIG. 55 is a block diagram illustrating higher layer-based examples of AI-enabled and sensing-enabled SL channel or protocol architectures according to an embodiment;

FIG. 56 is a block diagram illustrating another example communication system.

FIG. 57 illustrates a sequence of rotations that relate a global coordinate system to a local coordinate system;

FIG. 58 illustrates a coordinate system defined by axes, spherical angles, and spherical unit vectors;

FIG. 59 illustrates a two-dimensional planar antenna array structure of a dual polarized antenna;

FIG. 60 illustrates a two-dimensional planar antenna array structure of a single polarized antenna;

FIG. 61 illustrates a grid of spatial zones, allowing for spatial zones to be indexed.

### DETAILED DESCRIPTION

For illustrative purposes, specific example embodiments will now be explained in greater detail below in conjunction with the figures.

The embodiments set forth herein represent information sufficient to practice the claimed subject matter and illustrate ways of practicing such subject matter. Upon reading the following description in light of the accompanying figures, those of skill in the art will understand the concepts of the claimed subject matter and will recognize applications of these concepts not particularly addressed herein. It should be understood that these concepts and applications fall within the scope of the disclosure and the accompanying claims. In general, unless explicitly otherwise indicated, an element in the singular is not intended to mean one and only one but rather one or more. Plural elements may be singular in some cases unless explicitly so stated. Other such variations in disclosed embodiments are also possible.

Many of the disclosed embodiments refer to various “intelligent” features. In general, an “intelligent” feature is intended to indicate a feature that is enabled by one or more optimization functions with learning capabilities, such as any one or more of AI, sensing, and positioning. Examples include at least the following:
intelligent TRP management, or equivalently TRP management that is enabled by one or more intelligent functions;
intelligent beam management, or equivalently beam management that is enabled by one or more intelligent functions;
intelligent channel resource allocation, or equivalently channel resource allocation that is enabled by one or more intelligent functions;
intelligent power control, or equivalently power control that is enabled by one or more intelligent functions;
intelligent power utilization management, or equivalently power utilization management that is enabled by one or more intelligent functions;
intelligent spectrum utilization, or equivalently spectrum utilization that is enabled by one or more intelligent functions;
intelligent MCS, or equivalently MCS that is enabled by one or more intelligent functions;
intelligent HARQ strategy, or equivalently HARQ strategy that is enabled by one or more intelligent functions;
intelligent transmission and/or reception mode(s), or equivalently transmission and/or reception mode(s) enabled by one or more intelligent functions;
intelligent air interfaces, or equivalently air interfaces that are enabled by one or more intelligent functions;
intelligent PHY, or equivalently PHY that is enabled by one or more intelligent functions;
intelligent MAC, or equivalently MAC that is enabled by one or more intelligent functions;
intelligent UE-centric beamforming, or equivalently UE-centric beamforming that is enabled by one or more intelligent functions;
intelligent control, or equivalently control that is enabled by one or more intelligent functions; and
intelligent SL, or equivalently SL that is enabled by one or more intelligent functions.

In some cases, intelligent components or features may support or enable other intelligent features. For example, intelligent network architectures or components include network architectures or components that support intelligent functions. Similarly, intelligent backhaul includes backhaul that supports intelligent functions.

The present disclosure refers to “future” networks, of which 6th-generation (6G) or next evolved networks are used herein as examples. Features that are disclosed with reference to any specific example future network are intended to also or instead be applicable to other types of future networks.

Current technologies, standards, or networks are also referenced herein, including 3^{rd}-generation (3G), 4^{th}-generation (4G), 5^{th}-generation (5G), LTE, and NR networks as examples.

The present disclosure may refer to certain features being provided, enabled, performed, etc. by a “network”. In such instances, disclosed features are provided, enabled, performed, etc. by one or more devices or apparatus in a network, such as a base station or other network device or apparatus.

Information related to AI may be referred to herein in any of various ways, including information for AI, AI information, and AI data. Similarly, information related to sensing may be referred to herein in any of various ways, including information for sensing, sensing information, and sensing data. Information related to sensing may include results of sensing or measurements, also referred to herein as, for example, sensed data, sensing measurements, sensing measurement(s) data, sensing measurement(s) information, sensing results, measurement results, or measurements.

Future networks are expected to provide a new era featuring connected people, connected things, and connected intelligence with new services such as networked sensing and networked AI in addition to enhanced 5G usage scenarios. Within this context, it may be desirable for a future network air interface to be able to support new key performance indicators (KPIs) and much higher or stricter KPIs than those of 5G. Future networks may support an even higher spectrum range and wider bandwidth than 5G networks in order to deliver extremely high-speed data services and high resolution sensing. To meet these new and challenging goals, future network air interface designs may involve revolutionary breakthroughs. Future network design may take into account any of various aspects for features, such as the following:
intelligent air interface;
native AI;
power saving by design;
integrated connectivity and sensing;
proactive UE-centric beam operations;
predicting channel change;
integrated terrestrial and non-terrestrial systems;
super-flexible spectrum utilization;
analog and RF-aware systems.

These and other aspects of future network design are considered at least below.

An air interface, as used herein, may be considered as providing, enabling, or supporting a wireless communications link between two or more communicating devices, such as between a user equipment (UE) and a base station. Typically, both communicating devices need to know the air interface in order to successfully transmit and receive a transmission.

An air interface generally includes a number of components and associated parameters that collectively specify how a transmission is to be sent and/or received over a wireless channel between the two or more communicating devices. For example, an air interface may include one or more components defining a waveform, a frame structure, a multiple access scheme, a protocol, a coding scheme, and/or a modulation scheme for conveying information (data, for example) over the wireless channel. The air interface components may be implemented using one or more software and/or hardware components on the communicating devices. For example, a processor may perform channel encoding/decoding to implement the coding scheme of an air interface. Implementing an air interface, or communications over, via, or through an interface, may involve operations in different network layers, such as the physical layer and the medium access control (MAC) layer.

Regarding intelligent air interface, in some embodiments a future network air interface design is powered by a combination of model driven and data driven AI and is expected to enable tailored optimization of the air interface from provisional configuration to self-learning. A “personalized” air interface can customize a transmission scheme and parameters at the UE level and/or service level to maximize experience without sacrificing system capacity. An air interface that can be scaled to support such features as near-zero-latency ultra-reliable low latency communications (URLLC) may be especially preferred. In addition, a simple and agile signaling mechanism is provided in some embodiments to minimize or at least reduce signaling overhead, latency, and/or power consumption for either or both of network nodes and terminal devices. Air interface features may include, for example:
transition from slicing based 5G soft air interface to personalized air interface, with one or more of the following in some embodiments:
   tailored air interface optimization,
   customized transmission setup and parameter selection,
   driven by machine learning;
super flexible frame structure to support, for example, extreme URLLC, with one or more of the following in some embodiments:
   scalability to near-zero-latency, and/or
   deterministic transmission with zero-jitter;
agile and minimized or at least reduced signaling mechanism to reduce signaling overhead and signaling delay, with signaling being re-definable with machine learning in some embodiments;
joint analog/RF awareness, with one or more of the following in some embodiments:
   analog/RF impairment dependent physical layer (PHY) design, and/or
   cross digital/analog domain optimization.

Regarding 5G soft air interface, to provide an optimized method of supporting versatile application scenarios and a wide spectrum range, a unified new air interface featuring both flexibility and adaptability has been employed in 5G. The flexibility and configurability of that interface have led to it being referred to as a “soft” air interface, and enable optimization of the air interface for different usage scenarios, such as enhanced mobile broadband (eMBB), URLLC, and massive machine type communications (mMTC) within a unified framework.

Regarding personalized AI, a future network air interface design may be powered by a combination of model- and data-driven AI and may be expected to enable tailored optimization of air interface from provisional configuration to self learning. A personalized air interface can potentially customize a transmission and reception scheme and parameters at the UE level and/or service level to maximize experience without sacrificing system capacity.

In respect of native AI, for future networks AI may be a built-in feature of an air interface, enabling intelligent PHY and media access control (MAC). AI need not be limited to such applications network management optimization (such as load balancing and power saving), replacing non-linear or non-convex algorithms in transceiver modules, or compensating for deficiencies in non-linear models. Intelligence may be exploited to make PHY more powerful and efficient in future networks. Intelligence may also or instead facilitate optimization of PHY building block designs and procedural designs, including possible re-architecting of transceiver processes. Alternatively or in addition thereto, intelligence may help provide new sensing and positioning capabilities, which in turn can significantly change air interface component designs. AI-assisted sensing and positioning may be useful to make low-cost and highly accurate beamforming and tracking possible. Intelligent MAC can provide a smart controller based on single-agent or multi-agent reinforced learning, including cooperative machine learning for network and UE nodes. For example, with multi-parameter joint optimization and individual or joint procedure training, enormous performance gains can be obtained in terms of system capacity, UE experience, and power consumption. Multi-agent systems may motivate distributed solutions that can be cheaper and more efficient than single-agent systems, which may provide a more centralized solution. Native AI features may include, for example:
built-in capability for network and high-end terminals (for example, high processing capability with low latency and/or fully-featured functions), as opposed to low-end terminals (for example, lower processing capability with narrower bandwidth usage, lower power consumption, and/or less fully-featured functions than high-end terminals);
intelligent PHY, with one or more of the following in some embodiments:
   PHY element parameter optimization and update,
   channel acquisition,
   beamforming and tracking,
   sensing and positioning;
intelligent MAC, with one or more of the following in some embodiments
   smart controller powered with machine learning,
   single-agent or multi-agent scheduling of machine learning,
   multi-parameter joint optimization,
   a single procedure or joint procedure training for machine learning;
integrated with intelligent air interface.

Power saving by design refers to minimizing or at least reducing power consumption, for either or both of network nodes and terminal devices, and may be an important design target for future network air interface. Unlike 5G networks, in which power saving is an add-on feature or optional mode, power saving in future networks may be a built-in feature and default operation mode in some embodiments. With intelligent power utilization management, an on-demand power consumption strategy, and the help of other new enabling technologies (such as sensing/positioning-assisted channel sounding), it is anticipated that network nodes and terminals in future networks may feature significantly improved power utilization efficiency. Power saving features may include, for example:
built-in power saving mechanisms;
power savings mechanisms for both network nodes and terminal devices;
intelligent power utilization management;
default power saving operation;
on-demand based power consumption.

Regarding integrated connectivity and sensing, sensing not only may provide new functionalities and therefore new business opportunities, but may also assist communications. For example, a communication network can serve as a sensing (e.g., radar) network with high resolution and wide coverage. A communication network can also be viewed as a sensing network that could provide high resolution and wide coverage, and generate useful information (such as locations, doppler, beam directions, orientation, and images, for signal propagation environment and for communication nodes/devices for example) for assisting communications. In addition, sensing-based imaging capability of terminal devices may be exploited to offer new device functions. New design parameters for future networks may involve building a single network with both sensing and communication functions, which are to be integrated under the same air interface design framework. A new designed and integrated communication and sensing network may offer full sensing capabilities, while also meeting communication KPIs more effectively. Integrated connectivity and sensing features may include, for example:
a single network may have dual functionalities, such as a cellular network and sensing network;
sensing assisted communications; for example, new functions such as imaging, communication environment sensing, etc. for communication nodes and devices to estimate more accurately (than current NR networks for example) signal propagation environment and enhancing communication spectrum efficiency;
integrated sensing and positioning, according to which more accurate positioning can be achieved with assistance of sensing
sensing signal design and algorithms such as designs on signal waveforms pilot sequence and sensing signal processing, etc.

Beam-based transmission is important, especially for high frequencies, such as mmWave and THz band. With highly directional antennas, generating and maintaining precise alignment of transmitter and receiver beams involves significant effort. Beam management is expected to be more challenging in future networks due to exploration of higher frequency ranges. Fortunately, with the help of new technologies such as sensing, advanced positioning, and AI, conventional beam sweeping, beam failure detection, and beam recovery mechanisms can be proactive and UE-centric (which may also be referred to as UE-specific) beam operations. Beam operations may include one or more of beam generation, beam tracking, and beam adjustment, for example. In the context of UE-centric or UE-specific beam operations, “proactive” means that a network device and/or a UE may be dynamically following beam information and/or may predict beam changes based on, e.g., current UE location and mobility, to potentially reduce beam switching latency and/or increase beam switching reliability.

Alternatively or in addition, “handover-free” mobility may be realized at least at the physical layer. Handover-free mobility refers to avoiding handover at a higher layer or from the perspective of a higher layer (e.g., L3) by doing, for example, lower layer (L1/L2) beam switching. Such new intelligent UE-centric beamforming and beam management technologies may maximize or at least improve UE experience and overall system performance. Moreover, emerging reconfigurable intelligent surfaces (RISs) and new types of mobile antennas, such as those equipped with unmanned aerial vehicles (UAVs), may make it possible to shift from passively dealing with channel conditions to actively controlling them. With channel-aware antenna array deployment assisted by RISs and/or moving distributed antennas for example, radio transmission environment can be changed to create the desired transmission channel conditions, thereby achieving optimal or at least improved performance. Proactive UE-centric beam operations may provide or enable such features as any of the following, for example:
transition from beam failure detection and beam recovery to autonomous beam tracking and beam adjustment;
intelligent UE-centric optimal beam selection, with one or more of the following in some embodiments:
   assisted by sensing and/or localization,
   powered by AI,
   handover (HO)-free mobility, at least for PHY;
transition from passive beamforming to active beamforming, with one or more of the following in some embodiments:
   controlled transmission environment and channel condition,
   on-demand based activation and deactivation of accessory antennas (such as RIS, drone, or other types of distributed antennas).

Regarding predicting channel change, accurate channel information is important to achieving highly reliable wireless communications. Currently, channel acquisition is based on reference signal (RS)-assisted channel sounding. As such, it is difficult to obtain real-time channel information due to the measurement and reporting delay as well as concern about channel measurement overhead. It is also worth noting that channel aging deteriorates performance, especially for high-speed mobile UEs. Sensing and positioning-assisted channel sounding powered by AI can transform RS-based channel acquisition to environment-aware channel acquisition, which can be applied to help to reduce overhead and/or delay of existing channel reference signal-based channel acquisition schemes. With the information obtained from sensing/localization, a beam search process can be dramatically simplified. Proactive channel tracking and prediction can provide real-time channel information and at least reduce the impact of channel information becoming obsolete, which is also referred to as channel aging. In addition, the new channel acquisition technology can minimize or reduce both channel acquisition overhead and power consumption for network and terminal devices. Channel change prediction features may include, for example:
sensing/positioning assisted channel sounding, with one or more of the following in some embodiments:
   sub-space determination, where sub-space refers a part of full channel dimension that usually includes more important information,
   candidate beam identification;
beam indication or sub-space indication, with one or more of the following in some embodiments:
   minimized or at least reduced beam search space,
   minimized or at least reduced channel acquisition overhead,
   power saving for either or both of network devices and terminal devices such as UEs;
real-time channel tracking, with proactive channel tracking and channel prediction in some embodiments;
generalized quantized channel feedback channel, which is not antenna structure specific in some embodiments.

On the topic of integrated terrestrial and non-terrestrial systems, satellite systems have been introduced into recent 5G releases as extensions of terrestrial network (TN) communication systems. It is expected that the integrated terrestrial and non-terrestrial network (NTN) systems will achieve full-earth coverage and on-demand capacity in 6G networks. In future networks that include tightly integrated terrestrial and non-terrestrial systems, components or elements such as satellite constellations, UAVs, high altitude platforms (HAPSs), and drones etc., may be viewed as new types of moving network nodes, which involve new design considerations. Combining the designs of terrestrial and non-terrestrial systems may enable or provide such new features as more efficient multi-connection joint operations, more flexible functionality sharing, and faster cross-connection switching. These new features will go a long way in helping future networks achieve global coverage and seamless global mobility with low power consumption.

Integrated terrestrial and non-terrestrial systems may provide such features as the following, for example:
joint operation of TNs and NTNs, with one or more of the following in some embodiments:
   multi-connection joint operation,
   shared functionality,
   cross-connection switching and/or handover;
on-demand UAV deployment and/or moving of distributed antennas;
multi-layer cooperative mobility.

5G networks support sub-6G and mmWave carrier aggregation (CA), and also allow cross-operation of time division duplex (TDD) and frequency division duplex (FDD) carriers. Intelligent spectrum utilization and channel resource management are important future network design aspects. Higher-frequency spectra with wider bandwidth (for example, the high end of mmWave frequency bands up to terahertz (THz)) will be explored to support unprecedented data rates that are expected of future networks such as 6G networks. However, higher frequencies suffer from more sever path loss and atmospheric absorption. In light of this, design of a future network air interface should consider how to effectively utilize these new spectra jointly with other lower-frequency bands. Moreover, more mature full duplex is being eagerly anticipated. A simplified mechanism to allow fast cross-carrier switching and flexible bidirectional spectrum resource assignment in future networks may be particularly attractive. Also, a unified frame structure definition and signaling for FDD, TDD, and full duplex is expected to simplify system operations and support the coexistence of UEs with different duplex capabilities. These features all relate to what is referred to herein as super-flexible spectrum utilization, which may include any of the following, for example:
intelligent spectrum and channel resource utilization management;
simplified signaling mechanisms to allow fast cross-carrier switching and flexible bidirectional spectrum resource assignment;
unified frame definition and signaling mechanisms for FDD, TDD and full duplex;
coexistence of UEs with different duplex capabilities.

Regarding analog and RF-aware systems, baseband signal processing and algorithms are usually designed without carefully considering the characteristics of the analog and RF components, due to the difficulty in modeling impairments and non-linearity of such components. This is acceptable with lower frequencies, especially with linearization effects such as digital pre-distortion of power amplifiers. In future networks, baseband physical layer design is expected to account for RF impairments or restrictions, especially with higher-frequency spectra such as THz. With native AI capability, joint RF and baseband design and optimization may also be possible. Analog and RF-aware system features may include, for example:
analog/RF impairment dependent PHY design;
cross-domain optimization.

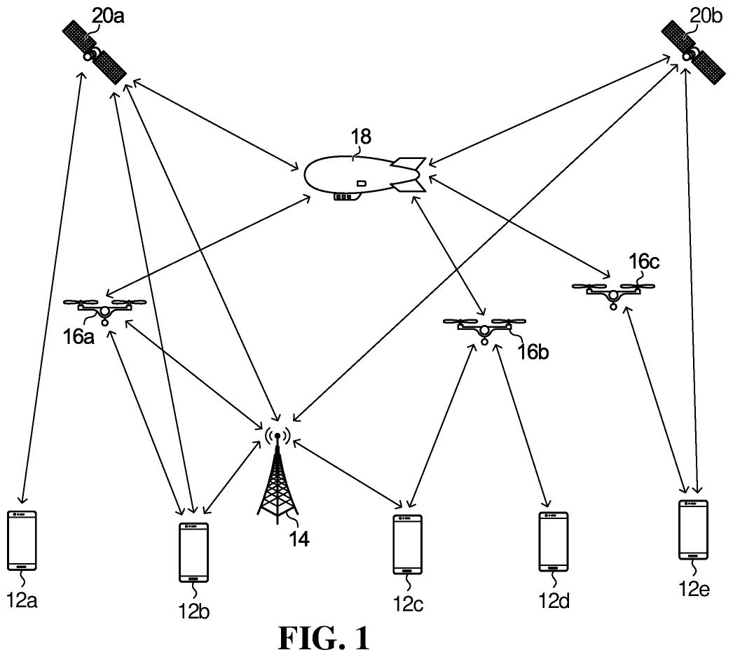

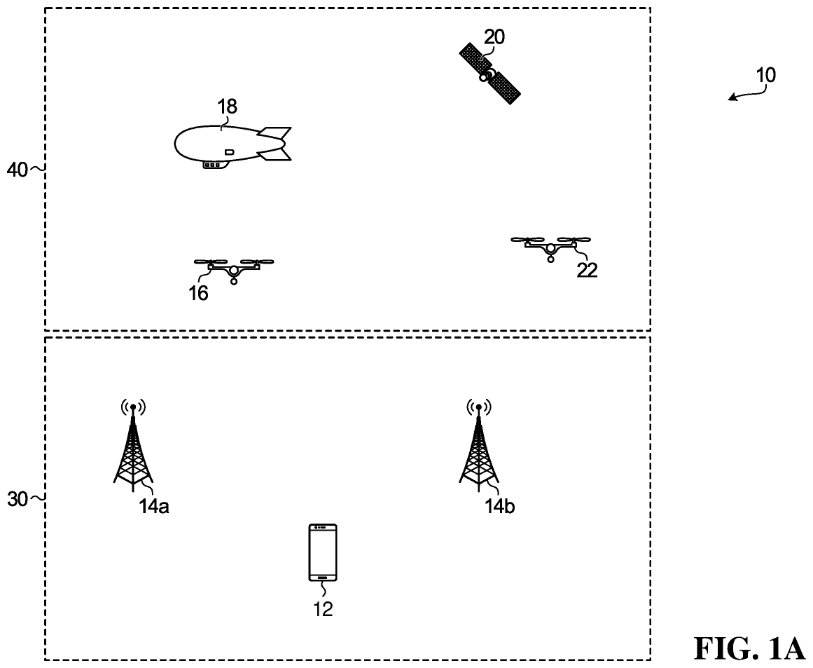

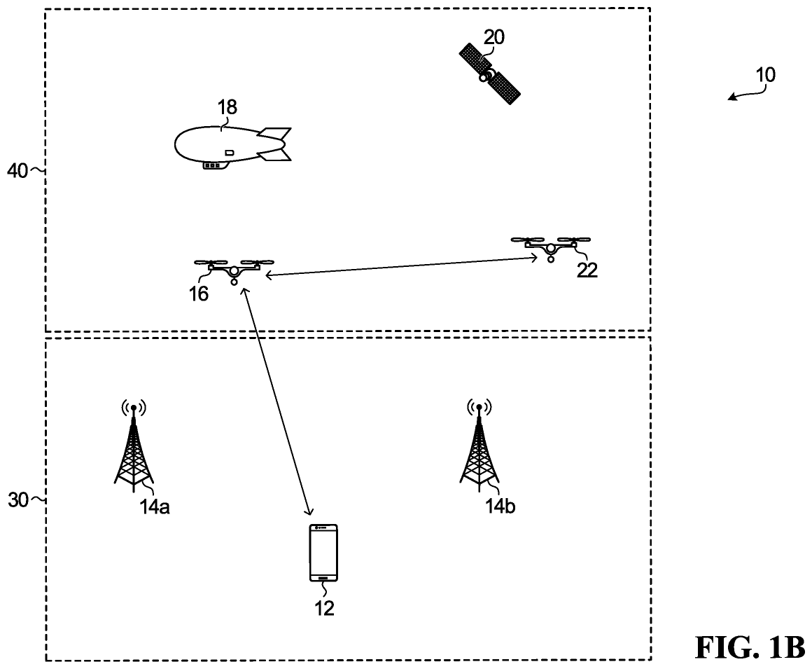

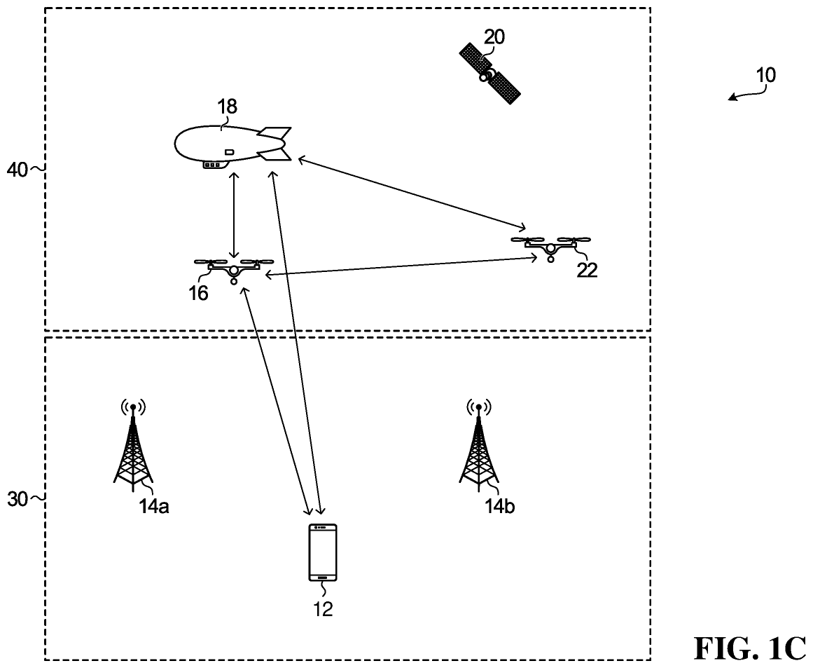

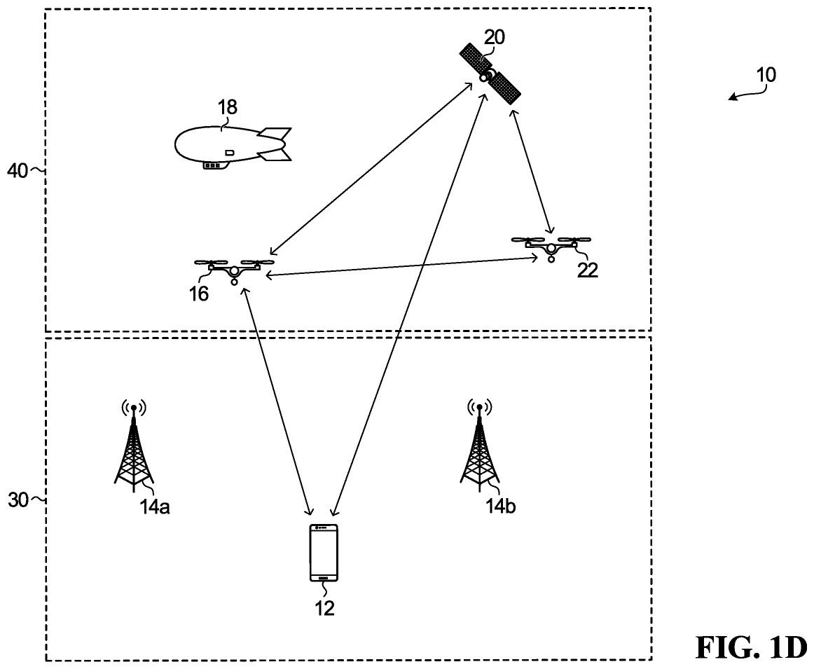

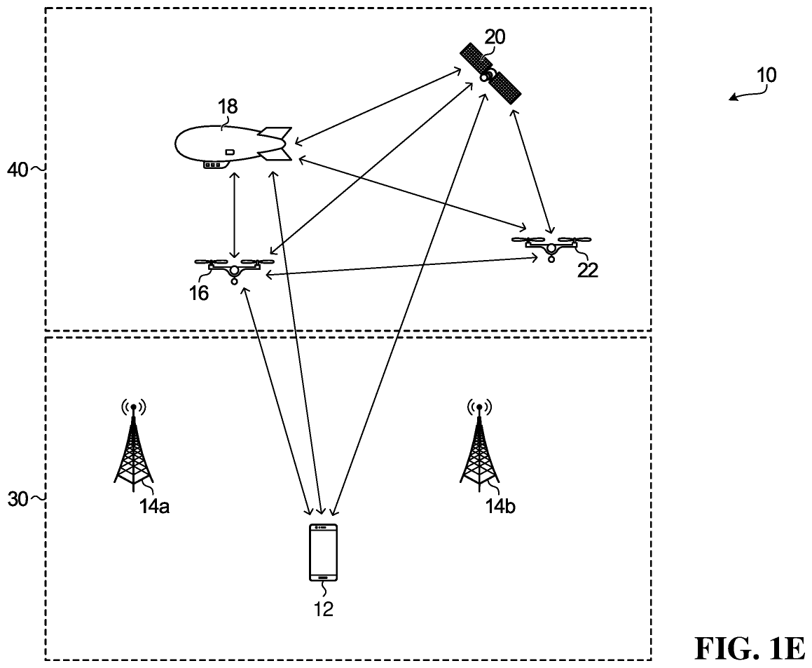

FIGS. 1 and 1A to 1F are block diagrams that provide simplified schematic illustrations of communication systems according to some embodiments.

One example design of a future network illustrated in FIG. 1 is a self-organized ubiquitous hierarchical network. Such a network may include or support such features as any of the following:
multi-layer deployment:
   a satellite-based transmit and receive points (TRPs) carried by or otherwise implemented in or on satellites, which may include low earth orbit (LEO) satellites and/or very low earth orbit (VLEO) satellites, for example,
   a UAVs (or unmanned aerial systems (UASs)), also referred to as flying TRPs, with high, medium, or low altitude airborne platform(s),
   a balloon-based TRPs,
   a quadcopter-based TRPs,
   a drone-based TRPs,
   a cellular TRPs,
   a other types of TRPs,
   a fleet of drones carried by and dispatched from an airship or airborne platform;
satellite and cellular TRPs form a basic communications system:
   flying TRPs can be deployed on-demand—for example, a fleet of drones can be carried by an airship or airborne platform and dispatched in a region that requires a service boost,
   networks or network segments may be self-formed, self-backhauling, and/or self-optimized, for example:
      an anchor or central node may be or include an airborne platform, a balloon-based TRP, or a high-capacity drone, and another drone-based TRP can be considered as a flying integrated access backhaul (IAB) node.

Over the past few decades, wireless networks have predominantly consisted of static terrestrial access points. However, considering the prevalence of UAVs, HAPSs, and VLEO satellites and the desire to integrate satellite communications into cellular networks, future networks likely will no longer be “horizontal” and two-dimensional. 3D “vertical” networks may include many moving and high-altitude access points, potentially including but not necessarily limited to geostationary satellites, such as UAVs, HAPSs, and VLEO satellites, as illustrated in FIG. 1.

The example in FIG. 1 includes both terrestrial and non-terrestrial components. The terrestrial and non-terrestrial components could be considered sub-systems or sub-networks of an integrated system or network. The terrestrial TRP 14 in FIG. 1 is an example of a terrestrial component. Non-terrestrial components in FIG. 1 include multiple non-terrestrial TRPs, which in the example shown are drone-based TRPs 16a, 16b, 16c, a balloon-based TRP 18, and satellite-based TRPs 20a-20b. UEs 12a, 12b, 12c, 12d, 12e are also shown in FIG. 1 as examples of terminal devices.

A new challenge for future networks is to support a diverse and heterogeneous range of access points, preferably with self-organization to seamlessly integrate new UAVs or passing low-orbit satellites for example, into a network without needing to reconfigure UEs. As a result of their relative proximity to the ground, UAVs, HAPSs, and VLEO satellites can carry out functions similar to terrestrial base stations, and can thus be seen as a new type of base station, albeit bringing a new set of challenges to be overcome. While such new types of base stations can utilize an air interface and frequency bands similar to those in terrestrial communication systems, a new approach may be desirable for cell planning, cell acquisition, and handover among non-terrestrial access nodes or between terrestrial and non-terrestrial access nodes. Moreover, similar to their terrestrial counterparts, non-terrestrial nodes and the devices with which they communicate may use adaptive and dynamic wireless backhaul to maintain connectivity. Supporting such diverse and heterogeneous access points with self-organization but without the need for high overhead reconfiguration remains a challenge. Solutions based on a virtualized air interface, for example, should simplify such features or functions as cell and TRP acquisition as well as data and control routing, to efficiently and seamlessly integrate non-terrestrial nodes with an underlying terrestrial network. Consequently, the addition and deletion of aerial access points, for example, should be largely transparent to end terminal devices such as UEs, beyond the physical-layer operations such as uplink (UL)/downlink (DL) synchronization, beamforming, measurement, and feedback associated with vertical access points.

Future networks that integrate terrestrial and non-terrestrial networks may aim to share a unified PHY and MAC layer design, so that the same modem chip equipped with an integrated protocol stack can support both terrestrial and non-terrestrial communications. Although a single chipset makes sense from a cost perspective, it is quite challenging to achieve due to the different design requirements for terrestrial and non-terrestrial networks, which may impact such factors as physical layer signal design, waveform, and adaptive modulation and coding (AMC). For example, satellite communication systems may have a stringent peak to average power ratio (PAPR) requirement. Although NR numerology has been optimized for low-latency communications, satellite communications should preferably be able to accommodate long transmission latency. A unified PHY/MAC design framework may be flexibly dimensioned and tailored via several parameters to accommodate different deployment scenarios, with native support for airborne or space-borne non-terrestrial communications.

Turning now to FIGS. 1A to 1F, various example integrated TN and NTN scenarios are considered. In these drawings, a communication system 10 includes both a terrestrial communication system 30 and a non-terrestrial communication system 40. The terrestrial communication system 30 and the non-terrestrial communication system 40 could be considered sub-systems of the communication system 10, or sub-networks of the same integrated network, but are referred to herein primarily as systems 30, 40 for ease of reference. The terrestrial communication system 30 includes multiple terrestrial TRPs (T-TRPs) 14a-14b. The non-terrestrial communication system 40 includes multiple non-terrestrial TRPs (NT-TRPs) 16, 18, 20.

A terrestrial TRP is a TRP that is, in some way, physically bound to the ground. For example, a terrestrial TRP could be mounted on a building or tower. A terrestrial communication system may also be referred to as a land-based or ground-based communication system, although a terrestrial communication system can also, or instead, be implemented on or in water.

A non-terrestrial TRP is any TRP that is not physically bound to the ground. A flying TRP is an example of a non-terrestrial TRP. A flying TRP may be implemented using communication equipment supported or carried by a flying device. Non-limiting examples of flying devices include airborne platforms (such as a blimp or an airship, for example), balloons, quadcopters and other aerial vehicles. In some implementations, a flying TRP may be supported or carried by a UAS or a UAV, such as a drone. A flying TRP may be a movable or mobile TRP that can be flexibly deployed in different locations to meet network demand. A satellite TRP is another example of a non-terrestrial TRP. A satellite TRP may be implemented using communication equipment supported or carried by a satellite. A satellite TRP may also be referred to as an orbiting TRP.

The non-terrestrial TRPs 16, 18 are examples of flying TRPs. More particularly, the non-terrestrial TRP 16 is illustrated as a quadcopter TRP (i.e., communication equipment carried by a quadcopter), and the non-terrestrial TRP 18 is illustrated as an airborne platform TRP (i.e., communication equipment carried by an airborne platform). The non-terrestrial TRP 20 is illustrated as a satellite TRP (i.e., communication equipment carried by a satellite).

The altitude, or height above the earth's surface, at which a non-terrestrial TRP operates is not limited herein. A flying TRP could be implemented at high, medium or low altitudes. For example, the operational altitude of airborne platform TRP or a balloon TRP could be between 8 and 50 km. The operational altitude of quadcopter TRP, in an example, could be between several meters and several kilometers, such as 5 km. In some embodiments, the altitude of a flying TRP is varied in response to network demands. The orbit of a satellite TRP is implementation specific, and could be a low earth orbit, a very low earth orbit, a medium earth orbit, a high earth orbit or a geosynchronous earth orbit, for example. A geostationary earth orbit is a circular orbit at 35,786 km above the earth's equator and following the direction of the earth's rotation. An object in such an orbit has an orbital period equal to the earth's rotational period and thus appears motionless, at a fixed position in the sky, to ground observers. A low earth orbit is an orbit around the around earth with an altitude between 500 km (orbital period of about 88 minutes), and 2,000 km (orbital period of about 127 minutes). A medium earth orbit is a region of space around the earth above a low earth orbit and below a geostationary earth orbit. A high earth orbit is any orbit that is above a geostationary orbit. In general, the orbit of a satellite TRP is not limited herein.

Non-terrestrial TRPs can be located at various altitudes, in addition to being located at various longitudes and latitudes, and accordingly a non-terrestrial communication system can form a three-dimensional (3D) communication system. For example, a quadcopter TRP could be implemented 100 m above the surface of the earth, an airborne platform TRP could be implemented between 8 and 50 km above the surface of the earth, and a satellite TRP could be implemented 10,000 km above the surface of the earth. A 3D wireless communication system can have extended coverage compared to a terrestrial communication system and enhance service quality for UEs. However, the configuration and design of a 3D wireless communication system may also be more complex.

Non-terrestrial TRPs may be implemented to service locations that are difficult to service using a terrestrial communication system. For example, a UE could be in an ocean, desert, mountain range or another location at which it is difficult to provide wireless coverage using a terrestrial TRP. Non-terrestrial TRPs are not bound to the ground, and are therefore able to more easily provide wireless access to UEs, especially UEs that are in more isolated or less accessible areas.

Non-terrestrial TRPs may be implemented to provide additional temporary capacity in an area where many UEs have been gathered for a period of time, such as a sporting event, concert, festival or other event that draws a large crowd. The additional UEs may exceed the normal capacity for that area.

Non-terrestrial TRPs may instead be deployed for fast disaster recovery. For example, a natural disaster in a particular area could place strain on a wireless communication system. Some terrestrial TRPs could be damaged by the disaster. In addition, network demands could be elevated during or after a natural disaster as UEs are used to try to contact help or loved ones. Non-terrestrial TRPs could be rapidly transported to the area of a natural disaster to enhance wireless communications in the area.

The communication system 10 further includes a terrestrial UE 12 and a non-terrestrial UE 22, which may or may not be considered part of the terrestrial communication system 30 and the non-terrestrial communication system 40, respectively. A terrestrial UE is bound to the ground. For example, a terrestrial UE could be a UE that is operated by a user on the ground. There are many different types of terrestrial UEs, including (but not limited to) cell phones, sensors, cars, trucks, buses, and trains. In contrast, a non-terrestrial UE is not bound to the ground. For example, a non-terrestrial UE could be implemented using a flying device or a satellite. A non-terrestrial UE that is implemented using a flying device may be referred to as a flying UE, whereas a non-terrestrial UE that is implemented using a satellite may be referred to as a satellite UE. Although the non-terrestrial UE 22 is depicted as a flying UE implemented using a quadcopter in FIG. 1A, this is only an example. A flying UE could instead be implemented using an airborne platform or a balloon. In some implementations, the non-terrestrial UE 22 is a drone that is used for surveillance in a disaster area, for example.

The communication system 10 can provide any of a wide range of communication services to UEs through the joint operation of multiple different types of TRPs. These different types of TRPs can include any terrestrial and/or non-terrestrial TRPs disclosed herein. In a non-terrestrial communication system, there may be different type of non-terrestrial TRPs, including satellite TRPs, airborne platform TRPs, balloon TRPs and quadcopter TRPs.

In general, different types of TRPs have different functions and/or capabilities in a communication system. For example, different types of TRPs may support different data rates of communications. The data rate of communications provided by quadcopter TRPs may be higher than the data rate of communications provided by airborne platform TRPs, balloon TRPs, and satellite TRPs. The data rate of communications provided by the airborne platform TRPs and balloon TRPs may be higher than the data rate of communications provided satellite TRPs. Thus, for example, satellite TRPs may provide low data rate communications to UEs, e.g., up to 1 Mbps. On the other hand, airborne platform TRPs and balloon TRPs may provide low to medium data rate communications to UEs, e.g., up to 10 Mbps. Quadcopter TRPs could provide high data rate communications to a UE in certain circumstances, e.g., 100 Mbps and above. It is noted that the terms of low, medium, and high in this disclosure are explanations to show the relative difference between different types of TRPs. The specific values of the data rates given to the low, medium, and high data rates are just examples in this disclosure, not limited to the examples provided. In some examples, some types of TRPs may act as antennas or remote radio units (RRUs), and some types of TRPs may act as base stations that have more sophisticated functions and are able to coordinate other RRU-type TRPs.

In some embodiments, different types of TRPs in a communication system may be used to provide different types of service to a UE. For example, satellite TRPs, airborne platform TRPs and balloon TRPs may be used for wide area sensing and sensor monitoring, while quadcopter TRPs can be used for traffic monitoring. In another example, a satellite TRP is used to provide wide area voice service, while a quadcopter TRP is used to provide high speed data service as a hot spot. Different types of TRPs can be turned-on (i.e., established, activated or enabled), turned-off (i.e., released, deactivated or disabled) and/or configured based on the needs of a service, for example.

In some embodiments, satellite TRPs are a separate and distinct type of TRP. In some embodiments, flying TRPs and terrestrial TRPs are the same type of TRP. However, this might not always be the case. Flying TRPs can instead be treated as a distinct type of TRP that is different from terrestrial TRPs. Flying TRPs might also include multiple different types of TRPs in some embodiments. For example, airborne platform TRPs, balloon TRPs, quadcopter TRPs and/or drone TRPs may or may not be classified as different types of TRPs. Flying TRPs that are implemented using the same type of flying device but have different communication capabilities or functions may or may not be classified as different types of TRPs.

In some embodiments, a particular TRP is capable of functioning as more than one TRP type. For example, the TRP could switch between different types of TRPs. The TRP could be actively or dynamically configured as one of the TRP types by the network, which may be changed as network demands change. The TRP may also or instead switch to act as a UE.

Referring again to the communication system 10, multiple different types of TRPs could be defined. For example, the terrestrial TRPs 14a-14b could be a first type of TRP, the flying TRP 16 could be a second type of TRP, the flying TRP 18 could be a third type of TRP, and the satellite TRP 20 could be a fourth type of TRP. In some implementations, one or more of the TRPs in the communication system 10 are capable of dynamically switching between different TRP types.

In some embodiments, different types of TRPs are organized into different sub-systems in a communication system. For example, four sub-systems may exist in the communication system 10. The first sub-system is a satellite sub-system including at least the satellite TRP 20, the second sub-system is an airborne sub-system including at least the airborne platform TRP 18, the third sub-system is a low-height flying sub-system including at least the quadcopter TRP 16 and possibly other low-height flying TRPs, and the fourth sub-system is a terrestrial sub-system including at least the terrestrial TRPs 14a-14b. In another examples, airborne platform TRP 18 and satellite TRP 20 can be categorized as one sub-system. In yet another example, quadcopter TRP 16 and terrestrial TRPs 14a-14b can be categorized as one sub-system. In a further example, quadcopter TRP 16, airborne platform TRP 18 and satellite TRP 20 can be categorized as one sub-system.

Throughout this disclosure, the term “connection” or “link” in the context of a UE-TRP connection or link refers to a communication connection established between a UE and a TRP, either directly or indirectly relayed by other TRPs. Consider FIG. 1D as an example. There exist three connections between the UE 12 and the satellite TRP 20. The first connection is the direct connection between the UE 12 and the satellite TRP 20, the second connection is the connection of UE 12-TRP 16-TRP 20, and the third connection is the connection of UE 12-TRP 16-TRP 22-TRP 20. When a connection between a UE and a TRP is established indirectly and relayed by other TRPs, the direct link between the UE and one of the other TRPs can be referred to as an access link, while other links between the TRPs can be referred to as backhauls or backhaul links. For example, in the third connection, the link UE 12-TRP 16 is the access link, and the links TRP 16-TRP 22 and TRP 22-TRP are backhaul links. The term “sub-system” refers to a communication sub-system comprising at least a given type of TRPs, which have high base station capabilities and can provide communication services to UEs, possibly together with other types of TRPs act as relaying TRPs. For example, a satellite sub-system in FIG. 1D can include at least the satellite TRP 20, the quadcopter TRP 16 and the quadcopter TRP 22. Other types of connections and links are also disclosed herein, including sidelinks between UEs.

Different types of TRPs can have different base station capabilities. For example, any two or more of the terrestrial TRPs 14a-14b and the non-terrestrial TRPs 16, 18, 20 could have different base station capabilities. In some examples, base station capabilities refer to at least one of abilities of baseband signal processing, scheduling or controlling data transmissions to/from UEs within its service area. Different base station capabilities relate to the relative functionality that is provided by a TRP. A group of TPRs may be classified into different levels, such as low base station capability TRP, medium base station capability TRP, and high base station capability TRP. For example, low base station capability means no or low ability of baseband signal processing, scheduling and controlling data transmissions. The low base station capability TRP may transmit data to UEs. An example of a TPR with low base station capability is a relay or IAB. Medium base station capability means medium ability of scheduling and controlling data transmissions. An example of a TRP with medium capability is a TRP having capabilities of baseband signal processing and transmission, or a TRP worked as a distributed antenna having a baseband signal processing capability and transmission capability. High base station capability means with full or most of the ability of scheduling and controlling data transmission. Such an example is the terrestrial base stations 14a, 14b. On the other hand, no base station capability means not only no ability of scheduling and controlling data transmissions, but also no ability to transmit data to UEs with a role like a base station. A TRP with no base station capability can act as a UE, or a distributed antenna that is operated as a remote radio unit, or a radio frequency transmitter having no signal processing, scheduling and controlling capabilities. It is noted that base station capabilities in this disclosure are just examples, and the present disclosure is not limited to these examples. Base station capabilities may have other classifications based on demand, for example.

In some embodiments, different non-terrestrial TRPs in a communication system are categorized as non-terrestrial TRPs with: no base station capability, low base station capability, medium base station capability and high base station capability. A TRP with no base station capability acts as a UE, whereas a non-terrestrial TRP with high base station capability has similar functionality to a terrestrial base station. Examples of TRPs with low base station capabilities, medium base station capabilities and high base station capabilities are provided elsewhere herein. Non-terrestrial TRPs with different base station capabilities might have different network requirements or network costs in a communication system.

In some embodiments, a TRP is capable of switching between high, medium and low base station capabilities. For example, a non-terrestrial TRP with relatively high base station capabilities can switch to act as a non-terrestrial TRP with relatively low base station capabilities, e.g. a non-terrestrial TRP with high base station capabilities can act as a non-terrestrial TRP with low base station capabilities for power savings. In another example, a non-terrestrial TRP with low, medium or high base station capabilities can also switch to act as a non-terrestrial TRP with no base station capabilities such as a UE.

Different types of TRPs can also have different network configurations or designs. For example, different types of TRPs may communicate with the UEs using different mechanisms. In contrast, multiple TRPs that are all the same type of TRP may use the same mechanisms to communicate with UEs. Different mechanisms of communication could include the use of different air interface configurations or air interface designs, for example. Different air interface designs could include different waveforms, different numerologies, different frame structures, different channelization (for example, channel structure or time-frequency resource mapping rules), and/or different retransmission mechanisms.

Control channel search spaces can also vary for different types of TRPs. In one example, when the non-terrestrial TRPs 16, 18, 20 are all different types of TRPs, each of the non-terrestrial TRPs 16, 18, 20 may have different control channel search spaces. Control channel search spaces may also vary for different communication systems or sub-systems. For example, the terrestrial TRPs 14a-14b in the terrestrial communication system 30 can be configured with a different control channel search space than the non-terrestrial TRPs 16, 18, 20 in the non-terrestrial communication system 40. At least one terrestrial TRP may have the ability to support or be configured with a larger control channel search space than at least one non-terrestrial TRP.

The terrestrial UE 12 may be configured to communicate with the terrestrial communication system 30, the non-terrestrial communication system 40, or both. Similarly, the non-terrestrial UE 22 may be configured to communicate with the terrestrial communication system 30, the non-terrestrial communication system 40, or both. FIGS. 1B to 1E illustrate double-headed arrows that each represent a wireless connection between a TRP and a UE, or between two TRPs. A connection, which may also be referred to as a wireless link or simply a link, enables communication (i.e., transmission and/or reception) between two devices in a communication system. For example, a connection can enable communication between a UE and one or multiple TRPs, between different TRPs, or between different UEs. A UE can form one or more connections with terrestrial TRPs and/or non-terrestrial TRPs in a communication system. In some cases, a connection is a dedicated connection for unicast transmission. In other cases, a connection is a broadcast or multicast connection between a group of UEs and one or multiple TRPs. A connection could support or enable uplink, downlink, sidelink, inter-TRP link and/or backhaul channels. A connection could also support or enable control channels and/or data channels. In some embodiments, different connections could be established for control channels, data channels, uplink channels and/or downlink channels between UE and one or multiple TRPs. This is an example of decoupling control channels, data channels, uplink channels, sidelink channels and/or downlink channels.

Referring to FIG. 1B, shown is the terrestrial UE 12 and the non-terrestrial UE 22 each having a connection to the non-terrestrial TRP 16. Each connection provides a single link that could provide wireless access to the terrestrial UE 12 and the non-terrestrial UE 22, respectively. In some implementations, multiple flying TRPs could be connected to a terrestrial or non-terrestrial UE to provide multiple parallel connections to the UE.

As noted above, a flying TRP may be a moveable or mobile TRP that can be flexibly deployed in different locations to meet network demand. For example, if the terrestrial UE 12 is suffering from poor wireless service in a particular location, the non-terrestrial TRP 16 may be repositioned to the location close to the terrestrial UE 12 and connect to the terrestrial UE 12 to improve the wireless service. Accordingly, non-terrestrial TRPs can provide regional service boosts based on network demand.

Non-terrestrial TRPs can be positioned closer to UEs and may be able to more easily form a line-of-sight (LOS) connection to the UEs. As such, transmit power at the UE might be reduced, which leads to power savings. Overhead reduction may also be achieved by providing wide-area coverage for a UE, which could result in reducing the number of cell-to-cell handovers and initial access procedures that the UE may perform, for example.

FIG. 1C illustrates an example of UEs having connections to different types of flying TRPs. FIG. 1C is similar to FIG. 1B, but also includes a connection between the non-terrestrial TRP 18 and the terrestrial UE 12 and a connection between the non-terrestrial TRP 18 and the non-terrestrial UE 22. Further, a connection is formed between the non-terrestrial TRP 16 and the non-terrestrial TRP 18 in the example shown.

In some implementations, the non-terrestrial TRP 18 acts as an anchor node or central node to coordinate the operation of other TRPs such as the non-terrestrial TRP 16. An anchor node or central node is an example of a controller in a communication system. For example, in a group of multiple flying TRPs, one of the flying TRPs could be designated as a central node. This central node then coordinates operation of the group of flying TRPs. The choice of a central node could be pre-configured or be actively configured by the network, for example. The choice of central node could also or instead be negotiated by multiple TRPs in a self-configured network. In some implementations, a central node is an airborne platform or a balloon, however this might not always be the case. In some embodiments, each non-terrestrial TRP in a group is fully under the control of a central node, and the non-terrestrial TRPs in the group do not communicate with each other. A central node may be implemented by a high base station capability TRP, for example. A non-terrestrial TRP with high base station capability can also act as a distributed node that is under the control of a central node.

In FIG. 1C, the non-terrestrial TRP 16 can provide a relay connection from the non-terrestrial TRP 18 to either or both of the terrestrial UE 12 and the non-terrestrial UE 22. For example, communications between the terrestrial UE 12 and the non-terrestrial TRP 18 can be forwarded via the non-terrestrial TRP 16 acting as a relay node. Similar comments apply to communications between the non-terrestrial UE 22 and the non-terrestrial TRP 18.

A relay connection uses one or more intermediate TRPs, or relay nodes, to support communication between a TRP and a UE. For example, a UE may be trying to access a high base station capability TRP, but the channel between the UE and the high base station capability TRP is too poor to form a direct connection. In such a case, one or more flying TRPs may be deployed as relay nodes between the UE and the high base station capability TRP to enable communication between the UE and the high base station capability TRP. A transmission from the UE could be received by one relay node and forwarded along the relay connection until the transmission reaches the high base station capability TRP. Similar comments apply to a transmission from high base station capability TRP to the UE. In a relay connection, each relay node that is traversed by a communication in a relay connection may be referred to as a “hop”. Relay nodes may be implemented using low base station capability TRPs, for example.

FIG. 1D illustrates an example of UEs having connections to a flying TRP and to a satellite TRP. Specifically, FIG. 1D illustrates the connections shown in FIG. 1B, and additional connections between the non-terrestrial TRP 20 and the terrestrial UE 12, the non-terrestrial UE 22 and the non-terrestrial TRP 16. The non-terrestrial TRP 20 is implemented using a satellite, and may be able to form wireless connections to the terrestrial UE 12, the non-terrestrial UE 22 and the non-terrestrial TRP 16 even when these devices are in remote locations. In some implementations, the non-terrestrial TRP 16 could be implemented as a relay node between the non-terrestrial TRP 20 and the terrestrial UE 12, and/or between the non-terrestrial TRP and the non-terrestrial UE 22, to help further enhance the wireless coverage for the terrestrial UE 12 and/or the non-terrestrial UE 22. For example, the non-terrestrial TRP 16 could boost the signal power coming from the non-terrestrial TRP 20. In FIG. 1D, the non-terrestrial TRP 20 could be a high base station capability TRP that optionally acts as a central node.

FIG. 1E illustrates a combination of the connections shown in FIGS. 1C and 1D. In this example, the terrestrial UE 12 and the non-terrestrial UE 22 are serviced by multiple different types of flying TRPs and a satellite TRP. The non-terrestrial TRPs 16, 18 could act as relay nodes in a relay connection to the terrestrial UE 12 and/or the non-terrestrial UE 22. In FIG. 1E, either or both of the non-terrestrial TRPs 18, 20 could be high base station capability TRPs that act as central nodes.

The non-terrestrial TRP 18 may simultaneously have two roles in the communication system 10. For example, the terrestrial UE 12 may have two separate connections, one to the non-terrestrial TRP 18 (via the non-terrestrial TRP 16), and the other to the non-terrestrial TRP 20 (via the non-terrestrial TRP 16 and the non-terrestrial TRP 18). In the connection to the non-terrestrial TRP 18, the non-terrestrial TRP 18 is acting as a central node. In the connection to the non-terrestrial TRP 20, the non-terrestrial TRP 18 is acting as a relay node. Additionally, the non-terrestrial TRP 18 can have wireless backhaul links with the non-terrestrial TRP 20, to enable coordination between the non-terrestrial TRPs 18, 20 to form the two connections for providing service to the terrestrial UE 12.

Referring now to FIG. 1F, shown is an example integration of the terrestrial communication system 30 and the non-terrestrial communication system 40. The integration of terrestrial and non-terrestrial communication systems may also be referred to as the joint operation of terrestrial and non-terrestrial communication systems. Conventionally, terrestrial communication systems and non-terrestrial communication systems have been deployed independently or separately.

In FIG. 1F, the terrestrial TRP 14a has connections to the non-terrestrial TRP 16 and to the terrestrial UE 12. The terrestrial TRP 14b has further connections to each of the non-terrestrial TRPs 16, 18, 20, the terrestrial UE 12 and the non-terrestrial UE 22. Accordingly, the terrestrial UE 12 and the non-terrestrial UE 22 are both serviced by the terrestrial communication system 30 and the non-terrestrial communication system 40, and are able to benefit from the functionalities provided by each of these communication systems.

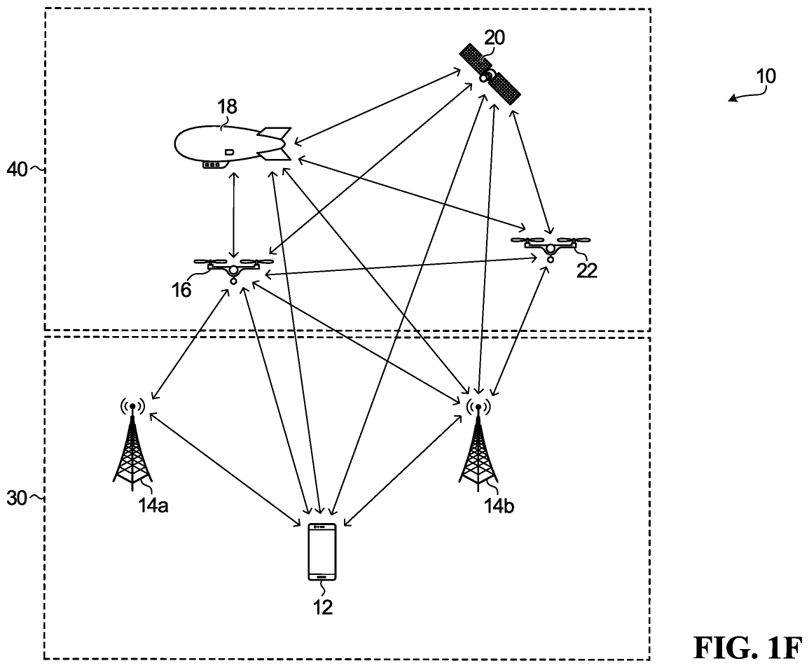

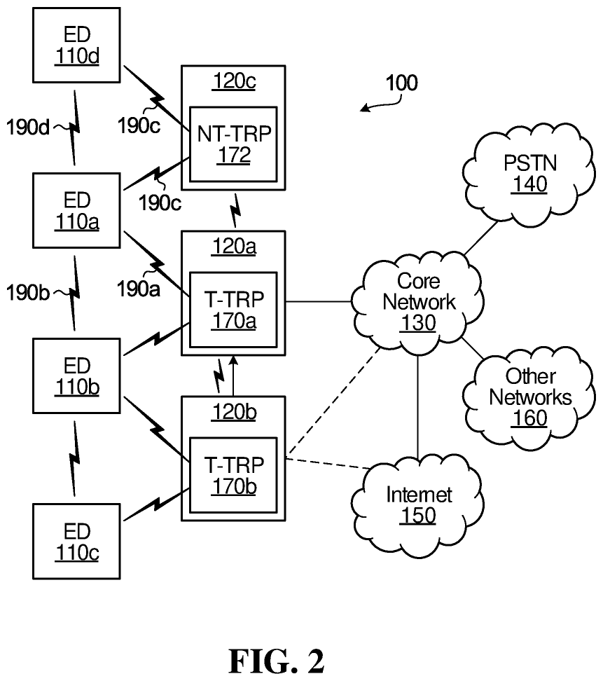

FIG. 2 illustrates another example communication system 100. In general, the communication system 100 enables multiple wireless or wired elements to communicate data and other content. The purpose of the communication system 100 may be to provide content, such as voice, data, video, and/or text, via broadcast, multicast and unicast, etc. The communication system 100 may operate by sharing resources, such as carrier spectrum bandwidth, between its constituent elements. The communication system 100 may include a terrestrial communication system and/or a non-terrestrial communication system. The communication system 100 may provide a wide range of communication services and applications (such as earth monitoring, remote sensing, passive sensing and positioning, navigation and tracking, autonomous delivery and mobility, etc.). The communication system 100 may provide a high degree of availability and robustness through a joint operation of the terrestrial communication system and the non-terrestrial communication system. For example, integrating a non-terrestrial communication system (or components thereof) into a terrestrial communication system can result in what may be considered a heterogeneous network comprising multiple layers. Compared to conventional communication networks, the heterogeneous network may achieve better overall performance through efficient multi-link joint operation, more flexible functionality sharing, and faster physical layer link switching between terrestrial networks and non-terrestrial networks.

The terrestrial communication system and the non-terrestrial communication system could be considered sub-systems of the communication system. In the example shown, the communication system 100 includes electronic devices (ED) 110a-110d (generically referred to as ED 110), radio access networks (RANs) 120a-120b, non-terrestrial communication network 120c, a core network 130, a public switched telephone network (PSTN) 140, the internet 150, and other networks 160. The RANs 120a-120b include respective base stations (BSs) 170a-170b, which may be generically referred to as terrestrial transmit and receive points (T-TRPs) 170a-170b. The non-terrestrial communication network 120c includes an access node 120c, which may be generically referred to as a non-terrestrial transmit and receive point (NT-TRP) 172.

Any ED 110 may be alternatively or additionally configured to interface, access, or communicate with any other T-TRP 170a-170b and NT-TRP 172, the internet 150, the core network 130, the PSTN 140, the other networks 160, or any combination thereof. In some examples, ED 110a may communicate an uplink and/or downlink transmission over an interface 190a with T-TRP 170a. In some examples, the EDs 110a, 110b and 110d may also communicate directly with one another via one or more sidelink air interfaces 190b, 190d. In some examples, ED 110d may communicate an uplink and/or downlink transmission over an interface 190c with NT-TRP 172.

The air interfaces 190a and 190b may use similar communication technology, such as any suitable radio access technology. For example, the communication system 100 may implement one or more channel access methods, such as code division multiple access (CDMA), time division multiple access (TDMA), frequency division multiple access (FDMA), orthogonal FDMA (OFDMA), or single-carrier FDMA (SC-FDMA) in the air interfaces 190a and 190b. The air interfaces 190a and 190b may utilize other higher dimension signal spaces, which may involve a combination of orthogonal and/or non-orthogonal dimensions.

The air interface 190c can enable communication between the ED 110d and one or multiple NT-TRPs 172 via a wireless link or simply a link. For some examples, the link is a dedicated connection for unicast transmission, a connection for broadcast transmission, or a connection between a group of EDs and one or multiple NT-TRPs for multicast transmission.

The RANs 120a and 120b are in communication with the core network 130 to provide the EDs 110a 110b, and 110c with various services such as voice, data, and other services. The RANs 120a and 120b and/or the core network 130 may be in direct or indirect communication with one or more other RANs (not shown), which may or may not be directly served by core network 130, and may or may not employ the same radio access technology as RAN 120a, RAN 120b or both. The core network 130 may also serve as a gateway access between (i) the RANs 120a and 120b or EDs 110a 110b, and 110c or both, and (ii) other networks (such as the PSTN 140, the internet 150, and the other networks 160). In addition, some or all of the EDs 110a 110b, and 110c may include functionality for communicating with different wireless networks over different wireless links using different wireless technologies and/or protocols. Instead of wireless communication (or in addition thereto), the EDs 110a 110b, and 110c may communicate via wired communication channels to a service provider or switch (not shown), and to the internet 150. PSTN 140 may include circuit switched telephone networks for providing plain old telephone service (POTS). Internet 150 may include a network of computers and subnets (intranets) or both, and incorporate protocols, such as internet protocol (IP), transmission control protocol (TCP), user datagram protocol (UDP). EDs 110a 110b, and 110c may be multimode devices capable of operation according to multiple radio access technologies, and incorporate multiple transceivers necessary to support such technologies.

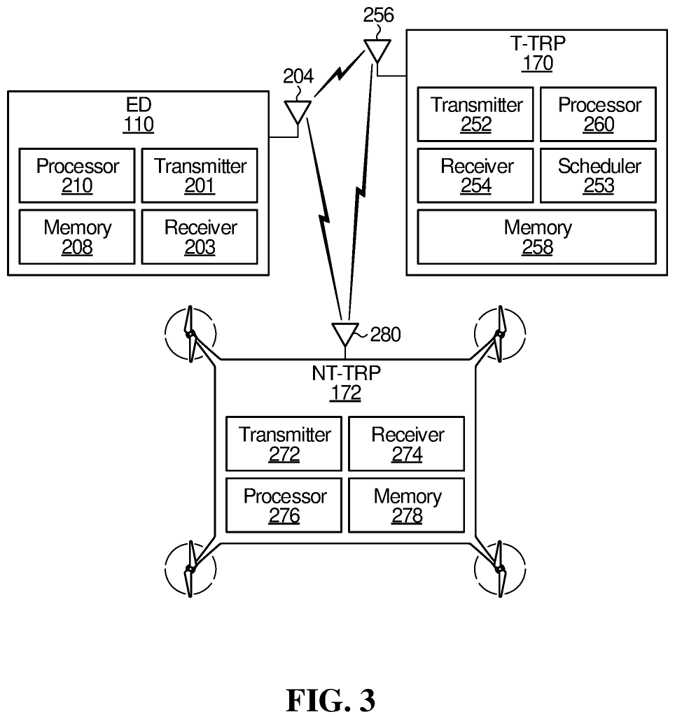

FIG. 3 illustrates another example of an ED 110 and network devices. The network devices are shown by way of example in FIG. 3 as base stations or T-TRPs 170a, 170b (at 170) and an NT-TRP 172. Non-limiting examples of network devices are system nodes, network entities, or RAN nodes (e.g. base stations, TRP, NT-TRP, etc.). The ED 110 is used to connect persons, objects, machines, etc. The ED 110 may be widely used in various scenarios, for example, cellular communications, device-to-device (D2D), vehicle to everything (V2X), peer-to-peer (P2P), machine-to-machine (M2M), machine-type communications (MTC), internet of things (IOT), virtual reality (VR), augmented reality (AR), industrial control, self-driving, remote medical, smart grid, smart furniture, smart office, smart wearable, smart transportation, smart city, drones, robots, remote sensing, passive sensing, positioning, navigation and tracking, autonomous delivery and mobility, etc. For example, the ED 110 may be a vehicle, or a media control unit (MCU) built into or otherwise carried by or installed in the vehicle.

Each ED 110 represents any suitable end user device for wireless operation and may include such devices (or may be referred to) as a user equipment/device (UE), a wireless transmit/receive unit (WTRU), a mobile station, a fixed or mobile subscriber unit, a cellular telephone, a station (STA), a machine type communication (MTC) device, a personal digital assistant (PDA), a smartphone, a laptop, a computer, a tablet, a wireless sensor, a consumer electronics device, a smart book, a vehicle, a car, a truck, a bus, a train, or an IoT device, an industrial device, or apparatus (e.g. communication module, modem, or chip) in the forgoing devices, among other possibilities. Future generation EDs 110 may be referred to using other terms. In some embodiments, an ED may be configured to function as a base station. For example, a UE may function as a scheduling entity, which provides sidelink signals between UEs in V2X, D2D, or P2P etc.

The base station 170a, 170b is a T-TRP and will hereafter be referred to as T-TRP 170. Also shown in FIG. 3, an NT-TRP will hereafter be referred to as NT-TRP 172. Each ED 110 connected to T-TRP 170 and/or NT-TRP 172 can be dynamically or semi-statically turned-on (i.e., established, activated, or enabled), turned-off (i.e., released, deactivated, or disabled) and/or configured in response to one of more of: connection availability and connection necessity.

The ED 110 includes a transmitter 201 and a receiver 203 coupled to one or more antennas 204. Only one antenna 204 is illustrated. One, some, or all of the antennas may alternatively be panels. The transmitter 201 and the receiver 203 may be integrated, e.g. as a transceiver. The transceiver is configured to modulate data or other content for transmission by at least one antenna 204 or network interface controller (NIC). The transceiver is also configured to demodulate data or other content received by the at least one antenna 204. Each transceiver includes any suitable structure for generating signals for wireless or wired transmission and/or processing signals received wirelessly or by wire. Each antenna 204 includes any suitable structure for transmitting and/or receiving wireless or wired signals.

The ED 110 includes at least one memory 208. The memory 208 stores instructions and data used, generated, or collected by the ED 110. For example, the memory 208 could store software instructions or modules configured to implement some or all of the functionality and/or embodiments described herein and that are executed by the processing unit(s) 210. Each memory 208 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, on-processor cache, and the like.

The ED 110 may further include one or more input/output devices (not shown) or interfaces (such as a wired interface to the internet 150). The input/output devices permit interaction with a user or other devices in the network. Each input/output device includes any suitable structure for providing information to or receiving information from a user, such as a speaker, microphone, keypad, keyboard, display, or touch screen, including network interface communications.

The ED 110 further includes a processor 210 for performing operations including those related to preparing a transmission for uplink transmission to the NT-TRP 172 and/or T-TRP 170, those related to processing downlink transmissions received from the NT-TRP 172 and/or T-TRP 170, and those related to processing sidelink transmission to and from another ED 110. Processing operations related to preparing a transmission for uplink transmission may include operations such as encoding, modulating, transmit beamforming, and generating symbols for transmission. Processing operations related to processing downlink transmissions may include operations such as receive beamforming, demodulating and decoding received symbols. Depending upon the embodiment, a downlink transmission may be received by the receiver 203, possibly using receive beamforming, and the processor 210 may extract signaling from the downlink transmission (e.g., by detecting and/or decoding the signaling). An example of signaling may be a reference signal transmitted by NT-TRP 172 and/or T-TRP 170. In some embodiments, the processor 210 implements the transmit beamforming and/or receive beamforming based on the indication of beam direction, e.g. beam angle information (BAI), received from T-TRP 170. In some embodiments, the processor 210 may perform operations relating to network access (e.g., initial access) and/or downlink synchronization, such as operations relating to detecting a synchronization sequence, decoding and obtaining the system information, etc. In some embodiments, the processor 210 may perform channel estimation, e.g. using a reference signal received from the NT-TRP 172 and/or T-TRP 170.

Although not illustrated, the processor 210 may form part of the transmitter 201 and/or receiver 203. Although not illustrated, the memory 208 may form part of the processor 210.

In some implementations (not shown in the drawing), the ED 110 may include an interface and a processor. The processor 210 may optionally store a program. The ED 110 may optionally include a memory, shown by way of example at 208. The memory may optionally store a program for execution by the processor 210. These components work together to provide the ED with various functionality described in this disclosure. For example, an ED processor and interface may work together to provide wireless connectivity between a TRP and an ED. The processor and the interface may work together to implement downlink transmission and/or uplink transmission of the ED. This type of more generalized structure, including an interface and a processor, and optionally a memory, may also or instead apply to a TRP and/or other types of network devices.

The processor 210, and one or more processing components of the transmitter 201 and/or the receiver 203, may each be implemented by the same or different one or more processors that are configured to execute instructions stored in a memory (e.g., in memory 208). Alternatively, some or all of the processor 210 and one or more processing components of the transmitter 201 and/or the receiver 203 may be implemented using dedicated circuitry, such as a programmed field-programmable gate array (FPGA), a graphical processing unit (GPU), or an application-specific integrated circuit (ASIC).

A TRP (NT-TRP, T-TRP, or TRP) disclosed in this disclosure may be known by other names in some implementations, such as a base station. The base station may be used in a broader sense and referred to by any of various names, for example: a base transceiver station (BTS), a radio base station, a network node, a network device, a device on the network side, a transmit/receive node, a Node B, an evolved NodeB (eNodeB or eNB), a Home eNodeB, a next Generation NodeB (gNB), a transmission point (TP), a site controller, an access point (AP), or a wireless router, a relay station, a remote radio head, a terrestrial node, a terrestrial network device, or a terrestrial base station, base band unit (BBU), remote radio unit (RRU), active antenna unit (AAU), remote radio head (RRH), central unit (CU), distributed unit (DU), positioning node, among other possibilities. A TRP may be macro BSs, pico BSs, relay node, donor node, or the like, or combinations thereof. A TRP may refer to the forgoing devices, or to apparatus (e.g., communication module, modem, or chip) in the forgoing devices.

In some embodiments, the parts of a TRP may be distributed. For example, some of the modules of the T-TRP 170 may be located remote from the equipment housing the antennas of the T-TRP 170, and may be coupled to the equipment housing the antennas over a communication link (not shown) sometimes known as front haul, such as common public radio interface (CPRI). Therefore, in some embodiments, the term TRP may also refer to modules on the network side that perform processing operations, such as determining the location of the ED 110, resource allocation (scheduling), message generation, and encoding/decoding, and that are not necessarily part of the equipment housing the antennas of the TRP. The modules may also be coupled to other TRPs. In some embodiments, a TRP may actually be a plurality of TRPs that are operating together to serve the ED 110, e.g. through coordinated multipoint transmissions.

Referring now specifically to the example T-TRP 170, as shown the T-TRP includes at least one transmitter 252 and at least one receiver 254 coupled to one or more antennas 256. Only one antenna 256 is illustrated. One, some, or all of the antennas may alternatively be panels. The transmitter 252 and the receiver 254 may be integrated as a transceiver. The T-TRP 170 further includes a processor 260 for performing operations including those related to: preparing a transmission for downlink transmission to the ED 110, processing an uplink transmission received from the ED 110, preparing a transmission for backhaul transmission to NT-TRP 172, and processing a transmission received over backhaul from the NT-TRP 172. Processing operations related to preparing a transmission for downlink or backhaul transmission may include operations such as encoding, modulating, precoding (e.g., multiple-input multiple-output (MIMO) precoding), transmit beamforming, and generating symbols for transmission. Processing operations related to processing received transmissions in the uplink or over backhaul may include operations such as receive beamforming, and demodulating and decoding received symbols. The processor 260 may also perform operations relating to network access (e.g., initial access) and/or downlink synchronization, such as generating the content of synchronization signal blocks (SSBs), generating the system information, etc. In some embodiments, the processor 260 also generates the indication of beam direction, e.g. BAI, which may be scheduled for transmission by scheduler 253. The processor 260 may perform other network-side processing operations described herein, such as determining the location of the ED 110, determining where to deploy NT-TRP 172, etc. In some embodiments, the processor 260 may generate signaling, e.g. to configure one or more parameters of the ED 110 and/or one or more parameters of the NT-TRP 172. Any signaling generated by the processor 260 is sent by the transmitter 252. Note that “signaling”, as used herein, may alternatively be called control signaling. Dynamic signaling may be transmitted in a control channel, e.g. a physical downlink control channel (PDCCH), and static or semi-static higher layer signaling may be included in a packet transmitted in a data channel, e.g. in a physical downlink shared channel (PDSCH).

A scheduler 253 may be coupled to the processor 260. The scheduler 253 may be included within or operated separately from the T-TRP 170, which may schedule uplink, downlink, and/or backhaul transmissions, including issuing scheduling grants and/or configuring scheduling-free (“configured grant”) resources. The T-TRP 170 further includes a memory 258 for storing information and data. The memory 258 stores instructions and data used, generated, or collected by the T-TRP 170. For example, the memory 258 could store software instructions or modules configured to implement some or all of the functionality and/or embodiments described herein and that are executed by the processor 260.

Although not illustrated, the processor 260 may form part of the transmitter 252 and/or receiver 254. Also, although not illustrated, the processor 260 may implement the scheduler 253. Although not illustrated, the memory 258 may form part of the processor 260.

The processor 260, the scheduler 253, and one or more processing components of the transmitter 252 and/or the receiver 254, may each be implemented by the same or different one or more processors that are configured to execute instructions stored in a memory, e.g. in memory 258. Alternatively, some or all of the processor 260, the scheduler 253, and one or more processing components of the transmitter 252 and/or the receiver 254, may be implemented using dedicated circuitry, such as an FPGA, a GPU, or an ASIC.

Although the NT-TRP 172 is illustrated as a drone only as an example, the NT-TRP 172 may be implemented in any of various other non-terrestrial forms. Also, the NT-TRP 172 may be known by other names in some implementations, such as a non-terrestrial node, a non-terrestrial network device, or a non-terrestrial base station. The NT-TRP 172 includes a transmitter 272 and a receiver 274 coupled to one or more antennas 280. Only one antenna 280 is illustrated. One, some, or all of the antennas may alternatively be panels. The transmitter 272 and the receiver 274 may be integrated as a transceiver. The NT-TRP 172 further includes a processor 276 for performing operations including those related to: preparing a transmission for downlink transmission to the ED 110, processing an uplink transmission received from the ED 110, preparing a transmission for backhaul transmission to T-TRP 170, and processing a transmission received over backhaul from the T-TRP 170. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, and demodulating and decoding received symbols. In some embodiments, the processor 276 implements the transmit beamforming and/or receive beamforming based on beam direction information (e.g., BAI) received from T-TRP 170. In some embodiments, the processor 276 may generate signaling, e.g. to configure one or more parameters of the ED 110. In some embodiments, the NT-TRP 172 implements physical layer processing, but does not implement higher layer functions such as functions at the MAC layer or radio link control (RLC) layer. As this is only an example, more generally, the NT-TRP 172 may implement higher layer functions in addition to physical layer processing.

The NT-TRP 172 further includes a memory 278 for storing information and data. Although not illustrated, the processor 276 may form part of the transmitter 272 and/or receiver 274. Although not illustrated, the memory 278 may form part of the processor 276.

The processor 276, and one or more processing components of the transmitter 272 and/or the receiver 274, may each be implemented by the same or different one or more processors that are configured to execute instructions stored in a memory, e.g. in memory 278. Alternatively, some or all of the processor 276 and one or more processing components of the transmitter 272 and/or the receiver 274 may be implemented using dedicated circuitry, such as a programmed FPGA, a GPU, or an ASIC. In some embodiments, the NT-TRP 172 may actually be a plurality of NT-TRPs that are operating together to serve the ED 110, e.g. through coordinated multipoint transmissions.

The T-TRP 170, the NT-TRP 172, and/or the ED 110 may include other components, but these have been omitted for the sake of clarity.

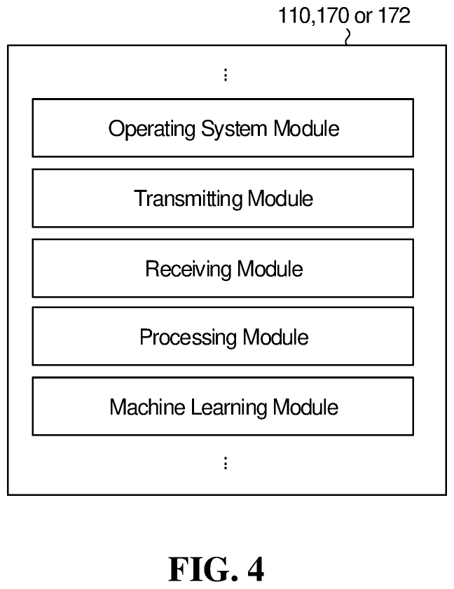

One or more steps of the embodiment methods provided herein may be performed by one or more units or modules. FIG. 4 illustrates an example of units or modules in a device, such as in ED 110, in T-TRP 170, or in NT-TRP 172. For example, a signal may be transmitted by a transmitting unit or a transmitting module. A signal may be received by a receiving unit or a receiving module. A signal may be processed by a processing unit or a processing module. Other steps may be performed by an artificial intelligence (AI) or machine learning (ML) module. The respective units or modules may be implemented using hardware, one or more components or devices that execute software, or a combination thereof. For instance, one or more of the units or modules may be an integrated circuit, such as a programmed FPGA, a GPU, or an ASIC. It will be appreciated that where the modules are implemented using software for execution by a processor for example, they may be retrieved by a processor, in whole or part as needed, individually or together for processing, in single or multiple instances, and that the modules themselves may include instructions for further deployment and instantiation.

The units or modules illustrated in FIG. 4 are examples only. A device may include additional, fewer, and/or different units or modules than shown. For example, in some embodiments a device may include a sensing module, in addition to or instead of an ML module or other AI module.

Additional details regarding the EDs 110, T-TRP 170, and NT-TRP 172 are known to those of skill in the art. As such, these details are omitted here.

In future wireless networks, the number of new devices, with diverse functionalities, could be increased exponentially relative to current networks. Also, a lot more new applications and use cases than in 5G may emerge with more diverse quality of service demands. These may result in new KPIs for future wireless networks (for example, 6G networks) that can be extremely challenging, so sensing technologies, and AI technologies, especially ML (deep learning) technologies, may be introduced to improve system performance and efficiency.

Future networks are expected to operate over higher frequency ranges with wider bandwidths (e.g., THz) and ultra-massive antenna arrays that will become more available. This may provide a unique opportunity to widen the scope of cellular network applications from pure communication to dual communication and sensing functionalities and/or other multi-faceted functionalities or features, for example.

6G networks and/or other future networks may involve sensing environments through high-precision positioning, mapping and reconstruction, and gesture/activity recognition, and thus sensing may be a new network service with a variety of activities and operations through obtaining information about a surrounding environment. A future network may include terminals, devices and network infrastructures to lead to capabilities such as the following: using more, and/or higher, spectrum with larger bandwidth; evolved antenna design with extremely large arrays and meta-surface; a larger scale of collaboration between base stations and UE; and/or advanced techniques for interference cancellation.

Integrated sensing and communication may involve various aspects of radio access network design. One potential challenge to be addressed involves how this integration affects radio access network design for different layers. From the physical layer perspective, for example, radio access network design may encompass any of the following:
a design to enable flexible and healthy coexistence between communication and sensing signals as well as related configurations, which may help ensure that performances of communication and sensing systems are not compromised;
system-wide solutions to collaboratively exploit sensing capabilities of different nodes, including network nodes and user devices;
signaling mechanisms that offer support between network entities to enable a network design and configure related parameters.

Sensing-assisted communication is also possible. Although sensing may be introduced as a separate service in the future, it might still be beneficial to consider how information obtained through sensing can be used in communications. One potential benefit of sensing will be environment characterization, which enables medium-aware communications due to more deterministic and predictable propagation channels. Sensing-assisted communication can provide environmental knowledge gained through sensing for improving communication, such as environmental knowledge used to optimize beamforming to a UE (medium-aware beamforming), environmental knowledge used to exploit potential degrees of freedom (DoF) in a propagation channel (medium aware channel rank boosting), and/or medium awareness to reduce or mitigate inter-UE interference. Sensing benefits to communications can include throughput spectrum usage improvement and interference mitigation, for example.

As another example, sensing-enabled communication, also referred to as backscatter communication, may provide benefit in scenarios in which devices with limited processing capabilities, such as many IoT devices in example, collect data. An illustrative example is media-based communication in which the communication medium is deliberately changed to convey information.

Communication-assisted sensing is another possible application. A communication platform may enable more efficient and smarter sensing by connecting sensing nodes. In a network of connected UEs, for example, on-demand sensing can be realized, in that sensing can be performed on the basis of a different node's request or delegated to another node. UE connectivity may also or instead enable collaborative sensing in which multiple sensing nodes obtain environmental information. These examples, and/or other advanced features, may be provided or supported in a carefully designed RAN in order to accommodate communication between the sensing nodes through DL, UL, and sidelink (SL) channels with minimum or at least reduced overhead and maximum or at least improved sensing efficiency.

Sensing-assisted positioning is another possible application or feature. Active localization, also referred to as positioning, involves localizing UEs through transmission or reception of signals to or from the UEs. A main potential advantage of sensing-assisted positioning is simple operation. Even though accurate knowledge of UE locations is extremely valuable, it is difficult to obtain due to many factors including multi-paths, imperfect time/frequency synchronization, limited UE sampling/processing capabilities and limited dynamic range of UEs. On the other hand, passive localization involves obtaining the location information of active or passive objects by processing echoes of a transmitted signal at one or multiple locations. Compared to active localization, passive localization through sensing may potentially provide distinct advantages, such as the following:
passive localization may help in identifying LOS links and mitigating residual non-LOS (NLOS) bias;
passive localization is much less impacted by synchronization errors between UEs and the network;
passive localization can improve positioning resolution and accuracy for cases where the localization bandwidth is constrained by target UEs.

In light of this, passive localization through sensing may potentially improve one or more shortcomings of active localization. Passive localization does, however, present a challenge in respect of a matching problem. This is due to the fact that received echoes do not have a unique signature to unambiguously associate them with the objects (and their latent location variables) from which they are reflected. This is in contrast to active localization (or beacon-based localization) where a signature recorded from a beacon or landmarks uniquely identifies associated objects. Advanced solutions to associate sensing observations with locations of active devices may therefore be desirable, to substantially improve active localization accuracy and resolution.

Future communication networks with sensing can enable a new range of services and applications, such as any one or more of: earth monitoring, remote sensing, positioning, navigation, tracking, autonomous delivery, and mobility. Terrestrial network based sensing and non-terrestrial network based sensing could provide intelligent context-aware networks to enhance the UE experience. For example, terrestrial network based sensing and non-terrestrial network based sensing may involve opportunities for localization and sensing applications based on a new set of features and service capabilities. Applications such as THz imaging and spectroscopy have the potential to provide continuous, real-time physiological information via dynamic, non-invasive, contactless measurements for future digital health technologies. Simultaneous localization and mapping (SLAM) methods may not only enable advanced cross reality (XR) applications but also enhance navigation of autonomous objects such as vehicles and drones. Further in terrestrial and non-terrestrial networks, measured channel data and sensing and positioning data can be obtained by large bandwidth, new spectrum, dense network and more light-of-sight (LOS) links. Based on these data, a radio environment map can be drawn through AI/ML methods, where channel information is linked to its corresponding positioning or environmental information to provide an enhanced physical layer design based on this map.

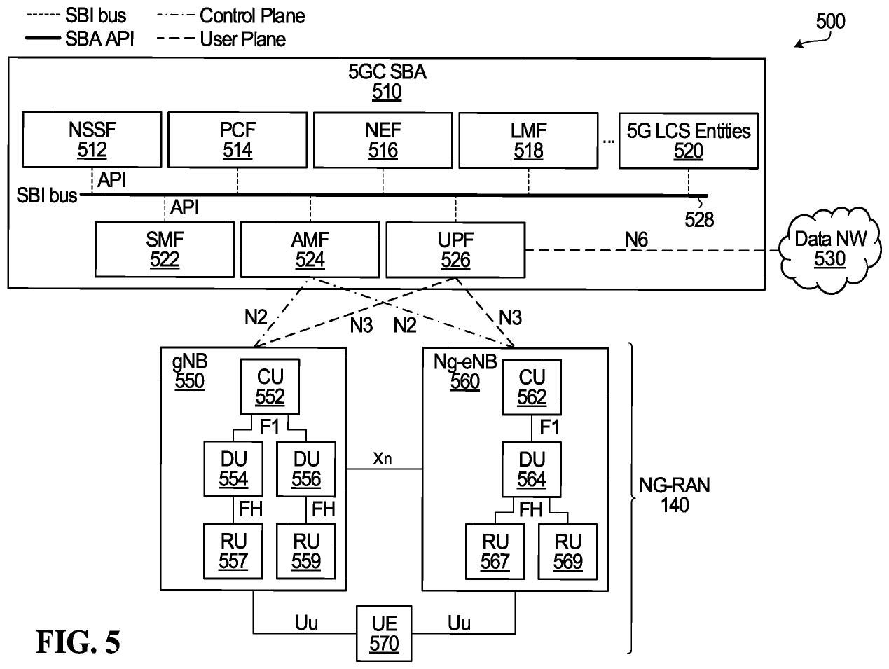

Regarding positioning as an illustrative example, FIG. 5 is a block diagram of an LTE/NR positioning architecture.

In the positioning architecture 500, a core network is shown at 510, a data network (NW) that may be external to the core network is shown at 530, and an NG-RAN (next generation radio access network) is shown at 540. The NG-RAN 540 includes a gNB 550 and an Ng-eNB 560, and a UE for which the NG-RAN provides access to the core network 510 is shown at 570.

The core network 510 is shown as a 5^{th} generation core service-based architecture (5GC SBA), and includes various functions or elements that are coupled together by a service based interface (SBI) bus 528. These functions or elements include a network slice selection function (NSSF) 512, a policy control function (PCF) 514, a network exposure function (NEF) 516, a location management function (LMF) 518, 5G location service (LCS) entities 520, a session management function (SMF) 522, an access and mobility management function (AMF) 524, and a user plane function (UPF) 526. The AMF 524 and the UPF 526 communicate with other elements outside the core network 510 through interfaces which are shown as N2, N3, and N6 interfaces.

The gNB 550 and the Ng-eNB 560 both have a CU (centralized unit)/DU (distributed unit)/RU (or RRU, remote radio unit) architecture, each including one CU 552, 562 and two RUs 557/559, 567/569. The gNB 550 includes two DUs 554, 556, and the Ng-eNB 560 includes one DU 564. Interfaces through which the gNB 550 and the Ng-eNB 560 communicate with each other and with the UE 570 are shown as Xn and Uu interfaces, respectively.

Those skilled in the art will be familiar with the positioning architecture 500, the elements illustrated in FIG. 5, and their operation. The present disclosure relates in part to sensing, and accordingly the LMF 518, the LCS entities 520, the AMF 524, and the UPF 526 and their operation related to positioning may be relevant.

For location services, the 5G LCS entities 520 may request positioning service from wireless network via the AMF 524, and the AMF 524 may then send the request to the LMF 518, where the associated RAN node(s) and the UE(s) may be determined for a positioning service and the associated positioning configurations are initiated by the LMF 518. Location services are those provided to clients, giving information. These services can be divided into: Value added services (such as route planning information), Legal and lawful interception services (such as those that might be used as evidence in legal proceedings), and Emergency services (these will provide location information for organizations such as police, fire and ambulance service). For example, to estimate the location of a UE, the network may configure the UE to send an uplink reference signal and more than one base station may measure the received signals in terms of directions of arrivals and delays, so the UE location can be estimated by the network. In a wireless network, except for the location of UE itself, more information is also required to support better communication, where the information may include surrounding information around the UE, e.g., channel conditions, surrounding environment, etc., which can be accomplished by the sensing operations.

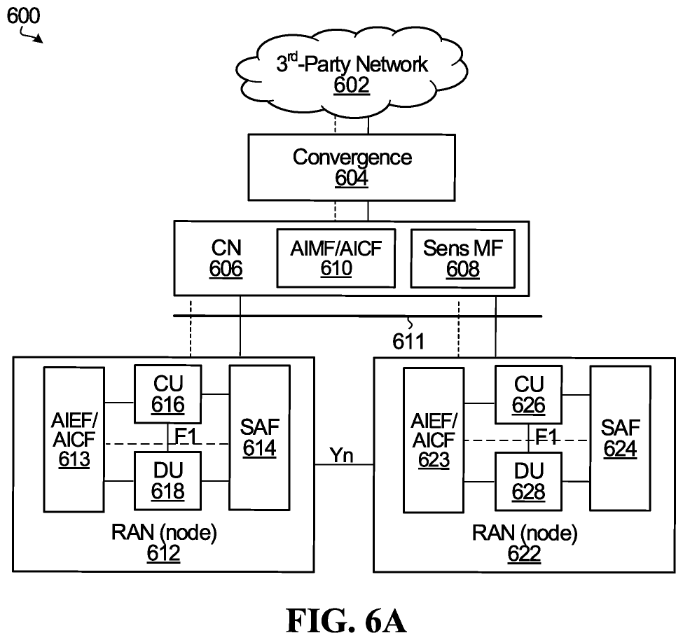

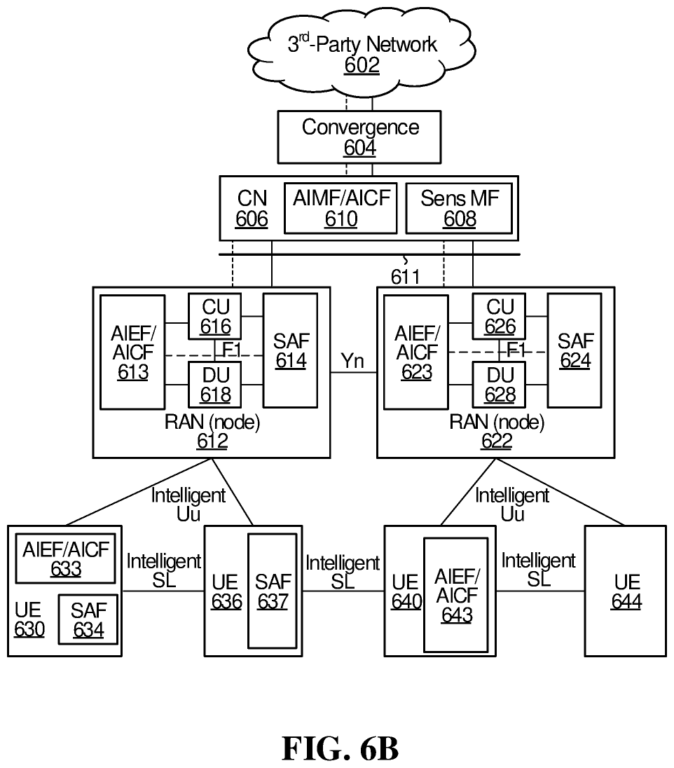

FIG. 6A is a block diagram illustrating a network architecture according to an embodiment. In the example architecture 600, a third-party network 602 interfaces with a core network 606 through a convergence element 604. The core network 606 includes an AI block 610, and a sensing block 608, which is also referred to herein as a sensing coordinator. The core network 606 connects to RAN nodes 612, 622 in one or more RANs, through interface links and an interface that is shown at 611, for example, which are used for transmitting data and/or control information. The one or more RAN nodes 612, 622 are in one or more RANs, and may be next generation nodes, legacy nodes, or combinations thereof. The RAN nodes 612, 622 are used to communicate with communication apparatus and/or with other network nodes. Non-limiting examples of RAN nodes are base station (BSs), TRPs, T-TRPs or NT-TRPs.

Although only two RAN nodes are shown in FIG. 6A, a RAN may include more than two RAN nodes, and RAN nodes need not have the same structure in all embodiments. Solely for the purpose of illustration, each RAN node 612, 622 in the example shown includes an AI agent or element 613, 623, and a sensing agent or element 614, 624, which is also referred to herein as a sensing coordinator. The AI agent and/or the sensing agent may or may not be operational as internal function(s) of a RAN node; for example, either or both of an AI agent and a sensing agent may be implemented in or otherwise provided by an independent device or external device, which may be located in a third-party network that belongs to a different operating company or entity, and has an external interface (but could be standardized) with the RAN node. More generally, a RAN may include one or more nodes of the same or different types. For example, the RAN nodes 612, 622 may include either or both of TN and NTN nodes. RAN nodes need not be commonly owned or operated by one operating company or entity, and NTN node(s) may or may not belong to the same operating company or entity as the TN node(s), for example.

Support for AI and sensing features may also or instead vary between nodes, and any RAN node may support either, both, or neither of AI and sensing. In the example shown, both RAN nodes 612, 622 support AI and sensing. In other embodiments, RAN nodes may encompass more variants in terms of AI/sensing functionality, including the following:
a RAN node may include either of an AI agent or element or a sensing agent or element;
a RAN node might not include either of an AI or sensing agent, or element, but may be able to interface with an external AI and/or sensing agent(s), element(s), or device(s), which may belong to a third-party company in some embodiments;
a RAN node might not include either of an AI agent or element or a sensing agent or element, but may interface with AI and/or sensing block(s) in a core network.

In the present disclosure, “block” and “agent” are used to distinguish AI and sensing elements or implementations for management/control (in a core network for example) from AI and sensing elements or implementations for execution of or performing AI and/or sensing operations (in a RAN or a UE for example). A sensing block may be used in a broader sense and referred to by any of various names, including for example: sensing element, sensing component, sensing controller, sensing coordinator, sensing module, etc. An AI block may similarly be used in a broader sense and referred to by any of various names, including for example: AI element, AI component, AI controller, AI coordinator, AI module, etc. A sensing agent or AI agent may also be referred to in different ways, including for example: sensing (or AI) element, sensing (or AI) component, sensing (or AI) coordinator, sensing (or AI) module, etc. In some embodiments, like sensing operations in some scenarios, features or functionalities of an AI block and an AI agent may be combined and co-located, in each of one or more RAN nodes for example, for AI operations in a future wireless network. Sensing block and agent features or functionalities may also or instead be combined and co-located in some embodiments.

The third-party network 602 is intended to represent any of various types of network that may interface or interact with a core network, with an AI element, and/or with a sensing element. For example, the third-party network 602 may request a sensing services from the sensing coordinator SensMF 608, via the core network 606 or not via the core network (for example, directly). The Internet is an example of a third-party network 602; other examples of third-party networks include data networks, data cloud and server networks, industrial or automation networks, power monitoring or supply networks, media networks, other fixed networks, etc.

The convergence element 604 may be implemented in any of various ways, to provide a controlled and unified core network interface with other networks (e.g., a wireline network). For example, although the convergence element 604 is shown separately in FIG. 6A, one or more network devices in the core network 606 and one or more network devices in the third-party network 602 may implement respective modules or functions to support an interface between a core network and an third-party network outside the core network.

The core network 606 may be or include, for example, an SBA or another type of core network.

The example architecture 600 illustrates optional RAN functional splitting or module splitting, into a CU 616, 626 and a DU 618, 628. For example, a CU 616, 626 may include or support higher protocol layers such as packet data convergence protocol (PDCP) and radio resource control (RRC) layers for a control plane and PDCP and service data adaptation protocol (SDAP) layers for a data plane, and a DU 618, 628 may include lower layers such as RLC, MAC, and PHY layers. The AI and sensing agents or elements 613, 614 and 623, 624 are interactive with either or both of the CU 616, 626 and the DU 618, 628 as part of control and data modules in the RAN nodes 612, 622.

In some embodiments, AI and/or sensing agent(s) may be operational with more detailed splitting functional units for a RAN node into CU (central unit), DU (distributed unit) and RU (radio unit). For example, AI and/or sensing agents may interact with one or more RUs for intelligent control and optimized configuration, where the RU is to convert radio signals sent to and from an antenna to a digital signal that can be transmitted over a front-haul interface to the DU. Fronthaul interface refers to an interface between a radio unit (RU) and distributed unit (DU) in a RAN node. As one RU may be physically located in a different site from the DU, an AI agent and/or a sensing agent can be within or co-located with the RU for real-time intelligent operation and/or sensing operation.

As one functional splitting scheme (and more splitting schemes and details are provided elsewhere herein), one RU may consist of a lower PHY part and a radio frequency (RF) module. The lower PHY part may perform baseband processing, e.g., using FPGAs or ASICs, and may include functions of fast Fourier transform (FFT)/inverse FFT (IFFT), cyclic prefix (CP) addition and/or removal, physical random access channel (PRACH) filtering, and optionally digital beamforming (DBF), etc. The RF module may be composed of antenna element arrays, bandpass filters, power amplifiers (PAs), low noise amplifiers (LNAs), digital analog converters (DACs), analog digital converters (ADCs), and optionally analog beamforming (ABF). AI agent and/or sensing agents or functionality can work closely with the lower PHY part and/or RF module for optimized beamforming, adaptive FFT/IFFT operation, dynamic and effective power usage and/or signal processing, for example.

FIG. 6A is illustrative of a network architecture in which both AI and sensing blocks 610, 608 are within the core network 606. The AI or sensing blocks 610, 608 may access one or more RAN nodes 612, 622 via backhaul connections between the core network 606 and the RAN node(s), and connect with the third-party network 602 via the common convergence element 604. AIMF/AICF and SensMF at 610, 608 are illustrative of an AI block and a sensing block, respectively, that are part of the core network. These blocks 610, 608 may be mutually inter-connected to each other via a functional application programming interface (API), for example. Such an API may be the same as or similar to an API that us used among core network functionalities. New interfaces may instead be provided between AI and CN, between sensing and CN, and/or between AI and sensing.

The AI block shown at 610 is also referred to herein as an AIMF/AICF, and similarly the sensing block 608 is also referred to herein as “SensMF”. The RAN-side AI element 613, 623 is also referred to herein as an AI agent or “AIEF/AICF”, and the RAN-side sensing element 614, 624 is also referred to herein as a sensing agent or “SAF”. Any RAN node may include both an AI agent “AIEF/AICF” and a sensing agent “SAF”, as in the example shown, but other embodiments are possible. More generally, a RAN node may include either, neither, or both of an AI agent “AIEF/AICF” and a sensing agent “SAF”.

AIMF/AICF refers to AI management function/AI control function, and the AI block 610 represents an AI management and control unit for one or more RANs/UEs, to work interactively with RAN nodes 612, 622, via the core network 606 in the embodiment shown. The AI block 610 is an AI training and computing center, configured to take collected data as input for training and provide trained model(s) and/or parameters for communication and/or other AI services.

AIEF/AICF at 613, 623 refers to AI execution function/AI control function. An AI agent 613, 623 may be located in a RAN node 612, 624 to assist AI operations in a RAN. An AI agent may also or instead be located in a UE to assist AI operations in the UE, as discussed in further detail below. An AI agent may focus on AI model execution and associated control functionality. In some embodiments, it is also possible to provide AI training locally at an AI agent in some embodiments.

The AI block 610 may operate an AI service without involving in any sensing operation. An AI block may instead operate with sensing functionality to provide both AI and sensing services. For example, the AI block 610 may receive sensing information as part or all of its AI training input data sets, or interactive AI and sensing operations may be especially useful during a machine learning and training process.

The present disclosure describes examples that may enable the support of AI capabilities in wireless communications. The disclosed examples may enable the use of trained AI models to generate inference data, for more efficient use of network resources and/or faster wireless communications in the AI-enabled wireless network, for example.

In the present disclosure, the term AI is intended to encompass all forms of machine learning, including supervised and unsupervised machine learning, deep machine learning, and network intelligent that may enable complicated problem solving through cooperation among AI-capable nodes. The term AI is intended to encompass all computer algorithms that can be automatically (i.e., with little or no human intervention) updated and optimized through experience (e.g., the collection of data).

In the present disclosure, the term AI model refers to a computer algorithm that is configured to accept defined input data and output defined inference data, in which parameters (e.g., weights) of the algorithm can be updated and optimized through training (e.g., using a training dataset, or using real-life collected data). An AI model may be implemented using one or more neural networks (e.g., including deep neural networks (DNN), recurrent neural networks (RNN), convolutional neural networks (CNN), and combinations of any of these types of neural networks) and using various neural network architectures (e.g., autoencoders, generative adversarial networks, etc.). Any of various techniques may be used to train the AI model, in order to update and optimize its parameters. For example, backpropagation is a common technique for training a DNN, in which a loss function is calculated between the inference data generated by the DNN and some target output (e.g., ground-truth data). A gradient of the loss function is calculated with respect to the parameters of the DNN, and the calculated gradient is used (e.g., using a gradient descent algorithm) to update the parameters with the goal of minimizing the loss function.

In examples provided herein, example network architectures are described in which an AI block or AI management module that is implemented by a network node (which may be outside of or within the core network) interacts with an AI agent, also referred to herein as an AI execution module, that is implemented by another node such as a RAN node (and/or optionally an end user device such as a UE). The present disclosure also describes, by way of example, features such as a task-driven approach to defining AI models, and a logical layer and protocol for communicating AI-related data.

Sensing is a feature of measuring surrounding environment information of a device related to the network, which may include, for example, any of: positioning, nearby objects, traffic, temperature, channel, etc. The sensing measurement is made by a sensing node, and the sensing node can be a node dedicated for sensing or a communication node with sensing capability. Sensing nodes may include, for example, any of: a radar station, a sensing device, a UE, a base station, a mobile access node such as a drone, a UAV, etc.

To make sensing operations happen, sensing activity is managed and/or controlled by sensing control devices or functions in the network in some embodiments. Two management and control functions for sensing are disclosed herein, and may support integrated sensing and communication and standalone sensing service.

These two functions for sensing include a first function referenced herein as a sensing management function (SensMF) and a sensing agent function (SAF). SensMF may be implemented in a core network or a RAN, such as in a network device in a core network as shown in FIG. 6A or in a RAN, and SAF may be implemented in a RAN in which sensing is to be performed. More, fewer, or different functions may be used in implementing features disclosed herein, and accordingly SensMF and SAF are illustrative examples.

SensMF may be involved in various sensing-related features or functions, including any one or more of the following, for example:
managing and coordinating one or more RAN node(s) and/or one or more UE(s) for sensing activity;
communicating, via AMF or otherwise (such as directly), for sensing procedures in a RAN, potentially including any one or more of: RAN configuration procedure for sensing, transfer of sensing associated information such as sensing measurement data, processed sensing measurement data, and/or sensing measurement data reports;
communicating, via UPF or otherwise (such as directly), for sensing procedures in a RAN, potentially including transfer of sensing associated information such as any one or more of: sensing measurement data, processed sensing measurement data, and sensing measurement data reports;
otherwise handling sensing measurement data, such as processing sensing measurement data and/or generating sensing measurement data reports.

SAF may similarly be involved in various sensing-related features or functions, including any one or more of the following, for example:
splitting sensing control plane (CP) and sensing user plane (UP), (SAF-CP and SAF-UP);
storing or otherwise maintaining local measurement data and/or other local sensing information;
communicating sensing measurement data to SensMF;
processing sensing measurement data;
receiving sensing analysis reports from SensMF, for communication control in RAN and/or for other purposes;
managing, coordinating, or otherwise assisting in an overall sensing and/or control process;
interfacing with an AI module or function.

A SAF can be located or deployed in a dedicated device or a sensing node such as a base station, and can control a sensing node or a group of sensing nodes. The sensing node(s) can send sensing results to the SAF node, through backhaul, an Uu link, or a sidelink for example, or send the sensing results directly to SensMF.

AI activity may similarly be managed and/or controlled by AI control devices or functions in or outside a core network, such as AIMF/AICF at 610, and be assisted and executed in other nodes such as RAN nodes, by AI agents such as AIEF/AICF at 613, 623 in the example shown in FIG. 6A. Integrated AI and communication and/or standalone AI service may be supported.

An AI block and/or AI management/control function(s) may be implemented in a core network, and an AI agent and/or AI execution function(s) may be implemented in a RAN node, as shown by way of example in FIG. 6A. More, fewer, or different functions may be used in implementing features disclosed herein, and accordingly AIMF/AICF and AIEF/AICF are illustrative examples.

An AI block or function may be involved in various AI-related features or functions, including any one or more of the following, for example:
managing and coordinating one or more RAN node(s) and/or one or more UE(s) for AI activity;
communicating, via AMF or otherwise (such as directly), for AI procedures in a RAN, potentially including any one or more of: RAN configuration procedure for AI operation, transfer of AI associated information such as sensing or AI measurement for AI local and/or global training, and/or AI measurement and reports;
communicating, via UPF or otherwise (such as directly), for AI procedures in a RAN, potentially including transfer of sensing associated information such as any one or more of: RAN configuration procedure for AI operation, transfer of AI associated information such as sensing and/or AI measurements for AI local and/or global training, and/or AI measurement and reports;
otherwise handling sensing and/or AI measurement data, local AI training and control, and/or generating AI trained parameters and reports.

An AI agent may similarly be involved in various AI-related features or functions, including any one or more of the following, for example:
splitting AI control plane (CP) and AI user plane (UP);
storing or otherwise maintaining AI associated data;
communicating AI associated data to one or more AI blocks;
processing AI associated data;
receiving information such as AI trained parameters and reports from one or more AI blocks;
managing, coordinating, or otherwise assisting in an overall AI and/or control process;
interfacing with an AI block.

In summary, basic sensing operations may at least involve one or more sensing nodes such as UE(s) and/or TRP(s) to physically perform sensing activities or procedures, and sensing management and control functions such as SensMF and SAF may help organize, manage, configure, and control the overall sensing activities. AI may also or instead be implemented in a generally similar manner, with AI management and control implemented in or otherwise provided by an AI block or function(s) and AI execution implemented in or otherwise provided by one or more AI agents.

In the present disclosure, a sensing coordinator may refer to any of SensMF, SAF, a sensing device, or a node or other device in which SensMF, SAF, sensing, or sensing-related features or functions are implemented. In general, a sensing coordinator is a node that can assist in sensing operations. Such a node can be a standalone node dedicated to just sensing operations or another type of node (for example, the T-TRP 170, the ED 110, or a node in the core network 130—see FIG. 2) that performs sensing operations in parallel with or otherwise in addition to handling communication transmissions. New protocol(s) and/or signaling mechanism(s) may be useful in implementing a corresponding interface link so that sensing can be performed with customized parameters and/or to meet particular requirements while minimizing or at least reducing signaling overhead and/or maximizing or at least improving whole system spectrum efficiency.

Sensing may encompass positioning, but the present disclosure is not limited to any particular type of sensing. For example, sensing may involve sensing any of various parameters or characteristics. Illustrative examples include: location parameters, object size, one or more object dimensions including 3D dimensions, one or more mobility parameters such as either or both of speed and direction, temperature, healthcare information, and material type such as wood, bricks, metal, etc. Any one or more of these parameters or characteristics, and/or others, may be sensed.

The sensing block 608 in FIG. 6A represents a sensing management and control unit for one or more RANs (and/or one or more UEs in other embodiments), to work interactively with RAN nodes via a CN. The sensing block may also or instead work interactively with RAN nodes directly in other embodiments. The sensing block 608 is a computing and processing center, taking collected sensing data as input to provide required sensing information for communication and/or sensing services. The sensing may include positioning and/or other sensing functionalities such as IoT and environment sensing features.

A sensing agent 614, 624 is provided in the RAN nodes 612, 622 to assist sensing operations in a RAN, and may also or instead be provided in one or more UEs in other embodiments to assist sensing operations in the UE(s). Each sensing agent 614, 624 may assist the sensing block 608 to provide sensing operations at a RAN node (and/or UE in other embodiments), including collecting sensing measurements and organizing sensing data intended for the sensing block for example.

A sensing block may operate a sensing service without also being involved in any AI operation. A sensing block may instead operate with AI functionality to provide both sensing and AI services. For example, the sensing block 608 may provide sensing information to the AI block 610 as part or all of AI training input data sets for the AI block, or interactive AI and sensing operations may be especially useful during a machine learning and training process. Thus, a sensing block may work with an AI block to enhance network performance.

In general, sensing operations may include more features than positioning. Positioning can be one of the sensing features in the sensing services disclosed herein, but the present disclosure is not in any way limited to positioning. Sensing operations can provide real-time or non-real time sensing information for enhanced communication in a wireless network, as well as independent sensing services for networks other than the wireless network or other network operators.

Some embodiments of the present disclosure provide sensing architectures, methods, and apparatus for coordinating sensing in wireless communication systems. Coordination of sensing may involve one or more devices or elements located in a radio access network, one or more devices or elements located in a core network, or both one or more devices or elements located in a radio access network and one or more devices or elements located in a core network. Embodiments that involve devices or elements that are located outside a core network and/or outside a RAN are also possible.

Positioning is a very specific feature that relates to determining the physical location of a UE in a wireless network (e.g., in a cell). Position determination may be by the UE itself and/or by network devices such as base stations and may involve measuring reference signals and analyzing measured information such as signal delays between the UE and the network devices. For actual wireless communication and optimized control, positioning of a UE is one measurement element among multiple possible measurement metrics. For example, a network may use information about surroundings of the UE, such as channel conditions, surrounding environment, etc., for better communication scheduling and control. In sensing operations, all related measurement information can be obtained for better communication.

In general, RAN AI and sensing capability and types according to aspects of the present disclosure may including any one or more of the following examples, and potentially others:
a RAN node has a built-in AI agent, or no built-in AI agent;
a RAN node has a built-in sensing agent or no built-in sensing agent;
a RAN node has no built-in AI agent or sensing agent but may be able to provide wireless communication measurements to support AI and/or sensing operations;
a RAN node has no built-in AI agent or sensing agent but can connect with an external device that supports AI and/or sensing, which, e.g., may belong to a third-party company.

Components of an intelligent architecture according to embodiments herein may include, for example, intelligent backhaul between AI/sensing/CN/RAN(s), and an inter-RAN node interface. Each of these components is further discussed by way of example herein.

FIG. 6B is a block diagram illustrating a network architecture according to another embodiment, in which the CN and RAN nodes and their functionalities are similar to those shown in FIG. 6A and described above. The network architecture in FIG. 6B also includes the following types of UEs:
a UE 630 with AI and sensing capabilities, including an AI agent shown as AIEF/AICF 633 and a sensing agent shown as SAF 634;
a UE 636 with sensing capability, including a sensing agent shown as SAF 637;
a UE 640 with AI capability, including an AI agent shown as AIEF/AICF 643; and
a UE 644 with no AI or sensing capability.

A UE such as the UE 644 with no AI or sensing capability may be able to interface with an external AI agent or device and/or an external sensing agent or device.

The diverse set of UEs in FIG. 6B can include high-end and/or low-end devices, including mobile phones, customer premises equipment (CPE), relay devices, IoT sensors, etc. UEs may connect with RAN nodes via one or more intelligent Uu links or another type of air interface, and/or communicate each other via intelligent SL, for example.

An intelligent Uu link or interface between RAN node(s) and UE(s) can be or include one or more (i.e., a combination) of: a conventional Uu link or interface, an AI-based Uu link or interface, a sensing-based Uu link or interface, etc.

An AI-based air link or interface and/or a sensing-based air link or interface may have specific channels and/or signaling messages, such as any of the following:
AI-specific Uu channels and/or signaling;
sensing-specific Uu channels and/or signaling;
shared AI and sensing Uu channels and/or signaling.

An intelligent SL or interface between UEs can be or include one or more (i.e., a combination) of a conventional SL or other UE-UE interface, an AI-based SL or other UE-UE interface, or a sensing-based SL or other UE-UE interface, etc.

In some embodiments, an AI-based air link or interface and/or a sensing-based air link or interface between UEs may have specific channels and/or signaling messages, such as any of the following:
AI-specific SL channels and/or signaling;
sensing-specific SL channels and/or signaling;
shared AI and sensing SL channels and/or signaling.

FIG. 6B illustrates that features disclosed herein may be provided at one or more RAN nodes, and/or at one or more UEs. In order to avoid further congestion in the drawings, various features are illustrated and discussed in the context of RAN nodes, but it should be appreciated that such features may also or instead be provided at one or more UEs. Thus, AI-related features and/or sensing-related features, for example, may be RAN node-based and/or UE-based.

Intelligent backhaul may encompass, for example, an interface between AI and RAN node(s), for AI-only service for example, with AI planes in two scenarios in some embodiments:
NR AMF/UPF protocol stacks with an additional AI layer on top for control/data;
new AI protocol layers for control/data.

UE interfacing is also considered herein.

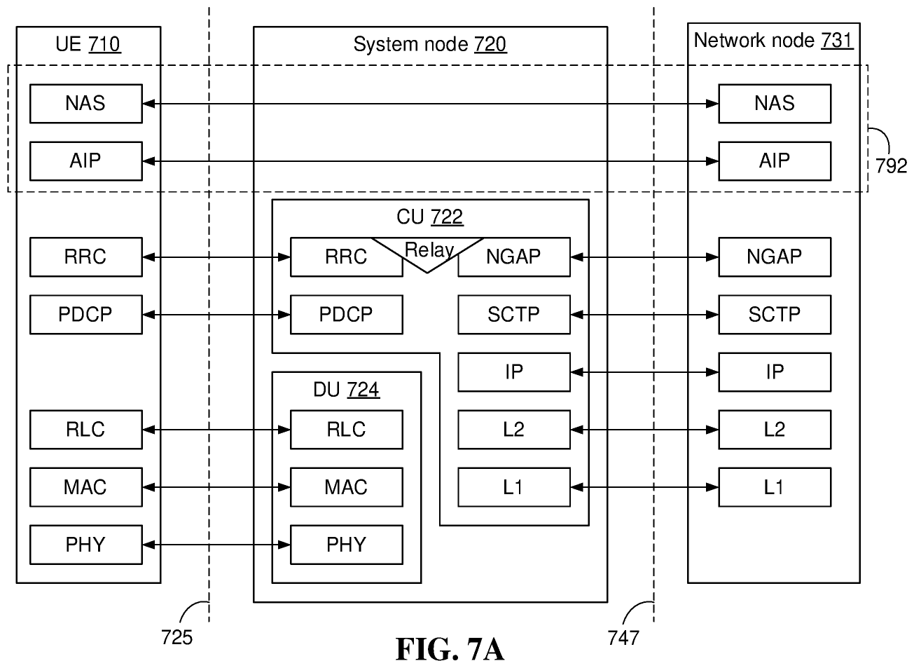

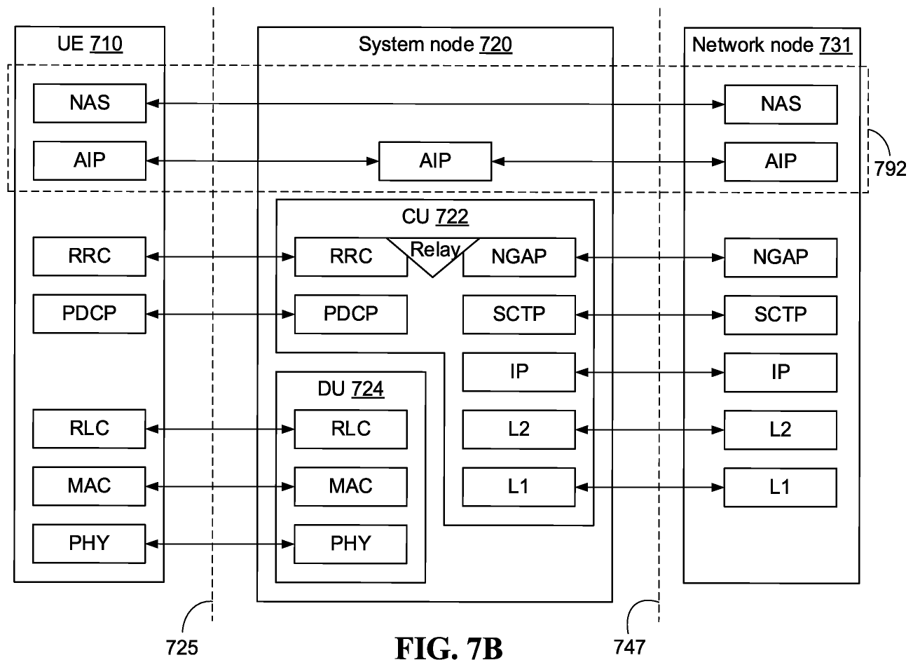

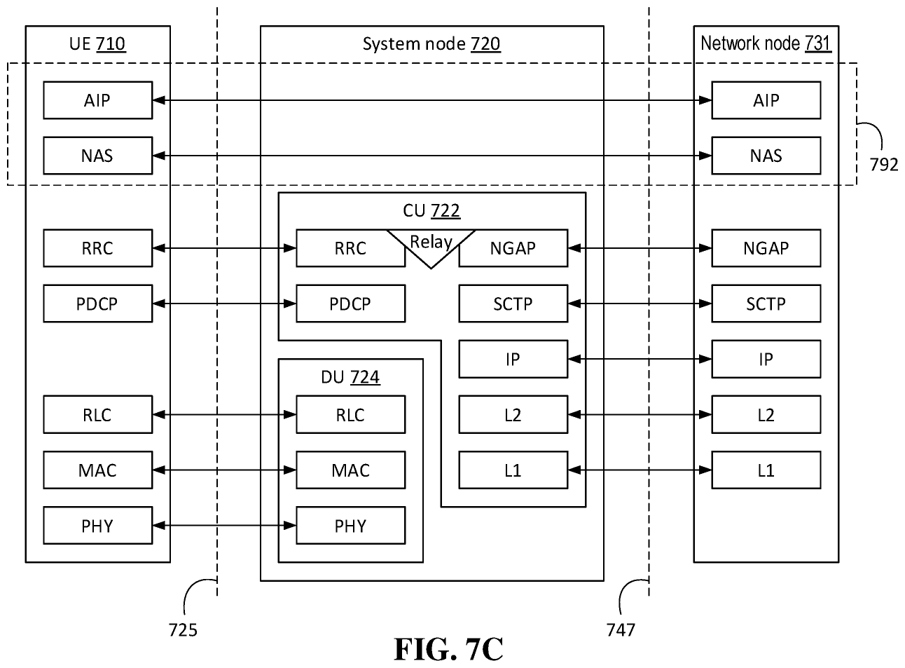

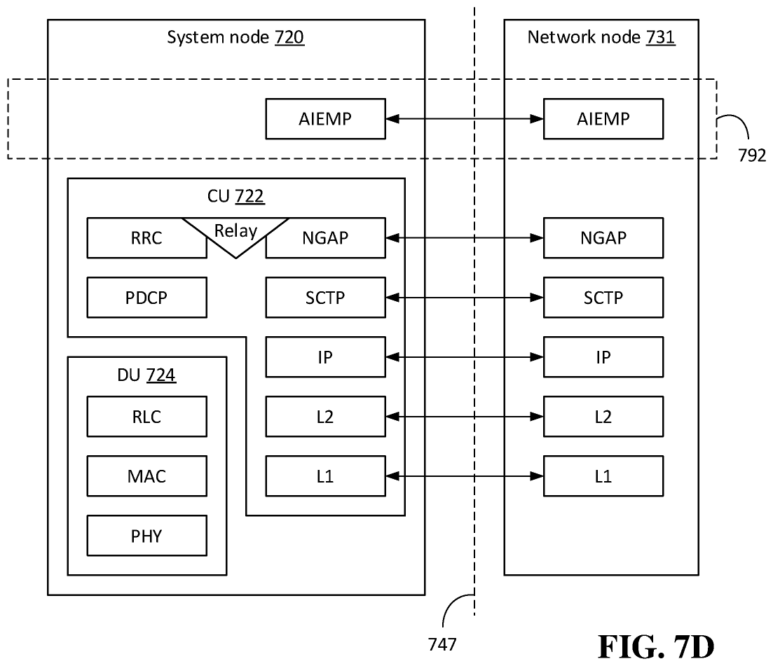

FIG. 7A is a block diagram illustrating an example implementation of an AI control plane (A-plane) 792 on top of an existing protocol stack as defined in 5G standards. Example protocol stacks for a UE 710, a system node 720, and a network node 731 are shown. This example relates to an embodiment in which a UE and a network node support AI features. The UE 710 may be a UE as shown at 630 or 640 in FIG. 6B, the system node 720 may be a RAN node, and the network node 731 may be in the core network 606 in FIG. 6B, for example. As noted elsewhere herein, in some embodiments, not all RAN nodes necessarily support AI features, and the example shown in FIG. 7A does not rely on AI features being supported at the system node 720.

In one example, the protocol stack at the UE 710 includes, from the lowest logical level to the highest logical level, the PHY layer, the MAC layer, the RLC layer, the PDCP layer, the RRC layer, and the non-access stratum (NAS) layer. At the system node 720, the protocol stack may be split into the centralized unit (CU) 722 and the distributed unit (DU) 724. It should be noted that the CU 722 may be further split into CU control plane (CU-CP) and CU user plane (CU-UP). For simplicity, only the CU-CP layers of the CU 722 are shown in FIG. 7A. In particular, the CU-CP may be implemented in a system node 720 that implements the AI execution module, also referred to herein as the AI agent, for the AN. In the example shown, the DU 724 includes the lower level PHY, MAC and RLC layers, which facilitate interactions with corresponding layers at the UE 710. In this example, the CU 722 includes the higher level RRC and PDCP layers. These layers of the CU 722 facilitate control plane interactions with corresponding layers at the UE 710. The CU 722 also includes layers responsible for interactions with the network node 731 in which the AI management module, also referred to herein as the AI block, is implemented, including (from low to high) the L1 layer, the L2 layer, the internet protocol (IP) layer, the stream control transmission protocol (SCTP) layer, and the next-generation application protocol (NGAP) layer (each of which facilitates interactions with corresponding layers at the network node 731). A communication relay in the system node 720 couples the RRC layer with the NGAP layer. It should be noted that the division of the protocol stack into the CU 722 and the DU 724 may not be implemented by the UE 710 (but the UE 710 may have similar logical layers in the protocol stack).

FIG. 7A shows an example in which the UE 710 (where an AI agent is implemented at the UE 710) communicates AI-related data with the network node 731 (where the AI block is implemented), where the system node 720 is transparent (i.e., the system node 720 does not decrypt or inspect the AI-related data communicated between the UE 710 and the network node 731). In this example, the A-plane 792 includes higher layer protocols, such as an AI-related protocol (AIP) layer as disclosed herein, and the NAS layer (as defined in existing 5G standards). The NAS layer is typically used to manage the establishment of communication sessions and for maintaining continuous communications between a core network and the UE 710 as the UE 710 moves. The AIP may encrypt all communications, ensuring secure transmission of AI-related data. The NAS layer also provides additional security, such as integrity protection and ciphering of NAS signaling messages. In some existing network protocol stacks, the NAS layer is the highest layer of the control plane between the UE 710 and the core network 430, and sits on top of the RRC layer. In an example, the AIP layer is added, and the NAS layer is included with the AIP layer in the A-plane 792. At the network node 731, the AIP layer is added between the NAS layer and the NGAP layer. The A-plane 792 enables secure exchange of AI-related information, separate from the existing control plane and data plane communications. It should be noted that, in the present disclosure, AI-related data that may be communicated to the network node 731 (e.g., from the UE 710 and/or system node 720) may include either or both of the following: raw (i.e., unprocessed or minimally processed) local data (e.g., raw network data), processed local data (e.g., local model parameters, inferred data generated by local AI model(s), and anonymized network data, etc.). Raw local data may be unprocessed network data that can include sensitive user data (e.g., user photographs, user videos, etc.), and thus it may be important to provide a secure logical layer for communication of such sensitive AI-related data.

The AI execution module or agent at the UE 710 may communicate with the system node 720 over an existing air interface 725 (e.g., an Uu link as currently defined in 5G wireless technology), but over the AIP layer to ensure secure data transmission. The system node 720 may communicate with the network node 731 over an AI-related interface (which may be a backhaul link currently not defined in 5G wireless technology), such as the interface 747 shown in FIG. 7A. However, it should be understood that communication between the network node 731 and the system node 720 may alternatively be via any suitable interface (e.g., via interfaces to the core network 430, as shown in FIG. 7A). The communications between the UE 710 and the network node 731 over the A-plane 792 may be forwarded by the system node 720 in a completely transparent manner.

FIG. 7B illustrates an alternative embodiment. FIG. 7B is similar to FIG. 7A, however an AI execution module or agent at the system node 720 is involved in communications between the AI execution module or agent at the UE 710 and the AI block at the network node 731. This is illustrative of an embodiment encompassed by FIG. 6B, in which the system node 720 in FIG. 7B may be a RAN node as shown in FIG. 6B.

As shown in FIG. 7B, the system node 720 may process AI-related data using the AIP layer (e.g., decrypt, process and re-encrypt the data), as an intermediary between the UE 710 and the network node 731. The system node 720 may make use of the AI-related data from the UE 710 (e.g., to perform training of a local AI model at the system node 720. The system node 720 may also simply relay the AI-related data from the UE 710 to the network node 430. This may expose UE data (e.g., network data locally collected at the UE 710) to the system node 720 as a tradeoff for the system node 720 taking on the role of processing the data (e.g., formatting the data into an appropriate message) for communication to the AI block and/or to enable the system node 720 to make use of the data from the UE 710. It should be noted that communication of AI-related data between the UE 710 and the system node 720 may also performed using the AIP layer in the A-plane 792 between the UE 710 and the system node 720.

FIG. 7C illustrates another alternative embodiment. FIG. 7C is similar to FIG. 7A, however the NAS layer sits directly on top of the RRC layer at the UE 710, and the AIP layer sits on top of the NAS layer. At the network node 731, the AIP layer sits on top of the NAS layer (which sits directly on top of the NGAP layer), and thus AI information in a form of AIP layer protocol is actually contained and delivered in the secured NAS message between the UE 710 and the system node 731. This embodiment may enable the existing protocol stack configuration to be largely preserved, while separating the NAS layer and the AIP layer into the A-plane 792. In this example, the system node 720 is transparent to the A-plane 792 communications between the UE 710 and the network node 731. However, the system node 720 may also act as an intermediary to process AI-related data, using the AIP layer, between the UE 710 and the network node 731 (e.g., similar to the example shown in FIG. 7B).

FIG. 7D is a block diagram illustrating an example of how the A-plane 792 is implemented for communication of AI-related data between the AI agent at the system node 720 and the AI block at the network node 731. The communication of AI-related data between the AI agent at the system node 720 and the AI block at the network node 731 may be over an AI execution/management protocol (AIEMP) layer. The AIEMP layer may be different from the AIP layer between the UE 710 and the network node 731, and may provide an encryption that is different from or similar to the encryption performed on the AIP layer. The AIEMP may be a layer of the A-plane 792 between the system node 720 and the network node 731, where the AIEMP layer may be the highest logical layer, above the existing layers of the protocol stack as defined in 5G standards. The existing layers of the protocol stack may be unchanged. Similarly to the communication of AI-related data from the UE 710 to the network node 731 (e.g., as described with respect to FIG. 7A), the AI-related data that is communicated from the system node 720 to the network node 731, using the AIEMP layer, may include raw local data and/or processed local data.

FIGS. 7A-7D illustrate communication of AI-related data over the A-plane 792 using the interfaces 725 and 747, which may be wireless interfaces. In some examples, communication of AI-related data may be over wireline interfaces. For example, communication of AI-related data between the system node 720 and the network node 731 may be over a backhaul wired link.

It should also be appreciated that the specific examples shown in FIGS. 7A-7D are illustrative and non-limiting. For example, the UE-based embodiments of the A-plane 792 shown in FIGS. 7A and 7C could also or instead be implemented at one or more system nodes 720, such as one or more RAN nodes. Other variations are also possible.

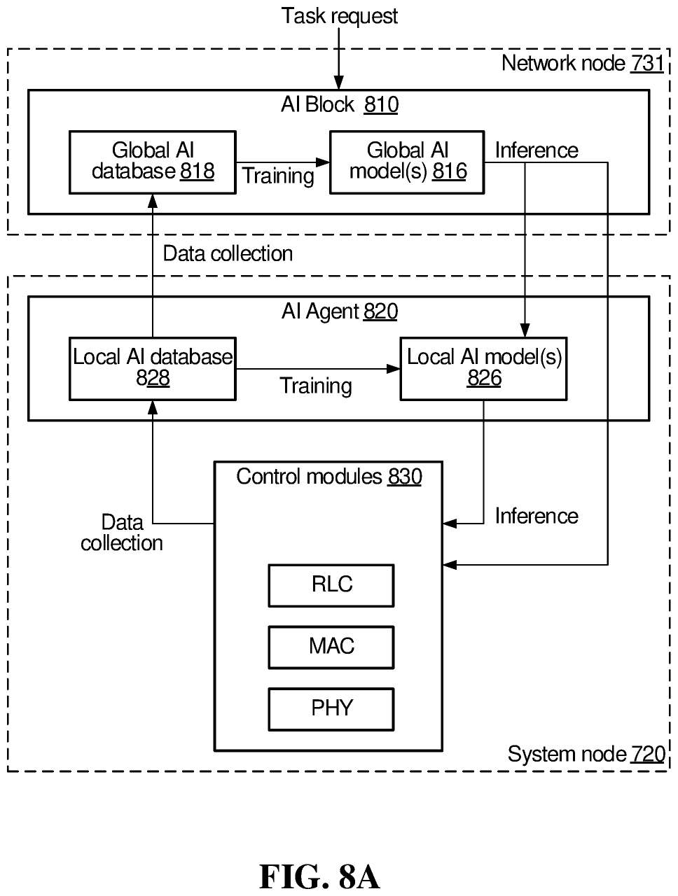

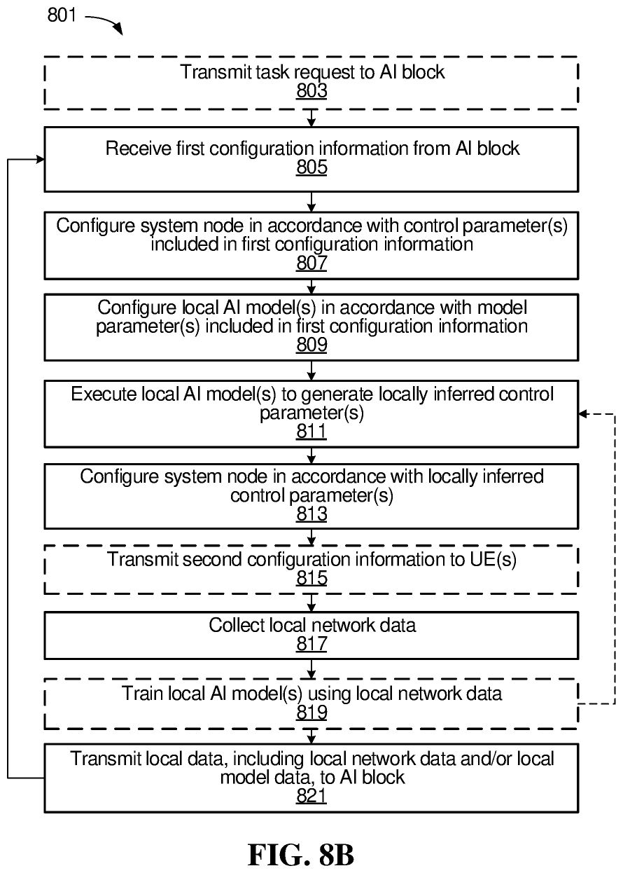

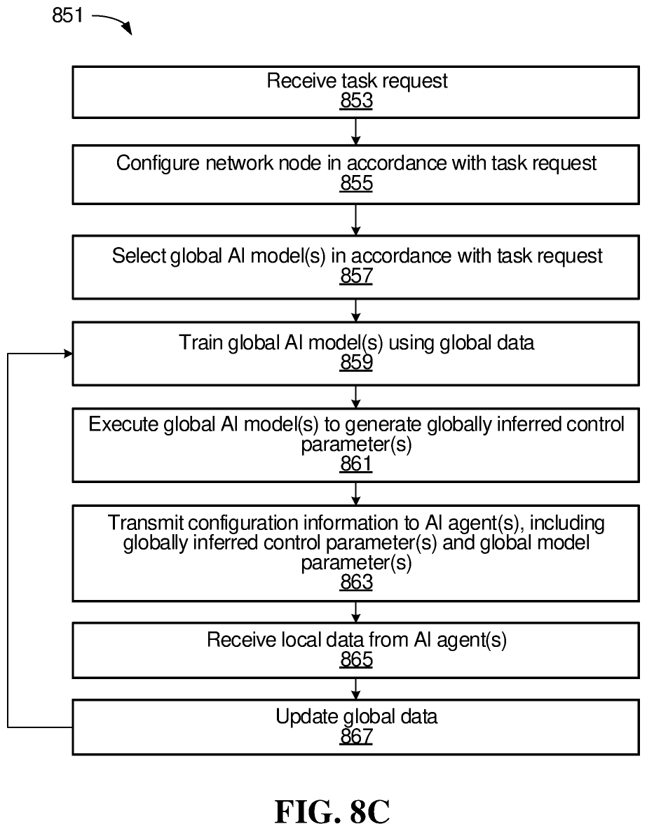

Consider now an AI operation example, with reference to FIGS. 8A-8C.

FIG. 8A is a simplified block diagram illustrating an example dataflow in an example operation of an AI block 810, which may also or instead be referred to as an AI management module for example, and an AI agent 820, which may also or instead be referred to as an AI execution module for example. In the illustrated example, the AI agent 820 is implemented in a system node 720, such as a BS of an access network. It should be understood that similar operations may be carried out if the AI agent 820 is implemented in a UE (and the system node 720 may be an intermediary to relay the AI-related communications between UE and the network node 731). Further, communications to and from the network node 731 may or may not be relayed through a core network.

A task request is received by the AI block 810. An example is first described in which the task request is a network task request. The network task request may be any request for a network task, including a request for a service, and may include one or more task requirements, such as one or more KPIs (e.g., latency, QoS, throughput, etc.) and/or application attributes (e.g., traffic types, etc.) related to the network task. The task request may be received from a customer of a wireless system, from an external network, and/or from nodes within the wireless system (e.g., from the system node 720 itself).

At the AI block 810, after receiving the task request, the AI block 810 performs functions (e.g., using functions provided by an AIMF and/or an AICF) to perform initial setup and configuration based on the task request. For example, the AI block 810 may use functions of the AICF to set the target KPI(s) and application or traffic type for the network task, in accordance with the one or more task requirements included in the task request. The initial setup and configuration may include selection of one or more global AI models 816 (from among a plurality of available global AI models 816 maintained by the AI block 810) to satisfy the task request. The global AI models 816 available to the AI block 810 may be developed, updated, configured and/or trained by an operator of a core network, other operators, an external network, or a third-party service, among other possibilities. The AI block 810 may select one or more selected global AI models 816 based on, for example, matching the definition of each global AI model (e.g., the associated task, the set of input-related attributes and/or the set of output-related attributes defined for each global AI model) with the task request. The AI block 810 may select a single global AI model 816, or may select a plurality of global AI models 816 to satisfy the task request (where each selected global AI model 816 may generate inference data that addresses a subset of the task requirements, for example).

After selecting the global AI model(s) 816 for the task request, the AI block 810 performs training of the global AI model(s) 816, for example using global data from a global AI database 818 maintained by the AI block 810 (e.g., using training functions provided by the AIMF). The training data from the global AI database 818 may include non-real time (non-RT) data (e.g., may be older than several milliseconds, or older than one second), and may include network data and/or model data collected from one or more AI agents 820 managed by the AI block 810. After training is complete (e.g., the loss function for each global AI model 816 has converged), the selected global AI model(s) 816 are executed to generate a set of global (or baseline) inference data (e.g., using model execution functions provided by the AIMF). The global inference data may include globally inferred (or baseline) control parameter(s) to be implemented at the system node 720. The AI block 810 may also extract, from the trained global AI model(s), global model parameters (e.g., the trained weights of the global AI model(s)), to be used by local AI model(s) at the AI agent 820. The globally inferred control parameter(s) and/or global model parameter(s) are communicated (e.g., using output functions of the AICF) to the AI agent 820 as configuration information, for example in a configuration message.

At the AI agent 820, the configuration information is received and optionally preprocessed (e.g., using input functions of the AICF). The received configuration information may include model parameter(s) that are used by the AI agent 820 to identify and configure one or more local AI model(s) 826. For example, the model parameter(s) may include an identifier of which local AI model(s) 826 the AI agent 820 should select from a plurality of available local AI models 826 (e.g., a plurality of possible local AI models and their unique identifiers may be predefined by a network standard, or may be preconfigured at the system node 720). The selected local AI model(s) 826 may be similar to the selected global AI model(s) 816 (e.g., having the same model definition and/or having the same model identifier). The model parameter(s) may also include globally trained weights, which may be used to initialize the weights of the selected local AI model(s) 826. For example, depending on the task request, the selected local AI model(s) 826 may (after being configured using the model parameter(s) received from the AI block 810) be executed to generate inferred control parameter(s) for one or more of: mobility control, interference control, cross-carrier interference control, cross-cell resource allocation, RLC functions (e.g., ARQ, etc.), MAC functions (e.g., scheduling, power control, etc.), and/or PHY functions (e.g., RF and antenna operation, etc.), among others.

The configuration information may also include control parameter(s), based on inference data generated by the selected global AI model(s) 816, that may be used to configure one or more control modules at the system node 720. For example, the control parameter(s) may be converted (e.g., using output functions of the AICF) from the output format of the global AI model(s) 816 into control instructions recognized by the control module(s) at the system node 720. The control parameter(s) from the AI block 810 may be tuned or updated by training the selected local AI model(s) 826 on local network data to generate locally inferred control parameter(s) (e.g., using model execution functions provided by the AIEF). In the example where the AI agent 820 is implemented at the system node 720, the system node 720 may also communicate control parameter(s) (whether received from the AI block 810 or generated using the selected local AI model(s) 826) to one or more UEs (not shown) served by the system node 720.

The system node 720 may also communicate configuration information to the one or more UEs, to configure the UE(s) to collect real-time or near-RT local network data. The system node 720 may also or instead configure itself to collect real-time or near-RT local network data. Local network data collected by the UE(s) and/or the system node 720 may be stored in a local AI database 828 maintained by the AI agent 820, and used for near-RT training of the selected local AI model(s) 826 (e.g., using training functions of the AIEF). Training of the selected local AI model(s) 826 may be performed relatively quickly (compared to training of the selected global AI model(s) 816) to enable generation of inference data in near-RT as the local data is collected (to enable near-RT adaptation to the dynamic real-world environment). For example, training of the selected local AI model(s) 826 may involve fewer training iterations compared to training of the selected global AI model(s) 816. The trained parameters of the selected local AI model(s) 826 (e.g., the trained weights) after near-RT training on local network data may also be extracted and stored as local model data in the local AI database 828.

In some examples, one or more of the control modules at the system node 720 (and optionally one or more UEs served by a RAN) may be configured directly based on the control parameter(s) included in the configuration information from the AI block 810. In some examples, one or more of the control modules at the system node 720 (and optionally one or more UEs served by the RAN) may be controlled based on locally inferred control parameter(s) generated by the selected local AI model(s) 826. In some examples, one or more of the control modules at the system node 720 (and optionally one or more UEs served by the RAN) may be controlled jointly by the control parameter(s) from the AI block 810 and by the locally inferred control parameter(s).

The local AI database 828 may be a shorter-term data storage (e.g., a cache or buffer), compared to the longer-term data storage at the global AI database 818. Local data maintained in the local AI database 828, including local network data and local model data, may be communicated (e.g., using output functions provided by the AICF) to the AI block 810 to be used for updating the global AI model(s) 816.

At the AI block 810, local data collected from one or more AI agents 820 are received (e.g., using input functions provided by the AICF) and added, as global data, to the global AI database 818. The global data may be used for non-RT training of the selected global AI model(s) 816. For example, if the local data from the AI agent(s) 820 include the locally-trained weights of the local AI model(s) (if the local AI model(s) have been updated by near-RT training), the AI block 810 may aggregate the locally-trained weights and use the aggregated result to update the weights of the selected global AI model(s) 816. After the selected global AI model(s) 816 have been updated, the selected global AI model(s) 816 may be executed to generate updated global inference data. The updated global inference data may be communicated (e.g., using output functions provided by the AICF) to the AI agent 820, for example as another configuration message or as an update message. In some examples, the update message communicated to the AI agent 820 may include control parameters or model parameters that have changed from the previous configuration message. The AI agent 820 may receive and process the updated configuration information in the manner described above.

In the example illustrated in FIG. 8A, the AI block 810 performs continuous data collection, training of selected global AI model(s) 816 and execution of the trained global AI model(s) 816 to generate updated data (including updated globally inferred control parameter(s) and/or global model parameter(s)), to enable continuous satisfaction of the task request (e.g., satisfaction of one or more KPIs included as task requirements in the task request). The AI agent 820 may similarly perform continuous updates of configuration parameter(s), continuous collection of local network data and optionally continuous training of the selected local AI model(s) 826, to enable continuous satisfaction of the task request (e.g., satisfaction of one or more KPIs included as task requirements in the task request). As illustrated in FIG. 8A, collection of local network data, training of global (or local) AI model(s) and generation of updated inference data (whether global or local) may be performed repeatedly as a loop, at least for the time duration indicated in the task request (or until the task request is updated or replaced), for example.

Another example is now described in which the task request is a collaborative task request. For example, the task request may be a request for collaborative training of an AI model, and may include an identifier of the AI model to be collaboratively trained, an identifier of data to be used and/or collected for training the AI model, a dataset to be used for training the AI model, locally trained model parameters to be used for collaboratively updating a global AI model, and/or a training target or requirement, among other possibilities. The task request may be received from a customer of a wireless system, from an external network, and/or from nodes within the wireless system (e.g., from the system node 720 itself).

At the AI block 810, after receiving the task request, the AI block 810 performs functions (e.g., using functions provided by an AIMF and/or an AICF) to perform initial setup and configuration based on the task request. For example, the AI block 810 may use functions of the AICF to select and initialize one or more AI models in accordance with the requirements of the collaborative task (e.g., in accordance with an identifier of the AI model to be collaboratively trained and/or in accordance with parameters of the AI model to be collaboratively updated).

After selecting the global AI model(s) 816 for the task request, the AI block 810 performs training of the global AI model(s) 816. For collaborative training, the AI block 810 may use training data provided and/or identified in the task request for training of the global AI model(s) 816. For example, the AI block 810 may use model data (e.g., locally trained model parameters) collected from one or more AI agents 820 managed by the AI block 810 to update the parameters of the global AI model(s) 816. In another example, the AI block 810 may use network data (e.g., locally generated and/or collected user data) collected from one or more AI agents 820 managed by the AI block 810, to train the global AI model(s) 816 on behalf of the AI agent(s) 820. After training is complete (e.g., the loss function for each global AI model 816 has converged), model data extracted from the selected global AI model(s) 816 (e.g., the globally updated weights of the global AI model(s)) may be communicated to be used by local AI model(s) at the AI agent 820. The global model parameter(s) may be communicated (e.g., using output functions of the AICF) to the AI agent 820 as configuration information, for example in a configuration message.

At the AI agent 820, the configuration information includes model parameter(s) that are used by the AI agent 820 to update one or more corresponding local AI model(s) 826 (e.g., the AI model(s) that are the target(s) of the collaborative training, as identified in the collaborative task request). For example, the model parameter(s) may include globally trained weights, which may be used to update the weights of the selected local AI model(s) 826. The AI agent 820 may then execute the updated local AI model(s) 826. Additionally or alternatively, the AI agent 820 may continue to collect local data (e.g., local raw data and/or local model data), which may be maintained in the local AI database 828. For example, the AI agent 820 may communicate newly collected local data to the AI block 810 to continue the collaborative training.

At the AI block 810, local data collected from one or more AI agents 820 are received (e.g., using input functions provided by the AICF) and may be used for collaborative of the selected global AI model(s) 816. For example, if the local data from the AI agent(s) 820 include the locally-trained weights of the local AI model(s) (if the local AI model(s) have been updated by near-RT training), the AI block 810 may aggregate the locally-trained weights and use the aggregated result to collaboratively update the weights of the selected global AI model(s) 816. After the selected global AI model(s) 816 have been updated, updated model parameters may be communicated back to the AI agent 820. This collaborative training, including communications between the AI block 810 and the AI agent 820, may be continued until an end condition is met (e.g., the model parameters have sufficiently converged, the target optimization and/or requirement of the collaborative training has been achieved, expiry of a timer, etc.). In some examples, the requestor of the collaborative task may transmit a message to the AI block 810 to indicate that the collaborative task should end.

It may be noted that, in some examples, the AI block 810 may participate in a collaborative task without requiring detailed information about the data being used for training and/or the AI model(s) being collaboratively trained. For example, the requestor of the collaborative task (e.g., the system node 720 and/or a UE) may define the optimization targets and/or may identify the AI model(s) to be collaboratively trained, and may also identify and/or provide the data to be used for training. In some examples, the AI block 810 may be implemented by a node that is a public AI service center (or a plug-in AI device), for example from a third-party, that can provide the functions of the AI block 810 (e.g., AI modeling and/or AI parameter training functions) based on the related training data and/or the task requirements in a request from a customer or a system node 720 (e.g., BS) or UE. In this way, the AI block 810 may be implemented as an independent and common AI node or device, which may provide AI-dedicated functions (e.g., as an AI modeling training tool box) for the system node 720 or UE. However, the AI block 810 might not be directly involved in any wireless system control. Such implementation of the AI block 810 may be useful if a wireless system wishes or requires its specific control goals to be kept private or confidential but requires AI modeling and training functions provided by the AI block 810 (e.g., the AI block 810 need not even be aware of any AI agent 820 present in the system node 720 or a UE that is requesting the task).

Some examples of how the AI block 810 cooperates with the AI agent 820 to satisfy a task request are now described. It should be understood that these examples are not intended to be limiting. Further, these examples are described in the context of the AI agent 820 being implemented at the system node 720. However, it should be understood that the AI agent 820 may additionally or alternatively be implemented elsewhere, at one or more UEs for example.

An example network task request may be a request for low latency service, such as to service URLLC traffic. The AI block 810 performs initial configuration to set a latency constraint (e.g., maximum 2 ms delay in end-to-end communication) in accordance with this network task. The AI block 810 also selects one or more global AI models 816 to address this network task, for example a global AI model associated with URLLC is selected. The AI block 810 trains the selected global AI model 816, using training data from the global AI database 818. The trained global AI model 816 is executed to generate global inference data that includes global control parameters that enable high reliability communications (e.g., an inferred parameter for a waveform, an inferred parameter for interference control, etc.). The AI block 810 communicates a configuration message to the AI agent 820 at the system node 720, including globally inferred control parameter(s) and model parameter(s). The AI agent 820 outputs the received globally inferred control parameter(s) to configure the appropriate control modules at the system node 720. The AI agent 820 also identifies and configures the local AI model 826 associated with URLLC, in accordance with the model parameter(s). The local AI model 826 is executed to generate locally inferred control parameter(s) for the control modules at the system node 720 (which may be used in place of or in addition to the globally inferred control parameter(s)). For example, control parameter(s) that may be inferred to satisfy the URLLC task may include parameters for a fast handover switching scheme for URLLC, an interference control scheme for URLLC, a defined cross-carrier resource allocation (to reduce cross-carrier interference), the RLC layer may be configured with no ARQ (to reduce latency), the MAC layer may be configured to use grant-free scheduling or a conservative resource configuration with power control for uplink communications, and the PHY layer may be configured to use an URLLC-optimized waveform and antenna configuration. The AI agent 820 collects local network data (e.g., channel status information (CSI), air-link latencies, end-to-end latencies, etc.) and communicates the local data (which may include either or both of the collected local network data and the local model data, such as the locally trained weights of the local AI model 826) to the AI block 810. The AI block 810 updates the global AI database 818 and performs non-RT training of the global AI model 816, to generate updated inference data. These operations may be repeated to continue satisfying the task request (i.e., enabling URLLC in this example).

Another example network task request may be a request for high throughput, for file downloading. The AI block 810 performs initial configuration to set a high throughput requirement (e.g., high spectrum efficiency for transmissions) in accordance with this network task. The AI block 810 also selects one or more global AI models 816 to address this network task, for example a global AI model associated with spectrum efficiency is selected. The AI block 810 trains the selected global AI model 816, using training data from the global AI database 818. The trained global AI model 816 is executed to generate global inference data that includes global control parameters that enable high spectrum efficiency (e.g., efficient resource scheduling, multi-TRP handover scheme, etc.). The AI block 810 communicates a configuration message to the AI agent 820 at the system node 720, including globally inferred control parameter(s) and model parameter(s). The AI agent 820 outputs the received globally inferred control parameter(s) to configure the appropriate control modules at the system node 720. The AI agent 820 also identifies and configures the local AI model 826 associated with spectrum efficiency, in accordance with the model parameter(s). The local AI model 826 is executed to generate locally inferred control parameter(s) for the control modules at the system node 720 (which may be used in place of or in addition to the globally inferred control parameter(s)). For example, control parameter(s) that may be inferred to satisfy the high throughput task may include parameters for a multi-TRP handover scheme, an interference control scheme for model interference control, a carrier aggregation and dual connectivity (DC) multi-carrier scheme, the RLC layer may be configured with a fast ARQ configuration, the MAC layer may be configured to use an aggressive resource scheduling and power control for uplink communications, and the PHY layer may be configured to use an antenna configuration for massive MIMO. The AI agent 820 collects local network data (e.g., actual throughput rate) and communicates the local data (which may include either or both of the collected local network data and the local model data, such as the locally trained weights of the local AI model 826) to the AI block 810. The AI block 810 updates the global AI database 818 and performs non-RT training of the global AI model 816, to generate updated inference data. These operations may be repeated to continue satisfying the task request (i.e., enabling high throughput in this example).

FIG. 8B is a flowchart illustrating an example method 801 for AI-based configuration, that may be performed using an AI agent such as 820. For simplicity, the method 801 will be discussed in the context of the AI agent 820 implemented at a system node 720. However, it should be understood that the method 801 may be performed using the AI agent 820 that is implemented elsewhere, such as at a UE. For example, the method 801 may be performed using a computing system (which may be a UE or a BS, for example), such as by a processing unit executing instructions stored in a memory.

Optionally, at 803, a task request is sent to the AI block 810, which is implemented at a network node 731. The task request may be a request for a particular network task, including a request for a service, a request to meet a network requirement, or a request to set a control configuration, for example. The task request may be a request for a collaborative task, such as collaborative training of an AI model. The collaborative task request may include an identifier of the AI model to be collaboratively trained, initial or locally trained parameters of the AI model, one or more training targets or requirements, and/or a set of training data (or an identifier of the training data) to be used for collaborative training.

At 805, a first set of configuration information is received from the AI block 810. The received configuration information may be referred to herein as a first set of configuration information. The first set of configuration information may be received in the form of a configuration message. The configuration message may be transmitted over an AI-dedicated logical layer, such as the AIEMP layer in the A-plane as described elsewhere herein. The first set of configuration information may include one or more control parameters and/or one or more model parameters. The first set of configuration information may include inference data generated by one or more trained global AI models at the AI block 810.

At 807, the system node 720 configures itself in accordance with the control parameter(s) included in the first set of configuration information. For example, an AICF at the AI agent 820 of the system node 720 may perform operations to translate control parameter(s) in the first set of configuration information into a format that is useable by the control modules at the system node 720. Configuration of the system node 720 may include configuring the system node 720 to collect local network data relevant to the network task, for example.

At 809, the system node 720 configures one or more local AI models in accordance with the model parameter(s) included in the first set of configuration information. For example, the model parameter(s) included in the first set of configuration information may include an identifier (e.g., a unique model identification number) identifying which local AI model(s) should be used at the AI agent 820 (e.g., the AI block 810 may configure the AI agent 820 to local AI model(s) that are the same as the global AI model(s), for example by transmitting the identifier(s) of the global AI model(s)). The AI agent 820 may then initialize the identified local AI model(s) using weights included in the model parameter(s). In some examples, such as when the system node 720 has requested a collaborative task for collaborative training of the local AI model(s), the model parameter(s) included in the first set of configuration information may be the collaboratively trained parameter(s) (e.g., weights) of the local AI model(s). The AI agent 820 may then update the parameter(s) of the local AI model(s) according to the collaboratively trained parameter(s).

At 811, the local AI model(s) are executed, to generate one or more locally inferred control parameters. The locally inferred control parameter(s) may replace or be in addition to any control parameter(s) included in the first set of configuration information. In other examples, there may not be any control parameter(s) included in the first set of configuration information (e.g., the configuration information from the AI block 810 includes only model parameter(s)).

At 813, the system node 720 is configured in accordance with the locally inferred control parameter(s). For example, the AICF at the AI agent 820 of the system node 720 may perform operations to translate inferred control parameter(s) generated by the local AI model(s) into a format that is useable by the control modules 830 at the system node 720. It should be noted that the locally inferred control parameter(s) may be used in addition to any control parameter(s) included in the first set of configuration information. In other examples, there may not be any control parameter(s) included in the first set of configuration information.

Optionally, at 815, a second set of configuration information may be transmitted to one or more UEs associated with the system node 720. The transmitted configuration information may be referred to herein as a second set of configuration information. The second set of configuration information may be transmitted in the form of a downlink configuration (e.g., as a DCI or RRC signal). The second set of configuration information may be transmitted over an AI-dedicated logical layer, such as the AIP layer in the A-plane as described above. The second set of configuration information may include control parameter(s) from the first set of configuration information. The second set of configuration information may additionally or alternatively include locally inferred control parameter(s) generated by the local AI model(s). The second set of configuration information may also configure the UE(s) to collect local network data relevant to training the local AI model(s) (e.g., depending on the task). Step 815 may be omitted if the method 801 is performed by a UE itself. Step 815 may also be omitted if there are no control parameter(s) applicable to the UE(s). Optionally, the second set of configuration information may also include one or more model parameters for configuring local AI model(s) by an AI agent 820 at the UE(s).

At 817, local data is collected. Collected local data may include network data collected at the system node 720 itself and/or network data collected from one or more UEs associated with the system node 720. The collected local network data may be preprocessed using functions provided by the AICF, for example, and may be maintained in a local AI database.

Optionally, at 819, the local AI model(s) may be trained using the collected local network data. The training may be performed in near-RT (e.g., within several microseconds or several milliseconds of the local network data being collected), to enable the local AI model(s) to be updated to reflect the dynamic local environment. The near-RT training may be relatively fast (e.g., involving only up to five or up to ten training iterations). Optionally, after training the local AI model(s) using the collected local network data, the method 801 may return to step 811 to execute the updated local AI model(s) to generate updated locally inferred control parameter(s). The trained model parameters (e.g., trained weights) of the updated local AI model(s) may be extracted by the AI agent 820 and stored as local model data.

At 821, the local data is transmitted to the AI block 810. The transmitted local data may include the local network data collected at step 817 and/or may include local model data (e.g., if optional step 819 is performed). For example, local data may be transmitted (e.g., using output functions provided by the AICF) over an AI-dedicated logical layer, such as the AIEMP layer in the A-plane as described elsewhere herein. The AI block 810 may collect local data from one or more RANs and/or UEs to update the global AI model(s), and to generate updated configuration information. The method 801 may return to step 805 to receive the updated configuration information from the AI block 810.

Steps 805 to 821 may be repeated one or more times, to continue satisfying a task request (e.g., continue providing a requested network service, or continue collaborative training of an AI model). Further, within each iteration of steps 805 to 821, steps 811 to 819 may optionally be repeated one or more times. For example, in one iteration of steps 805 to 821, step 821 may be performed once, to provide the local data to the AI block 810 in a non-RT data transmission (e.g., the local data may be transmitted to the AI block 810 more than several milliseconds after the local data was collected). For example, the AI agent 820 may periodically (e.g., every 100 ms or every 1 s) or intermittently transmit local data to the AI block 810. However, between the time that the local network data was collected (at step 817) and the time that the local data is transmitted to the AI block 810 (at step 821), the local AI model(s) may be repeatedly trained in near-RT on the collected local network data and the configuration of the system node 720 may be repeatedly updated using the locally inferred control parameter(s) from the updated local AI model(s). Further, between the time that the local data is transmitted to the AI block 810 (at step 821) and the time that updated configuration information (generated by the updated global AI model(s)) is received from the AI block (at step 805), the local AI model(s) may continue to be retrained in near-RT using the collected local network data.

FIG. 8C is a flowchart illustrating an example method 851 for AI-based configuration, that may be performed using the AI block 810 implemented at the network node 731. The method 851 involves communications with one or more AI agents 820, which may include AI agent(s) 820 implemented at a system node 720 and/or at a UE. The method 851 may be performed using a computing system which may be a network server, for example, such as by a processing unit executing instructions stored in a memory.

At 853, a task request is received. For example, the task request may be received from a system node 720 that is managed by the AI block 810, may be received from a customer of a wireless system, or may be received from an operator of the wireless system. The task request may be a request for a particular network task, including a request for a service, a request to meet a network requirement, or a request to set a control configuration, for example. In another example, the task request may be a request for a collaborative task, such as collaborative training of an AI model. The collaborative task request may include an identifier of the AI model to be collaboratively trained, initial or locally trained parameters of the AI model, one or more training targets or requirements, and/or a set of training data (or an identifier of the training data) to be used for collaborative training.

At 855, the network node 731 is configured in accordance with the task request. For example, the AI block 810 may (e.g., using output functions of an AICF) convert the task request into one or more configurations to be implemented at the network node 731. For example, the network node 731 may be configured to set one or more performance requirements in accordance with the network task (e.g., set a maximum end-to-end delay in accordance with a URLLC task).

At 857, one or more global AI models are selected in accordance with the task request. A single network task may require multiple functions to be performed (e.g., to satisfy multiple task requirements). For example, a single network task may involve multiple KPIs to be satisfied (e.g., a URLLC task may involve satisfying latency requirements as well as interference requirements). The AI block 810 may select, from a plurality of available global AI models, one or more selected global AI models to address the network task. For example, the AI block 810 may select one or more global AI models based on the associated task defined for each global AI model. In some examples, the global AI model(s) that should be used for a given network task may be predefined (e.g., the AI block 810 may use a predefined rule or lookup table to select the global AI model(s) for a given network task). In another example, the global AI model(s) may be selected in accordance with an identifier (e.g., included in a request for a collaborative task) included in the task request.

At 859, the selected global AI model(s) are trained using global data (e.g., from a global AI database maintained by the AI block 810). Training of the selected global AI model(s) may be more comprehensive than the near-RT training of local AI model(s) performed by the AI agent 820. For example, the selected global AI model(s) may be trained for a larger number of training iterations (e.g., more than 10 or up to 100 or more training iterations), compared to the near-RT training of local AI model(s). The selected global AI model(s) may be trained until a convergence condition is satisfied (e.g., the loss function for each global AI model converge at a minimum). The global data includes network data collected from one or more AI agents (e.g., at one or more system nodes 720 and/or one or more UEs) managed by the AI block 810, and is non-RT data (i.e., the global data does not reflect the actual network environment in real-time). The global data may also include training data provided or identifier for collaborative training (e.g., included in a collaborative task request).

At 861, after training is complete, the selected global AI model(s) are executed to generate globally inferred control parameter(s). If multiple global AI models have been selected, each global AI model may generate a subset of the globally inferred control parameter(s). In some examples, if the task is a collaborative task for collaborative training of an AI model, step 861 may be omitted.

At 863, configuration information is transmitted to the one or more AI agents 820 managed by the AI block 810. The configuration information includes the globally inferred control parameter(s), and/or may include global model parameter(s) extracted from the selected global AI model(s). For example, the trained weights of the selected global AI model(s) may be extracted and included in the transmitted configuration information. The configuration information transmitted by the AI block 810 to one or more AI agents 820 may be referred to as the first set of configuration information. The first set of configuration information may be transmitted in the form of a configuration message. The configuration message may be transmitted over an AI-dedicated logical layer, such as the AIEMP layer in the A-plane (e.g., if the AI agent(s) 820 are at respective system node(s) 720) and/or the AIP layer in the A-plane (e.g., if the AI agent(s) 820 are at respective UE(s)) as described elsewhere herein.

At 865, local data is received from respective AI agent(s) 820. The local data may include local network data collected by each respective AI agent(s) and/or may include local model data (e.g., locally trained weights of the respective local AI model(s)) extracted by each respective AI agent(s) after near-RT training of the local AI model(s). The local data may be received over an AI-dedicated logical layer, such as the AIEMP layer in the A-plane (e.g., if the AI agent(s) 820 are at respective system node(s) 720) and/or the AIP layer in the A-plane (e.g., if the AI agent(s) 820 are at respective UE(s)). It should be understood that there may be some time interval between step 863 and 865 (e.g., a time interval of several milliseconds, up to 100 ms, or up to 1 s), during which local data collection and optional local training of local AI model(s) may take place at the respective AI agent(s) 820.

At 867, the global data (e.g., stored in the global AI database maintained by the AI block 810) is updated with the received local data. The method 531 may return to step 859 to retrain the selected global AI model(s) using the updated global data. For example, if the received local data include locally trained weights extracted from local AI model(s), retraining the selected global AI model(s) may include updating the weights of the global AI model(s) based on the locally trained weights.

Steps 859 to 867 may be repeated one or more times, to continue satisfying a task request (e.g., continue providing a requested network service, or continue collaborative training of an AI model).

Intelligent backhaul may also or instead encompass, for example, an interface between sensing and RAN node(s), for sensing-only service for example, with sensing planes in two scenarios in some embodiments:
NR AMF/UPF protocol stacks with an additional sensing layer on top for control/data;
new sensing protocol layers for control/data.

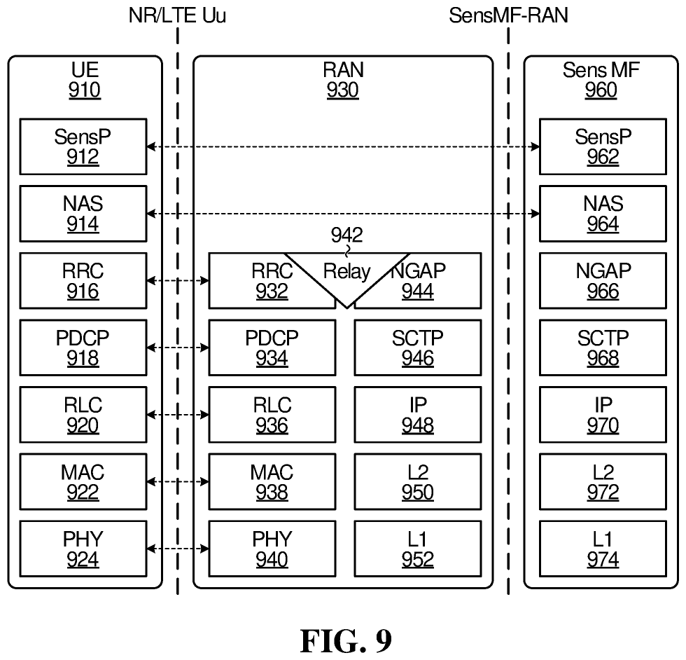

FIG. 9 is a block diagram illustrating example protocol stacks according to an embodiment. Example protocol stacks at a UE, RAN, and SensMF are shown at 910, 930, 960, respectively, for an example that is based on an Uu air interface between the UE and the RAN. FIG. 9, and other block diagrams illustrating protocol stacks, are examples only. Other embodiments may include similar or different protocol layers, arranged in similar or different ways.

A sensing protocol or SensProtocol (SensP) layer 912, 962, shown in the example UE and SensMF protocol stacks 910, 960, is a higher protocol layer between a SensMF and a UE to support transfer of control information and/or sensing information transfer over an air interface, which is or at least includes a Uu interface in the example shown.

Non-access stratum (NAS) layer 914, 964, also shown in the example UE and SensMF protocol stacks 910, 960, is another higher protocol layer, and forms a highest stratum of a control plane between a UE and a core network at the radio interface in the example shown. NAS protocols may be responsible for such features as any one or more of: supporting mobility of the UE and session management procedures to establish and maintain IP connectivity between the UE and the core network in the example shown. NAS security is an additional function of the NAS layer that may be provided in some embodiments to support one or more services to the NAS protocols, such as integrity protection and/or ciphering of NAS signaling messages for example. As a result, SensP layer 912, 962 is on top of the NAS layer 914, 964, and the sensing information in a form of SensP layer protocol is actually contained and delivered in the secured NAS message in a form of NAS protocol.

A radio resource control (RRC) layer 916, 932, shown in the UE and RAN protocol stacks at 910, 930, is responsible for such features as any of: broadcast of system information related to the NAS layer; broadcast of system information related to an access stratum (AS); paging; establishment, maintenance and release of an RRC connection between the UE and a base station or other network device; security functions; etc.

A packet data convergence protocol (PDCP) layer 918, 934 is also shown in the example UE and RAN protocol stacks 910, 930, and is responsible for such features as any of: sequence numbering; header compression and decompression; transfer of user data; reordering and duplicate detection, if order delivery to layers above PDCP is required; PDCP protocol data unit (PDU) routing in the case of split bearers; ciphering and deciphering; duplication of PDCP PDUs; etc.

A radio link control (RLC) layer 920, 936 is shown in the example UE and RAN protocol stacks 910, 930, and is responsible for such features as any of: transfer of upper layer PDUs; sequence numbering independent of sequence numbering in PDCP; automatic repeat request (ARQ) segmentation and re-segmentation; reassembly of service data units (SDUs); etc.

A media access control (MAC) layer 922, 938, also shown in the example UE and RAN protocol stacks 910, 930, is responsible for such features as any of: mapping between logical channels and transport channels; multiplexing of MAC SDUs from one logical channel or different logical channels onto transport blocks (TBs) to be delivered to a physical layer on transport channels; demultiplexing of MAC SDUs from one logical channel or different logical channels from TBs delivered from a physical layer on transport channels; scheduling information reporting; and dynamic scheduling for downlink and uplink data transmissions for one or more UEs.

The physical (PHY) layer 924, 940 may provide or support such features as any of: channel encoding and decoding; bit interleaving; modulation; signal processing; etc. A PHY Layer handles all information from MAC layer transport channels over an air interface and may also handle such procedures as link adaptation through adaptive modulation and coding (AMC) for example, power control, cell search for either or both of initial synchronization and handover purposes, and/or other measurements, jointly working with a MAC layer.

The relay 942 represents the information relaying over different protocol stacks by a protocol conversion from one interface to another, where the protocol conversion is between an air interface (between UE 910 and RAN 930) and wireline interface (between RAN 930 and SensMF 960).

The NG (next generation) application protocol (NGAP) layer 944, 966 in the RAN and SensMF example protocol stacks 930, 960 provides a way of exchanging control plane messages associated with the UE over the interface between the RAN and SensMF, where the UE association with the RAN at NGAP layer 944 is by UE NGAP ID unique in the RAN, and the UE association with SensMF at NGAP layer 966 is by UE NGAP ID unique in the SensMF, and two UE NGAP IDs may be coupled in the RAN and SensMF upon session setup.

The RAN and SensMF example protocol stacks 930, 960 also include a stream control transmission protocol (SCTP) layer 946, 968, which may provide features similar to those of the PDCP layer 918, 934 but for a wired SensMF-RAN interface.

Similarly, the internet protocol (IP) layer 948, 970, layer 2 (L2) 950, 972, and layer 1 (L1) 952, 974 protocol layers in the example shown may provide features similar to those RLC, MAC, and PHY layers in the NR/LTE Uu air interface, but for a wired SensMF-RAN interface in the example shown.

FIG. 9 shows an example of protocol layering for SensMF/UE interaction. In this example, SensP is used on top of a current air interface (Uu) protocol. In other embodiments SensP may be used with a newly designed air interface for sensing in lower layers. SensP is intended to represent a higher layer protocol to carry sensing data, optionally with encryption, according a sensing format defined for data transmission between UE and a sensing module or coordinator such as SensMF.

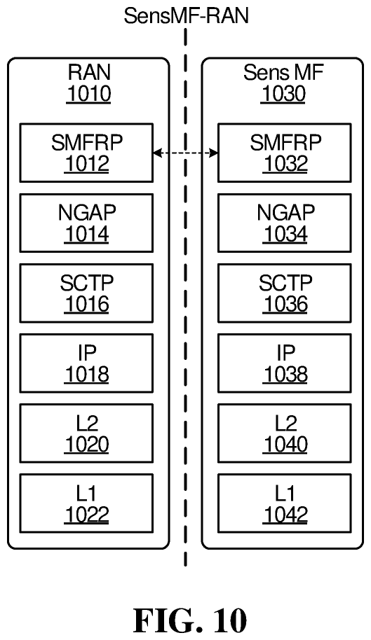

FIG. 10 is a block diagram illustrating example protocol stacks according to another embodiment. Example protocol stacks at a RAN and SensMF are shown at 1010 and 1030, respectively. FIG. 10 relates to RAN/SensMF interaction, and may be applied to any of various types of interface between UEs and the RAN.

A SensMFRAN protocol (SMFRP) layer 1012, 1032, represents a higher protocol layer between SensMF and a RAN node, to support transfer of control information and sensing information over an interface between SensMF and a RAN node, which is a wireline connection interface in this example. The other illustrated protocol layers include NGAP layer 1014, 1034, SCTP layer 1016, 1036, IP layer 1018, 1038, L2 1020, 1040, and L1 1022, 1042, which are described by way of example at least above.

FIG. 10 shows an example of protocol layering for SensMF/RAN node interaction. SMFRP can be used on top of a wireline connection interface as in the example shown, on top of a current air interface (Uu) protocol, or with a newly designed air interface for sensing in lower layers. SensP is another higher layer protocol to carry sensing data, optionally with encryption, and with a sensing format defined for data transmission between sensing coordinators, which may include a UE as shown in FIG. 9, a RAN node with a sensing agent, and/or a sensing coordinator such as SensMF implemented in a core network or a third-party network.

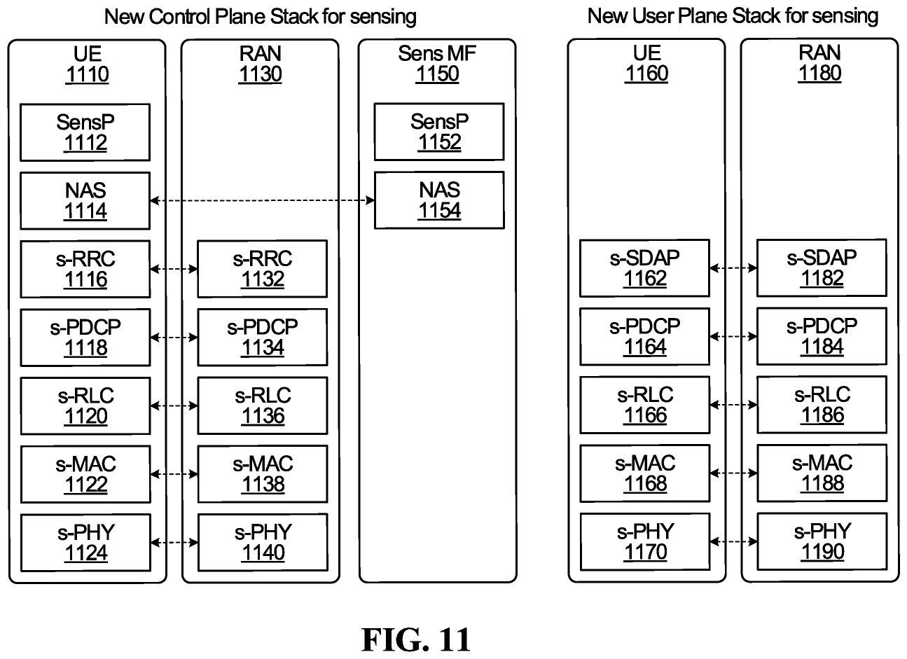

FIG. 11 is a block diagram illustrating example protocol stacks according to a further embodiment, and includes example protocol stacks for a new control plane for sensing and a new user plane for sensing. Example control plane protocol stacks at a UE, RAN, and SensMF are shown at 1110, 1130, 1150, respectively, and example user plane protocol for a UE and RAN are shown at 1160 and 1180, respectively.

The example in FIG. 9 is based on a Uu air interface between the UE and the RAN, and in the example sensing connectivity protocol stacks in FIG. 11 the UE/RAN air interfaces are newly designed or modified sensing-specific interfaces, as indicated by the “s-” labels for the protocol layers. In general, an air interface for sensing can be between a RAN and a UE, and/or include wireless backhaul between SensMF and RAN.

The SensP layers 1112, 1152 and the NAS layers 1114, 1154 are described by way of example at least above.

The s-RRC layers 1116, 1132 may have similar functions to RRC layers in current network (e.g., 3G, 4G or 5G network) air interface RRC protocol, or optionally the s-RRC layers may further have modified RRC features for supporting a sensing function. For example, system information broadcasting for s-RRC may include a sensing configuration for a device during initial access to the network, sensing capability information support, etc.

The s-PDCP layers 1118, 1134 may have similar functions to the PDCP layers in current network (e.g., 3G, 4G or 5G network) air interface PDCP protocol, or optionally the s-PDCP layers may further have modified PDCP features for supporting a sensing function, for example, to provide PDCP routing and relaying over one or more relay nodes, etc.

The s-RLC layers 1120, 1136 may have similar functions to the RLC layers in current network (e.g., 3G, 4G or 5G network) air interface RLC protocol, or optionally the s-RLC layers may further have modified RLC features for supporting a sensing function, for example, with no SDU segmentation.

The s-MAC layers 1122, 1138 may have similar functions to the MAC layers in current networks (e.g., 3G, 4G or 5G network) air interface MAC protocol, or optionally the s-MAC layers may further have modified MAC features for supporting a sensing function, for example, using one or more new MAC control elements, one or more new logical channel identifier(s), different scheduling, etc.

Similarly, the s-PHY layers 1124, 1140 may functions to the PHY layers in current network (e.g., 3G, 4G or 5G network) air interface PHY protocol, or optionally the s-PHY layers may further have modified PHY features for supporting a sensing function, for example, using one or more of: a different waveform, different encoding, different decoding, a different modulation and coding scheme (MCS), etc.

In the example new user plane for sensing, the following layers are described by way of example at least above: s-PDCP 1164, 1184, s-RLC 1166, 1186, s-MAC 1168, 1188, s-PHY layer 1170, 1190. A service data adaptation protocol (SDAP) layer is responsible for, for example, mapping between a quality-of-service (QoS) flow and a data radio bearer and marking QoS flow identifier (QFI) in both downlink and uplink packets, and a single protocol entity of SDAP is configured for each individual PDU session except for dual connectivity where two entities can be configured. The s-SDAP layers 1162, 1182 may have similar functions to the SDAP layers in current network (e.g., 3G, 4G or 5G network) air interface SDAP protocol, or optionally the s-SDAP layers may further have modified SDAP features for supporting a sensing function, for example, to define QoS flow IDs for sensing packets differently from downlink and uplink data bearers or in a special identity or identities for sensing, etc.

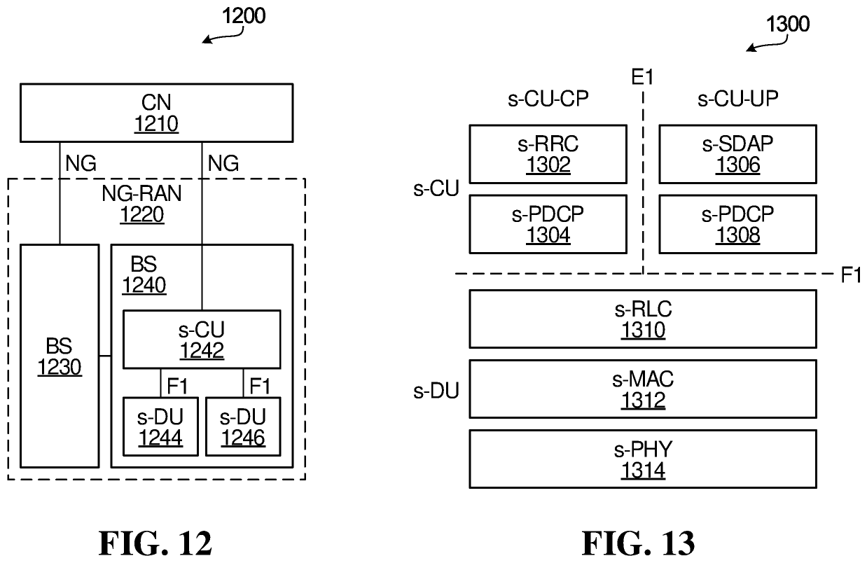

FIG. 12 is a block diagram illustrating an example interface between a core network and a RAN. The example 1200 illustrates an “NG” interface between a core network 1210 and a RAN 1220, in which two BSs 1230, 1240 are shown as example RAN nodes. The BS 1240 has a sensing-specific CU/DU architecture including an s-CU 1242 and two s-DUs 1244, 1246. The BS 1230 may have the same or similar structure in some embodiments.

FIG. 13 is a block diagram illustrating another example of protocol stacks according to an embodiment, for a CP/UP split at a RAN node. RAN features that are based on protocol stacks may be divided into a CU and a DU, and such splitting can be applied anywhere from PHY to PDCP layers in some embodiments.

In the example 1300, an s-CU-CP protocol stack includes an s-RRC layer 1302 and an s-PDCP layer 1304, an s-CU-UP protocol stack includes an s-SDAP layer 1306 and an s-PDCP layer 1308, and an s-DU protocol stack includes an s-RLC layer 1310, an s-MAC layer 1312, and an s-PHY layer 1314. These protocol layers are described by way of example at least above. E1 and F1 interfaces are also shown as examples in FIG. 13. s-CU and s-DU in FIG. 13 indicate legacy CU and DU with a sensing agent, or/and a sensing node with sensing capability.

The example in FIG. 13 illustrates CU/DU splitting at the RLC layer, with the s-CU including s-RRC and s-PDCP layers 1302, 1304 (for the control plane), and s-SDAP and s-PDCP layers 1306, 1308 (for the user plane), and the s-DU including s-RLC, s-MAC, and s-PHY layers 1310, 1312, 1314. Not every RAN node necessarily includes a CU-CP (or s-CU-CP), but at least one RAN node may include one CU-UP (or s-CU-CP) and at least one DU (or s-DU). One CU-CP (or s-CU-CP) may be able to connect to and control multiple RAN nodes with CU-UPs (or s-CU-CPs) and DUs (or s-DUs).

It should be appreciated that the examples in FIGS. 9-13 are intended to be illustrative and non-limiting. For example, sensing-related features may be supported or provided, at one or more UEs and/or at one or more network nodes, which may include nodes in one or more RANs, a CN, or an external node that is outside a RAN or CN.

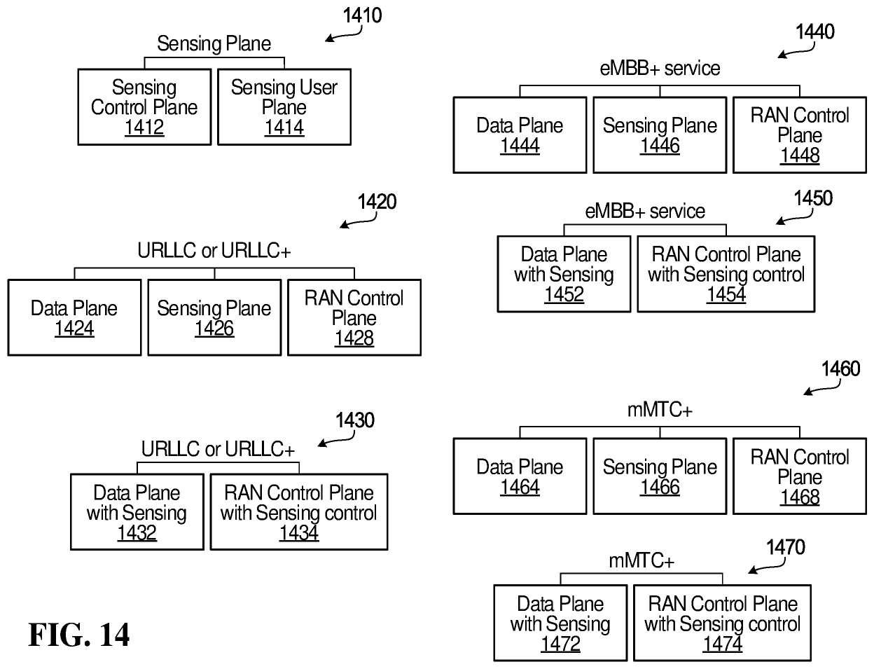

FIG. 14 includes block diagrams illustrating example sensing applications. AI may also or instead be used in any of these example applications, and/or others.

A service such as ultra-reliable low latency communications (URLLC) or URLLC+, or an application, may configure such parameters as time and frequency resources and/or transmission parameters associated with or coupled with the service or application for a UE. In this scenario, the service configuration may be related to or coupled with a sensing configuration on a sensing plane as shown by way of example at 1410 including control plane 1412 and user plane 1414, and work jointly to achieve application requirements or enhance performance, such as increasing reliability. As such, configuration parameters such as RRC configuration parameters for a service may include one or more sensing parameters, such as a sensing activity configuration associated with the service.

Use cases or services of URLLC or URLLC+, shown by way of example at 1420 and 1430, may have different coupling configurations with a sensing plane. Non-integrated data (or user), sensing, and control planes are shown at 1424, 1426, and 1428, and integrated data (or user) and control planes with integrated sensing are shown at 1432 and 1434. Similarly, enhanced mobile broadband (eMBB)+ service 1440 and eMBB+ service 1450 may have different configurations with sensing planes, including non-integrated data, sensing, and control planes 1444, 1446 and 1448, or integrated data and control planes 1452 and 1454 with integrated sensing. Another example application is massive machine type communications (mMTC)+ service 1460 and mMTC+ service 1470, which may have different configurations with sensing planes, including non-integrated data, sensing, and control planes 1464, 1466 and 1468, or integrated data and control planes 1472 and 1474 with integrated sensing.

In some embodiments, AI operation can be applied, independently or on top of (or otherwise in combination with) sensing operation to each use case or service in FIG. 14. For example, a service configuration may be related to or coupled with an AI configuration on an AI plane that includes an AI control plane and an AI user plane, similar to the sensing example shown at 1410. In this type of embodiment, a service configuration may work jointly to achieve application requirements or enhance performance, such as increasing reliability. As such, configuration parameters such as RRC configuration parameters for a service may include one or more AI parameters, such as an AI activity configuration associated with the service.

To apply AI operation on top of sensing, use cases or services of URLLC or URLLC+, shown by way of example at 1420 and 1430 for sensing only, may have different coupling configurations with sensing and AI plane(s). Non-integrated data (or user), sensing and AI, and control planes can be applied to 1424, 1426, and 1428, and integrated data (or user) and control planes with sensing and AI can be applied to 1432 and 1434. Similarly, enhanced mobile broadband (eMBB)+ service 1440 and eMBB+ service 1450 for sensing only may have different configurations with sensing and AI planes, including non-integrated data, sensing and AI, and control planes 1444, 1446 and 1448, or integrated data and control planes 1452 and 1454 with sensing and AI. Another example application is massive machine type communications (mMTC)+ service 1460 and mMTC+ service 1470, which may have different configurations with sensing and AI planes, including non-integrated data, sensing and sensing, and control planes 1464, 1466 and 1468, or integrated data and control planes 1472 and 1474 with sensing and AI.

For example, in an industrial internet of things (IoT) application in a factory or in auto-driving industry, high reliability and extremely low latency may be required. For example, an auto-driving network can take advantage of online or real-time sensing information on, e.g., road traffic loading, environment condition, in a network (e.g., a city) for safer and effective car auto-driving. Consider an example in which a sensing architecture in the network is as shown in FIG. 6A or 6B is used, focusing here only on the interaction between SensMF 608 and RAN/SAF 614, 624 message exchange.

The auto-driving network may request a sensing service in certain time periods or all the time from a wireless network with sensing functionality, and the sensing service request may be made via a sensing service center of the auto-driving network (which can be an office in the auto-driving network) to the SensMF 608 associated with the wireless network including RAN/SAF 614, 624. To get the online or real time sensing information on city traffic and road conditions, the sensing service center may send a sensing service request (SSR) message to the SensMF 608 with specific sensing requirements, which in an embodiment may include a request on sensing vehicle traffic across the network by a set of specific sensing nodes in some specific locations (e.g., key traffic roads). The SSR can be transmitted through an interface link.

The SensMF 608 may coordinate one or more RAN node(s) and/or one or more UE(s) based on the SSR. For example, the SensMF 608 may determine one or more RAN node(s) 612, 622 to perform online or real time sensing measurement based on the capability and service provided by the RAN nodes, and configure them to perform online or real time sensing measurement, for example by communicating a configuration or otherwise completing a configuration procedure with the one or more RAN node(s). After configuring or coordinating one or more RAN node(s), and/or possibly one or more UE(s), the SensMF 608 sends the SSR to RAN/SAF 614, 624. For example, the SensMF 608 may determine more details in terms of sensing KPIs such as measured vehicle mobility, direction, and how often sensing reporting is to be done for each individual sensing node in the sensing areas of interest, and then the SSR may be sent to associated RAN node(s) 612, 622 with SAF(s) 614, 624 (directly, or indirectly via the core network 606) in order to configure the associated sensing node(s) for the sensing operation and the task.

For example, the SSR may include one of more of a sensing task, sensing parameter(s), sensing resource(s), or other sensing configuration for the online or real time sensing measurement. Note that one SensMF 608 may deal with more than one RAN node with SAF, and thus more than one SSR may be sent to different SAFs at different RAN nodes. Each of these sensing nodes may be configured to measure the KPIs in its individual vicinity; and the configuration interface may be, for example, an air interface and the configuration signaling can be or include RRC signaling or message(s) that may include SensMF configured sensing information over a sensing-specific protocol between the SensMF 608 and the sensing node 612, 614. For example, the sensing protocol can be any one shown in FIGS. 10 and 11.

A RAN node/SAF 612/614, 622/624 may perform a sensing procedure with one or more UEs. For example, the RAN node can determine one or more UE(s) to perform online or real time sensing measurement based on the UE's capability, mobility, location, or service, and receive sensing measurement information or data from the associated UE(s), as considered in more detail elsewhere herein. The RAN node can send or share the sensing measurement information or data to a SAF, the SAF can analyze and/or otherwise process the sensing measurement information or data, and forward the sensing measurement information or data to the SensMF 608, or sensing analysis reports to the SensMF 608 based on the requirement between the SAF and the SensMF 608. In another option, each sensing node may send the measurement (e.g., KPIs) information back in configured time slots (e.g., duration and reporting periodically) to its associated RAN node and SAF 612/614, 622/624.

In one RAN node/SAF 612/614, 622/624, part or all of the sensing information (e.g., measured KPIs) from all the associated sensing nodes may be collected (and optionally processed for, e.g., RAN node local usage with SAF such as local communication control) as a response (SSResp) and then sent to the SensMF 608. For example, the SSResp can be or include any one of sensing measurement information, data or an analysis report, where sensing measurement information, data or an analysis report from each sensing node may be transferred to the SensMF 608 by applying a sensing-specific protocol via a sensing related information transferring path of either a control plane or user plane.

The SensMF 608 may process the SSResp from all sensing nodes in associated sensing RAN node(s). For example, the SensMF may put together multiple responses or information from multiple responses, perform number averaging and smoothing, interpolate, and/or perform or apply other analyzing methodology, etc., to determine or otherwise obtain a city map with real-time vehicle traffic and road conditions for city areas or streets of interest as a response to send to the sensing service center of the auto-driving network for online traffic information. Such an online and real-time sensing task may lead to safer and/or more effective car auto-driving operations.

The above embodiments with sensing functionality may apply to other use cases or service cases as well. Moreover, in the above embodiments, AI operation may work together with sensing functionality, or AI may be applied on top of sensing functionality to each of these use cases or services. For example, in an industrial internet of things (IoT) application in a factory or in auto-driving industry, high reliability and/or extremely low latency may be important. An auto-driving network can take advantage of online or real-time sensing information on, e.g., road traffic loading, environment condition, in a network (e.g., a city) for safer and/or more effective car auto-driving, where real-time sensing information may be used by an AI model as training inputs for smart and even more safe and/or effective car auto-driving. To support such an application, the AI and sensing architectures in the network examples as shown in FIG. 6A or 6B can be applied in some embodiments.

A sensing feature may also or instead be useful in an URLLC solution. For example, with URLLC+, sensing information such as sudden movement, environment change, network traffic congestion varying, etc., may be of paramount importance, for such purposes as to optimize data transmission control, to avoid incidental events on-the-fly, and/or for collision control due to urgent situations. Moreover, on top of sensing and control, applying AI operation in these scenarios may make URLLC+ more effective, reliable or intelligent to deal with situations such as sudden movement, environment change, network traffic congestion varying, and to optimize data transmission control, to avoid incidental events on-the-fly, and/or for collision control due to urgent situations.

These features, and/or others, may also or instead be applicable to other applications or services that are to work with sensing operations.

Various sensing features and embodiments are described in detail at least above. Disclosed embodiments include, for example, a method that involves communicating, by a first sensing coordinator in a radio access network, a first signal with a second sensing coordinator through an interface link. Examples of first and second sensing coordinators include not only SAF and SensMF, but also other sensing components including those at a UE or other electric device that may be involved in sensing procedures. Multiple sensing coordinators may also or instead be implemented together.

A sensing coordinator such as SensMF or SAF may implement or include a sensing protocol layer, and communicating information for sensing, such as configuration(s) and/or sensing measurement data, may involve communicating a signal through an interface link using the sensing protocol. Various examples of sensing protocol stacks including sensing protocol layers that may be involved in communicating a signal between sensing coordinators are provided in FIGS. 9 to 13. FIG. 10 provides a particular example of a sensing protocol layer, in the form of SMFRP layer 1012 in the RAN protocol stack 1010, that may be involved in communicating a signal between a first sensing coordinator in a RAN and a second sensing coordinator SensMF, which may be located in a CN or in another network. Other examples of sensing protocol layers that may be involved in sensing and communicating a signal between sensing coordinators, which may include one or more components at a UE or other device for sensing, are shown in FIGS. 9 to 13.

An interface link may be or include any of various types of links. An air interface link for sensing, for example, can be one between a RAN and a UE, and/or wireless backhaul between SensMF and a RAN, for example. New designs may also or instead be provided for either or both of control planes and user planes between components that are involved in sensing.

For example, an interface link may be or include any one or more of the following: a Uu air interface link between the first sensing coordinator and an electric device such as a UE or other device; an air interface link of new radio vehicle-to-anything (NR v2x), long term evolution machine type communication (LTE-M), Power Class 5 (PC5), Institute of Electrical and Electronics Engineers (IEEE) 802.15.4, and IEEE 802.11, between the first sensing coordinator and an electric device; a sensing-specific air interface link between the first sensing coordinator and an electric device; a next generation (NG) interface link or sensing interface link between the first sensing coordinator and a network entity of a core network or a backhaul network including the examples shown in FIGS. 9 to 13; a sensing control link and/or a sensing data link between the first sensing coordinator and a network entity of the core network or a backhaul network; and a sensing control link and/or a sensing data link between the first sensing coordinator and a network entity that is outside of a core network or a backhaul network.

These interface link examples refer to a sensing-specific air interface link. FIG. 11, for example, illustrates an embodiment in which a sensing-specific air interface link involves sensing-specific s-PHY, s-MAC, and s-RLC protocol layers. These sensing-specific protocol layers are different from conventional PHY, MAC, and RLC protocol layers, and any one or more of these sensing-specific protocol layers may be provided in some embodiments.

Various protocol stack embodiments are also disclosed. For example, a sensing coordinator may include any one or more of the following: a control plane stack for the sensing protocol, with higher layers including one or both of s-PDCP and s-RRC as in FIG. 10 for example; a user plane stack for the sensing protocol, with higher layers including one or both of s-PDCP and s-SDAP, as in FIG. 11 for example; and a sensing-specific s-CU or s-DU, such as s-CU-CP, s-CU-UP, and s-DU as shown by way of example in FIGS. 12 and 13. Moreover, to apply AI on top of sensing functionality, a protocol set to support both sensing and AI may be provided; such a protocol set can replace a sensing only protocol layer by a protocol layer of supporting both sensing and AI features. For example, the sensing protocol layers such as s-RRC, s-SDAP, s-PDCP, s-RLC, s-MAC, s-PHY in preceding examples can be replaced by layers supporting both sensing and AI, which can be denoted by as-RRC, as-SDAP, as-PDCP, as-RLC, as-MAC, as-PHY, among which some of the layers may be new designs and others could be similar to, substantially the same as, or modified from current network protocol layers in support of both sensing and AI operations.

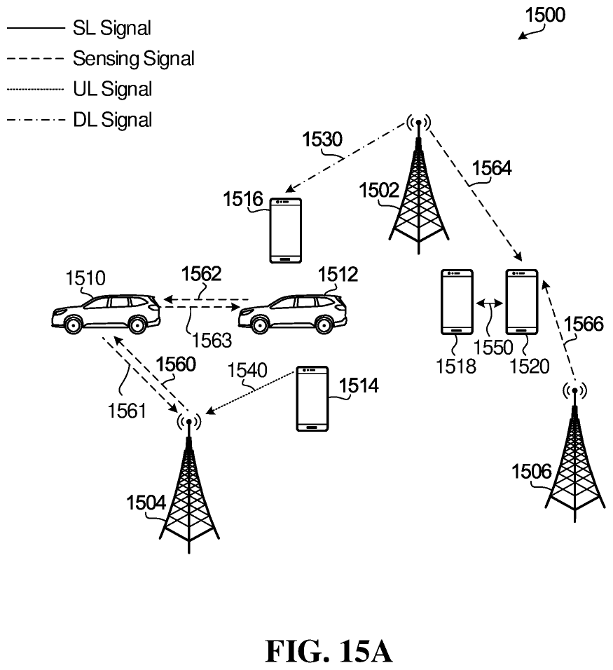

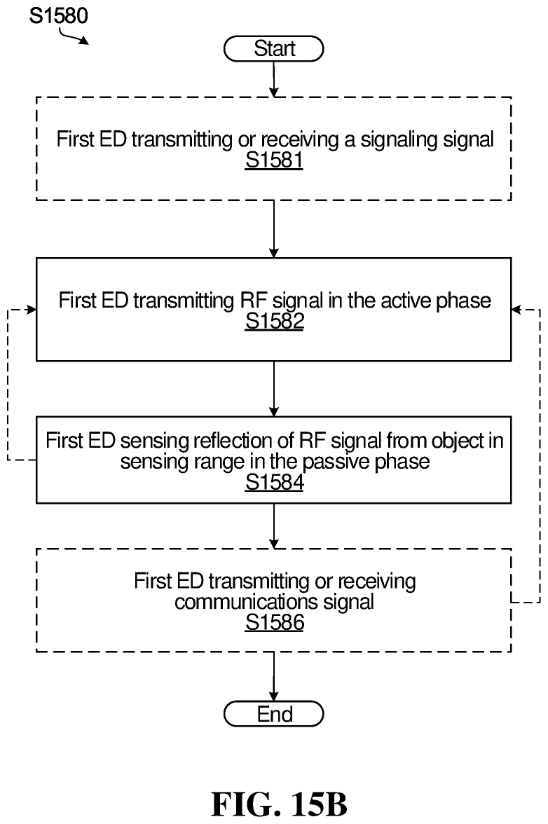

FIG. 15A is a diagram illustrating an example communication system 1500 implementing integrated communication and sensing in a half-duplex (HDX) mode using monostatic sensing nodes. The communication system 1500 includes multiple TRPs 1502, 1504, 1506, and multiple UEs 1510, 1512, 1514, 1516, 1518, 1520. In FIG. 15A, for illustration purposes only, the UEs 1510, 1512 are illustrated as vehicles and the UEs 1514, 1516, 1518, 1520 are illustrated as cell phones, however, these are only examples and other types of UEs may be included in the system 1500.

The TRP 1502 is a base station that transmits a downlink (DL) signal 1530 to the UE 1516. The DL signal 1530 is an example of a communication signal carrying data. The TRP 1502 also transmits a sensing signal 464 in the direction of the UEs 1518, 1520. Therefore, the TRP 1502 is involved in sensing and is considered to be both a sensing node (SeN) and a communication node.

The TRP 1504 is a base station that receives an uplink (UL) signal 1540 from the UE 1514, and transmits a sensing signal 1560 in the direction of the UE 1510. The UL signal 1540 is an example of a communication signal carrying data. Since the TRP 1504 is involved in sensing, this TRP is considered to be both a sensing node (SeN) and a communication node.

The TRP 1506 transmits a sensing signal 1566 in the direction of the UE 1520, and therefore this TRP is considered to be a sensing node. The TRP 1506 may or may not transmit or receive communication signals in the communications system 1500. In some embodiments, the TRP 1506 may be replaced with a sensing agent (SA) that is dedicated to sensing, and does not transmit or receive any communication signals in the communication system 1500.

The UEs 1510, 1512, 1514, 1516, 1518, 1520 are capable of transmitting and receiving communication signals on at least one of UL, DL, and SL. For example, the UEs 1518, 1520 are communicating with each other via SL signals 1550. At least some of the UEs 1510, 1512, 1514, 1516, 1518, 1520 are also sensing nodes in the communication system 1500. By way of example, the UE 1512 may transmit a sensing signal 1562 in the direction of the UE2 1510 during an active phase of operation. The sensing signal 1562 may include or carry communication data, such as payload data, control data, and signaling data. A reflection signal 1563 of the sensing signal 1562 is reflected off UE 1510 and returned to and sensed by UE 1512 during a passive phase of operation. Therefore, the UE 1512 is considered to be both a sensing node and a communication node.

A sensing node in the communication system 1500 may implement monostatic or bi-static sensing. At least some of the sensing nodes such as UEs 1510, 1512, 1518 and 1520 may be configured to operate in an HDX monostatic mode. In some embodiments, all of the sensing nodes in the communication system 1500 may be configured to operate in the HDX monostatic mode. In other embodiments, all or at least some of the sensing nodes such as UEs 1510, 1512, 1518 and 1520 may be configured for sensing measurement and reporting to an AI agent and/or AI block, where all or part of the sensing measurements may be transmitted to the AI agent and/or AI block for AI training and/or control. Such sensing and reporting behavior can also or instead be configured for one or more TRPs from the TPRs 1502, 1504, 1506. In this way, integrated sensing and communication, as well as AI-based intelligent control in the network, may be achieved.

In the case of monostatic sensing, the transmitter of a sensing signal is a transceiver such as a monostatic sensing node transceiver, and also receives a reflection of the sensing signal to determine the properties of one or more objects within its sensing range. In an example, the TRP 1504 may receive a reflection 1561 of the sensing signal 1560 from the UE 1510 and potentially determine properties of the UE 1510 based on the reflection 1561 of the sensing signal. In another example, the UE2 1512 may receive reflection 1563 of the sensing signal 1562 and potentially determine properties of the UE 1510 based on the sensed reflection 1563.

In some embodiments, the communication system 1500 or at least some of the entities in the system may operate in a HDX mode. For example, a first one of the EDs in the system, such as the UEs 1510, 1512, 1514, 1516, 1518, 1520 or TRPs 1502, 1504, 1506, may communicate with at least another one (second one) of the EDs in the HDX mode. The transceiver of the first ED may be a monostatic transceiver configured to cyclically alternate between operation in an active phase and operation in a passive phase for a plurality of cycles, each cycle including a plurality of communication and sensing subcycles.

During operation, in the active phase of a communication and sensing subcycle, a pulse signal is transmitted from the transceiver. The pulse signal is an RF signal and is used as a sensing signal, but also has a waveform structured to facilitate carrying communication data. In the passive phase of the communication and sensing subcycle, the transceiver of the first ED also senses a reflection of the pulse signal reflected from an object at a distance (d) from the transceiver, for sensing objects within a sensing range. In the passive phase, the first ED may also detect and receive communication signals from the second ED or possibly other EDs. The first ED may use the monostatic transceiver to detect and receive the communication signals. The first ED may also include a separate receiver for receiving the communication signals. However, to avoid possible interference, the separate receiver may also be operated in the HDX mode. In these embodiments, any of the sensing signals 1560, 1562, 1564, 1566 and communication signals 1530, 1540, 1550 illustrated in FIG. 15A may be used for both communication and sensing. In these embodiments, the pulse signal may be structured to optimize the duty cycle of the transceiver so as to meet both communication and sensing requirements while maximizing operation performance and efficiency. In a particular embodiment, the pulse signal waveform is configured and structured so that the ratio of the duration of the active phase and the duration of the passive phase in a sensing cycle or subcycle is greater than a predetermined threshold ratio, and at least a predetermined proportion of the reflection reflected from targets within a given range is received by the transceiver.

In an example, the ratio or proportion may be expressed as a time value; accordingly, the pulse signal in this example is configured and structured so that active phase time is a specific value or range of values, and the passive phase time is a specific value or range of values associated with the respective value or values of the active phase time. As a result, the pulse signal is configured such that the time value of the reflection is greater than a threshold value. The ratio or proportion may also be indicated or expressed as a multiple of a known or predefined value or metric. The predefined value may be a predefined symbol time, such as a sensing symbol time, as will be further discussed below.

The durations of the active and passive phases, and the waveform and structures of the pulse signal may also be otherwise configured according to embodiments described herein to improve communication and sensing performance. For example, constraints on the ratio of the phase durations may be provided to balance the competing factors of efficient use of the signal resources for communication and the sensing performance, as discussed above and in further details below.

An example of the operation process at the first ED is illustrated in FIG. 15B, as process S1580.

In process S1580, the first ED, such as the UE 1512, is operated to communicate with at least one second ED, which may be any one or more of BS 1502, 1504, 1506 or UE 1510, 1514, 1516, 1518, 1520. The first ED is operated to cyclically alternate between an active phase and a passive phase.

In the active phase, at S1582, the first ED transmits a radio frequency (RF) signal in the active phase. The RF signal may be a pulse signal suitable as a sensing signal. The pulse signal is beneficially configured to also be suitable for carrying communication data within the pulse signal. For example, the pulse signal may have a waveform structured to carry communication data.

In the passive phase, at S1584, the first ED senses a reflection of the RF signal reflected from an object, such as reflection 1563 from UE 1510.

The active phase and passive phase are alternately and cyclically repeated for a plurality of cycles. Each cycle may include a plurality subcycles. The active and passive phases and the RF signal are configured and structured to receive at least a threshold portion or proportion of the reflected signal during the passive phase when the object is within a sensing range, as will be further described below. In some embodiments, the threshold portion or proportion may be indicated or expressed as, or by, a known or predefined value or metric, or a multiple of a base value or reference value. An example metric or value is time, and the base value or metric may be a unit of time or a standard time duration.

In the passive phase, at S1584, the first ED may optionally be operated to receive a communication signal from one or more other EDs, which may include UEs or BS.

Optionally, the first ED may be operated to transmit a control signaling signal indicative of one or more signal parameters associated with the RF signal during the active phase at S1582.

Optionally, the first ED may be operated to receive a control signaling signal indicative of one or more signal parameters associated with the RF signal to be transmitted by the first ED, or a communication signal to be received by the first ED, during the passive phase. The first ED may process the control signaling signal and construct the RF signal to be transmitted in subsequent cycles.

In an example, the first ED may be operated to transmit or receive a control signaling signal at optional stage S1581, separately from the RF signal of S1582. The control signaling signal may include any of various information, indications and/or parameters. For example, if the first ED receives a control signaling signal at either S1581 or S1584, the first ED may configure and structure the signal to be transmitted at S1582 based on the information or parameters indicated in the control signaling signal received by the first ED. The control signaling signal may be received from a UE or a BS, or any TP.

If the first ED transmits a control signaling signal, the control signaling signal may include information, indications, and parameters about the signal to be transmitted during the active phase at S1582. In this case, the control signaling signal may be transmitted to any other ED, such as a UE or a BS.

Alternatively or furthermore, the RF signal transmitted at S1582 may include a control signaling portion. The control signaling portion may indicate one or more of signal frame structure; subcycle index of each subcycle that comprises encoded data; and a waveform, numerology, or pulse shape function, for a signal to be transmitted from the first ED. The signaling portion may include an indication that a cycle or subcycle of the RF signal to be transmitted includes encoded data. The encoded data may be payload data or control data, or include both. For example, the signaling indication may include an indicator of a subcycle index, a frequency resource scheduling index, or a beamforming index, associated with the subcycle or the encoded data.

The process S1580 may begin when the first ED starts to sense or communicate with another ED. The process S1580 may terminate when the first ED is no longer used for sensing, or when the first ED terminates both sensing and communication operations.

For example, as illustrated in FIG. 15B, in the process S1580, the first ED may continue, or start, to transmit or receive communications signals, at S1586, after termination of the sensing operations. After a period of communication only operation, the first ED may also resume sensing operations, such as restarting the cyclic operations at S1582 and S1584.

It is noted that the order of operations at S1581, S1582, S1584, and S1586 may be modified and vary from the order shown in FIG. 15B, and operations at S1581 and S1586 may be performed at the same time or integrated with operations at S1582 or S1584.

The signal sensed or received during an earlier passive phase may be used to configure and structure a signal to be transmitted in a later active phase, or for scheduling and receiving a communication signal in later passive phase. The received communication signal may be a sensing signal transmitted by another ED that also embeds or carries communication data, including payload data or control data.

Each of the first ED and second ED(s) may be a UE or a BS.

The signal received or transmitted by the first ED may include control signaling that provides information about the parameters or structure details of the signal to be transmitted by the first ED, or of a signal to be received by the first ED.

The control signaling may include information about embedding communication data in a sensing signal such as the RF signal transmitted by the first ED.

The control signaling may include information about multiplexing a communication signal and a sensing signal for DL, UL, or SL, for example.

In the case of bi-static sensing, the receiver of a reflected sensing signal is different from the transmitter of the sensing signal. In some embodiments, a BS, TRP or UE may also be capable of operating in a bi-static or multi-static mode, such as at selected times or in communication with certain selected EDs that are also capable of operating in the bi-static or multi-static mode. For example, any or all of the UEs 1510, 1512, 1514, 1516, 1518, 1520 may be involved in sensing by receiving reflections of the sensing signals 1560, 1562, 1564, 1566. Similarly, any or all of the TRPs 1502, 1504, 1506 may receive reflections of the sensing signals 1560, 1562, 1564, 1566. Although some embodiments relate to monostatic sensing, embodiments can also or instead be applied to and beneficial for bi-static or multi-static sensing, particularly to facilitate compatibility and reduce interference, for example, when used in a system with both monostatic and multi-static nodes.

In an example, the sensing signal 1564 may be reflected off of the UE 1520 and be received by the TRP 1506. It should be noted that a sensing signal might not physically reflect off of a UE, but may instead reflect off an object that is associated with the UE. For example, the sensing signal 1564 may reflect off of a user or vehicle that is carrying the UE 1520. The TRP 1506 may determine certain properties of the UE 1520 based on a reflection of the sensing signal 1564, including the range, location, shape, and speed or velocity of the UE 1520, for example. In some implementations, the TRP 1506 may transmit information pertaining to the reflection of the sensing signal 1564 to the TRP 1502, or to any other network entity. The information pertaining to the reflection of the sensing signal 1564 may include, for example, any one or more of: the time that the reflection was received, the time-of-flight of the sensing signal (for example, if the TRP 1506 knows when the sensing signal was transmitted), the carrier frequency of the reflected sensing signal, the angle of arrival of the reflected sensing signal, and the Doppler shift of the sensing signal (for example, if the TRP 1506 knows the original carrier frequency of the sensing signal). Other types of information pertaining to the reflection of a sensing signal are contemplated, and may also or instead be included in the information pertaining to the reflection of the sensing signal.

The TRP 1502 may determine properties of the UE 1520 based on the received information pertaining to the reflection of the sensing signal 1564. If the TRP 1506 has determined certain properties of the UE 1520 based on the reflection of the sensing signal 1564, such as the location of the UE 1520, then the information pertaining to the reflection of the sensing signal 1564 may also or instead include these properties.

In another example, the sensing signal 1562 may be reflected off of the UE 1510 and be received by the TRP 1504. Similar to the example provided above, the TRP 1504 may determine properties of the UE 1510 based on the reflection 1563 of the sensing signal 1562, and transmit information pertaining to the reflection of the sensing signal to another network entity, such as the UEs 1510, 1512.

In a further example, the sensing signal 1566 may be reflected off of the UE 1520 and be received by the UE 1518. The UE 1518 may determine properties of the UE 1520 based on the reflection of the sensing signal, and transmit information pertaining to the reflection of the sensing signal to another network entity, such as the UE 1520 or the TRPs 1502, 1506.

The sensing signals 1560, 1562, 1564, 1566 are transmitted along particular directions, and in general, a sensing node may transmit multiple sensing signals in multiple different directions. In some implementations, sensing signals are used to sense the environment over a given area, and beam sweeping is one of the possible techniques to expand the covered sensing area. Beam sweeping can be performed using analog beamforming to form a beam along a desired direction using phase shifters, for example. Digital beamforming and hybrid beamforming are also possible. During beam sweeping, a sensing node may transmit multiple sensing signals according to a beam sweeping pattern, where each sensing signal is beamformed in a particular direction.

The UEs 1510, 1512, 1514, 1516, 1518, 1520 are examples of objects in the communication system 1500, any or all of which could be detected and measured using a sensing signal. However, other types of objects could also be detected and measured using sensing signals. Although not illustrated in FIG. 15A, the environment surrounding the communication system 1500 may include one or more scattering objects that reflect sensing signals and potentially obstruct communication signals. For example, trees and buildings could at least partially block the path from the TRP 1502 to the UE 1520, and potentially impede communications between the TRP 1502 and the UE 1520. The properties of these trees and buildings may be determined based on a reflection of the sensing signal 1564, for example.

In some embodiments, communication signals are configured based on the determined properties of one or more objects. The configuration of a communication signal may include the configuration of a numerology, waveform, frame structure, multiple access scheme, protocol, beamforming direction, coding scheme, or modulation scheme, or any combination thereof. Any or all of the communication signals 1530, 1540, 1550 may be configured based on the properties of the UEs 1514, 1516, 1518, 1520. In one example, the location and velocity of the UE 1516 may be used to help determine a suitable configuration for the DL signal 1530. The properties of any scattering objects between the UE 1516 and the TRP 1502 may also be used to help determine a suitable configuration for the DL signal 1530. Beamforming may be used to direct the DL signal 1530 towards the UE 1516 and to avoid any scattering objects. In another example, the location and velocity of the UE 1514 may be used to help determine a suitable configuration for the UL signal 1540. The properties of any scattering objects between the UE 1514 and the TRP 1504 may also be used to help determine a suitable configuration for the UL signal 1540. Beamforming may be used to direct the UL signal 1540 towards the TRP 1504 and to avoid any scattering objects. In a further example, the location and velocity of the UEs 1518, 1520 may be used to help determine a suitable configuration for the SL signals 1550. The properties of any scattering objects between the UEs 1518, 1520 may also be used to help determine a suitable configuration for the SL signals 1550. Beamforming may be used to direct the SL signals 1550 to either or both of the UEs 1518, 1520 and to avoid any scattering objects.

The properties of the UEs 1510, 1512, 1514, 1516, 1518, 1520 may also or instead be used for purposes other than communications. For example, the location and velocity of the UEs 1510, 1512 may be used for the purpose of autonomous driving, or for simply locating a target object.

The transmission of sensing signals 1560, 1562, 1564, 1566 and communication signals 1530, 1540, 1550 may potentially result in interference in the communication system 1500, which can be detrimental to both communication and sensing operations.

In some embodiments, these measurement information such as the location and velocity from one or more of all UEs or the UEs 1510, 1512, 1518 1520, and/or one or more of the TRPs 1502-1506 may be reported to an AI agent and/or AI block for part of information on AI control and/or AI training.

Another aspect of intelligent backhaul according to some embodiments is an AI/sensing integrated interface with RAN node(s), for an AI and sensing integrated service for example, with control/data planes in two scenarios in some embodiments:
NR AMF/UPF protocol stacks with an additional AI/sensing layer on top for control/data;

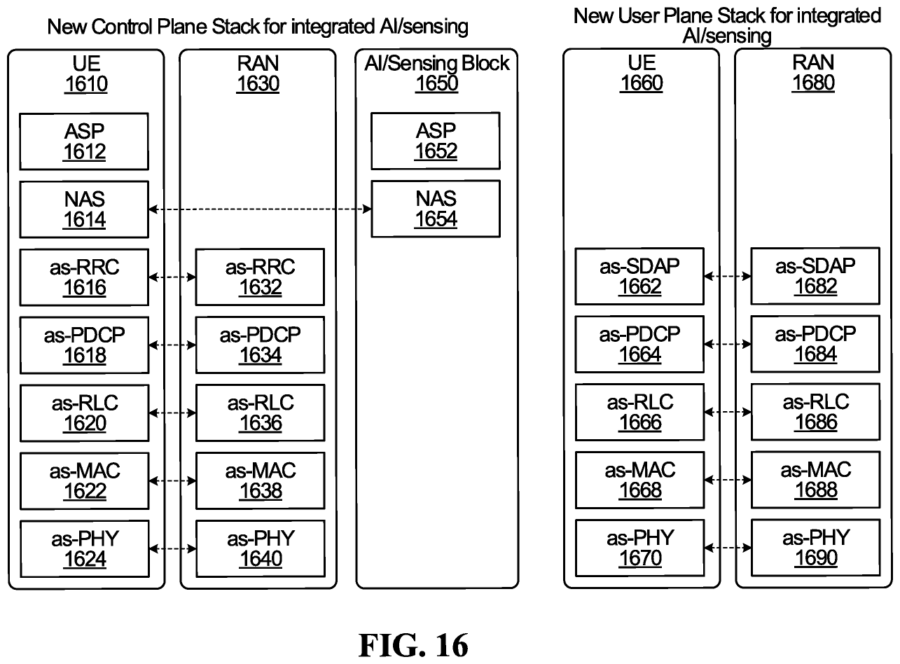

In this case, the AI and sensing control plane protocol stacks at a UE, RAN, and AI and sensing blocks may be similar to FIG. 9, where the sensing protocol or SensProtocol (SensP) layer 912, 962, shown in the example UE and SensMF protocol stacks 910, 960, is replaced by AI-sensing protocol (ASP) layer, and other underlying layers are the same as in FIG. 9. In this example, the ASP layer is on top of the NAS layer such as 914, 964 of FIG. 9, and therefore the AI and/or sensing information in a form of ASP layer protocol is actually contained and delivered in the secured NAS message in a form of NAS protocol.
new AI/sensing protocol layers for control/data.
   The AI and sensing user plane protocol stacks can be newly designed as described by way of example below based on FIG. 16.

FIG. 16 is a block diagram illustrating example protocol stacks according to a further embodiment, and includes example protocol stacks for a new AI/sensing integrated control plane and a new AI/sensing integrated user plane. Example control plane protocol stacks at a UE, RAN, and an AI and sensing block are shown at 1610, 1630, 1650, respectively, and example user plane protocol for a UE and RAN are shown at 1660 and 1680, respectively.

In the example protocol stacks in FIG. 16 the UE/RAN air interfaces are newly designed or modified AI/sensing integrated interfaces, as indicated by the ASP layers 1612, 1652 and the “as-” labels for other protocol layers. In general, an air interface for integrated AI/sensing can be between a RAN and a UE, and/or include wireless backhaul between an AI/sensing block and RAN.

The ASP (AI and sensing protocol) layers 1612, 1652 and the NAS layers 1614, 1654 are described by way of example at least above. In FIG. 16, a modified as-NAS layer, newly designed or modified for an AI/sensing integrated interface, may replace the illustrated NAS layers 1614, 1654, and further have modified NAS features for supporting integrated AI and/or sensing function(s).

The as-RRC layers 1616, 1632 may have similar functions to the RRC layers in current network (e.g., 3G, 4G or 5G network) air interface RRC protocol, or optionally the as-RRC layers may further have modified RRC features for supporting integrated AI and/or sensing function(s). For example, system information broadcasting for as-RRC may include an integrated AI/sensing configuration for a device during initial access to the network, AI/sensing capability information support, etc.

The as-PDCP layers 1618, 1634 may have similar functions to the PDCP layers in current network (e.g., 3G, 4G or 5G network) air interface PDCP protocol, or optionally, the as-PDCP layers 1618, 1634 may further have modified PDCP features for supporting AI and/or sensing function(s), for example, to provide PDCP routing and relaying over one or more relay nodes, etc.

The as-RLC layers 1620, 1636 may have similar functions to the RLC layers in current network (e.g., 3G, 4G or 5G network) air interface RLC protocol, or optionally the as-RLC layers may further have modified RLC features for supporting AI and/or sensing function(s), for example, with no SDU segmentation.

The as-MAC layers 1622, 1638 may have similar functions to the MAC layers in current network (e.g., 3G, 4G or 5G network) air interface MAC protocol, or optionally the as-MAC layers may further have modified MAC features for supporting AI and/or sensing function(s), for example, using one or more new MAC control elements, one or more new logical channel identifier(s), different scheduling, etc.

Similarly, the as-PHY layers 1616, 1640 may have similar functions to the SDAP layers in current network (e.g., 3G, 4G or 5G network) air interface PHY protocol, or optionally the as-PHY layers may further have modified PHY features for supporting AI and/or sensing functions, for example, using one or more of: a different waveform, different encoding, different decoding, a different modulation and coding scheme (MCS), etc.

In the example new user plane for integrated AI/sensing, the following layers are described by way of example at least above: as-PDCP 1664, 1684, as-RLC 1666, 1686, as-MAC 1668, 1688, as-PHY layer 1670, 1690. A service data adaptation protocol (SDAP) layer is responsible for, for example, mapping between a quality-of-service (QoS) flow and a data radio bearer and marking QoS flow identifier (QFI) in both downlink and uplink packets, and a single protocol entity of SDAP is configured for each individual PDU session except for dual connectivity where two entities can be configured. The as-SDAP layers 1662, 1682 may have similar functions to the SDAP layers in current network (e.g., 3G, 4G or 5G network) air interface SDAP protocol, or optionally the as-SDAP layers may further have modified SDAP features for supporting AI and/or sensing, for example, to define QoS flow IDs for AI/sensing packets differently from downlink and uplink data bearers or in a special identity or identities for sensing, etc.

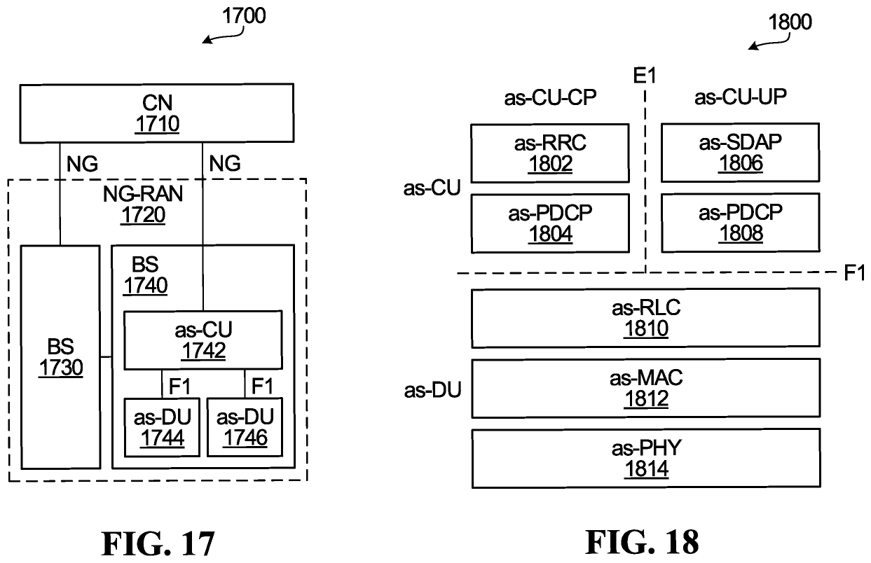

FIG. 17 is a block diagram illustrating an example interface between a core network and a RAN. The example 1700 illustrates an “NG” interface between a core network 1710 and a RAN 1720, in which two BSs 1730, 1740 are shown as example RAN nodes. The BS 1740 has a CU/DU architecture for integrated AI/sensing, including an as-CU 1742 and two as-DUs 1744, 1746. The BS 1730 may have the same or similar structure in some embodiments.

FIG. 18 is a block diagram illustrating another example of protocol stacks according to an embodiment, for a CP/UP split at a RAN node. RAN features that are based on protocol stacks may be divided into a CU and a DU, and such splitting can be applied anywhere from PHY to PDCP layers in some embodiments.

In the example 1800, an as-CU-CP protocol stack includes an as-RRC layer 1802 and an as-PDCP layer 1804, an as-CU-UP protocol stack includes an as-SDAP layer 1806 and an as-PDCP layer 1808, and an as-DU protocol stack includes an as-RLC layer 1810, an as-MAC layer 1812, and an as-PHY layer 1814. These protocol layers are described by way of example at least above. E1 and F1 interfaces are also shown as examples in FIG. 18. as-CU and as-DU in FIG. 18 indicate legacy CU and DU with integrated AI/sensing, or/and an AI/sensing node with AI and sensing capability.

The example in FIG. 18 illustrates CU/DU splitting at the RLC layer, with the as-CU including as-RRC and as-PDCP layers 1802, 1804 (for the control plane), and as-SDAP and as-PDCP layers 1806, 1808 (for the user plane), and the as-DU including as-RLC, as-MAC, and as-PHY layers 1810, 1812, 1814. Not every RAN node necessarily includes a CU-CP (or as-CU-CP), but at least one RAN node may include one CU-UP (or as-CU-CP) and at least one DU (or as-DU). One CU-CP (or as-CU-CP) may be able to connect to and control multiple RAN nodes with CU-UPs (or as-CU-CPs) and DUs (or as-DUs).

The example interfaces are intended solely for illustrative purposes, and do not limit the present disclosure. For example, AI and/or sensing may connect or interface with one or more RAN nodes via a core network. Also, although air interfaces are considered in detail herein, it should be appreciated that interfacing for AI and/or sensing can be either wireline or wireless.

As noted above, components of an intelligent architecture according to embodiments herein may include intelligent backhaul and an inter-RAN node interface. Intelligent backhaul is discussed by way of example above. Turning now to inter-RAN node interfacing, an inter-RAN node interface Yn is illustrated in FIGS. 6A and 6B.

A RAN may include one or more RAN nodes, including either or both of fixed and mobile nodes such as TN nodes, IAB, drone, UAV, NTN nodes, etc. An interface between two RAN nodes can be wireline or wireless. A wireless interface may use communication protocols with control and user planes using one or more of wireless backhaul (e.g., fixed base station and IAB), intelligent Uu, and/or intelligent SL, etc.

NTN nodes such as satellite stations can be third-party equipment from a different vendor than wireless network vendor, where NT-NTN interfacing can be different from TN-TN internal interfacing such as Xn. A newly designed interface is provided between TN node and NTN nodes in some embodiments, and takes into consideration the potentially large air interface latency between TN and NTN nodes and node synchronization issues.

An inter-RAN node interface may be key to such features as node synchronization, joint scheduling (e.g., resource sharing, broadcasting, RS and measurement configuration, etc.), and mobility management and support among different RAN nodes.

In FIGS. 6A and 6B, AI and sensing blocks 610, 608 are included within the CN 606. AI, sensing, and other CN functionalities may have inter-connections through one or more internal functional interfaces, which may apply CN common functional APIs. Moreover, the AI and sensing blocks 610, 608 may have shared or separate control and user planes communicating with a RAN node and/or a UE (not shown in FIGS. 6A and 6B).

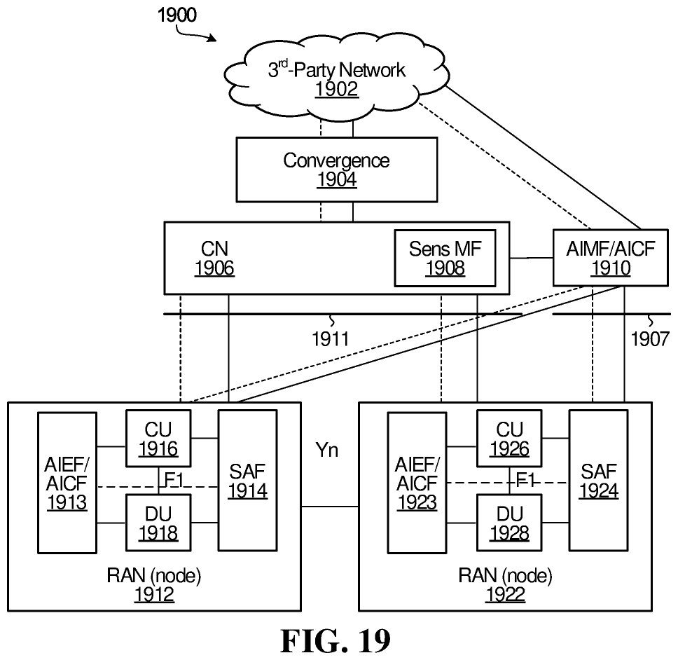

FIG. 19 is a block diagram illustrating a network architecture according to a further embodiment, in which sensing is based in a core network and AI is based outside the core network. The example network 1900 in FIG. 19 is similar to the example in FIG. 6A, and includes a third-party network 1902, a convergence element 1904, a core network 1906, an AI block or element 1910, a sensing block or element 1908, RAN nodes 1912, 1922 in one or more RANs, and interfaces 1911, 1907, for example, which are used for transmitting data and/or control information. Each RAN node 1912, 1922 includes an AI agent or element 1913, 1923, and a sensing agent or element 1914, 1924, and has a distributed architecture including a CU 1916, 1926 and a DU 1918, 1928.

The embodiment in FIG. 19 differs from that of FIG. 6A in that the sensing block 1908 is within the CN 1906 while the AI block 1910 is located outside of the CN. Thus the sensing block 1908 accesses the RAN node(s) 1912, 1922 via backhaul between CN 1906 and the RAN node(s), whereas the AI block 1910 may access the RAN node(s) directly via the interface 1907. In the example shown, the AI block 1910 may also connect directly with the third-party network 1902 such as a data network, and/or with the CN 1906.

Although most components in FIG. 19 may be implemented in the same way as in FIG. 6A, the different architecture in FIG. 19 may impact operation of not only the AI block 1910, but also components other than the AI block. For example, the third-party network, the convergence element, the CN, and the RAN nodes in FIG. 19 interact differently with the AI block 1910 than their counterparts in FIG. 6A, and the interface 1911 in FIG. 19 may or may not need to support AI interfacing where the AI interface is supported, the AI block is able to go through CN to connect to RAN node(s) via the interface 1911. All components in FIG. 19 are therefore labelled with different reference numbers than in FIG. 6A.

The interface 1907 can be a wireline or wireless interface. A wireline interface at 1907 may be the same as or similar to a RAN backhaul interface at 1911, for example. A wireless interface at 1907 may be the same as or similar to a Uu link or interface. In another embodiment, the interface 1907 may use an AI-specific link or interface, with AI-based control and user planes for example.

The AI block 1910 also has a connection interface with the CN 1906, and thus the sensing block 1908, in the example shown. This connection interface may be wireline or wireless. A wireline CN interface can use an API that is the same as or similar to an API between CN functionalities, for example, and a wireless CN interface may be the same as or similar to a Uu link or interface. A custom or specific AI/CN interface and/or specific AI-sensing interface is also possible.

Other features as disclosed herein, such as those disclosed with reference to any of FIGS. 6A to 18 and/or elsewhere herein, may also or instead apply to the example network architecture shown in FIG. 19 in terms of, e.g., connections, interfaces and/or protocol stacks that are applicable to FIG. 19.

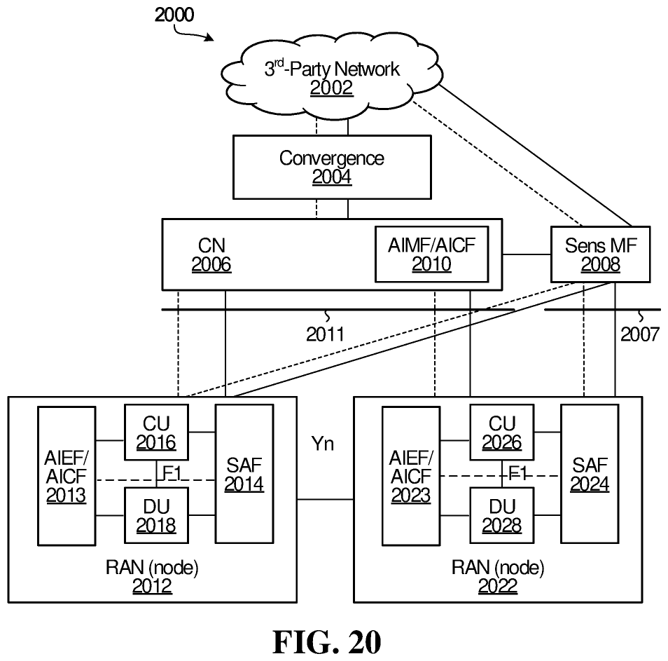

FIG. 20 is a block diagram illustrating a network architecture according to a further embodiment, in which sensing is based outside a core network and AI is based inside the core network. The example network 2000 in FIG. 20 is substantially similar to the example in FIG. 6A, and includes a third-party network 2002, a convergence element 2004, a core network 2006, an AI block or element 2010, a sensing block or element 2008, RAN nodes 2012, 2022 in one or more RANs, and interfaces 2011, 2007. Each RAN node 2012, 2022 includes an AI agent or element 2013, 2023, and a sensing agent or element 2014, 2024, and has a distributed architecture including a CU 2016, 2026 and a DU 2018, 2028.

The embodiment in FIG. 20 differs from that of FIG. 6A in that the sensing block 2008 is located outside the CN 2006 while the AI block 2010 is within the CN. Thus the AI block 2010 accesses the RAN node(s) 2012, 2022 via backhaul between CN 2006 and the RAN node(s), whereas the sensing block 2018 may access the RAN node(s) directly via the interface 2007. In the example shown, the sensing block 2008 may also connect directly with the third-party network 2002 such as a data network, and/or with the CN 2006.

The embodiment in FIG. 20 also differs from that of FIG. 19, in that it is the sensing block 2008 in FIG. 20 rather than the AI block 2010 that is located outside the CN 2006.

Although most components in FIG. 20 may be implemented in the same way as in FIG. 6A and/or FIG. 19, the different architecture in FIG. 20 may impact operation of not only the sensing block 2008, but also components other than the sensing block. For example, the third-party network, the convergence element, the CN, and the RAN nodes in FIG. 20 interact differently with the sensing block 2008 than their counterparts in FIG. 6A or FIG. 19, and the interface 2011 in FIG. 20 may or may not support interfacing for sensing where the sensing interface 2007 is supported. In embodiments in which the interface 2011 supports interfacing for sensing, the sensing block shown by way of example as SensMF 2008 is able to go through the CN 2006 to connect to one or more RAN node(s) via the interface 2011. All components in FIG. 20 are therefore labelled with different reference numbers than in FIGS. 6A and 19.

The interface 2007 can be a wireline or wireless interface, for example, which is used for transmitting data and/or control information. A wireline interface at 2007 may be the same as or similar to a RAN backhaul interface at 2011, for example. A wireless interface at 2007 may be the same as or similar to a Uu link or interface. In another embodiment, the interface 2007 may use a sensing-specific link or interface, with sensing-based control and user planes for example.

The sensing block 2008 also has a connection interface with the CN 2006, and thus the AI block 2010, in the example shown. This connection interface may be wireline or wireless. A wireline CN interface can use an API that is the same as or similar to an API between CN functionalities, for example, and a wireless CN interface may be the same as or similar to a Uu link or interface. A custom or specific sensing/CN interface is also possible.

Other features as disclosed herein, such as those disclosed with reference to any of FIGS. 6A to 19, and/or elsewhere herein, may also or instead apply to the example network architecture shown in FIG. 20 in terms of, e.g., connections, interfaces and/or protocol stacks that are applicable to FIG. 20.

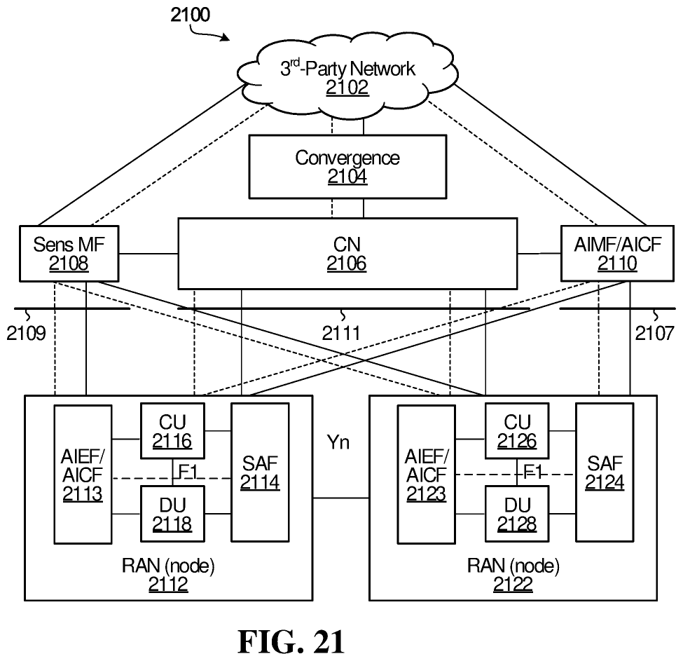

FIG. 21 is a block diagram illustrating a network architecture according to yet another embodiment, in which AI and sensing are both based outside a core network. The example network 2100 in FIG. 21 is substantially similar to the example in FIG. 6A, and includes a third-party network 2102, a convergence element 2104, a core network 2106, an AI block or element 2110, a sensing block or element 2108, RAN nodes 2112, 2122 in one or more RANs, and interfaces 2109, 2111, 2107. Each RAN node 2112, 2122 includes an AI agent or element 2113, 2123, and a sensing agent or element 2114, 2124, and has a distributed architecture including a CU 2116, 2126 and a DU 2118, 2128.

The embodiment in FIG. 21 differs from that of FIG. 6A in that both the sensing block 2108 and the AI block 2110 are located outside the CN 2106. Thus the sensing block 2108 and the AI block 2110 may access the RAN node(s) 2112, 2122 directly via their respective interfaces 2109, 2107. In the example shown, the sensing block 2108 and the AI block 2110 may also connect directly with the third-party network 2102 such as a data network, and/or with the CN 2106.

The embodiment in FIG. 21 also differs from that of FIGS. 19 and 20 in that both the sensing block 2108 and the AI block 2110 are located outside the CN 2106.

Although most components in FIG. 21 may be implemented in the same way as in FIG. 6A, FIG. 19, and/or FIG. 20, the different architecture in FIG. 21 may impact operation of not only the sensing block 2108 and/or the AI block 2110, but also other components. For example, the third-party network, the convergence element, the CN, and the RAN nodes in FIG. 21 interact differently with the sensing block 2108 and the AI block 2110 than their counterparts in FIG. 6A, and the interface 2111 in FIG. 21 may or may not support interfacing for sensing or AI where the sensing interface 2108 and/or the AI interface 2107 is supported. In embodiments in which the interface 2111 supports interfacing for sensing (and/or AI), the interface 2111 enables the sensing block shown by way of example as SensMF 2108 and/or the AI block shown by way of example as AIMF/AICF 2110 to go through the CN 2106 to connect to one or more RAN node(s) via the interface 2111. All components in FIG. 21 are therefore labelled with different reference numbers than in FIGS. 6A, 19, and 20.

Each interface 2109, 2107 can be a wireline or wireless interface, for example, which is used for transmitting data and/or control information. A wireline interface at may be the same as or similar to a RAN backhaul interface at 2111, for example. A wireless interface may be the same as or similar to a Uu link or interface. In another embodiment, the interface 2109 may use a sensing-specific link or interface, with sensing-based control and user planes for example. The interface 2107 may use an AI-specific link or interface, with AI-based control and user planes for example.

The sensing block 2108 also has a connection interface with the CN 2106, and the AI block 2110 has a connection interface with the CN as well. These connection interfaces may be wireline or wireless. A wireline CN interface can use an API that is the same as or similar to an API between CN functionalities, for example, and a wireless CN interface may be the same as or similar to a Uu link or interface. A custom or specific sensing/CN interface and/or AI/CN interface is also possible.

More generally, the CN 2106, the sensing block 2108, and the AI block 2110 are separate from each other and can be mutually inter-connected to each other, via a functional API that is the same as or similar to an API that is used among CN functionalities or via new interfaces, for example. Additionally or alternatively, each of the CN 2106, the sensing block 2108, and the AI block 2110 can have its own individual connection(s) with one or more RAN node(s) 2112, 2122.

In some embodiments, the AI block 2110 and the sensing block 2108 may interconnect with each other via the CN 2106. Although not explicitly shown in FIG. 21, the AI block 2110 and the sensing block 2108 may also or instead have a direct connection, based on an API in the CN 2106 or based on a specific AI-sensing interface, for example.

Other features as disclosed herein, such as those disclosed with reference to any of FIGS. 6A to 20, and/or elsewhere herein, may also or instead apply to the example network architecture shown in FIG. 21 in terms of, e.g., connections, interfaces and/or protocol stacks that are applicable to FIG. 21.

Some embodiments of the present disclosure provide architectures, methods, and apparatus for coordinating or providing one or both of sensing and AI in wireless communication systems. Sensing and AI may involve one or more devices or elements located in a radio access network, one or more devices or elements located in a core network, or both one or more devices or elements located in a radio access network and one or more devices or elements located in a core network. Many of the examples above involve an AI block, a sensing block, or an AI/sensing block in a core network or external to the core network and a RAN, and one or more AI agents, sensing agents, or AI/sensing agents in one or more RANs. Other embodiments are also possible.

For example, for either or both of sensing and AI, another option is to support only local sensing and/or local AI operation by combining sensing block and sensing agent features or functionalities (and/or AI block and AI agent features or functionalities) in a RAN, in a single RAN node for example. Embodiments include a block and an agent (sensing, AI, or sensing/AI) both implemented at a RAN node, or an element or module that supports both block and agent operations implemented in a RAN node. Sensing and/or AI management/control and operation may also or instead be concentrated in RAN by implementing block features at one or more RAN nodes and agent features at one or more UEs. Another possible option is to implement both block and agent features in a UE.

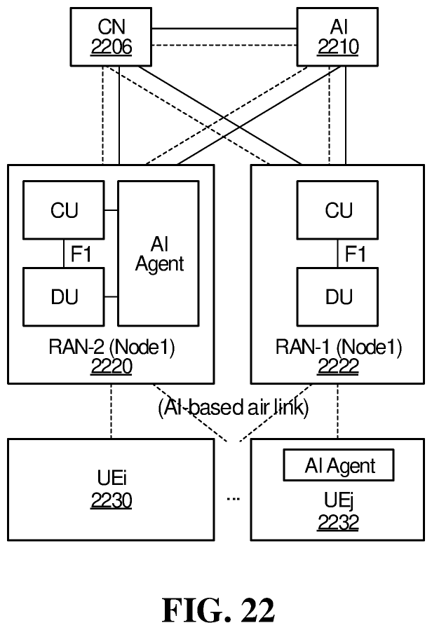

AI may provide coordination among RANs and/or RAN nodes. FIG. 22, for example, is a block diagram illustrating a network architecture that enables AI to support operations such as resource allocation for RANs. In this example, AI may provide a solution to optimize or at least improve allocation of frequency resources among RANs or RAN nodes, and/or support coverage and beam management based on associated RAN conditions, such as traffic requirements and UE location distribution maps in RANs or RAN nodes.

FIG. 22 illustrates a core network (CN) 2206, an AI block 2210, RAN nodes 2220, 2222 which have a CU/DU architecture and one of which includes an AI agent, and UEs 2230, 2232, one of which includes an AI agent. Example implementations of these components and interconnections or interfaces therebetween are provided elsewhere herein.

One illustrated operational procedure related to FIG. 22 is outlined below.

The CN 2206 may send RAN information, such as traffic information and/or UE distribution maps of multiple RANs for example, to the AI block 2210 and request the AI block to compute DL configurations on such parameters or characteristics as coverage and beam direction in each of one or more RANs and the RAN nodes 2220, 2222.

The AI block 2210 may identify or determine, based on calculation requirements, one or more AI models to train for computing the configurations.

After the AI training is complete, the AI block 2210 may produce sets of configurations on, for example, antenna orientation and beam direction, frequency resource allocation, etc. for one or more RAN nodes 2220, 2222 in the same RAN or multiple RANs.

The AI block 2210 may send a set of configurations to each RAN node 2220, 2222 in a control or user plane, where the control plane or the user plane can be an AI-based control plane or an AI-based user plane, including modified current control/user plane with AI layer information or a brand new purely AI-based control/user plane as discussed by way of example elsewhere herein. The AI block 2210 may send the configurations directly to one or more RANs or RAN nodes, and/or send configurations via the CN 2206 in the example shown. As noted above, configurations may relate to antenna orientation and beam direction, for example, for one or more RAN nodes in the same RAN or distributed among multiple RANs.

Optionally, one or more RANs may collect some data and/or feedback, and send such data/feedback to the AI block 2210, via an AI-based control plane or an AI-based user plane for example, for continued training or refining one or more AI models. Data and/or feedback, which may be considered training data in the context of training or refining an AI model, may be sent to the AI block 2210 directly from RAN(s) or RAN node(s), and/or via the CN 2206 in the example shown. FIG. 22 illustrates both a RAN node-based AI agent at 2220 and a UE-based AI agent at 2232, and in general one or more AI agents may be provided or deployed in a RAN, at one or more RAN nodes, at one or more UEs, and/or at one or more other AI devices. In some examples, more than one UE connects to more than one RAN node-based AI agent at 2220 via a respective one of multiple AI-based links.

In some embodiments, when signaling and an AI operation are finished, signaling to end the AI operation may be sent, by the CN 2206 for example, to the AI block 2210.

Other features as disclosed herein, such as those disclosed with reference to any of FIGS. 6A to 21, and/or elsewhere herein, may also or instead apply to the example network architecture shown in FIG. 22 in terms of, e.g., connections, interfaces and/or protocol stacks that are applicable to FIG. 22.

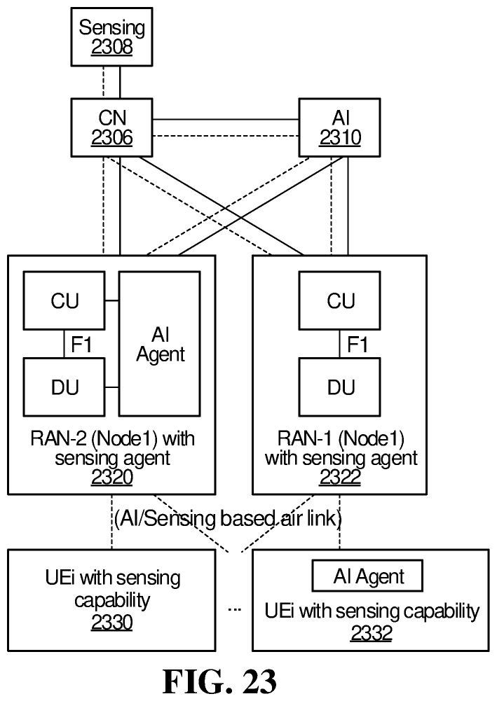

AI may operate with sensing to provide coordination among RANs and/or RAN nodes. FIG. 23, for example, is a block diagram illustrating a network architecture that enables AI and sensing to support operations such as resource allocation for RANs. In this example, AI and sensing may work together to provide a solution to optimize or at least improve allocation of frequency resources among RANs or RAN nodes, and/or support coverage and beam management based on associated RAN conditions, such as traffic requirements and UE location distribution maps in RANs or RAN nodes, are not provided to AI beforehand.

FIG. 23 illustrates a CN 2306, a sensing block 2308, an AI block 2310, RAN nodes 2320, 2322 which have a CU/DU architecture, and UEs 2330, 2332. One of the RAN nodes 2320 includes an AI agent, and both of the RAN nodes 2320, 2322 include a sensing agent. One of the UEs 2332 includes an AI agent, and both of the UEs 2330, 2332 have sensing capabilities. Example implementations of these components and interconnections or interfaces between then are provided elsewhere herein.

The example architecture in FIG. 23 differs from that in FIG. 22 in that FIG. 22 includes a sensing block 2308. Sensing may impact how components interact with each other, and accordingly the components in FIG. 23 are labelled differently than in FIG. 22. However, components other than the sensing block 2308 in FIG. 23 may otherwise be the same as or similar to corresponding components in FIG. 22.

One illustrated operational procedure related to AI and sensing in the architecture of FIG. 23 is outlined below.

The CN 2306 sends a request to the AI block 2310 to compute DL configurations on such parameters or characteristics as coverage and beam direction in each of one or more RANs and the RAN nodes 2320, 2322.

The AI block 2310 may need input data regarding UE and traffic maps in the RAN(s), for example, to complete the request or a task associated with the request. Collecting that input data may involve assistance from sensing, through a sensing service for example. The AI block 2310 may send a request, via the CN 2306 in the example shown, to the sensing block 2308, for such input data.

Based on the AI block request and associated data requirements, the sensing block may generate and send associated sensing configurations to one or more RANs, RAN nodes, or sensing agents, via the CN 2306 in a sensing control plane for example.

The RAN(s), RAN node(s), or sensing agent(s) may perform, implement, or apply the corresponding sensing configurations in the RAN node(s), and associated UE(s) with sensing capability in the example shown, and sensing activities can then be performed to collect sensing data. Sensing capability is labelled in FIG. 23 only at the UEs 2330, 2332 in FIG. 23, but other types of sensing devices, including one or more RAN nodes for example, may also or instead collect sensing data.

The UE(s) and/or the RAN node(s)/sensing agent(s) that are involved in collecting sensing data can send the collected sensing data via the sensing control plane or the sensing user plane, for example, to the sensing block 2308. The sensing block 2308 processes the sensing data, from one or more RAN node(s)/sensing agent(s) in one or more RANs, and calculates or otherwise determines the information that is needed by the AI block 2310, such as UE and traffic maps in one or more RANs in this example, and sends the sensing report to the AI block.

The AI block 2310 may identify or determine, based on calculation requirements and the received sensing data for example, one or more AI models to train for computing configurations.

As in the example provided above with reference to FIG. 22, after the AI training is complete, the AI block 2310 may produce sets of configurations on, for example, antenna orientation and beam direction, frequency resource allocation, etc. for one or more RAN nodes 2320, 2322 in the same RAN or multiple RANs.

The AI block 2310 may send a set of configurations to each RAN node 2320, 2322 in a control or user plane, where the control plane or the user plane can be an AI-based control plane or an AI-based user plane, including modified current control/user plane with AI layer information or a brand new purely AI-based control/user plane as discussed by way of example elsewhere herein. The AI block 2310 may send the configurations directly to one or more RANs or RAN nodes, and/or send configurations via the CN 2306 in the example shown. As noted above, configurations may relate to antenna orientation and beam direction, for example, for one or more RAN nodes in the same RAN or distributed among multiple RANs.

Optionally, one or more RANs may collect data and/or feedback, in addition to the sensing data referenced above, and send such data/feedback to the AI block 2310, via an AI-based control plane or an AI-based user plane for example, for continued training or refining one or more AI models. Data and/or feedback, which may be considered training data in the context of training or refining an AI model, may be sent to the AI block 2310 directly from RAN(s) or RAN node(s), and/or via the CN 2306 in the example shown.

FIG. 23 illustrates both a RAN node-based AI agent at 2320 and a UE-based AI agent at 2332, and in general one or more AI agents may be provided or deployed in a RAN, at one or more RAN nodes, at one or more UEs, and/or at one or more other AI devices. Similarly, one or more sensing agents may be provided or deployed in a RAN, at one or more RAN nodes, at one or more UEs, and/or at one or more other devices, and one or more devices with sensing capabilities, including but not limited to RAN nodes and UEs, may also be deployed. In some examples, more than one UE connects more than one RAN node-based AI agent at 2320 and a UE-based AI agent at 2332 via a respective one of multiple AI/sensing-based links.

In some embodiments, when signaling and an AI and sensing operation are finished, signaling to end the AI and sensing operation may be sent, by the CN 2306 for example, to the AI block 2310.

Other features as disclosed herein, such as those disclosed with reference to any of FIGS. 6A to 22, and/or elsewhere herein, may also or instead apply to the example network architecture shown in FIG. 23 in terms of, e.g., connections, interfaces and/or protocol stacks that are applicable to FIG. 23.

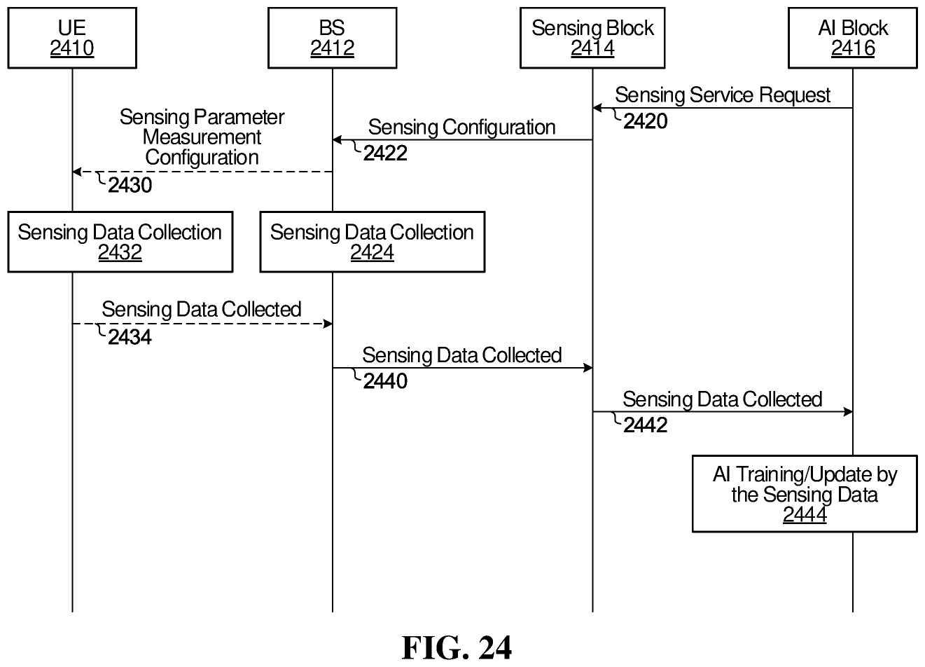

FIG. 24 is a signal flow diagram illustrating another example integrated AI and sensing procedure, similar to the example provided above with reference to FIG. 23, but without necessarily involving a CN. In FIG. 23, the example architecture with AI and sensing demonstrates that an AI block may connect with a sensing block via a CN but may have no direct connections with sensing elements in RANs. The RAN nodes 2320, 2322 each have a sensing agent in FIG. 23 to support sensing in one or more RANs, and the UEs 2330, 2332 have sensing capability available, either in each UE itself or by connecting to a separate sensing device (not shown).

In another embodiment, there can be direct link or connection between AI and sensing blocks, and this is illustrated in FIG. 24. The AI block 2416 and the sensing block 2414 can communicate directly with each other, through a common interface such as a CN functionality API or specific AI-sensing interface for example, and the AI-sensing connection can be wireline or wireless.

FIG. 24 illustrates the AI block 2416 sending, and the sensing block 2414 receiving, a sensing service request at 2420. Thus, 2420 denotes a step that involves the AI block 2416 sending a sensing service request to the sensing block 2414, and a step that involves the sensing block 2414 receiving a sensing service request from the AI block 2416. A sensing service request may include, for example, information indicating one of more of sensing task, sensing parameters, sensing resources, or other sensing configuration for a sensing operation.

Based on the sensing service request 2420, the sensing block 2414 generates and sends, and the BS 2412 receives, a sensing configuration 2422, which may be applied at either or both of the BS and the UE 2410 in this example, depending on whether the BS or the UE is to perform sensing to collect sensing data. Thus, at 2422 FIG. 24 illustrates a step that involves the sensing block 2414 generating and sending a sensing configuration to the BS 2412, and a step that involves the BS 2412 receiving a sensing configuration from the sensing block 2414. A sensing configuration may include, for example, control information for sensing (e.g., sensing configuration (e.g., waveform for sensing signals, sensing frame structure), sensing measurement configuration and/or sensing triggering/feedback command(s)).

Sensing control information or a sensing configuration may be sent by the BS 2412 and received by the UE 2410 as illustrated by the dashed line at 2430. This involves the BS 2412 sending, to the UE 2410, a sensing parameter measurement configuration in the example shown. At the UE 2410, a step of receiving the sensing parameter measurement configuration from the BS 2412 may be performed. A sensing parameter measurement configuration, also referred to herein as a sensing measurement configuration, may include, for example, one or more of: sensing quantity configuration (e.g., specifying a parameter or type of information that is to be sensed), frame structure (FS) configuration (e.g., sensing symbols), sensing periodicity, etc.

A step of collecting sensing data by the BS 2412, also referred to herein as sensing, is shown at 2424, and the UE 2410 may also or instead perform sensing to collect sensing data (or collecting sensing data) at 2432. A step 2434 involves the UE 2410 sending the sensing data to the BS 2412. 2434 is also illustrative of a BS obtaining, by receiving in this example, sensing data from a sensor or sensing device, which is the UE 2410 in this example.

Sensing data, whether collected by the BS 2412 and/or the UE 2410, is sent by the BS 2412 and received by the sensing block 2414 at 2440. Thus, 2440 illustrates both a step of the BS 2412 sending sensing data to the sensing block 2414, and a step of the sensing block 2414 receiving sensing data from the BS 2412.

Either or both of the BS 2412 and the UE 2410 may collect sensing data. For example, the BS 2412 may collect and send only its own sensing data to the sensing block 2414 when UE 2410 is not enabled for sensing data collection. The BS 2412 may send its own sensing data and UE sensing data to the sensing block 2414 if both the BS and the UE 2410 are enabled for sensing data collection. In some embodiments, the BS 2412 does not collect its own sensing data, and instead obtains sensing data from the UE 2410 and sends the UE sensing data to the sensing block 2414.

The sensing data received by the sensing block 2414 is transmitted, in a sensing report for example, by the sensing block to the AI block 2416 at 2442. 2442 therefore encompasses the sensing block 2414 sending sensing data to the AI block 2416, and the AI block 2416 receiving sensing data from the sensing block 2414. AI training, update, and/or other processing or operations using the sensing data may be performed by the AI block 2416, as shown at 2444.

In another embodiment, based on any of the example networks or architectures disclosed above or elsewhere herein, AI and sensing integrated communication may be implemented in applications with interaction between the electronic or “cyber” world and physical world. Such applications with interaction between the electronic or “cyber” world and physical world may employ any of various network architectures with one or more protocol stacks as described herein. For example, network architectures with both sensing and AI operations may be more favorable to apply to this type of application.

The cyber world, or cyberspace, refers to an online environment where many participants are involved in social interactions and have the ability to affect and influence each other, where people interact in cyberspace through the use of digital media. Cyber world and physical world fusion is one use case which may involve transmitting and processing a large amount of information from the physical world to the cyber world, and feeding back to the physical world without delay from the cyber world after the information is processed by neural network(s) or AI in the cyber world. Such a close interaction between the cyber world and physical world may have many applications in future networks, including advanced wearable devices such as “XR” (e.g., virtual reality (VR), augmented reality (AR), mixed reality (MR)) devices, high definition images and holograms.

To support such a use case, integrated AI, sensing, and communication may be particularly useful where, for example, the sensing and learning information relates to diverse targets such as the human body or cars, and/or diverse sensing devices such as wearable devices, tactile sensors, etc. in the physical world (and possibly along with the sensing information at the neural edge). Such sensing and learning information may be collected and timely fed into an AI block or AI agent, and the AI block or AI agent may process the input information and provide a reliable real-time inferencing information to the physical world for operations such as virtual-X and/or tactile operations. Such cyber-physical world interaction and cooperation may be key characteristics of this use case.

For uplink transmission for sensing and learning information input from the physical world to the cyber world, very large data transmission capability with very low latency may be preferred, and for downlink transmission from the cyber world to the physical world as inferencing data high reliability without delay may be preferred. These and/or other design constraints, targets, and/or criteria may be taken into account in interface or channel design, as discussed in further detail elsewhere herein.

The present disclosure also relates in part to future network air interface designs, and proposes a new framework that is intended to support future radio access technologies in an efficient way. Desirable features of such a design may include, for example, one or more of the following:
more intelligent and environmentally friendly (“greener”), with native AI and power-saving capability;
more flexible spectrum utilization, up to THz for example;
efficient integration of communications and sensing;
tighter integration of terrestrial and non-terrestrial communications;
a simpler protocol and signaling mechanism with low overhead and complexity.

Intelligent protocol and signaling mechanisms can be an important part of an AI-enabled and “personalized” air interface that is intended to natively support intelligent PHY/MAC in some embodiments. An AI-enabled intelligent air interface can be much more adaptive to different PHY and MAC conditions and automatically optimize the PHY and/or MAC parameters based on different conditions and using dynamic and proactive operations. This represents a fundamental distinction between flexible air interface and an intelligent air interface as disclosed herein.

Regarding sensing, to obtain sensing information a device such as a TRP may transmit a signal to target object (e.g., a suspected UE) and, based on the reflection of the signal, the TRP may compute such information as the angle (for beamforming), the distance of the device from the TRP, and/or doppler shifting information. Positioning or localization information may be obtained in any of a variety of ways, including using a positioning report from a UE (such as a report of the UE's global positioning system (GPS) coordinates), using positioning reference signals (PRSs), sensing, tracking, and/or predicting the position of the UE, etc.

The network node or UE may have its own sensing functionality and/or dedicated sensing node(s) to obtain sensing information (e.g., network data) for AI operations. Sensing information can assist AI implementation. For example, an AI algorithm may incorporate sensing information that detects changes in environment, such as the introduction or removal of an obstruction between a TRP and a UE. An AI algorithm may also or instead incorporate the current location, speed, beam direction, etc., of the UE. The output of an AI algorithm may be a prediction of a communication channel, and in this way the channel may be constructed and tracked over time. There might not need to be a transmission of a reference signal/determining CSI in the way implemented in conventional non-AI implementations.

Sensing may encompass multiple sensing modes. For example, in a first sensing mode, communication and sensing may involve separate radio access technologies (RATs). Each RAT may be designed to optimize or at least improve communication or sensing, which may in turn lead to separate physical layer processing chains. Each RAT may also or instead have different protocol stacks to suit the different needs of service requirements, such as with or without automatic repeat request (ARQ), hybrid ARQ (HARQ), segmentations, ordering etc. Such a sensing mode also allows the coexistence and simultaneous operation of communication-only nodes and sensing-only nodes.

A different sensing mode, which may be referred to as a second sensing mode, may involve communication and sensing having the same RAT. Communication and sensing may be performed via the same or separate physical channels, logical channels, and transport channels, and/or can be conducted at the same or different frequency carriers. Integrated sensing and communication can be performed by carrier aggregation, for example.

AI technologies (which encompass ML technologies) may be applied in communication, including AI-based communication in the physical layer and/or AI-based communication in the MAC layer. For the physical layer, AI communication may aim to optimize or improve component design and/or improve algorithm performance in respect of any of various communication characteristics or parameters. For example, AI may be applied in relation to the implementation of: channel coding, channel modelling, channel estimation, channel decoding, modulation, demodulation, MIMO, waveform, multiple access, physical layer element parameter optimization and update, beamforming, tracking, sensing, and/or positioning, etc. For the MAC layer, AI communication may aim to utilize AI capability for learning, prediction, and/or making a decision to solve a complicated optimization problem with possible better strategy and/or optimal solution, such as to optimize functionality in the MAC layer. For example, AI may be applied to implement: intelligent TRP management, intelligent beam management, intelligent channel resource allocation, intelligent power control, intelligent spectrum utilization, intelligent MCS, intelligent HARQ strategy, and/or intelligent transmission/reception mode adaptation, etc.

In some embodiments, an AI architecture may involve multiple nodes, where the multiple nodes may possibly be organized in one of two modes, including a centralized mode and a distributed mode, both of which may be deployed in an access network, a core network, or an edge computing system or third party network. A centralized training and computing architecture may be restricted by possibly large communication overhead and strict user data privacy. A distributed training and computing architecture may include or involve any of several frameworks, such as distributed machine learning and federated learning for example. In some embodiments, an AI architecture may include an intelligent controller that can perform as a single agent or a multi-agent, based on joint optimization or individual optimization. New protocols and signaling mechanisms may be desired so that corresponding interface links can be personalized with customized parameters to meet particular requirements while minimizing or reducing signaling overhead and maximizing or increasing whole system spectrum efficiency by enabling personalized AI technologies.

In some embodiments herein, new protocols and signaling mechanisms are provided for operating within and switching between different modes of operation, including between AI and non-AI modes and/or between sensing and non-sensing modes, and for measurement and feedback to accommodate various different possible measurements and information that may be fed back between components, depending upon the implementation.

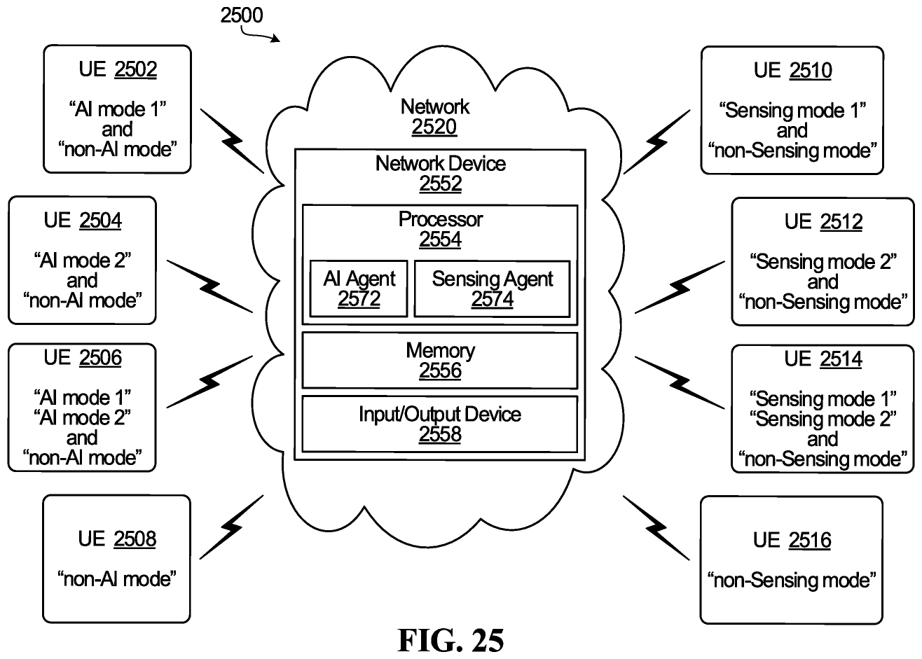

FIG. 25 is a block diagram illustrating another example communication system 2500, which includes UEs 2502, 2504, 2506, 2508, 2510, 2512, 2514, 2516, a network 2520 such as a RAN, and a network device 2552. The network device 2552 includes a processor 2554, a memory 2556, and an input/output device 2558. Examples of all of these components are provided elsewhere herein. In the embodiment shown, a processor-implemented AI agent 2572 and sensing agent 2574 are also provided in the network device 2552.

The system 2500 is illustrative of an example in which network device 2552 may be deployed in an access network, a core network, or an edge computing system or third-party network, depending upon the implementation. In one example, the network device 2552 may implement an intelligent controller which can perform as a single agent or multi-agent, based on joint optimization or individual optimization. In one example, the network device 2552 can be (or be implemented within) T-TRP 170 or NT-TRP 172 (FIGS. 2-4). In some embodiments, the network device 2552 may perform communication with AI operation, based on joint optimization or individual optimization. In another example, the network device 2552 can be a T-TRP controller and/or a NT-TRP controller which can manage T-TRP 170 or NT-TRP 172 to perform communication with AI operation, based on joint optimization or individual optimization.

More generally, the network device 2552 may be deployed in an access network such as a RAN 120a-120b and/or a non-terrestrial communication network such as 120c in FIG. 2, a core network 130, or an edge computing system or third-party network. Examples of TRPs are shown at 170, 172 in FIGS. 2-4, and network device 2552 can be (or be implemented within) T-TRP 170 or NT-TRP 172. The UEs 2502, 2504, 2506, 2508, 2510, 2512, 2514, 2516 in FIG. 25 can be (or be implemented within) an ED 110 as shown by way of example in FIGS. 2-4. Other examples of networks, network devices, and terminals such as UEs are shown in other drawings as well, and features that are disclosed herein as potentially being applicable to the embodiments shown in FIGS. 2-4 and/or other drawings or embodiments may also or instead apply to the embodiment shown in FIG. 25.

An air interface that uses AI as part of the implementation, e.g. to optimize one or more components of the air interface, will be referred to herein as an “AI-enabled air interface”. In some embodiments, there may be two types of AI operation in an AI-enabled air interface: both the network and the UE implement learning; or learning is only applied by the network.

In the embodiment in FIG. 25, the network device 2552 has the ability to implement an AI-enabled air interface for communication with one or more UEs. However, a given UE might or might not have the ability to communicate on an AI-enabled interface. If certain UEs have the ability to communicate on an AI-enabled interface, then the AI capabilities of those UEs might be different. For example, different UEs may be capable of implementing or supporting different types of AI, e.g. an autoencoder, reinforcement learning, neural network (NN), deep neural network (DNN), etc. As another example, different UEs may implement AI in relation to different air interface components. For example, one UE may be able to support an AI implementation for one or more physical layer components, e.g. for modulation and coding, and another UE might not, but might instead be able to support AI implementation for a protocol at the MAC layer, e.g. for a retransmission protocol. Some UEs may implement AI themselves in relation to one or more air interface components, e.g. perform learning, whereas other UEs may not perform learning themselves but may be able to operate in conjunction with an AI implementation on the network side, e.g. by receiving configurations from the network for one or more air interface components that are optimized by the network device 2552 using AI, and/or by assisting other devices (such as a network device or other AI capable UE) to train an AI algorithm or module (such as a neural network or other ML algorithm) by providing requested measurement results or observations.

FIG. 25 illustrates an example in which network device 2552 includes an AI agent 2572. The AI agent 2572 is implemented by the processor 2554, and is therefore shown as being within the processor 2554. The AI agent 2572 may execute one or more AI algorithms (e.g. ML algorithms) to try to optimize one or more air interface components in relation to one or more UEs, possibly on a UE-specific and/or service-specific basis, for example. In some embodiments, the AI agent 2572 may implement an intelligent air interface controller as described at least below. The AI agent 2572 may implement AI in relation to physical layer air interface components and/or MAC layer air interface components, depending upon the implementation. Different air interface components may be jointly optimized, or each separately optimized in an autonomous fashion, depending upon the implementation. The specific AI algorithm(s) executed are implementation and/or scenario specific and may include, for example, a neural network, such as a DNN, an autoencoder, reinforcement learning, etc.

For the sake of example, the four UEs 2502, 2504, 2506, and 2508 in FIG. 25 are each illustrated as having different capabilities in relation to implementing one or more air interface components.

The UE 2502 has the capability to support an AI-enabled air interface configuration, and can operate in a mode referred to herein as “AI mode 1”. AI mode 1 refers to a mode in which the UE itself does not implement learning or training. However, the UE is able to operate in conjunction with the network device 2552 in order to accommodate and support the implementation of one or more air interface components optimized using AI by the network device 2552. For example, when operating in AI mode 1, the UE 2502 may transmit, to the network device 2552, information used for training at the network device 2552, and/or information (e.g., measurement results and/or information on error rates) used by the network device 2552 to monitor and/or adjust the AI optimization. The specific information transmitted by the UE 2502 is implementation-specific and may depend upon the AI algorithm and/or specific AI-enabled air interface components being optimized.

In some embodiments, when operating in AI mode 1, the UE 2502 is able to implement an air interface component at the UE-side in a manner different from how the air interface component would be implemented if the UE 2502 were not capable of supporting an AI-enabled air interface. For example, the UE 2502 might itself not be able to implement ML learning in relation to its modulation and coding, but the UE 2502 may be able to provide information to the network device 2552 and receive and utilize parameters relating to modulation and coding that are different from and possibly better optimized compared to the limited set of fixed options for modulation and coding defined in a conventional non-AI-enabled air interface. As another example, the UE 2502 might not be able to directly learn and train to realize an optimized retransmission protocol, but the UE 2502 may be able to provide the needed information to the network device 2552 so that the network device 2552 can perform the required learning and optimization, and post-training the UE 2502 can then follow the optimized protocol determined by the network device 2552. As another example, the UE 2502 might not be able to directly learn and train to optimize modulation, but a modulation scheme may be determined by the network device 2552 using AI, and the UE 2502 may be able to accommodate an irregular modulation constellation determined and indicated by the network device 2552. The modulation indication method may be different from a non-AI-based scheme.

In some embodiments, when operating in AI mode 1, although the UE 2502 itself does not implement learning or training, the UE 2502 may receive an AI model determined by the network device 2552 and execute the model.

Besides AI mode 1, the UE 2502 can also operate in a non-AI mode in which the air interface is not AI-enabled. In non-AI mode, the air interface between the UE 2502 and the network may operate in a conventional non-AI manner. During operation, the UE 2502 may switch between AI mode 1 and non-AI mode.

The UE 2504 also has the capability to support an AI-enabled air interface configuration. However, when implementing an AI-enabled air interface, UE 2504 operates in a different AI mode, referred to herein as “AI mode 2”. AI mode 2 refers to a mode in which the UE implements AI learning or training, e.g. the UE itself may directly implement a ML algorithm to optimize one or more air interface components. When operating in AI mode 2, the UE 2504 and network device 2552 may exchange information for the purposes of training. The information exchanged between the UE 2504 and the network device 2552 is implementation specific, and it might not have a meaning understandable to a human (e.g., it might be intermediary data produced during execution of a ML algorithm). It might also or instead be that the information exchanged is not predefined by a standard, e.g. bits may be exchanged, but the bits might not be associated with a predefined meaning. In some embodiments, the network device 2552 may provide or indicate, to the UE 2504, one or more parameters to be used in the AI model implemented at the UE 2504 when the UE 2504 is operating in AI mode 2. As one example, the network device 2552 may send or indicate updated neural network weights to be implemented in a neural network executed on the UE-side, in order to try to optimize one or more aspects of the air interface between the UE 2504 and a T-TRP or NT-TRP.

Although the example in FIG. 25 assumes AI capability on the network side, it might be the case that the network 2520 does not itself perform training/learning, and a UE operating in AI mode 2 may perform learning/training itself, possibly with dedicated training signals sent from the network. In other embodiments, end-to-end (E2E) learning may be implemented by the UE operating in AI mode 2 and the network device 2552, e.g. to jointly optimize on the transmission and receive side.

Besides AI mode 2, the UE 2504 can also operate in a non-AI mode in which the air interface is not AI-enabled. In non-AI mode, the air interface between the UE 2504 and the network may operate in a conventional non-AI manner. During operation, the UE 2504 may switch between AI mode 2 and non-AI mode.

The UE 2506 is more advanced than the UE 2502 or the UE 2504 in that the UE 2506 can operate in AI mode 1 and/or AI mode 2. The UE 2506 is also able to operate in a non-AI mode. During operation, the UE 2506 may switch between these three modes of operation.

The UE 2508 does not have the capability to support an AI-enabled air interface configuration. The network device 2552 might still use AI to try to better optimize or configure one or more air interface components for communicating with the UE 2508, e.g. to select between different possible predefined options for an air interface component. However, the air interface implementation, including the exchanges between the UE 2508 and the network 2520, are limited to a conventional non-AI air interface and its associated predefined options. The associated predefined options may be defined by a standard, for example. In other embodiments, the network device 2552 does not implement AI at all in relation to the UE 2508, but instead implements the air interface in a fully conventional non-AI manner. The mechanisms for measurement, feedback, link adaptation, MAC layer protocols, etc. operate in a conventional non-AI manner. For example, measurement and feedback happens regularly for the purposes of link adaptation, MIMO precoding, etc.

In addition to the above, different UEs having the ability to support an AI-enabled air interface may have different levels of AI capabilities. For example, the UE 2502 might only support AI implementation in relation to a few air interface components in the physical layer, e.g. modulation and coding, whereas the UE 2504 may support AI implementation in relation to several air interface components in both the physical layer in MAC layer. Also, sometimes a UE may support joint AI optimization of multiple air interface components, whereas other UEs might only support AI optimization of individual air interface components on a component-by-component basis.

Although two possible modes of operation (AI mode 1 and AI mode 2) are explained above for a UE supporting an AI-enabled interface, there may be fewer, different, and/or more modes of operation when supporting an AI-enabled interface. For example, instead of a single AI mode 2, there may be two modes: a more advanced higher-power mode in which the UE can support joint optimization of several air interface components via AI, and a simpler lower-power mode in which the UE can support an AI-enabled air interface, but only for one or two air interface components, and without joint optimization between those components. As another example, instead of AI mode 1 and AI mode 2 described above, there may be three AI modes: (1) UE can assist the network with training (e.g., by providing information) and the UE can operate with AI optimized parameters; (2) UE cannot perform AI training itself but can run a trained AI module that was trained by a network device; (3) the UE itself can perform AI training. Other and/or additional modes of operation related to an AI-enabled air interface may include modes such as (but not limited to): a training mode, a fallback non-AI mode, a mode in which only a reduced subset of air interface components are implemented using AI, etc.

UE 2510 has the capability to support a sensing-enabled air interface configuration, and can operate in “sensing mode 1”. When operating in sensing mode 1, the UE 2510 may perform sensing in a dedicated sensing carrier, and transmit the sensing data to the network device which can be used to assist AI execution. Besides sensing mode 1, the UE 2510 can also operate in a non-sensing mode in which the air interface is not sensing enabled. In non-sensing mode, the air interface between the UE 2510 and the network 2520 may operate in a conventional non-sensing manner. During operation, the UE 2510 may switch between sensing mode 1 and non-sensing mode.

UE 2512 has the capability to support a sensing-enabled air interface configuration, and can operate in a different sensing mode, “sensing mode 2”. When operating in sensing mode 2, the UE 2512 may perform sensing in the same carrier for wireless communication, and transmit the sensing data to the network device which can be used to assist AI execution. In sensing mode 2, the network device 2552 can configure time and/or frequency resources for sensing, and the UE 2512 performs sensing according to an indication from the network device and reports sensing data to the network device to assist in one or more of AI training, AI update, and AI execution. The UE 2512 can also operate in the non-sensing mode in which the air interface is not sensing enabled, and the air interface between the UE 2512 and the network 2520 may operate in a conventional non-sensing manner. During operation, the UE 2512 may switch between sensing mode 2 and non-sensing mode. UE 2514 has the capability to support a sensing-enabled air interface configuration, and can operate in “sensing mode 1” and/or “sensing mode 2”. The network device 2552 configures the UE 2514 to operate in sensing mode 1 or sensing mode 2. For example, if traffic in a communication carrier is high, the network device 2552 may configure the UE 2514 to operate in sensing mode 1 wherein the UE performs sensing in a dedicated sensing carrier. Under other operating conditions or criteria, the network device 2552 may configure the UE 2514 to operate in sensing mode 2. The UE 2514 can also operate in the non-sensing mode. During operation, the UE 2514 may switch between sensing mode 1, sensing mode 2, and non-sensing mode.

UE 2516 does not have the capability to support a sensing-enabled air interface configuration, and the UE operates in a conventional non-sensing manner. The network device 2552 might still use sensing to try to better optimize or configure one or more air interface components for communicating with the UE 2516, e.g. to select between different possible predefined options for an air interface component. However, the air interface implementation, including the exchanges between the UE 2516 and the network 2520, are limited to a conventional non-sensing air interface and its associated predefined options. The associated predefined options may be defined by a standard, for example. In other embodiments, the network device 2552 does not implement sensing at all in relation to the UE 2516, but instead implements the air interface in a non-sensing manner.

In FIG. 25, UE modes are illustrated as single-functioned (either AI mode(s) or sensing mode(s)), but this is a non-limiting example. UEs may have the capability to support either or both of AI and sensing, as shown by way of example in FIGS. 6B, 22, and 23, and/or as otherwise disclosed herein. It should therefore be appreciated that UEs may be categorized based on one or more of: AI and sensing functionalities, such as ability to support any of multiple AI modes (e.g., not only AI modes 1 and/or 2 in FIG. 25, but more generally any of “n” different AI modes including an AI mode 1 to AI mode n), any of multiple sensing modes (e.g., not only sensing modes 1 and/or 2 in FIG. 25, but more generally any of “n” different sensing modes including a sensing mode 1 to sensing mode M), any of one or more non-AI modes, and/or any of one or more non-sensing modes. Multiple AI modes may correspond to how powerful of AI functionality or which specific AI feature(s) are supported for each AI mode. With reference to FIG. 25 for example, AI mode 1 may have relatively simple AI functionality compared to AI mode 2, and AI mode 2 may have relatively complicated and accurate prediction capability compared to AI mode 1, etc. Similarly, multiple sensing modes may correspond to how powerful of sensing functionality or which specific sensing feature(s) are supported for each sensing mode. For example, a simple IoT sensor, an environment sensor, and a healthcare sensor, etc., may support different sensing modes.

In the example in FIG. 25, the network device 2552 configures the air interface for different UEs having different capabilities. Some UEs, e.g. the UE 2508, do not support an AI-enabled air interface. Other UEs support an AI-enabled interface, e.g. the UEs 2502, 2504, and 2506. Even if a UE supports an AI-enabled air interface, the UE might not always implement an AI-enabled air interface, e.g. operation of the air interface in a conventional non-AI manner might be necessary or desirable if there is an error or during training or retraining. Therefore, in general the network device 2552 accommodates air interface configuration for both non-AI-enabled air interface components and AI-enabled air interface components.

The network device 2552 may also or instead configure the air interface for different UEs having different capabilities. Some UEs, e.g. the UE 2516, do not support a sensing-enabled air interface. Other UEs support a sensing-enabled interface, e.g. the UEs 2510, 2512, and 2514. Even if a UE supports a sensing-enabled air interface, the UE might not always implement a sensing-enabled air interface, e.g. operation of the air interface in a conventional non-sensing manner might be necessary or desirable if there is an error or during training or retraining. Therefore, in general the network device 2552 accommodates air interface configuration for both non-sensing-enabled air interface components and sensing-enabled air interface components.

Embodiments are presented herein relating to switching between different AI modes and/or sensing modes, including a fallback or default non-AI mode and/or non-sensing mode. Embodiments are also presented herein relating to unified control signaling and measurement signaling and related feedback channel configuration, e.g. in order to have a unified signaling procedure for the variety of different signaling and measurement that may be performed depending upon the AI or non-AI capabilities and/or sensing or non-sensing capabilities of UEs. However, first an overview is provided that discusses some of the intelligence that may be implemented in an AI-enabled interface and an example network architecture in which some or all of the intelligence may be implemented.

Advances continue to be made in antenna and bandwidth capabilities, thereby allowing for possibly more communication traffic and/or better communication over a wireless link. Additionally, advances continue in the field of computer architecture and computational power, e.g. with the introduction of general-purpose graphics processing units (GP-GPUs). Future generations of communication devices may have more computational and/or communication ability than previous generations, which may allow for the adoption of AI for implementing air interface components. Future generations of networks may also have access to more accurate and/or new information (compared to previous networks) that may form the basis of inputs to AI models, e.g.: physical speed/velocity at which a device is moving, a link budget of the device, channel conditions of the device, one or more device capabilities, a service type that is to be supported, sensing information, and/or positioning information, etc.

One or more air interface components may be implemented using an AI model. The term AI model may refer to a computer algorithm that is configured to accept defined input data and output defined inference data, in which parameters (e.g., weights) of the algorithm can be updated and optimized through training (e.g., using a training dataset, or using real-life collected data). An AI model may be implemented using one or more neural networks (e.g., including deep neural networks (DNN), recurrent neural networks (RNN), convolutional neural networks (CNN), and combinations thereof) and using any of various neural network architectures (e.g., autoencoders, generative adversarial networks, etc.). Any of various techniques may be used to train the AI model, in order to update and optimize its parameters. For example, backpropagation is a common technique for training a DNN, in which a loss function is calculated between the inference data generated by the DNN and some target output (e.g., ground-truth data). A gradient of the loss function is calculated with respect to the parameters of the DNN, and the calculated gradient is used (e.g., using a gradient descent algorithm) to update the parameters with the goal of minimizing the loss function.

In some embodiments, an AI model encompasses neural networks, which are used in machine learning. A neural network is composed of a plurality of computational units (which may also be referred to as neurons), which are arranged in one or more layers. The process of receiving an input at an input layer and generating an output at an output layer may be referred to as forward propagation. In forward propagation, each layer receives an input (which may have any suitable data format, such as vector, matrix, or multidimensional array) and performs computations to generate an output (which may have different dimensions than the input). The computations performed by a layer typically involve applying (e.g., multiplying) the input by a set of weights (also referred to as coefficients). With the exception of the first layer of the neural network (i.e., the input layer), the input to each layer is the output of a previous layer. A neural network may include one or more layers between the first layer (i.e., input layer) and the last layer (i.e., output layer), which may be referred to as inner layers or hidden layers. Various neural networks may be designed with various architectures (e.g., various numbers of layers, with various functions being performed by each layer).

A neural network is trained to optimize the parameters (e.g., weights) of the neural network. This optimization is performed in an automated manner, and may be referred to as machine learning. Training of a neural network involves forward propagating an input data sample to generate an output value (also referred to as a predicted output value or inferred output value), and comparing the generated output value with a known or desired target value (e.g., a ground-truth value). A loss function is defined to quantitatively represent the difference between the generated output value and the target value, and the goal of training the neural network is to minimize the loss function. Backpropagation is an algorithm for training a neural network. Backpropagation is used to adjust (also referred to as update) a value of a parameter (e.g., a weight) in the neural network, so that the computed loss function becomes smaller. Backpropagation involves computing a gradient of the loss function with respect to the parameters to be optimized, and a gradient algorithm (e.g., gradient descent) is used to update the parameters to reduce the loss function. Backpropagation is performed iteratively, so that the loss function is converged or minimized over a number of iterations. After a training condition is satisfied (e.g., the loss function has converged, or a predefined number of training iterations have been performed), the neural network is considered to be trained. The trained neural network may be deployed (or executed) to generate inferred output data from input data. In some embodiments, training of a neural network may be ongoing even after a neural network has been deployed, such that the parameters of the neural network may be repeatedly updated with up-to-date training data.

Using AI, e.g. by implementing an AI model as described above and/or elsewhere herein, one or more air interface components may be AI-enabled. In some embodiments, the AI may be used to try to optimize one or more components of the air interface for communication between the network and devices, possibly on a device-specific and/or service-specific customized or personalized basis. Some examples of possible AI-enabled air interface components are described herein, at least below.

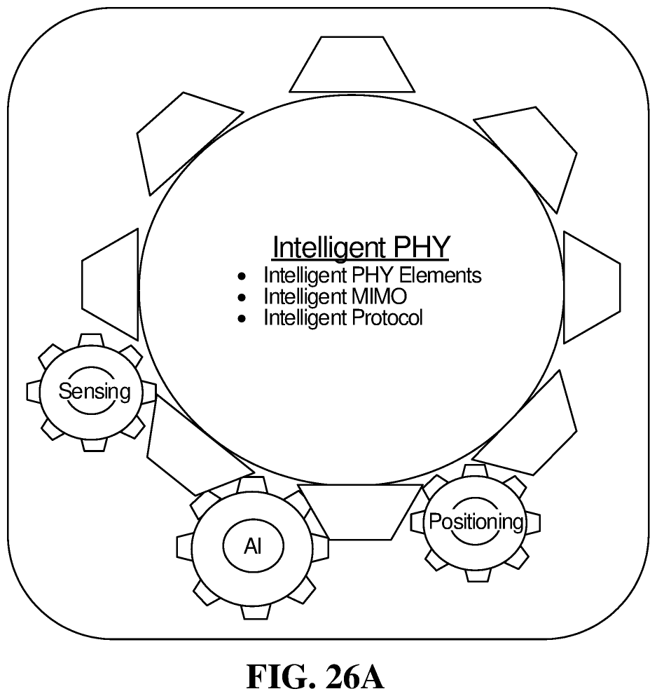

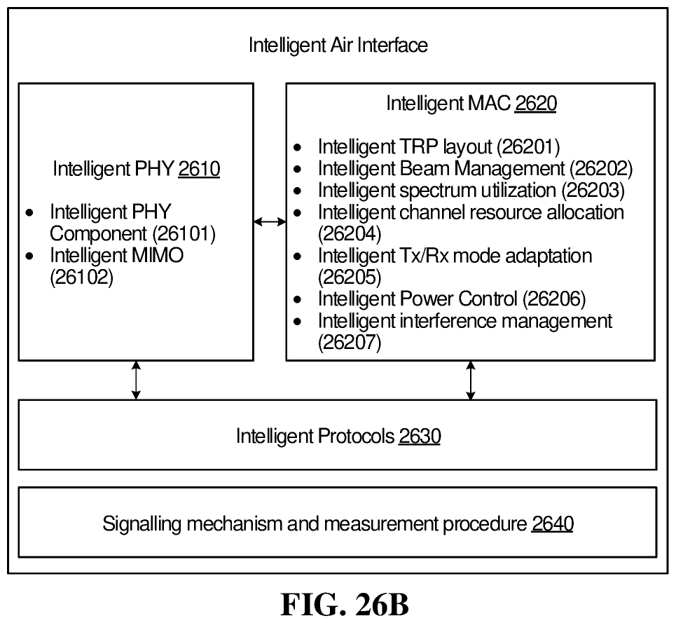

FIG. 26A is a block diagram illustrating how various components of an intelligent system may work together in some embodiments. The components illustrated in FIG. 26A include intelligent PHY, sensing, AI, and positioning, all of which are considered in further detail elsewhere herein.

Intelligent PHY is one of the components of an intelligent air interface in some embodiments. As referenced herein, intelligent PHY may encompass such features as any one or more of those shown in FIG. 26A: intelligent PHY elements, intelligent MIMO, and intelligent protocol, for example. AI, and possibly other features such as sensing and/or positioning for example, may work together with intelligent PHY in some embodiments.

Intelligent PHY elements may include, for example, AI-assisted parameter optimization, AI-based PHY designs, coding, modulation, waveform, etc., any or all of which may be involved in an intelligent PHY implementation. Intelligent MIMO may be provided in some embodiments, with such features as any one or more of: intelligent channel acquisition, intelligent channel tracking and prediction, intelligent channel construction, and intelligent beamforming. Intelligent protocol may include or provide such features as intelligent link adaptation and/or intelligent retransmission protocol in some embodiments.

FIG. 26B is a block diagram illustrating an intelligent air interface according to one embodiment. The intelligent air interface in FIG. 26B is a flexible framework which can support AI implementation in relation to one, some, or all of the items illustrated, which are each shown within one of three groups: intelligent PHY 2610, intelligent MAC 2620, and intelligent protocols 2630. Although illustrated as a separate box, the intelligent protocols 2630 might involve MAC and/or PHY layer components or operations, and therefore as noted at least above intelligent PHY elements may include intelligent protocol.

Signaling mechanisms and measurement procedures 2640, e.g. as described herein, may support communication related to implementation of the intelligent PHY 2610 and/or intelligent MAC 2620 and/or intelligent protocols 2630. In some examples, intelligent PHY 2610 provides AI-assisted physical layer component optimization/designs to achieve intelligent PHY components (26101) and/or intelligent MIMO (26102). In some examples, intelligent MAC 2620 provides or supports optimization and/or designs for intelligent TRP layout (26201), intelligent beam management (26202), intelligent spectrum utilization (26203), intelligent channel resource allocation (26204), intelligent transmission/reception mode adaptation (26205), intelligent power control (26206), and/or intelligent interference management (26207). In some examples, intelligent protocols 2630 provide or support optimization and/or designs relating to protocols implemented in the air interface, e.g. retransmission, link adaptation, etc. In some examples, the signaling and measurement procedure 2640 may support the communication of information in an air interface implementing intelligent protocols 2630, intelligent MAC 2620 and/or intelligent PHY 2610.

In some embodiments, intelligent PHY 2610 includes a number of components and associated parameters that collectively specify how a transmission is to be sent and/or received over a wireless communications link between two or more communicating devices.

In some embodiments, an AI-enabled air interface implementing intelligent PHY 2610 may include one or more components optimizing parameters and/or defining the waveform(s), frame structure(s), multiple access scheme(s), protocol(s), coding scheme(s) and/or modulation scheme(s) for conveying information (e.g., data) over a wireless communications link. The wireless communications link may support a link between a radio access network and user equipment (e.g., a “Uu” link), and/or the wireless communications link may support a link between device and device, such as between two UEs (e.g. a “sidelink”), and/or the wireless communications link may support a link between a non-terrestrial (NT) communication network and a UE. When an intelligent air interface (e.g., including intelligent PHY 2610) is implemented, the wireless communications link may support a new type of link between an AI component in a radio access network and user equipment.

The following are some examples of air interface components, any one or more of which may be implemented using AI:
PHY element parameter optimization and update: Optimized parameters (such as coding, modulation, MIMO parameters) may dynamically change due to the fast time-varying channel characteristics of the physical layer in a real environment, for example.
A waveform component may specify a shape and form of a signal being transmitted. Waveform options may include, for example, orthogonal multiple access waveforms and non-orthogonal multiple access waveforms. Non-limiting examples of such waveform options include Orthogonal Frequency Division Multiplexing (OFDM), Filtered OFDM (f-OFDM), Time windowing OFDM, Filter Bank Multicarrier (FBMC), Universal Filtered Multicarrier (UFMC), Generalized Frequency Division Multiplexing (GFDM), Wavelet Packet Modulation (WPM), Faster Than Nyquist (FTN) Waveform, and low Peak to Average Power Ratio Waveform (low PAPR WF). A waveform component may be implemented using AI.
A frame structure component may specify a configuration of a frame or group of frames. The frame structure component may indicate one or more of a time, frequency, pilot signature, code, or other parameter(s) of a frame or group of frames. A frame structure component may be implemented using AI.
Super flexible frame structure and agile signaling: In some embodiments, a super flexible frame structure in a personalized air interface framework may be designed with more flexible waveform parameters and transmission duration, e.g. using AI. These aspects of a flexible frame structure may be tailored to adapt to diverse requirements from a wide range of scenarios, such as for 0.1 ms extreme low latency. As a result, there may be many options for each parameter in a system. In some implementations, a control signaling framework may be implemented as a simplified and agile mechanism, e.g. requiring relatively few control signaling formats, while the control information may have flexible size. In some implementations, control signaling is detected with simplified procedures and minimized overhead and UE capability. In some implementations, the control signaling may be forward compatible, with no need to introduce a new format for future developments.
A multiple access scheme component may specify multiple access technique options, including technologies defining how communicating devices share a common physical channel, such as: Time Division Multiple Access (TDMA), Frequency Division Multiple Access (FDMA), Code Division Multiple Access (CDMA), Single Carrier Frequency Division Multiple Access (SC-FDMA), Low Density Signature Multicarrier Code Division Multiple Access (LDS-MC-CDMA), Non-Orthogonal Multiple Access (NOMA), Pattern Division Multiple Access (PDMA), Lattice Partition Multiple Access (LPMA), Resource Spread Multiple Access (RSMA), and Sparse Code Multiple Access (SCMA). Furthermore, multiple access technique options may include: scheduled access versus non-scheduled access, also known as grant-free access; non-orthogonal multiple access versus orthogonal multiple access, e.g., via a dedicated channel resource (e.g., no sharing between multiple communicating devices); contention-based shared channel resources versus non-contention-based shared channel resources, and cognitive radio-based access. A multiple access scheme component may be implemented using AI.
A hybrid automatic repeat request (HARQ) protocol component may specify how a transmission and/or a retransmission is to be made. Non-limiting examples of transmission and/or retransmission mechanism options include those that specify a scheduled data pipe size, a signaling mechanism for transmission and/or retransmission, and a retransmission mechanism. A HARQ protocol component may be implemented using AI.
A coding and modulation component may specify how information being transmitted may be encoded/decoded and modulated/demodulated for transmission/reception purposes. Coding may refer to methods of error detection and forward error correction. Non-limiting examples of coding options include turbo trellis codes, turbo product codes, fountain codes, low-density parity check codes, and polar codes. Modulation may refer, simply, to the constellation (including, for example, the modulation technique and order), or more specifically to any of various types of advanced modulation methods such as hierarchical modulation and low PAPR modulation. A coding and modulation component may be implemented using AI.

Note that an air interface component in the physical layer (e.g., implemented in intelligent PHY 2610) may sometimes alternatively be referred to as a “model” rather than a component.

In some implementations, intelligent PHY components 26101 may obtain parameter optimization, optimization for coding and decoding, modulation and demodulation, MIMO and receiver, waveform and multiple access. In some implementations, intelligent MIMO 26102 may obtain intelligent channel acquisition, intelligent channel tracking and prediction, intelligent channel construction, and intelligent beamforming. In some implementations, intelligent protocols 2630 may obtain intelligent link adaptation and intelligent retransmission protocol. In some implementations, intelligent MAC 2620 may implement an intelligent controller.

More details relating to an AI-enabled or AI-assisted air interface are described herein, at least below.

One or more air interface components in the physical layer may be AI-enabled, e.g. implemented as intelligent PHY component 26101. The physical layer components implemented using AI, and details of AI algorithms or models, are implementation specific. However, a few illustrative examples are described herein, at least below, for completeness.

As one example, for communication between a network and a particular UE, AI may be used to provide optimization of channel coding without a predefined coding scheme. Self-learning/training and optimization may be used to determine an optimal coding scheme and related parameters. For example, in some embodiments, a forward error correction (FEC) scheme is not predefined and AI is used to determine a UE-specific customized FEC scheme. In some such embodiments, autoencoder based ML may be used as part of an iterative training process during a training phase in order to train an encoder component at a transmitting device and a decoder component at a receiving device. For example, during such a training process, an encoder at a TRP and a decoder at a UE may be iteratively trained by exchanging a training sequence/updated training sequence. In general, the more trained cases/scenarios, the better performance. After training is done, the trained encoder component at the transmitting device and the trained decoder component at the receiving device can work together based on changing channel conditions to provide encoded data that may outperform results generated from a non-AI-based FEC scheme. In some embodiments, the AI algorithms for self-learning/training and optimization may be downloaded by the UE from a network/server/other device. For individual optimization of channel coding with predefined coding schemes, such as low density parity check (LDPC) code, Reed-Muller (RM) code, polar code or other coding schemes, the parameters for the coding scheme may be optimized. In one example, an optimized coding rate is obtained by AI running on the network side, the UE side, or both the network and UE sides. The coding rate information might not need to be exchanged between the UE and the network. However, in some cases, the coding rate may be signaled to receiver (which may be the UE or the network, depending upon the implementation). In some embodiments, the parameters for channel coding may be signaled to a UE (possibly periodically or event triggered), e.g., semi-statically (such as via RRC signaling) or dynamically (such as via DCI) or possibly via other new physical layer signaling. In some implementations, training may be done all on the network side or assisted by UE side training or mutual training between the network side and the UE side.

As another example, for communication between the network and a particular UE, AI may be used to provide optimization of modulation without a predefined constellation. Modulation may be implemented using AI, with the optimization targets and/or algorithms of which being understood by both the transmitter and the receiver. For example, the AI algorithm may be configured to maximize Euclidian or non-Euclidian distance between constellation points.

As another example, for communication between the network and a particular UE, AI may be used to provide optimization of waveform generation, possibly without a predefined waveform type, without a predefined pulse shape, and/or without predefined waveform parameters. Self-learning/training and optimization may be used to determine optimal waveform type, pulse shape and/or waveform parameters. In some implementations, the AI algorithm for self-learning/training and optimization may be downloaded by the UE from a network/server/other device. In some implementations, there may be a finite set of predefined waveform types, and selection of a predefined waveform type from the finite set and determination of the pulse shape and other waveform parameters may be done through self-optimization. In some implementations, an AI-based or AI-assisted waveform generation may enable per UE based optimization of one or more waveform parameters, such as pulse shape, pulse width, subcarrier spacing (SCS), cyclic prefix, pulse separation, sampling rate, PAPR, etc.

Individual or joint optimization of physical layer air interface components may be implemented using AI, depending upon the AI capabilities of the UE. For example, the coding, modulation, and waveform may each be implemented using AI and independently optimized, or they may be jointly (or partly jointly) optimized. Any parameter updating as part of the AI implementation may be transmitted through unicast, broadcast, or groupcast signaling, depending upon the implementation. Transmission of updated parameters may occur semi-statically (e.g., in RRC signaling or a MAC CE) or dynamically (e.g., in DCI). The AI might be enabled or disabled, depending upon the scenario or UE capability. Signaling related to enabling or disabling AI may be sent semi-statically or dynamically.

In some implementations of AI-enabled physical components, the following procedure may be followed. The transmitting device sends training signals to the receiving device. The training may relate to and/or indicate single parameter/components or combinations of multiple parameters/components. The training might be periodic or trigger-based. In some implementations, for the downlink channel, UE feedback might provide the best or preferred parameter(s), and the UE feedback might be sent using default air interface parameters and/or resources. “Default” air-interface parameters and/or resources may refer to either: (i) the parameters and/or resources of a conventional non-AI-enabled air interface known by both the transmitting and receiving device, or (ii) the current air interface parameters and/or resources used for communication between the transmitting and receiving device. In some implementations, the TRP sends, to the UE, an indication of a chosen parameter, or the TRP applies the parameter without indication, in which case blind detection may need to be performed by the UE. In some implementations, for the uplink, the TRP may send information (e.g., an indication of one or more parameters) to the UE, for use by the UE. Examples of such information may include measurement result(s), KPI(s), and/or other information for AI training/updating, data communication, or AI operation performance monitoring, etc. In some embodiments, the information may be sent using default air interface parameters and/or resources. In some implementations, there may be personalized AI training/implementation for different UE capabilities. For example, AI-capable UEs having high-end functionality may accommodate larger training sets or parameters with possibly less air-interface overhead. For example, less overhead may be required for maintaining optimal communication link quality, e.g. reduced cyclic prefix (CP) overhead, fewer redundant bits, etc. For example, CP overhead may be set as 1%, 3%, or 5% for high end AI capable UEs, and may instead be set as 4% or 5% for low end AI capable UEs. In some implementations, there may be a combination/joint optimization of CP and reference signal training for high end AI capable UEs, but not for low end AI capable UEs. Low end AI capable UEs might have fewer training sets or parameters (which may be beneficial for reduced training overhead and/or fast convergence), but possibly with larger air-interface overhead (e.g. post-training).

Further to the above examples, and for the sake of completeness, the following is a list of air interface components/models in the physical layer that may benefit from an AI implementation by intelligent PHY 2610 in some embodiments:
Channel coding and decoding: Channel coding is used for more reliable data transmission over noisy channels. For fading channels in particular, AI may be implemented for the channel coding. The decoding might also be difficult because it might involve high computational complexity. Impractical assumptions sometimes must be made to decode codes with affordable complexity, which sacrifices performance in exchange. In one example, AI may also (or instead) be implemented in a channel decoder, e.g., the decoding process may be modeled as a classification task.
Modulation and demodulation: The main goal of a modulator is mapping multiple bits into a transmitted symbol, e.g. to try to achieve higher spectral efficiency given limited bandwidth. In one example, modulation schemes such as M-ary quadrature amplitude modulation (M-QAM) are used in wireless communication systems. Such square-shaped constellations may assist with low complexity for demodulation at the receiver. However, there exists some other constellation designs with additional considerations such as non-euclidean distance, and probabilistic shaping gains. In some embodiments, AI is implemented in the modulation/demodulation to exploit the shaping gains and possibly design suitable constellations for specific application scenarios. In some embodiments, AI is implemented to optimize an irregular constellation (perhaps in terms of optimizing Euclidean distance), where the optimization may incorporate factors such as PAPR reduction and/or robustness to impairments from devices or the communication channel (e.g. phase noise, Doppler, power amplifier (PA) non-linearity, etc.).
MIMO and receiver: AI-driven techniques may be used to design MIMO-related modules, such as a CSI feedback schemes, antenna selection, channel tracking and prediction, pre-coding, and/or channel estimation and detection. In some implementations, an AI algorithm may be deployed in an offline-training/online-inference way, which may address the issue of potentially large training overhead caused by AI methods.
Waveform and multiple access: Waveform generation is responsible for mapping the information symbols into signals suitable for electromagnetic propagation. In one example, deep learning may be implemented for waveform generation. For example, without using an explicit discrete Fourier transform (DFT) module, deep learning or other learning-based methods may be used to design advanced waveforms. In some implementations, it may be possible to directly design a new waveform to replace standard OFDM by setting some particular requirements, for example, PAPR constraint or low level of out-of-band emission. This may support asynchronous transmission to possibly avoid the large overhead of synchronization signaling caused by massive terminals, and/or it may be robust to UE collision. It may also entail implementing a good localization property in the time domain to provide low-latency services and to support small packet transmission efficiently.
Optimization of parameters: Parameters, such as coding, modulation, MIMO parameters, may be optimized using AI to try to have a positive impact on the performance of the communication systems. In some implementations, optimized parameters might dynamically change due to fast time-varying channel characteristics of the physical layer in the real environment. By utilizing AI methods, optimized parameters may possibly be obtained, e.g. by neural networks, possibly with much lower complexity than traditional schemes. In addition, traditional parameter optimization is per building block, such as, bit-interleaved coded modulation (BICM) model, while joint optimization of multiple blocks may provide additional performance gains by an AI neural network, e.g. joint source and channel optimization. Furthermore, to adapt to fast time-varying channel status, self-learning of optimized parameters by AI may be utilized to try to further improve performance.

Physical layer components of an air interface that are not implemented using AI (e.g., that are not part of intelligent PHY 2610) may operate in a conventional non-AI manner and may still aim to have (more limited) optimization within the parameters defined. For example, particular modulation and/or coding and/or waveform schemes, technologies, or parameters may be predefined, with selection being limited to predefined options, e.g. based on channel conditions determined from measuring transmitted reference signals.

One or more air interface components related to transmission or reception over multiple antennas (or panels) may be AI-enabled. Examples of such air interface components include air interface components implementing any one or more of: beamforming, precoding, channel acquisition, channel tracking, channel prediction, channel construction, etc. Such air interface components may be part of intelligent MIMO 26102.

The specific components implemented using AI, and the details of the AI algorithms or models, are implementation specific. However, several illustrative examples are described herein, at least below, for completeness.

As one example, in non-AI implementations, precoding parameters may be determined in a conventional fashion, e.g. based on transmission of a reference signal and measurement of that reference signal. In one example, a TRP transmits, to a UE, a reference signal (such as a channel state information reference signal (CSI-RS)). The reference signal is used by the UE to perform a measurement and thereby obtain a measurement result. For example, the measurement may be measuring CSI to obtain the CSI. The UE then transmits a measurement report to report some or all of the measurement result, for example to report some or all of the CSI. The TRP then selects and implements one or more precoding parameters based on the measurement result, e.g. to perform digital beamforming. Alternatively, instead of sending the measurement results, the UE might send an indication of the precoding parameters corresponding to the measurement results, e.g. the UE might send an indication of a codebook to be used for the precoding. In some embodiments, the UE may instead or additionally send a rank indicator (RI), channel quality indicator (CQI), CSI-RS resource indicator (CRI), and/or SS/PBCH resource block indicator. In another example, the UE may send a reference signal to the TRP, which is used to obtain CSI and determine precoding parameters. Methods of this nature are currently employed in non-AI air interface implementations. However, in an AI implementation, the network device 352 may use AI to determine precoding parameters for a TRP for communication with a particular UE. Inputs to AI may include information such as the UE's current location, speed, beam direction (angle of arrival and/or angle of departure information), etc. AI output may include one or more precoding parameters, for digital beamforming, analog beamforming, and/or hybrid beamforming (digital+analog beamforming), for example. Transmission of a reference signal and associated feedback of a measurement result might not be necessary in an AI implementation.

In another example, in non-AI implementations, channel information may be acquired for a wireless channel between a TRP and a particular UE in a conventional fashion, for example by transmission of a reference signal and using the reference signal to measure CSI. However, in an AI implementation, a channel may be constructed and/or tracked using AI. For example, in general a channel between a UE and a TRP changes due to movement of the UE or changes in environment. An AI algorithm may incorporate sensing information that detects changes in the environment, such as introduction or removal of an obstruction between the TRP and the UE. An AI algorithm may also or instead incorporate one or more of the current location, speed, beam direction, etc. of the UE. The output of an AI algorithm may be a prediction of the channel, and in this way the channel may be constructed and/or tracked over time. There might not be a transmission of a reference signal or determining CSI in the way implemented in conventional non-AI implementations.

In another example, AI (for example in the form of an autoencoder) may be applied to the transmission and/or reception to compress the channel and reduce channel feedback overhead. For example, an autoencoded neural network may be trained and executed at the UE and TRP. The UE measures the CSI according to a downlink reference signal and compresses the CSI, which is then reported to the TRP with less overhead. After receiving the compressed CSI at the TRP, the network uses AI to restore the original CSI.

AI might be enabled or disabled, depending upon the scenario or UE capability. Signaling related to enabling or disabling AI may be sent semi-statically or dynamically.

In AI implementations, AI inputs may include sensing and/or positioning information for one or more UEs, e.g. to predict and/or track the channel for the one or more UEs. The measurement mechanisms used (e.g., transmission of reference signals, measuring and feedback, channel sounding mechanisms, etc.) may be different for an AI implementation versus a non-AI implementation. However, in some embodiments, there is are unified measuring and feedback channel configurations designed to accommodate both AI and non-AI capable devices, including AI capable devices having different types of AI implementations resulting in different needs for measurement and/or feedback.

Further to the above, and for the sake of completeness, the following are some examples of components/models in an air interface that may benefit from an AI implementation, e.g. by intelligent MIMO 26102:
Channel acquisition: As a distinguishing property of wireless communications, acquiring information on wireless channel and transmission environment has always been a fundamental aspect of system design. In one example, historic channel data and sensing data is stored as data sets, based on which a radio environment map is drawn through AI methods. Based on such a radio environment map or radio map, channel information might be obtained not only through common measurement, but also or instead by inference based on other information, such as location for example.
Beamforming and tracking: As the carrier frequency reaches millimeter wave or THz range for example, beam-centric design, such as beam-based transmission, beam alignment, and/or beam tracking, may be extensively applied in wireless communication. In this context, efficient beamforming and tracking may become important. In some embodiments, and relying on prediction capability, AI methods may be implemented to optimize antenna selection, beamforming and/or pre-coding procedures jointly.
Sensing and positioning: In some embodiments, both measured channel data and sensing and positioning data may be available and obtained, due to availability of large bandwidth, new spectrum, dense network and/or more line-of-sight (LOS) links. Based on this data, in some embodiments a radio environmental map may be drawn through AI methods, where channel information is linked to its corresponding positioning or environmental information. As a result, physical layer and/or MAC layer design may possibly be enhanced.

One or more air interface components related to executing protocols (e.g., possibly in the MAC layer) may be AI-enabled, e.g. via intelligent protocols 2630. For example, AI may be applied to air interface components implementing one or more of link adaptation, radio resource management (RRM), retransmission schemes, etc.

Intelligent PHY and intelligent MAC may be desirable to support tailored air interface frameworks and so accommodate diverse services and devices. In order to support intelligent PHY and intelligent MAC natively, a new protocol and signaling mechanism may be provided, for example to allow the corresponding air interface to be personalized with customized parameters in order to meet particular requirements while minimizing or reducing signaling overheads and maximizing or improving whole system spectrum efficiency by personalized artificial intelligence technologies.

The specific components implemented using AI, and the details of the AI algorithms or models, are implementation specific. However, several illustrative examples are described herein, at least below, for completeness. The following are some examples of protocol and/or signaling components/models of an air interface that may benefit from an AI implementation, e.g. by intelligent protocols 2630:
Super-flexible frame structure and agile signaling, also described above.
Intelligent spectrum utilization: The potential spectrum for future networks can include low-band, mid-band, mmWave bands, THz bands, and even visible-light band. The spectrum range for such networks is thus much wider than that for 5G, and designing a high-efficiency system to support such a wide spectrum range can be challenging.
In current networks (e.g. 3G, 4G and 5G networks), both CA and DC schemes are adopted to jointly utilize multiple pieces of wide spectrum. There are multiple DC schemes adopted in 5G to provide flexible usage of spectrum. With more combinations of frequency carriers for future networks, a new air interface with intelligent, simplified and efficient operation is desirable, to support the whole range of spectrum operations.
Current spectrum assignments and frame structures are usually associated with duplex mode, either FDD or TDD, which may place restrictions on the efficient usage of spectrum. It is expected that full duplexing may mature in the 6G era.

As another example, in non-AI implementations, link adaptation may be performed in which there are a predefined limited number of different modulation and coding (MCS) schemes, and a look up table (LUT) or the like may be used to select one of the MCS schemes based on channel information. A reference signal (e.g., a CSI-RS) may be transmitted and used for measurement to determine channel information. Methods of this nature are currently employed in non-AI air interface implementations. However, in an AI implementation, the network and/or UE may use AI to perform link adaptation, e.g. based on the state of the channel as may be determined using AI. Transmission of a reference signal might not be needed at all or as often.

As a further example, in non-AI implementations, retransmissions may be governed according to a protocol defined by a standard, and particular information may need to be signaled, such as process identifier (ID), and/or redundancy version (RV), and/or the type of combining that may be used (e.g. chase combining or incremental redundancy), etc. Methods of this nature are currently employed in non-AI air interface implementations. However, in an AI implementation, a network device may determine a customized retransmission protocol on a UE-specific basis (or for a group of UEs), e.g. possibly dependent upon the UE position, sensing information, determined or predicted channel conditions for the UE, etc. Post-training, control information to be dynamically indicated for the customized retransmission protocol may be different from (e.g., less than) the control information needed to be dynamically indicated in convention HARQ protocols. For example, the AI-enabled retransmission protocol might not need to signal process ID or an RV, etc.

AI might be enabled or disabled, depending upon the scenario or UE capability. Signaling related to enabling or disabling AI may be sent semi-statically or dynamically.

A network may include a controller in the MAC layer that may make decisions during the life cycle of the communication system, such as TRP layout, beamforming and beam management, spectrum utilization, channel resource allocation (e.g., scheduling time, frequency, and/or spatial resources for data transmission), MCS adaptation, HARQ management, transmission and/or reception mode adaptation, power control, and/or interference management. Wireless communication environments may be highly dynamic due to the varying channel conditions, traffic conditions, loading, interference, etc. In general, system performance may be improved if transmission parameters are able to adapt to a fast-changing environment. However, conventional non-AI methods mainly rely on optimization theory, which may be “NP-hard” (or as hard as non-deterministic polynomial-time) and too complicated to feasibly implement. In this context, AI may be used to implement an intelligent controller for air transmission optimization in the MAC layer.

For example, a network device may implement an intelligent MAC controller in which any one, some, or all of the following might be determined (e.g. optimized), possibly on a joint basis depending upon the implementation:
TRP layout and TRP activation/deactivation: A TRP, as used herein, may be a T-TRP (e.g., a base station) or a NT-TRP (e.g., a drone, satellite, high altitude platform station (HAPS), etc.). TRP layout and TRP activation/deactivation may be implemented by intelligent TRP layout 26201. In some embodiments, the TRP selection may be made for each of one or more UEs (e.g., a selection of which TRP(s) to serve which UE(s)).
Beamforming and beam management in relation to each of one or more UEs: A beamforming and beam management may be implemented by intelligent beam management 26202.
Spectrum utilization in relation to each of one or more UEs: A spectrum utilization procedure may be implemented by intelligent spectrum utilization 26203.
Channel resource allocation in relation to each of one or more UEs: A channel resource allocation procedure may be implemented by intelligent channel resource allocation 26204.
Transmit/receive mode adaptation in relation to each of one or more UEs: Transmit mode and/or receive mode adaptation may be implemented by intelligent transmit/receive mode adaptation 26205.
Power control in relation to each of one or more UEs: Power control may be implemented by intelligent power control 26206.
Interference management in relation to each of one or more UEs: Interference management may be implemented by intelligent interference management 26207.

In general, one or more air interface components related to a MAC layer may be AI-enabled, e.g. via intelligent MAC 2620. The specific components implemented using AI, and details of AI algorithms or models, are implementation specific. However, several illustrative examples are described herein, at least below, for completeness. The following are some examples of components or models in an intelligent air interface that may benefit from an AI implementation, e.g. by intelligent MAC 2620 and/or intelligent protocols 2630, and some of which encompass or generally correspond to MAC features listed by way of example above:
Intelligent TRP management: Single TRP and multi-TRP joint transmission, for example, macro-cells, small cells, pico-cells, femto-cells, remote radio heads, relay nodes, and so on, may possibly be implemented. It has previously been a challenge to design an efficient TRP management scheme while considering trade-offs between performance and complexity. Typical problems, including TRP selection, TRP turning on/off, power control, and resource allocation, may be difficult to solve. This may especially be the case with a large-scale network. Instead of using a complicated mathematical optimization method, AI may be implemented to possibly provide a better solution that has less complexity and that may adapt to network conditions. For example, a policy network in DRL (deep reinforcement learning) and/or multi-agent DRL can be designed and deployed to support intelligent TRP management for the integration of terrestrial and non-terrestrial networks. In some embodiments, TRP management may be implemented by intelligent TRP layout 26201
Intelligent beam management: Multiple antennas or a phase shift antenna array may dynamically form one or more beams, on the basis of channel conditions, for directional transmissions to one or more UEs. A receiver may accurately tune a receiver antenna or panel to the direction of the arrival beam. In some implementations, AI may be used to learn environment changes and perform beam steering and/or other such beam management operations, possibly more accurately and/or within a very short period of time. In some implementations, rules may be generated and guide operation of phase shifts of radio frequency devices, e.g. antenna elements, which then may work or be operated in a smarter or more appropriate or optimal way by learning different policies under different situations. In some embodiments, beam management may be performed by intelligent beam management 26202.
Intelligent MCS: In some embodiments, adaptive modulation and coding (AMC) is an important mechanism to adapt a system to the dynamics of a wireless channel. AMC algorithms may rely on feedback from a receiver to make a decision reactively. However, fast-varying channels, together with scheduling delays, often render feedback out-of-date. To address this issue, AI may be employed to determine MCS settings, for example. Through learning by experience and interaction with other AI elements, an intelligent MAC may be more likely to make a better decision on MCS, and/or to make that decision proactively rather than reactively.
Intelligent HARQ strategy: Besides combining algorithms for multiple redundancy versions in the physical layer, the operation of a HARQ procedure may also have impacts on performance, such as on finite transmission opportunities and on the resources that are allocated between new transmissions and retransmissions. In some embodiments, to achieve a global optimization, such impacts may be considered from a cross-layer point of view, with AI being implemented to process a large amount of information that may be available from various sources.
Intelligent Tx/Rx mode adaptation: In a network with multiple communicating participants, coordination among them may be key to efficiency. Both system conditions, such as the wireless channel and buffer status, and behavior of other players, may be highly dynamic and therefore extremely difficult if not impossible to predict with traditional methods. In some embodiments, AI may help by learning and prediction, for example to provide more accuracy, to reduce in the Tx/Rx mode adaptation overhead, and/or to improve overall system performance. In some embodiments, Tx/Rx mode adaptation is performed by intelligent Tx/Rx mod adaptation 26205.
Intelligent interference management: Managing interference has been a key task for cellular networks. Interference changes dynamically and, without real-time communication, it may be difficult to measure interference accurately. In some embodiments, AI may be implemented to learn interference at network devices and UEs individually and/or jointly. A global optimal strategy may then be configured automatically by the AI in order to bring interference under control, potentially achieving the greatest, or at least improved, spectrum efficiency and/or power efficiency. In some embodiments, the interference management is performed by intelligent interference management 26207.
Intelligent channel resource allocation: A scheduler for channel resource allocation may be viewed as the “brain” of a cellular network because it determines the allocation of transmission opportunities, and its performance contributes to system performance. In some implementations, transmission opportunities, and/or other radio resources such as spectrum, antenna port, and spreading codes, may be managed by AI, possibly together with intelligent TRP management. Coordination of radio resources among multiple base stations can potentially be improved for higher global performance. In some embodiments, channel resource allocation is performed by intelligent channel resource allocation 26204.
Intelligent power control: Attenuation of radio signals and/or broadcasting characteristics of wireless channels may make it desirable to control power in wireless communications. For example, objectives of power control may be to guarantee coverage so that cell-edge UEs still can receive their information, while at the same time keeping interference to other UEs as low as possible. In some embodiments, power control and interference coordination are jointly optimized. However, instead of solving a complicated optimization problem which is repeated when an operating environment changes, AI may be implemented to provide an alternative solution. In some embodiments, the power control is performed by intelligent power control 26206.
Native intelligent power saving: In some embodiments, with the use of AI, such features as intelligent MIMO and beam management, intelligent spectrum utilization, intelligent channel prediction, and/or intelligent power control may be supported. These may dramatically reduce power consumption of devices (e.g., UEs) and network nodes compared with non-AI technologies, especially for data. Some examples are as follows: (i) data transmission duration may be significantly shortened by an AI implementation, thus possibly reducing active time; (ii) optimized operating bandwidth may be allocated by the network according to real-time traffic amount and channel information, and thus a UE may use a smaller bandwidth to reduce power consumption when there is no heavy traffic; (iii) effective transmission channels may be designed such that control signaling may be optimized and/or the number of state transitions or power mode changes may be minimized in order to achieve improved or maximal power saving for devices (e.g., UEs) and network nodes (e.g., TRPs); (iv) with an air interface that is personalized for each UE (or group of UEs) or each service, different types of UEs and/or services may have different requirements for power consumption, and as a result power saving solutions may be personalized for different types of UEs/services while meeting requirements for communication.
With an air interface that supports intelligent MIMO and beam management, intelligent spectrum utilization, and accurate positioning in some embodiments, power consumption either or both of devices and network nodes can potentially be dramatically reduced compared with traditional technologies, especially for data. A future network air interface can thus be considered a framework that may provide greater power saving capability.
For example, as noted above data transmission duration can potentially be significantly shortened. As a result, a device may be able to stay longer in an operating mode when it is not actively accessing or interacting with the network. This may make it feasible for operating a system with native power saving, which may be especially important for energy-efficient devices and environmentally friendly networks.
For super-low-latency applications, such as enhanced URLLC (or URLLC plus), upon traffic arrival the schemes or mechanisms in support of native power saving may provide flexible functionalities.
Power saving features may provide ultra-fast access to networks and super-high data transmissions; an example is an optimized RRC state design with smart power mode management and operation.
An air interface that is personalized for each device may support different requirements or targets for power consumption by different types of devices, and/or enable straightforward power saving solutions to be personalized for different types of devices while meeting requirements for communication.

Any one, some, or all of the preceding examples may be implemented. In some embodiments, power consumption may be optimized using AI by: optimizing active time, and/or optimizing operation bandwidth, and/or optimizing spectrum range and channel source assignment. Optimization may possibly be according to quality requirement of the services, UE types, UE distribution, UE available power, etc.

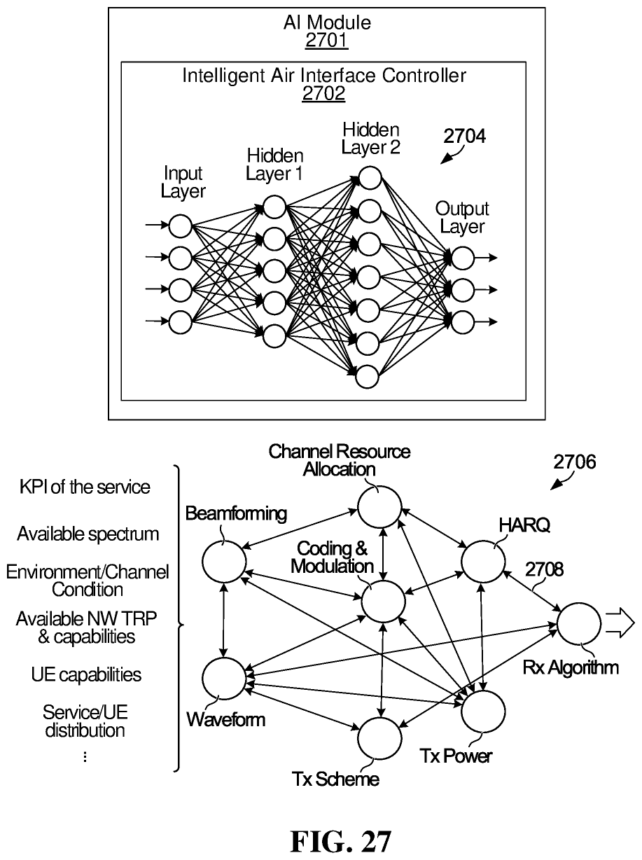

FIG. 27 is a block diagram illustrating an example intelligent air interface controller 2702 implemented by an AI module 2701, according to one embodiment. The AI module 2701 may be or include an AI agent and/or an AI block, depending upon whether training, inference, or both, are being considered, for example. The intelligent air interface controller 2702 may be based on the intelligent PHY 2610, intelligent MAC 2620, and/or intelligent protocols 2630 in FIG. 26B, for example. For an example, the lines 2708 in the FIG. 27 shows that the change of the parameters for one air interface component affect the parameter determination of other connected air interface components. With AI module 2701, the parameters for some or all air interface components can be optimized jointly.

In one embodiment, the intelligent air interface controller 2702 implements AI, e.g. in the form of a neural network 2704, in order to optimize or jointly optimize any one, some, or all of the intelligent MAC controller items listed immediately above, and/or possibly other air interface components, which may include scheduling and/or control functions. The illustration of a neural network 2704 is only an example. Any type of AI algorithms or models may be implemented. The complexity and level of AI-based optimization is implementation specific. In some implementations, the AI may control one or more air interface components in a single TRP or for a group of TRPs (e.g., jointly optimized). In some implementations, one, some, or all air interface components may be individually optimized, whereas in other implementations, one, some, or all air interface components may be jointly optimized. In some implementations, only certain related components may be jointly optimized, e.g. optimizing spectrum utilization and interference management for one or more UEs. In some embodiments, optimization of one or more items may be done jointly for a group of TRPs, where the TRPs in the group of TRPs may all be of the same type (e.g., all T-TRPs) or of different types (e.g., a group of TRPs including a T-TRP and a NT-TRP).

Graph 2706 is a schematic high-level example of factors that may be considered in AI, e.g. by neural network 2704, to produce the output controlling the air interface components. Inputs to the neural network 2704 schematically illustrated via graph 2706 may include, for each UE, factors such as:
(A) Key performance indicators (KPIs) of the service, e.g. block error rate (BLER), packet drop rate, energy efficiency (power consumptions and network devices and terminal devices), throughput, coverage (link budget), QoS requirements (such as latency and/or reliability of the service), connectivity (the number of connected devices), sensing resolution, position accuracy, etc.
(B) Available spectrum, e.g. some UEs might have the capability to transmit on different or more spectrum compared to other UEs. For example, the carriers available for each service and/or each UE may be considered.
(C) Environment/channel conditions, e.g. between the UE and a TRP.
(D) Available TRPs and their capabilities, e.g. some TRPs might support more advanced functionality than other TRPs.
(E) Capability of the UE, e.g. non-AI capable, AI capable, AI mode 1, AI mode 2, etc.
(F) Service/UE distribution, e.g. for supporting different services.

An AI algorithm or model may take these inputs and consider and jointly optimize different air interface components on a UE-by-UE specific basis, e.g. for the example items listed in the schematic graph 2706, such as beamforming, waveform generation, coding and modulation, channel resource allocation, transmission scheme, retransmission protocol, transmission power, receiver algorithms, etc. In some embodiments, the optimization may instead be done for a group of UEs, rather than UE-by-UE specific. In some embodiments, the optimization may be on a service-specific basis. An arrow (e.g., arrow 2708) between nodes indicates a joint consideration/optimization of the components connected by arrows. Outputs of the neural network 2704 schematically illustrated via graph 2706 may include, for each UE (or group of UEs and/or each service), items such as: rules/protocols, e.g. for link adaptation (the determination, selection and signaling of coding rate and modulation level, etc.); procedures to be implemented, e.g. a retransmission protocol to follow; parameter settings, e.g. such as for spectrum utilization, power control, beamforming, physical component parameters, etc. For example, the intelligent air interface controller 2702 may select an optimal waveform, beamforming, MCS, etc. for each UE (or group of UEs or service) at each T-TRP or NT-TRP. Optimization may be on a TRP and/or UE-specific basis, and parameters to be sent to UEs are forwarded to the appropriate TRPs to be transmitted to the appropriate UEs.

In some implementations, optimization targets for the intelligent air interface controller 2702 might not only be for meeting the performance requirements of each service or each UE (or group of UEs), but may also (or instead) be for overall network performance, such as system capacity, network power consumption, etc.

In some implementations, the intelligent air interface controller 2702 may implement control to enable or disable AI-enabled air interface components used for communication between the network and one or more UEs. In some implementations, like in the example illustrated in FIG. 27, the intelligent air interface controller 2702 may integrate (e.g., jointly optimize) air interface components in both the physical and MAC layers.

In some embodiments, spectrum utilization may be controlled/coordinated using AI, e.g. by intelligent spectrum utilization 26203. Some example details of intelligent spectrum utilization are provided below.

The potential spectrums for future networks may be low band, mid-band, mmWave bands, THz bands, and possibly even visible light band. In some embodiments, intelligent spectrum utilization may be implemented in association with more flexible spectrum utilization, in which there may be fewer restrictions and/or more options for configuring carriers and/or bandwidth parts (BWPs) on a UE-specific basis for example.

As one example, in some embodiments, there is not necessarily coupling between carriers, e.g. between uplink and downlink carriers. For example, an uplink carrier and a downlink carrier may be independently indicated so as to allow the uplink carrier and the downlink carrier to be independently added, released, modified, activated, deactivated, and/or scheduled. As another example, there may be a plurality of uplink carriers and/or downlink carriers, with signaling indicating addition, modification, release, activation, deactivation, and/or scheduling of a particular carrier of the uplink carriers and/or downlink carriers, e.g. on an independent carrier-by-carrier basis. In some implementations, a base station may schedule a transmission on a carrier and/or BWP, e.g. using DCI, and the DCI may also indicate the carrier and/or BWP on which the transmission is scheduled. Through the decoupling of carriers, flexible linkage may thereby be provided.

As used herein, “adding” a carrier for a UE refers to indicating, to the UE, a carrier that may possibly be used for communication to and/or from the UE. “Activating” a carrier refers to indicating, to the UE, that the carrier is now available for use for communication to and/or from the UE. “Scheduling” a carrier for a UE refers to scheduling a transmission on the carrier. “Removing” a carrier for a UE refers to indicating, to the UE, that the carrier is no longer available to possibly be used for communication to and/or from the UE. In some embodiments, removing a carrier is the same as deactivating the carrier. In other embodiments, a carrier might be deactivated without being removed. “Modifying” a carrier for a UE refers to updating/changing configuration of a carrier for a UE, e.g. changing a carrier index and/or changing bandwidth and/or changing transmission direction and/or changing a function of the carrier, etc. The same definitions apply to BWPs.

In some implementations, a carrier may be configured for a particular function, e.g. one carrier may be configured for transmitting or receiving signals used for channel measurement, another carrier may be configured for transmitting or receiving data, and another carrier may be configured for transmitting or receiving control information. In some implementations, a UE may be assigned a group of carriers, e.g. via RRC signaling, but one or more of the carriers in the group might not be defined, e.g. the carrier might not be specified as being downlink or uplink, etc. The carrier may then be defined for the UE later, e.g. at the same time as scheduling a transmission on the carrier. In some implementations, more than two carrier groups may be defined for a UE to allow for the UE to perform multiple connectivity, i.e. more than just dual connectivity. In some implementations, the number of added and/or activated carriers for a UE, e.g. the number of carriers configured for UE in a carrier group, may be larger than the capability of the UE. Then, during operation, the network may instruct radio frequency (RF) switching to communicate on a number of carriers that is within UE capabilities.

AI may be implemented to use or take advantage of the flexible spectrum embodiments described above. As one example, if there is decoupling between uplink and downlink carriers, the output of an AI algorithm may independently instruct adding, releasing, modifying, activating, deactivating, and/or scheduling different downlink and uplink carriers, without being limited by coupling between certain uplink carriers and downlink carriers. As another example, if different carriers can be configured for different functions, the output of an AI algorithm may instruct configuration of different functions for different carriers, e.g. for purposes of optimization. As another example, some carriers may support transmissions on an AI-enabled air interface, whereas others may not, and so different UEs may be configured to transmit/receive on different carriers depending upon their AI capabilities.

As another example, the intelligent air interface controller 2702 may control one TRP or a group of TRPs, and the intelligent air interface controller 2702 may further determine the channel resource assignment for a group of UEs served by the TRP or group of TRPs. In determining the channel resource assignment, the intelligent air interface controller 2702 may apply one or more AI algorithms to decide channel resource allocation strategy, e.g. to assign which carrier/BWP to which transmission channels for one or more UEs. The transmission channels may be, for example, any one, some, or all of the following: downlink control channel, uplink control channel, downlink data channel, uplink data channel, downlink measurement channel, uplink measurement channel. The input attributes or parameters to an AI model may be any, some, or all of the following: available spectrums (carriers), data rate and/or coverage supported by each carrier, traffic load, UE distribution, service type for each UE, KPI requirement of the service(s), UE power availability, channel conditions of the UE(s) (e.g., whether the UE is located at the cell edge), coverage requirement of the service(s) for the UE(s), number of antennas for TRP(s) and UE(s), etc. The optimization target of the AI model may be meeting all service requirements for all UEs, and/or minimizing power consumption of TRPs and UEs, and/or minimizing inter-UE interference and/or inter-cell interference, and/or maximizing UE experience, etc. In some embodiments, the intelligent air interface controller 2702 may run in a distributed manner (individual operation) or in a centralized manner (joint optimization for a group of TRPs). The intelligent air interface controller 2702 may be located in one of the TRPs or in a dedicated node. The AI training may be done by an intelligent controller node or by another AI node or by multiple AI nodes, e.g. in the case of multi-node joint training.

The description above equally applies to BWPs. For example, different BWPs may be decoupled from each other and possibly linked flexibly, and an AI algorithm may exploit this flexibility to provide enhanced optimization.

In some embodiments, communication is not limited to the uplink and downlink directions, but may also or instead include device-to-device (D2D) communication, integrated access backhaul (IAB) communication, non-terrestrial communication, and so on. The flexibility described above in relation to uplink and downlink carriers may equally apply to sidelink carriers, unlicensed carriers, etc., e.g. in terms of decoupling, flexible linkage, etc.

In a flexible spectrum utilization embodiment, AI may be used to try to provide a duplexing agnostic technology with adequate configurability to accommodate different communication nodes and communication types. In some implementations, a single frame structure may be designed to support all duplex modes and communication nodes, and resource allocation schemes in the intelligent air interface may be able to perform effective transmissions in multiple air links.

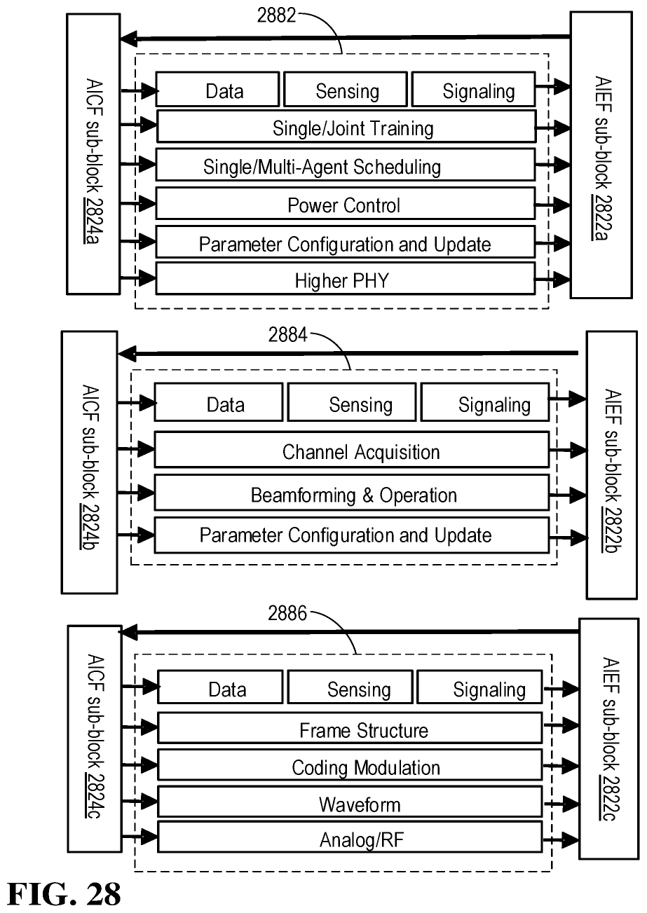

FIGS. 28-30 are block diagrams illustrating examples of how logical layers of a system node or UE may communicate with an AI agent in some embodiments. Example protocol stacks are shown in other drawings and discussed elsewhere herein, and FIGS. 28-30 illustrate communications in another way, based on logical layers.

In some embodiments, an AI agent implements or supports an AIEF and an AICF, and implementations of these functions are illustrated as separated blocks and sub-blocks in FIGS. 28-30. However, it should be understood that the AIEF and the AICF blocks and sub-blocks are not necessarily independent functional blocks, and that the AIEF and the AICF blocks and sub-blocks may be intended to function together within AI agent.

FIG. 28 shows an example of a distributed approach to controlling the logical layers. In this example, the AIEF and AICF are logically divided into sub-blocks 2822a/2822b/2822c and 2824a/2824b/2824c, respectively, to control the control modules of a system node or UE corresponding to different logical layers. The sub-blocks 2822a-c may be logical divisions of an AIEF, such that the sub-blocks 2822a-c all perform similar functions but are responsible for controlling a defined subset of the control modules of the system node or UE. Similarly, the sub-blocks 2824a-c may be logical divisions of an AICF, such that the sub-blocks 2824a-c all perform similar functions but are responsible for communicating with a defined subset of the control modules of the system node or UE. This may enable each sub-block 2822a-c and 2824a-c to be located more closely to the respective subset of control modules, which may allow for faster communication of control parameters to the control modules.

In the example of FIG. 28, a first logical AIEF sub-block 2822a and a first logical AICF sub-block 2824a provide control to a first subset of control modules 2882. For example, the first subset of control modules 2882 may control functions of the higher PHY layers (e.g., single/joint training functions, single/multi-agent scheduling functions, power control functions, parameter configuration and update functions, and other higher PHY functions). In operation, the AICF sub-block 2824a may output one or more control parameters (e.g., received from an AI block in a CN or an external system or network, and/or generated by one or more local AI models and outputted by the AIEF sub-block 2822a) to the first subset of control modules 2882. Data generated by the first subset of control modules 2882 (e.g., network data collected by the control modules 2882, such as measurement data and/or sensed data, which may be used for training local and/or global AI models) are received as input by the AIEF sub-block 2822a. The AIEF sub-block 2822a may, for example, preprocess this received data and use the data as near-RT training data for one or more local AI models maintained by the AI agent. The AIEF sub-block 2822a may also output inference data generated by one or more local AI models to the AICF sub-block 2824a, which in turn interfaces (e.g., using a common API) with the first subset of control modules 2882 to provide the inference data as control parameters to the first subset of control modules 2882.

A second logical AIEF sub-block 2822b and a second logical AICF sub-block 2824b provide control to a second subset of control modules 2884. For example, the second subset of control modules 2884 may control functions of the MAC layer (e.g., channel acquisition functions, beamforming and operation functions, and parameter configuration and update functions, as well as functions for receiving data, sensing and signaling). The operation of the AICF sub-block 2824b and the AIEF sub-block 2822b to control the second subset of the control modules 2884 may be similar to that described above with reference to the first logical AIEF sub-block 2822a, the first logical AICF sub-block 2824a, and the first subset of control modules 2882.

A third logical AIEF sub-block 2822c and a third logical AICF sub-block 2824c provide control to a third subset of control modules 2886. For example, the third subset of control modules 2886 may control functions of the lower PHY layers (e.g., controlling one or more of frame structure, coding modulation, waveform, and analog/RF parameters). The operation of the AICF sub-block 2824c and the AIEF sub-block 2822c to control the third subset of the control modules 2886 may be similar to that described above with reference to the first logical AIEF sub-block 2822a, the first logical AICF sub-block 2824a, and the first subset of control modules 2882.

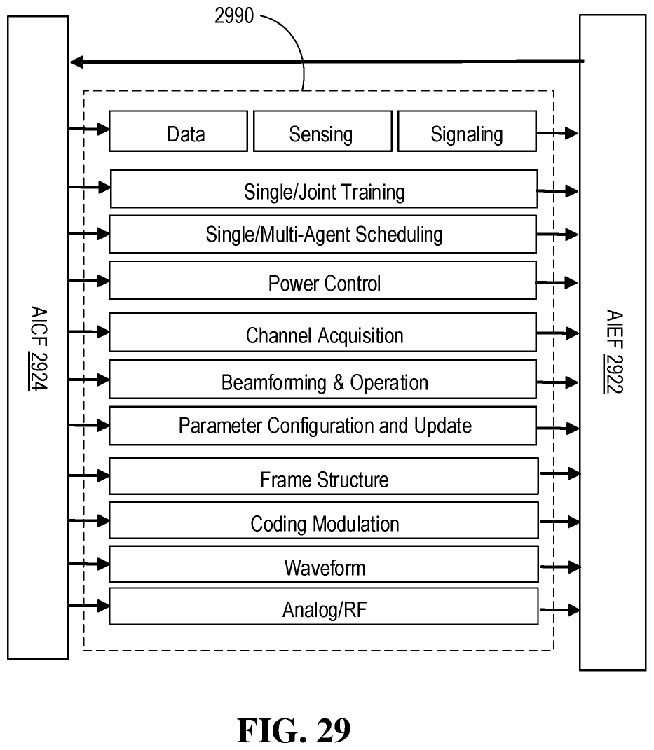

FIG. 29 shows an example of an undistributed (or centralized) approach to controlling the logical layers. In this example, the AIEF 2922 and AICF 2924 control all control modules 2990 of a system node or UE, without division by logical layer. This may enable more optimized control of the control modules. For example, a local AI model may be implemented at an AI agent to generate inference data for optimizing control at different logical layers, and the generated inference data may be provided by the AIEF 2922 and AICF 2924 to the corresponding control modules, regardless of the logical layer.

An AI agent may implement the AIEF 2922 and AICF 2924 in a distributed manner (e.g., as shown in FIG. 28) or an undistributed manner (e.g., as shown in FIG. 29). Different AI agents (e.g., implemented at different system nodes and/or different UEs) may implement AI agents in different ways. An AI block may communicate with an AI agent via an open interface whether a distributed or undistributed approach is used at the AI agent.

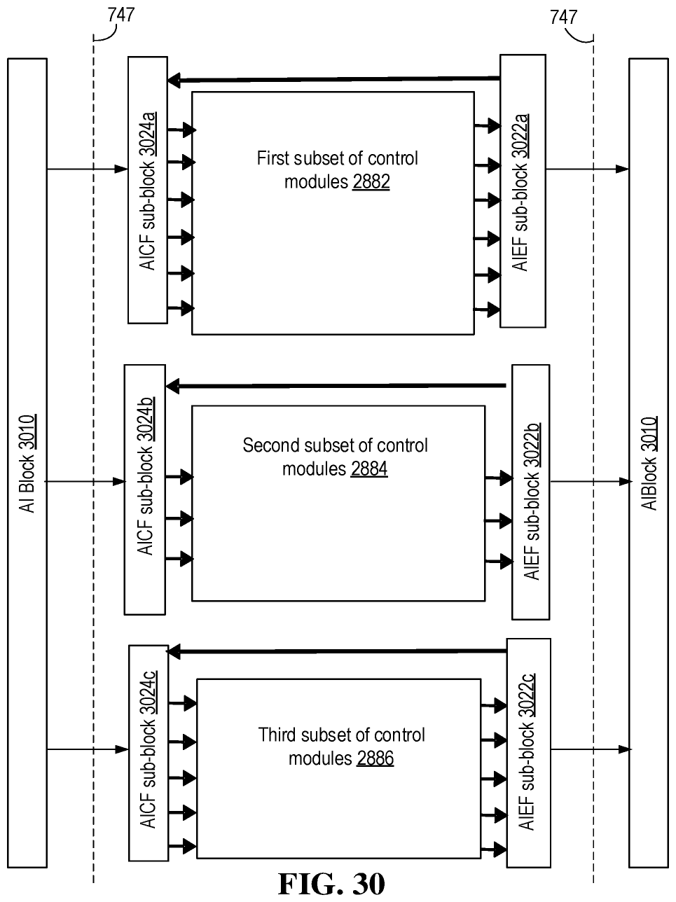

FIG. 30 illustrates an example of an AI block 3010 communicating with sub-blocks 3022a/3022b/3022c and 3024a/3024c/3024c via an open interface, such as the interface 747 as illustrated in FIGS. 7A-7D. Although the interface 747 is shown, it should be understood that other interfaces may be used. In this example, an AIEF and an AICF are implemented in a distributed manner, and accordingly the AI block 3010 provides distributed control of the sub-blocks 3022a-c and 3024a-c (e.g., the AI block 3010 may have knowledge of which sub-blocks 3022a-c and 3024a-c communicate with which subset of control modules). It should be noted that FIG. 30 shows two instances of the AI block 3010 in order to illustrate the flow of communication, however there may be only one instance of the AI block 3010 in actual implementation. Data from the AI block 3010 (e.g., control parameters, model parameters, etc.) may be received by the AICF sub-blocks 3024a-c via the interface 747, and used to control the respective control modules. Data from the AIEF sub-blocks 3022a-c (e.g., model parameters of local AI models, inference data generated by local AI models, collected local network data, etc.) may be outputted to the AI block 3010 via the interface 747.

Communication of AI-related data (e.g., collected network data, model parameters, etc.) may be performed over an AI-related protocol. The present disclosure describes an AI-related protocol that is communicated over a higher level AI-dedicated logical layer. In some embodiments of the present disclosure, an AI control plane is disclosed. Examples are provided at least above with reference to FIGS. 7A-7D.

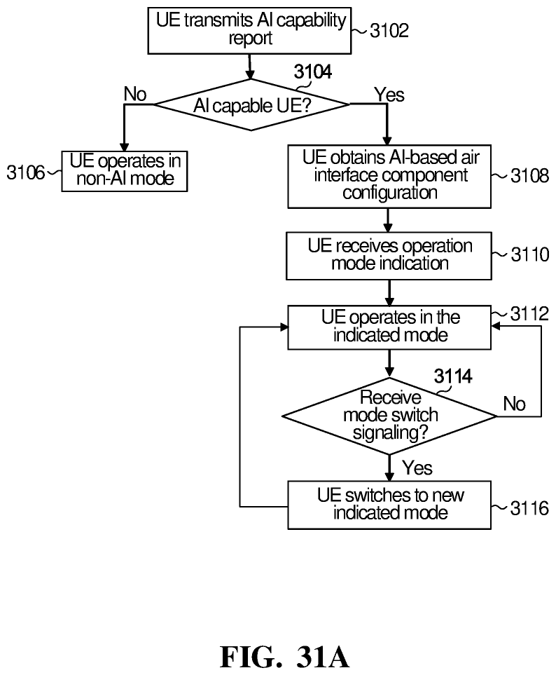

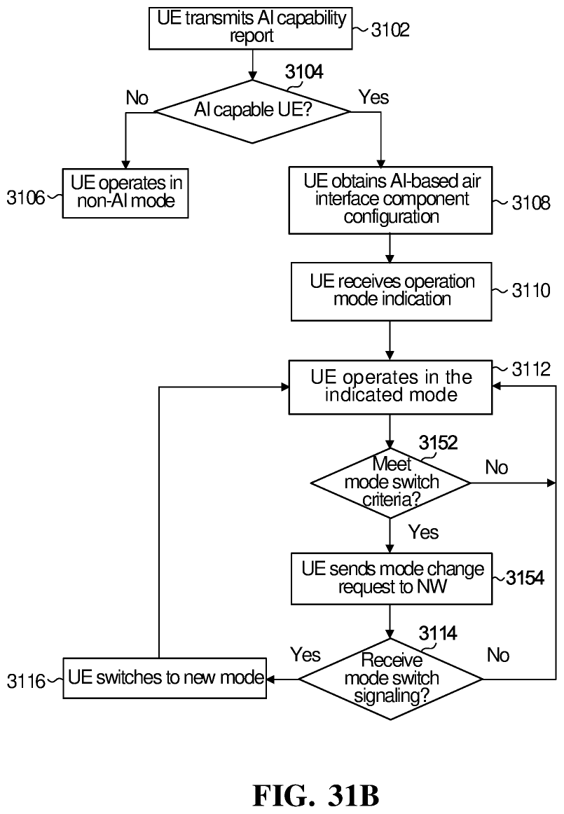

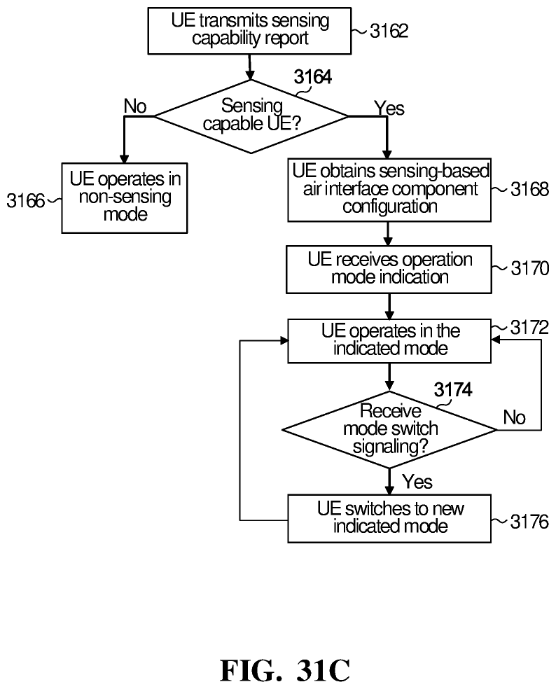

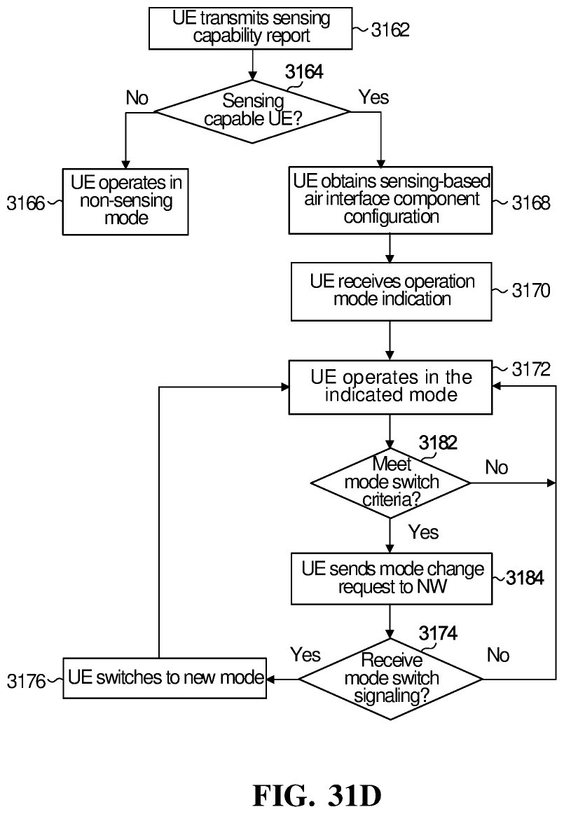

FIGS. 31A and 31B are flow diagrams illustrating methods for AI mode adaptation/switching, according to various embodiments.

FIG. 31A illustrates a method for AI mode adaptation/switching, according to one embodiment. In the method of FIG. 31A, the switching of the UE from one AI mode to another is initiated by the network, e.g. by network device 2552 in FIG. 25.

In step 3102, the UE transmits a capability report or other indication to the network indicating one or more of the UE's AI capabilities. In some embodiments, the capability report may be transmitted during an initial access procedure. In some embodiments, the capability report may also or instead be sent by the UE in response to a capability enquiry from a TRP. The capability report indicates whether or not the UE is capable of implementing AI in relation to one or more air interface components in some embodiments. If the UE is AI capable, then the capability report may provide additional information, such as (but not limited to): an indication of which mode or modes of operation the UE is capable of operating in (e.g., AI mode 1 and/or AI mode 2 described earlier); and/or an indication of the type and/or level of complexity of AI the UE is capable of supporting, e.g., which function/operation AI can support, and/or what kind of AI algorithm or model can be supported (e.g., autoencoder, reinforcement learning, neural network (NN), deep neural network (DNN), how many layers of NN can be supported, etc.); and/or an indication of whether the UE can assist with training; and/or an indication of the air interface components for which the UE supports an AI implementation, which may include components in the physical and/or MAC layer; and/or an indication of whether the UE supports AI joint optimization of one or more components of the air interface. In some embodiments, there may be a predefined number of modes/capabilities within AI, and the modes/capabilities of the UE may be signaled by indicating particular patterns of bits.

At step 3104, the network device receives the capability report and determines whether the UE is even AI capable. If the UE is not AI capable, then the method proceeds to step 3106 in which the UE operates in a non-AI mode, e.g. an air interface is implemented in a conventional non-AI way, such as according to the signaling, measurement, and feedback protocols defined in a standard that does not incorporate AI.

If the UE is AI capable, then at step 3108 the UE receives from the network, or otherwise obtains, an AI-based air interface component configuration. Step 3108 may be optional in some implementations, e.g. if the UE performs learning at its end and does not receive a component configuration from the network, or if certain AI configurations and/or algorithms have been predefined (e.g., in a standard) such that a component configuration does not need to be received from the network. The component configuration is implementation specific and depends upon the capabilities of the UE and the air interface components being implemented using AI. The component configuration may relate to a configuration of parameters for physical layer components, the configuration of a protocol, e.g. in the MAC layer (such as a retransmission protocol), etc. In some embodiments, before the component configuration is determined, training may occur on the network and/or UE side, which may involve the transmission of training related information from the UE to the network, or vice versa.

At step 3110, the UE receives, from the network, an operation mode indication. The operation mode indication provides an indication of the mode of operation the UE is to operate in, which is within the capabilities of the UE. Different modes of operation may include: AI mode 1 described earlier, AI mode 2 described earlier, a training mode, a non-AI mode, an AI mode in which only particular components are optimized using AI, an AI mode in which joint optimization of particular components is enabled or disabled, etc. Note that in some embodiments, step 3110 and step 3108 may be reversed. In some embodiments, step 3110 may inherently occur as part of the configuration in step 3108, e.g. the configuration of particular AI-based air interface component(s) is indicative of the operation mode in which the UE will operate.

Also, just because the UE is AI capable and/or just because the UE obtains an AI-based air interface component configuration in step 3108, it does not mean that the UE is necessarily initially instructed to operate in an AI mode in step 3110. For example, a network device may initially instruct the UE to operate over a predefined conventional non-AI air interface, e.g. because this is associated with lower power consumption and may possibly achieve adequate performance.

At step 3112, the UE operates in the indicated mode, implementing the air interface in the way configured for that mode of operation.

If, during operation, the UE receives mode switch signaling from the network (as determined at step 3114), then at step 3116, the UE switches to the new mode of operation indicated in the switch signaling. Switching to the new mode of operation might or might not require configuration or reconfiguration of one or more air interface components, depending upon the implementation.

In some embodiments, the mode switch signaling may be sent from the network to the UE semi-statically (e.g., in RRC signaling or in a MAC control element (CE)) or dynamically (e.g. in DCI). In some embodiments, the mode switch signaling might be UE-specific, e.g. unicast. In other embodiments, the mode switch signaling might be for a group of UEs, in which case the mode switch signaling might be group-cast, multicast or broadcast, or UE-specific. For example, the network device may disable/enable an AI mode for a particular group of UEs, for a particular service/application, and/or for a particular environment. In one example, the network device may decide to completely turn off AI (i.e., switch to non-AI conventional operation) for some or all UEs, e.g. when the network load is low, when there is no active service or UE that needs AI-based air interface operation, and/or if the network needs to control power consumption. Broadcast signaling may be used to switch the UEs to non-AI conventional operation.

In the method in FIG. 31A, the network device determines to switch the mode of operation of the UE and issues an indication of the new mode in the form of mode switch signaling for transmission to the UE. A few illustrative examples of reasons why switching might be triggered are as follows.

In one example, the network device initially configures the UE (via the operation mode indication in step 3110) to operate over a predefined conventional non-AI air interface, e.g. because the conventional non-AI air interface is associated with lower power consumption and may provide suitable performance. Then, one or more KPIs for the UE may be monitored by the network device (e.g., error rate, such as BLER or packet drop rate or other service requirements). If the monitoring reveals that performance is not acceptable (e.g., falls within a certain range or below a particular threshold), then the network device may switch the UE to an AI-enabled air interface mode to try to improve performance.

In another example, the network device instructs the UE to switch into a non-AI mode for one, some, or all of the following reasons: power consumption is too high (e.g., power consumption of UE or network exceeds a threshold); and/or the network load drops (e.g., fewer UEs being served) such that it is expected that a conventional non-AI air interface will provide suitable performance; and/or service type change such that it is expected that a conventional non-AI air interface will provide suitable performance; and/or the channel between the UE and a TRP is (or is predicted to be) of high quality (e.g., above a particular threshold) such that it is expected that a conventional non-AI air interface will provide suitable performance; and/or the channel between the UE and a TRP has improved (or is predicted to improve) because, for example, the UE's moving speed reduces, the SINR improves, the channel types changes (e.g., from non-LoS to LoS or multi-path effect reduces, etc.) such that it is expected that a conventional non-AI air interface will provide suitable performance; and/or a KPI is not meeting expectations (e.g., a KPI drops below a particular threshold or falls within a particular range), indicating low performance of the AI (e.g., performance of the AI degrading and falling below a particular threshold); and/or system capacity is constrained; and/or training or retraining of the AI needs to be performed, etc.

As another example, the service or traffic type or scenario of the UE may change, such that the current mode of operation is no longer a best match. For example, the UE switches to a service requiring brief simple communication of low amounts of traffic, and as a result the network device switches the UE mode to a conventional non-AI air interface. As another example, the UE switches to a service requiring higher/tighter performance requirements such as better latency, reliability, data rate, etc., and as a result the network device upgrades the UE from a non-AI mode to an AI mode (or to a higher AI mode if the UE is already in an AI mode).

As another example, an intelligent air interface controller in a network device may enable, disable, or switch modes, prompting an associated mode switch for the UE.

FIG. 31B illustrates a variation of FIG. 31A in which additional steps 3152 and 3154 are added, which allows for the UE to initiate a request to change its operation mode. Steps 3102 to 3112 are the same as FIG. 31A. If during operation in a particular mode the UE determines mode switching criteria is met (in step 3152), then at step 3154 the UE sends a mode change request message to the network, e.g. by sending the request to a TRP serving the UE. The mode change request may indicate the new mode of operation to which the UE wishes to switch. Steps 3114 and 3116 are the same as in FIG. 31A, except an additional reason the network might send mode switch signaling is to switch the UE to the mode requested by the UE in step 3154.

FIG. 31C illustrates a method for sensing mode adaptation/switching, according to one embodiment. In the method of FIG. 31C, the switching of the UE from one sensing mode to another is initiated by the network, e.g. by network device 2552 in FIG. 25.

In step 3162, the UE transmits a capability report or other indication to the network indicating one or more of the UE's sensing capabilities. In some embodiments, the capability report may be transmitted during an initial access procedure. In some embodiments, the capability report may also or instead be sent by the UE in response to a capability enquiry from a TRP. The capability report indicates whether or not the UE is capable of implementing sensing in relation to one or more air interface components in some embodiments. If the UE is sensing capable, then the capability report may provide additional information, such as (but not limited to): an indication of which mode or modes of operation the UE is capable of operating in (e.g. sensing mode 1 and/or sensing mode 2 described earlier); and/or an indication of the type and/or level of complexity of sensing the UE is capable of supporting, e.g., what kind of sensing can be supported; and/or an indication of whether the UE can assist with sensing for training; and/or an indication of the air interface components for which the UE supports a sensing implementation, which may include components in the physical and/or MAC layer. In some embodiments, there may be a predefined number of modes/capabilities within sensing, and the modes/capabilities of the UE may be signaled by indicating particular patterns of bits.

At step 3164, the network device receives the capability report and determines whether the UE is even sensing capable. If the UE is not sensing capable, then the method proceeds to step 3166 in which the UE operates in a non-sensing mode, e.g. an air interface is implemented in a conventional non-sensing way, such as according to the signaling, measurement, and feedback protocols defined in a standard that does not incorporate sensing.

If the UE is sensing capable, then at step 3168 the UE receives from the network, or otherwise obtains, a sensing-based air interface component configuration. Step 3168 may be optional in some implementations, e.g. if the UE does not receive a component configuration from the network, or if certain sensing configurations and/or algorithms have been predefined (e.g., in a standard) such that a component configuration does not need to be received from the network. The component configuration is implementation specific and depends upon the capabilities of the UE and the air interface components being implemented using sensing. The component configuration may relate to a configuration of parameters for physical layer components, the configuration of a protocol, e.g. in the MAC layer (such as a retransmission protocol), etc.

At step 3170, the UE receives, from the network, an operation mode indication. The operation mode indication provides an indication of the mode of operation the UE is to operate in, which is within the capabilities of the UE. Different modes of operation may include: sensing mode 1 described earlier, sensing mode 2 described earlier, a non-sensing mode, a sensing mode in which only particular components are optimized using sensing, a sensing mode in which certain features are enabled or disabled, etc. Note that in some embodiments, step 3170 and step 3168 may be reversed. In some embodiments, step 3170 may inherently occur as part of the configuration in step 3168, e.g. the configuration of particular sensing-based air interface component(s) is indicative of the operation mode in which the UE will operate.

Also, just because the UE is sensing capable and/or just because the UE obtains a sensing-based air interface component configuration in step 3168, it does not mean that the UE is necessarily initially instructed to operate in a sensing mode in step 3170. For example, a network device may initially instruct the UE to operate over a predefined conventional non-sensing air interface, e.g. because this is associated with lower power consumption and may possibly achieve adequate performance.

At step 3172, the UE operates in the indicated mode, implementing the air interface in the way configured for that mode of operation.

If, during operation, the UE receives mode switch signaling from the network (as determined at step 3174), then at step 3176, the UE switches to the new mode of operation indicated in the switch signaling. Switching to the new mode of operation might or might not require configuration or reconfiguration of one or more air interface components, depending upon the implementation.

In some embodiments, the mode switch signaling may be sent from the network to the UE semi-statically (e.g., in RRC signaling or in a MAC control element (CE)) or dynamically (e.g. in DCI). In some embodiments, the mode switch signaling might be UE-specific, e.g. unicast. In other embodiments, the mode switch signaling might be for a group of UEs, in which case the mode switch signaling might be group-cast, multicast or broadcast, or UE-specific. For example, the network device may disable/enable a sensing mode for a particular group of UEs, for a particular service/application, and/or for a particular environment. In one example, the network device may decide to completely turn off sensing (i.e., switch to non-sensing conventional operation) for some or all UEs, e.g. when the network load is low, when there is no active service or UE that needs sensing-based air interface operation, and/or if the network needs to control power consumption. Broadcast signaling may be used to switch the UEs to non-sensing conventional operation.

In the method in FIG. 31C, the network device determines to switch the mode of operation of the UE and issues an indication of the new mode in the form of mode switch signaling for transmission to the UE. A few illustrative examples of reasons why switching might be triggered are as follows.

In one example, the network device initially configures the UE (via the operation mode indication in step 3170) to operate over a predefined conventional non-sensing air interface, e.g. because the conventional non-sensing air interface is associated with lower power consumption and may provide suitable performance. Then, one or more KPIs for the UE may be monitored by the network device (e.g., error rate, such as BLER or packet drop rate or other service requirements). If the monitoring reveals that performance is not acceptable (e.g. falls within a certain range or below a particular threshold), then the network device may switch the UE to a sensing-enabled air interface mode to try to improve performance.

In another example, the network device instructs the UE to switch into a non-sensing mode for one, some, or all of the following reasons: power consumption is too high (e.g., power consumption of UE or network exceeds a threshold); and/or the network load drops (e.g., fewer UEs being served) such that it is expected that a conventional non-sensing air interface will provide suitable performance; and/or service type change such that it is expected that a conventional non-sensing air interface will provide suitable performance; and/or the channel between the UE and a TRP is (or is predicted to be) of high quality (e.g., above a particular threshold) such that it is expected that a conventional non-sensing air interface will provide suitable performance; and/or the channel between the UE and a TRP has improved (or is predicted to improve) because, for example, the UE's moving speed reduces, the SINR improves, the channel types changes (e.g., from non-LoS to LoS or multi-path effect reduces, etc.) such that it is expected that a conventional non-sensing air interface will provide suitable performance; and/or a KPI is not meeting expectations (e.g., a KPI drops below a particular threshold or falls within a particular range), indicating low performance of sensing (e.g., performance of the sensing degrading and falling below a particular threshold); and/or system capacity is constrained, etc.

As another example, the service or traffic type or scenario of the UE may change, such that the current mode of operation is no longer a best match. For example, the UE switches to a service requiring brief simple communication of low amounts of traffic, and as a result the network device switches the UE mode to a conventional non-sensing air interface. As another example, the UE switches to a service requiring higher/tighter performance requirements such as better latency, reliability, data rate, etc., and as a result the network device upgrades the UE from a non-sensing mode to a sensing mode (or to a higher sensing mode if the UE is already in a sensing mode).

As another example, an air interface controller in a network device may enable, disable, or switch modes, prompting an associated mode switch for the UE.

FIG. 31D illustrates a variation of FIG. 31C in which additional steps 3182 and 3184 are added, which allows for the UE to initiate a request to change its operation mode. Steps 3162 to 3172 are the same as FIG. 31C. If during operation in a particular mode the UE determines mode switching criteria is met (in step 3182), then at step 3184 the UE sends a mode change request message to the network, e.g. by sending the request to a TRP serving the UE. The mode change request may indicate the new mode of operation to which the UE wishes to switch. Steps 3174 and 3176 are the same as in FIG. 31C, except an additional reason the network might send mode switch signaling is to switch the UE to the mode requested by the UE in step 3184.

FIGS. 31A-B provide examples for AI mode adaptation or switching, and FIGS. 31C-D provide examples for sensing mode adaptation or switching. Such mode adaptation or switching may be applied independently, or in combination. In some embodiments, AI and sensing modes are adapted or switched together, and such features as capability reporting, configuration, operation, and mode switching relate to both AI and sensing.

Other variations of any or all of the example methods are also possible.

For example, the mode change request message sent in step 3154 and/or step 3184 may indicate that a mode switch is needed or requested, but the message might not indicate the new mode of operation to which the UE wishes to switch. In some such instances, the mode change request message sent in step 3154 and/or step 3184 might simply include an indication of whether the UE wishes to upgrade or downgrade the operation mode.

Illustrative examples of reasons why the UE may request to switch modes are as follows. In one example, the UE is operating in a non-AI mode or a lower-end AI mode (e.g., with only basic optimizations), but the UE begins experiencing poor performance, e.g. due to a change in channel conditions. In response, the UE requests to switch to a more advanced mode (e.g., more sophisticated AI mode) to try to better optimize one or more air interface components. In another example, the UE must or desires to enter a power saving mode (e.g., because of a low battery), and so the UE requests to downgrade, e.g. switch to a non-AI mode, which consumes less power than an AI mode. In another example, the power available to the UE increases, e.g. the UE is plugged into an electrical socket, and so the UE requests to upgrade, e.g. switch to a sophisticated high-end AI mode that is associated with higher power consumption, but that aims to jointly optimize several air interface components to increase performance. In another example, a KPI of the UE (e.g., throughput, error rate) fall within a range of performance that is unacceptable, which triggers the UE to request to upgrade, e.g. switch to an AI mode (or to a higher AI mode if the UE is already in an AI mode). In another example, a service or traffic scenario or requirement for the UE changes, which is better suited to a different mode of operation.

These and/or other examples may also or instead apply to sensing mode switching.

When switching from one mode of operation to another, the air interface components are reconfigured appropriately. For example, the UE may be operating in a mode in which MCS and the retransmission protocol are implemented using AI and/or sensing, with the result of better performance and the transmission of less control information post-training. If the UE is instructed to switch (fall back) to conventional non-AI and/or non-sensing mode, then the UE adapts the MCS and retransmission air interface components to follow the conventional predefined non-AI and/or non-sensing scheme, e.g. the MCS is adjusted using link adaptation based on channel quality measurement, and the retransmission returns to a conventional HARQ retransmission protocol.

Different operating modes may require different content and/or amount of control information to be exchanged. As an example, an air interface may be implemented between a first UE and the network in which a non-AI conventional HARQ retransmission protocol is used. In the execution of the HARQ retransmission protocol, a HARQ process ID and/or redundancy version (RV) may need to be signaled in control information, e.g. in DCI. Another air interface may be implemented between a second UE and the network in which an AI-based retransmission protocol is used. The AI-based retransmission protocol might not require transmission of a process ID or RV. The content and frequency of the control information exchanged might be more during training and less post-training. As another example, an air interface implemented in one instance may rely on regular transmission of a measurement report (e.g., indicating CSI), whereas another air interface implemented in another instance, and that is AI-enabled, might not rely on transmission of reference signals or measurement reports, or might not rely on their transmission as often. These and/or other examples may also or instead apply to sensing modes.

In some embodiments, a unified control signaling procedure may be provided that can accommodate both AI-enabled and non-AI-enabled interfaces and/or sensing-enabled and non-sensing-enabled interfaces, with accommodation of different amounts and content of control information that may need to be transmitted. The same unified control signaling procedure may be implemented for both AI-capable and non-AI capable devices and/or for both sensing-enabled and non-sensing-enabled devices.

In some embodiments, the unified control signaling procedure is implemented by having a first size and/or format allotted for transmission of first control information regardless of the mode of operation or AI/sensing capability, and a second size and/or format carrying different content depending upon the mode of operation and specific control information that needs to be transmitted. In some embodiments, the second size and content may be implementation specific and vary depending upon whether AI/sensing is implemented and the specifics of the AI/sensing implementation. Some examples will be presented below in the context of two-stage DCI.

A DCI structure may include one stage DCI and two stage DCI. In one stage DCI structure, the DCI has a single part and is carried on a physical channel, e.g. a control channel, such as a physical downlink control channel (PDCCH). A UE receives the DCI on the physical channel and decodes the DCI to obtain the control information. The control information may schedule a transmission in a data channel. In a two stage DCI structure, the DCI structure includes two parts, i.e. first stage DCI and corresponding second stage DCI. In some embodiments, the first stage DCI and the second stage DCI are transmitted in different physical channels, e.g. the first stage DCI is carried on a control channel (e.g., a PDCCH) and the second stage DCI is carried on a data channel (e.g., a PDSCH). In some embodiments, the second stage DCI is not multiplexed with UE downlink data, e.g. the second stage DCI is transmitted on a PDSCH without downlink shared channel (DL-SCH), where the DL-SCH is a transport channel used for the transmission of downlink data. That is, in some embodiments, the physical resources of the PDSCH used to transmit the second stage DCI are used for a transmission including the second stage DCI without multiplexing with other downlink data. For example, where the unit of transmission on the PDSCH is a physical resource block (PRB) in frequency-domain and a slot in time-domain, an entire resource block in a slot may be available for second stage DCI transmission. This may allow maximum flexibility in terms of the size of the second stage DCI, with fewer constraints on the amount of control information that could be transmitted in the second stage DCI. This may also avoid the complexity of rate matching for downlink data if the downlink data is multiplexed with the second stage DCI.

In some embodiments, the second stage DCI is carried by a PDSCH without data transmission (e.g., as mentioned above), or the second stage DCI is carried in a specific physical channel (e.g., a specific downlink data channel, or a specific downlink control channel) only for the second stage DCI transmission.

In some embodiments, the first stage DCI indicates control information for the second stage DCI, e.g. time/frequency/spatial resources of the second stage DCI. Optionally, the first stage DCI can indicate the presence of the second stage DCI. In some embodiments, the first stage DCI includes the control information for the second stage DCI and the second stage DCI includes additional control information for the UE; or the first stage DCI includes the control information for the second stage DCI and partial additional control information for the UE, and the second stage DCI includes other additional control information for the UE.

In some embodiments, the second stage DCI may indicate at least one of the following for scheduling data transmission for a UE:
scheduling information for one PDSCH in one carrier and/or BWP;
scheduling information for multiple PDSCHs in one carrier and/or BWP;
scheduling information for one PUSCH in one carrier and/or BWP;
scheduling information for multiple PUSCHs in one carrier and/or BWP;
scheduling information for one PDSCH and one PUSCH in one carrier and/or BWP;
scheduling information for one PDSCH and multiple PUSCHs in one carrier and/or BWP;
scheduling information for multiple PDSCHs and one PUSCH in one carrier and/or BWP;
scheduling information for multiple PDSCHs and multiple PUSCHs in one carrier and/or BWP;
scheduling information for sidelink in one carrier and/or BWP;
partial scheduling information for at least one PUSCH and/or at least one PDSCH in one carrier and/or BWP, where the partial scheduling information is an update to scheduling information in the first stage DCI;
partial scheduling information for at least one PUSCH and/or at least one PDSCH, where remaining scheduling information for the at least one PUSCH and/or at least one PDSCH is included in the first stage DCI;
configuration and/or scheduling information related to an AI function;
configuration and/or scheduling information related to a non-AI function;
configuration and/or scheduling information related to a sensing function;
configuration and/or scheduling information related to a non-sensing function.

In some embodiments, the UE receives the first stage DCI (for example by receiving a physical channel carrying the first stage DCI) and performs decoding (e.g., blind decoding) to decode the first stage DCI. Scheduling information for the second stage DCI, within the PDSCH, is explicitly indicated by the first stage DCI. The result is that the second stage DCI can be received and decoded by the UE without the need to perform blind decoding, based on the scheduling information in the first stage DCI. As compared to scheduling a PDSCH carrying downlink data, in some embodiments more robust scheduling information is used to schedule a PDSCH carrying second stage DCI, increasing the likelihood of that the receiving UE can successfully decode the second stage DCI.

Because the second stage DCI is not limited by constraints that may exist for PDCCH transmissions, the size of the second stage DCI is more flexible and may be used to carry control information having different formats, sizes, and/or contents dependent upon the mode of operation of the UE, e.g. whether or not the UE is implementing an AI-enabled air interface and/or sensing-enabled air interface, and (if so) the specifics of the AI/sensing implementation.

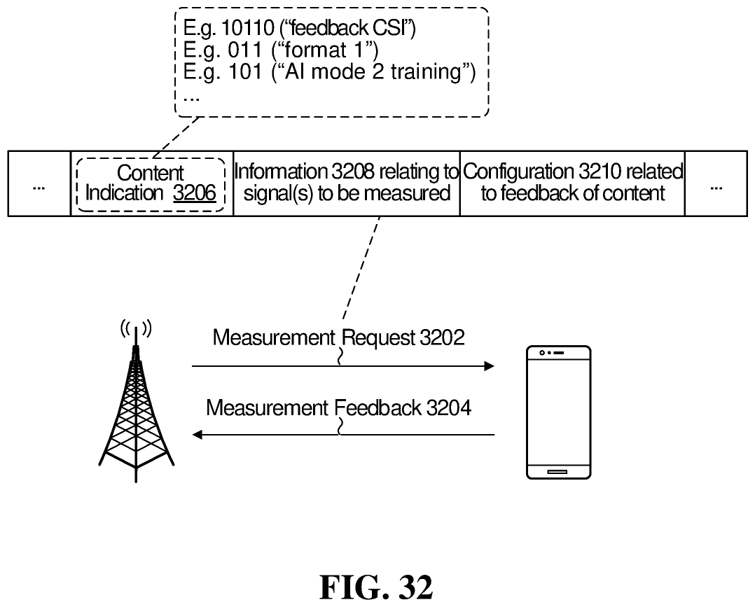

FIG. 32 is a block diagram illustrating a UE providing measurement feedback to a base station, according to one embodiment.

FIG. 32 illustrates a UE providing measurement feedback to a base station, according to one embodiment. The base station transmits a measurement request 3202 to the UE. In response, the UE performs the configured measurement and transmits content in the form of measurement feedback 3204. Measurement feedback 3204 refers to content that is based on a measurement. Depending upon the implementation, the content might be an explicit indication of channel quality (e.g., channel measurement results, such as CSI, signal to noise ratio (SNR), signal to interference plus noise ratio (SINR)) or precoding matrix and/or codebook. In other implementations, the content might additionally or instead be other information that is ultimately at least partially derived from the measurement, e.g.: output from an AI algorithm or intermediate or final training output; and/or performance KPI, such as throughput, latency, spectrum efficiency, power consumption, coverage (successful access ratio, retransmission ratio etc.); and/or error rate in relation to certain signal processing components, e.g. mean squared error (MSE), BLER, bit error rate (BER), log likelihood ratio (LLR), etc.

In some embodiments, the measurement request 3202 is sent on-demand, e.g. in response to an event. A non-exhaustive list of example events may include: training is required; and/or feedback on the channel quality is required; and/or channel quality (e.g., SINR) is below a threshold; and/or performance KPI (e.g., error rate) is below a threshold; etc. In some embodiments, instead of or in addition to being sent based on an event, the measurement request 3202 might be sent at predefined or preconfigured time intervals, e.g. periodically, semi-persistently, etc. The measurement request 3202 acts as a trigger for measurement and feedback to occur. In some embodiments, the measurement request 3202 may be sent dynamically, e.g. in physical layer control signaling, such as DCI. In some embodiments, the measurement request 3202 may be sent in higher-layer signaling, such as in RRC signaling, or in a MAC control element (MAC CE).

As discussed at least above, different devices may perform measurements at different intervals, e.g. depending upon whether the air interface is AI-enabled, and if it is AI-enabled, depending upon the specific AI implementation. The measurement request 3202 may therefore be sent at different times, as needed, for different UEs, depending upon the measurement/feedback needs for each UE. As also discussed at least above, different content may need to be fed back for different UEs, depending upon the air interface implementation. Therefore, in some embodiments, the measurement request 3202 includes an indication of the content the UE is to transmit to in the feedback 3204.

FIG. 32 illustrates an example measurement request carrying an indication 3206 of the content that is to be transmitted back to the base station. In some embodiments, the indication 3206 might be an explicit indication of what needs to be fed back, e.g. a bit pattern that indicates “feedback CSI”. In some embodiments, the indication 3206 might be an implicit indication of what needs to be fed back. For example, the measurement request 3202 may indicate a particular one of a plurality of formats for feedback, where each one of the formats is associated with transmitting back respective particular content, and the association is predefined or preconfigured prior to transmitting the measurement request 3202. As another example, the indication 3206 may indicate a particular one of a plurality of operating modes, where each one of the operating modes is associated with transmitting back respective particular content, and the association is predefined or preconfigured prior to transmitting the measurement request 3202. For example, if the indication 3206 is a bit pattern that indicates “AI mode 2 training”, then the UE knows that it is to feedback particular content (e.g., output from an AI algorithm) to the base station.

In addition to indication 3206, or instead of indication 3206, the measurement request 3202 may include information 3208 related to the signal(s) to be measured, e.g. scheduling and/or configuration information for the one or more signals that is/are to be transmitted by the network and measured by the UE. For example, the information 3208 might include an indication of the time-frequency location of a reference signal, possibly one or more characteristics or properties of the reference signal (e.g., the format or identity of the reference signal), etc.

The measurement request 3202 might also or instead include a configuration 3210 relating to transmission of the content that is derived based on the measurement. For example, the configuration 3210 may be a configuration of a feedback channel. In some embodiments, the configuration 3210 might include any one, some, or all of the following: a time location at which the content is to be transmitted; a frequency location at which the content is to be transmitted; a format of the content; a size of the content; a modulation scheme for the content; a coding scheme for the content; a beam direction for transmitting the content; etc.

In some embodiments, the measurement request 3202 is a one-shot measurement request, e.g. the measurement request 3202 instructs the UE to only perform a measurement once (e.g., based on a single reference signal transmitted by the network) and/or the UE is configured to send only a single transmission of feedback information associated with or derived from the measurement. If the measurement request 3202 is a one-shot measurement request, then the information in the measurement request may include:
(1) An indication of a time-frequency location at which the reference signal will be transmitted in the downlink channel, e.g. an indication that the reference signal will start at (and/or be within) resource block (RB) #3. This information may be part of information 3208.
   and/or
(2) An indication of feedback timing for when the content derived using the reference signal is to be fed back in the uplink, e.g. 1 ms after receiving the reference signal. In some embodiments, the feedback timing may be an absolute time or relative time, e.g. a slot indicator, a time offset from a time domain reference, etc. This information may part of configuration 3210. In some implementations, the frequency location of where to send the content may also or instead need to be indicated, e.g. if the UE does not know in advance the frequency location of where to send the feedback in the uplink channel.

In some embodiments, the measurement request 3202 is a multiple measurement request, e.g. the measurement request configures the UE to perform multiple measurements at different times (e.g., based on a series of reference signals transmitted by the network) and/or the measurement request configures the UE to transmit measurement feedback multiple times. If the measurement request 3202 is a multiple measurement request, then the information in the measurement request may include:
(1) An indication of the configuration of resources at which a series of reference signals are to be transmitted in the downlink, e.g. first reference signal transmitted at RB #2, and subsequent reference signal sent every 1 ms thereafter for 10 ms. This information may be part of information 3208.
   and/or
(2) An indication of feedback channel resources to use to send the feedback, e.g. starting and finishing time for the feedback and/or feedback interval, e.g. start feedback 0.5 ms after receiving first reference signal and feedback every 1 ms thereafter for 10 times. This information may be part of configuration 3210.

In some embodiments, there may be different predefined or preconfigured formats for feeding back the content, e.g. a first feedback format 1 corresponding to a one-shot measurement feedback and a second feedback format 2 corresponding to a multiple measurement feedback. In some embodiments, some or all of information 3208 and/or 3210 may be indicated implicitly, e.g. by indicating a particular format that maps to a known configuration. In some embodiments, the format may be indicated in content indication 3206, in which case it might be that a single indication of a format indicates to the UE one, some, or all of the following: (i) the configuration of the signals to be measured, e.g. their time-frequency location; (ii) which content is to be derived from the measurement and fed back; and/or (iii) the configuration of resources for sending the content, e.g. the time-frequency location at which to feed back the content.

In some embodiments, the measurement request 3202 is of a same format regardless of whether the air interface is implemented with or without AI, e.g. to have a unified measurement request format. For example, measurement request 3202 includes fields 3206, 3208, and 3210. These fields may be the same format, location, length, etc. for all measurement requests 3202, with the contents of the bits being different on a UE-specific basis, e.g. depending upon whether or not AI is implemented in the air interface and the specifics of the implementation. For example, a measurement request of the same format may be sent to a UE implementing a conventional non-AI air interface, and to another UE implementing an AI-enabled air interface, but with the following differences: the measurement request sent to the UE implementing the AI-enabled air interface may be sent less often (post training) and may indicate different content to feedback compared to the UE implementing the conventional non-AI air interface. The feedback channels may be configured differently for each of the two UEs, but this may be done by way of different indications in the measurement request of unified format.

In some embodiments, the network configures different parameters of the feedback channel, such as the resources for transmitting the feedback. The resources may be or include time-frequency resources in a control channel and/or in a data channel. Some or all of the configuration may be in a measurement request (e.g., in configuration 3210), or configured in another message (e.g., preconfigured in higher-layer signaling). In some embodiments, the resources and/or formats of the feedback channel for AI/sensing/positioning or non-AI/non-sensing/non-positioning may be separately configured. In some embodiments, upon the TRP transmitting an indication and/or configuration of a dedicated feedback channel for fallback mode (non-AI air interface operation), the network knows the UE will enter into the fallback mode. In some embodiments, the contents or the number of bits of the feedback depends upon whether AI/sensing/positioning is enabled. For example, with AI/sensing/positioning, a small number of bits or small feedback types/formats may be reported, and a more robust resource may be used for the feedback, e.g. coding with more redundancy.

In some embodiments, the reference signal/pilot settings for measurement may be preconfigured or predefined, e.g. the time-frequency location of a reference signal and/or pilot may be preconfigured or predefined. In some embodiments, the measurement request may include a starting and/or ending time of the measurement, e.g. the measurement request may indicate that a reference signal may be sent from time A to time B, where time A and time B may be absolute times and/or relative times (e.g., slot number). In some embodiments, the measurement request may include a starting and/or ending time of when feedback is to be transmitted, e.g. the measurement request may indicate that the feedback is to be transmitted from time C to time D, where time C and time D may be absolute times and/or relative times (e.g. slot number). Time C and time D might or might not overlap with time A and/or time B.

In some embodiments, when a measurement is to occur, the air interface falls back to a conventional non-AI air interface, e.g. for transmission of the measurement request and/or for transmission of the reference signal(s) and/or for transmission of the feedback.

Although the embodiments above assume a signal (e.g., a reference signal) is transmitted that is measured and used to derive content to be fed back, in other embodiments it might be the case that a signal for measurement is not sent, e.g. if content for feedback is derived from channel sensing.

The use of measurement requests and a configurable feedback channel may allow for the support of different formats, configurations, and contents (e.g., feedback payloads) for the measurement and the feedback. Measurement and feedback for a UE implementing an air interface that is not AI-enabled may be different from measurement and feedback for another UE implementing an AI-enabled air interface, and both may be accommodated. For example, the non-AI-enabled air interface may utilize measurement requests that configure multiple measurements, whereas the AI-enabled air interface may utilize one-shot measurement requests.

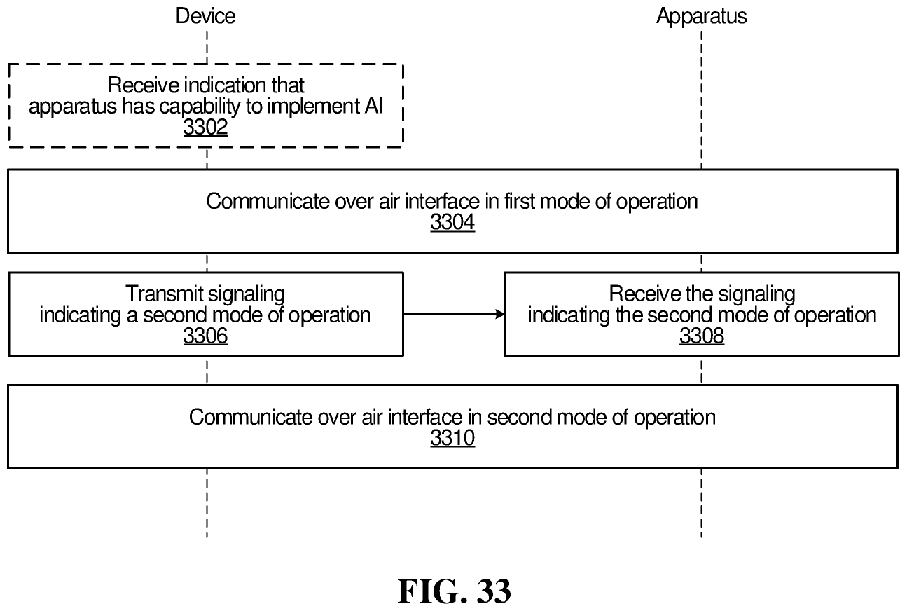

FIG. 33 illustrates a method performed by an apparatus and a device, according to one embodiment. The apparatus may be an ED 110, e.g. a UE, although not necessarily. The device may be a network device, e.g. a TRP or network device 2552, although not necessarily.

Optionally, at step 3302, the device receives, e.g. from the apparatus, an indication that the apparatus has a capability to implement AI in relation to an air interface. Step 3302 is optional because in some embodiments the AI capability of the apparatus might already be known in advance of the method. If step 3302 is implemented, the indication may be in a capability report, e.g. like described earlier in relation to step 3102 of FIG. 31A.

At step 3304, the apparatus and device communicate over an air interface in a first mode of operation. At step 3306, the device transmits, to the apparatus, signaling indicating a second mode of operation that is different from the first mode of operation. At step 3308, the apparatus receives the signaling indicating the second mode of operation. At step 3310, the apparatus and device subsequently communicate over the air interface in the second mode of operation.

In one example, the first mode of operation is implemented using AI and the second mode of operation is not implemented using AI. In another example, the first mode of operation is not implemented using AI and the second mode of operation is implemented using AI. In either case, in the method of FIG. 33 there is a switch between a mode having AI implementation and a mode not having AI implementation. In another example, the first and second modes both implement AI, but possibly different levels of AI implementation (e.g., one mode might be AI mode 1 described at least earlier herein, and the other mode might be AI mode 2 described at least earlier herein).

By performing the method of FIG. 33, the device (e.g., network device) has the ability to control the switching of modes of operation for the air interface, possibly on a UE-specific basis. More flexibility is thereby provided in some embodiments. For example, depending upon the scenario encountered for an apparatus, that apparatus may be configured to implement AI, possibly implement different types of AI, and fall back to a non-AI conventional mode in relation to communicating over an air interface. Specific example scenarios are discussed above in relation to FIGS. 31A and 31B. Any of the examples explained in relation to FIGS. 31A and 31B, and/or elsewhere herein, may be incorporated into the method of FIG. 33.

In some embodiments, the apparatus is configured to operate in the first mode based on the apparatus's AI capability and/or based on receiving an indication of the first mode.

In some embodiments, the signaling indicating the second mode and/or signaling indicating the first mode comprises at least one of: one stage DCI; two stage DCI; RRC signaling; or a MAC CE.

Some embodiments are now set forth from the perspective of the apparatus.

In some embodiments, the method of FIG. 33 may include receiving first stage DCI, decoding the first stage DCI to obtain scheduling information for second stage DCI, and receiving the second stage DCI based on the scheduling information. Two stage DCI may allow for flexibility in the size, content and/or format of the control information transmitted, e.g. by having the flexibility in the second stage DCI, thereby accommodating the different types, contents, and sizes of control information that may need to be transmitted for different AI and non-AI implementations.

Examples of two stage DCI are described at least earlier herein, and any of the examples described herein may be implemented in relation to FIG. 33. For example, in some embodiments, the second stage DCI may carry control information relating to the first mode of operation or the second mode of operation. In some embodiments, the first stage DCI and/or the second stage DCI may include an indication of whether the second stage DCI carries control information relating to the first mode of operation or the second mode of operation.

In some embodiments, prior to receiving the signaling in step 3308, the method of FIG. 33 includes transmitting a message requesting a mode of operation different from the first mode, and receiving the signaling is in response to the message. In this way, the apparatus may initiate a mode change, rather than having to rely on the device, which may provide more flexibility. On the other hand, in some embodiments, the transmission of the signaling is triggered by the device (e.g., a network device) without an explicit message from the apparatus requesting a mode of operation different from the first mode.

In some embodiments, transmission of the signaling in step 3306 is in response to at least one of: entering or leaving a training or retraining mode; power consumption falling within a particular range; network load falling within a particular range; a key performance indicator (KPI) falling within a particular range; channel quality falling within a particular range; or a change in service and/or traffic type for the apparatus.

In some embodiments, the method of FIG. 33 may include the apparatus receiving additional signaling indicating a third mode of operation, where the third mode of operation is implemented using AI. In response to receiving the additional signaling, the apparatus communicates over the air interface in the third mode of operation. In some embodiments, the apparatus performs learning in the first mode or second mode, but not in the third mode. In other embodiments, the apparatus performs learning in the third mode and not in the first mode or second mode.

In some embodiments, at least one air interface component is implemented using AI in the first mode of operation, and the at least one air interface component is not implemented using AI in the second mode of operation. In other embodiments, at least one air interface component is implemented using AI in the second mode of operation, and the at least one air interface component is not implemented using AI in the first mode of operation. In any case, in some embodiments, the at least one air interface component includes a physical layer component and/or a MAC layer component.

Some embodiments are now set forth from the perspective of the device.

In some embodiments, the apparatus is configured, by the device, to operate in the first mode or the second mode based on the apparatus's AI capability.

In some embodiments, the signaling indicating the second mode and/or signaling indicating the first mode includes at least one of: one stage DCI; two stage DCI; RRC signaling; or a MAC CE.

In some embodiments, the method of FIG. 33 may include the device transmitting first stage DCI that carries scheduling information for second stage DCI, and transmitting the second stage DCI based on the scheduling information. Examples of two stage DCI are described herein, and any of the examples described earlier may be implemented in relation to FIG. 33. For example, in some embodiments, the second stage DCI carries control information relating to the first mode of operation or the second mode of operation. In some embodiments, the first stage DCI and/or the second stage DCI includes an indication of whether the second stage DCI carries control information relating to the first mode of operation or the second mode of operation.

In some embodiments, prior to transmitting the signaling in step 3306, the method of FIG. 33 includes receiving a message from the apparatus, the message requesting a mode of operation different from the first mode. Transmitting the signaling is then in response to the message. In other embodiments, transmission of the signaling in step 3306 is triggered without an explicit message from the apparatus requesting a mode of operation different from the first mode.

In some embodiments, transmission of the signaling in step 3306 is in response to at least one of: entering or leaving a training or retraining mode; power consumption falling within a particular range; network load falling within a particular range; a key performance indicator (KPI) falling within a particular range; channel quality falling within a particular range; or a change in service and/or traffic type for the apparatus.

In some embodiments, the method of FIG. 33 includes: the device transmitting additional signaling indicating a third mode of operation, where the third mode of operation is also implemented using AI; and subsequent to transmitting the additional signaling, communicating over the air interface in the third mode of operation. In some embodiments, the apparatus is to perform learning in the second mode or first mode and not the third mode. In other embodiments, the apparatus is to perform learning in the third mode and not in the first mode or the second mode.

In some embodiments, at least one air interface component is implemented using AI in the first mode of operation, and the at least one air interface component is not implemented using AI in the second mode of operation. In other embodiments, the at least one air interface component is implemented using AI in the second mode of operation, and the at least one air interface component is not implemented using AI in the first mode of operation. In any case, in some embodiments, the at least one air interface component includes a physical layer component and/or a MAC layer component.

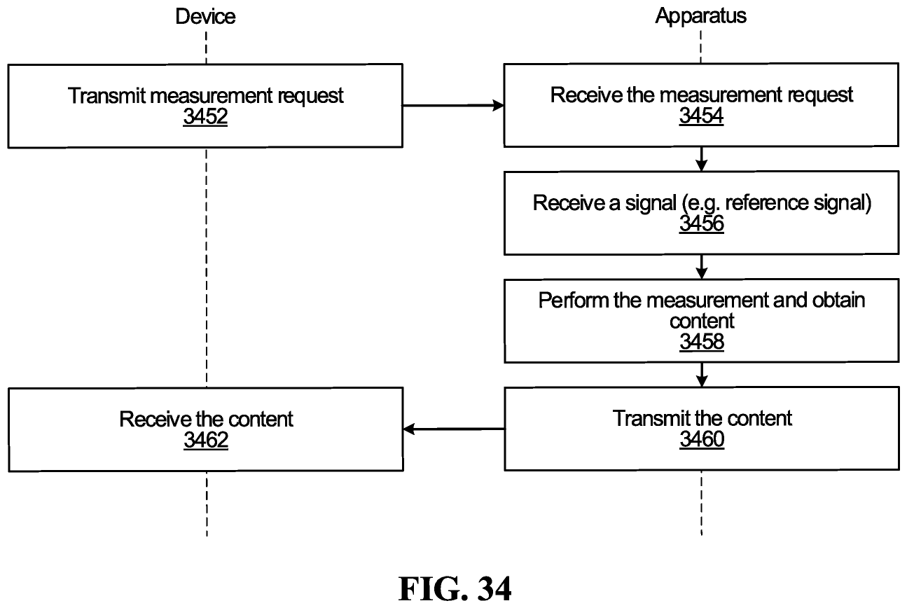

FIG. 34 illustrates a method performed by an apparatus and a device, according to another embodiment. The apparatus may be an ED 110, e.g. a UE, although not necessarily. The device may be a network device, e.g. a TRP or network device 2552, although not necessarily.

At step 3452, the device transmits a measurement request to the apparatus. The measurement request includes an indication of content to be transmitted by the apparatus. The content is to be obtained from a measurement performed by the apparatus.

At step 3454, the apparatus receives the measurement request. At step 3456, the apparatus receives a signal, e.g. from the device. The signal may be, for example, a reference signal. At step 3458, the apparatus performs the measurement using the signal and obtains the content based on the measurement.

At step 3460, the apparatus transmits the content to the device. At step 3462, the device receives the content from the apparatus.

By performing the method of FIG. 34, measurement may be performed on demand, with different apparatuses (e.g., different UEs) possibly being instructed to perform measurements at different times or different intervals, and possibly transmitting back different content. Different modes of operation, including a non-AI mode, non-sensing mode, different AI implementations, and/or different sensing implementations may be accommodated. For example, measurement and feedback for a UE implementing an air interface that is not AI-enabled may be different from measurement and feedback for another UE implementing an AI-enabled air interface, and both may be accommodated via a single unified mechanism.

In some embodiments, the content is different depending upon whether or not the apparatus communicates over an air interface that is implemented using AI. For example, as discussed earlier, an AI-enabled air interface may require different bits of information fed back compared to an air interface operating in a conventional non-AI manner. The AI implementation may possibly require fewer bits to be fed back and/or feedback less often compared to an air interface operating in a conventional non-AI manner. Content of varying sizes and types may be accommodated.

In some embodiments, the measurement request is of a same format regardless of whether the air interface is implemented with or without AI. An example is described in relation to FIG. 32. This may provide a unified mechanism for measurement and feedback for varying AI and non-AI implementations.

More generally, many different examples are explained earlier, e.g. in relation to FIG. 32, and any of those examples may be incorporated into the method of FIG. 34.

For example, in some embodiments, the measurement request indicates the content by indicating one of a plurality of modes. The plurality of modes may include: (i) a first mode for communicating over an air interface that is implemented using AI, and (ii) a second mode for communicating over an air interface that is not implemented using AI. An example of indicating content by indicating one of a plurality of modes is “101—AI mode 2 training” in FIG. 32.

In some embodiments, the measurement request indicates the content by instead or additionally indicating one of a plurality of formats for transmitting feedback. The plurality of formats for transmitting feedback may include: (i) a first format for communicating feedback relating to an air interface that is implemented using AI, and (ii) a second format for communicating feedback relating to an air interface that is not implemented using AI. An example of indicating content by indicating one of a plurality of formats is “011—format 1” in FIG. 32.

In some embodiments, the measurement request may indicate at least one of: a time location at which the content is to be transmitted; a frequency location at which the content is to be transmitted; a format of the content; a size of the content; a modulation scheme for the content; a coding scheme for the content; or a beam direction for transmitting the content. For example, such information may be included as configuration 3210 of FIG. 32. By indicating such information, a feedback channel for transmitting the content may be flexibly configured for the apparatus.

In some embodiments, the transmission of the measurement request is in response to at least one of: channel quality dropping below a threshold; a KPI falling within a particular range; or training occurring or needing to occur in relation to at least one air interface component implemented using AI.

In some embodiments, the measurement request may include: (i) an indication of a time-frequency location at which the signal is to be transmitted to the apparatus; and/or (ii) a configuration of a feedback channel for transmitting the content. In some such embodiments, the measurement request may indicate a plurality of different time-frequency locations, each of which for transmission of a respective different signal of a plurality of signals. The configuration of the feedback channel may include an indication of at least a plurality of different time locations, each of which for transmission of respective content derived from a corresponding different one of the signals. Such information may be in fields 808 and/or 810 of the example of the measurement request in FIG. 32.

In some embodiments, the measurement request may be transmitted in at least one of: DCI, RRC signaling, or a MAC CE.

Examples of an apparatus (e.g., ED or UE) and a device (e.g., TRP or network device) to perform the various methods described herein are also disclosed.

The apparatus may include a memory to store processor-executable instructions, and a processor to execute the processor-executable instructions. When the processor executes the processor-executable instructions, the processor may be caused to perform the method steps of the apparatus as described herein, e.g. in relation to FIGS. 33 and/or 34. As one example, the processor may receive signaling indicating a mode of operation (e.g., receive the signaling at the input of the processor), and cause the apparatus to communicate over the air interface in the indicated mode of operation (e.g., the first or second mode). The processor may cause the apparatus to communicate over the air interface in a mode of operation by implementing operations consistent with that mode of operation, e.g. performing necessary measurements and generating content from those measurements, as configured for the mode of operation, implementing the air interface components (possibly using AI), preparing uplink transmissions and processing downlink transmissions, e.g. encoding, decoding, etc., and configuring and/or instructing transmission/reception on an RF chain. In another example, operations of the processor may include receiving (e.g., at the input of the processor) a measurement request, decoding the measurement request to obtain the information in the measurement request, subsequently receiving a signal (e.g., a reference signal) possibly in accordance with the information in the measurement request, performing the measurement using the signal, obtaining content based on the measurement, and causing the apparatus to transmit the content, e.g. by preparing the transmission (e.g., encoding the content, etc.), implementing the air interface components (possibly using AI), and/or instructing transmission on the RF chain.

The device may include a memory to store processor-executable instructions, and a processor to execute the processor-executable instructions. When the processor executes the processor-executable instructions, the processor may be caused perform the method steps of the device as described above, e.g. in relation to FIGS. 33 and/or FIG. 34. As an example, the processor may receive (e.g., at the input of the processor) an indication that an apparatus has a capability to implement AI in relation to an air interface. The processor may cause the device to communicate over the air interface in a mode of operation by implementing operations consistent with that mode of operation, e.g. implementing the air interface components (possibly using AI), configuring an air interface component and/or sending signaling based on information fed back from the apparatus in that mode of operation, processing uplink transmissions and preparing downlink transmissions, e.g. encoding, decoding, etc., and configuring and/or instructing transmission/reception on an RF chain. The processor may output signaling for transmission to the apparatus, where the signaling indicates a different mode of operation (e.g., switching to a second mode of operation). The processor may cause and/or instruct transmission of that signaling, e.g. prepare the transmission by encoding, etc., instruct the RF chain to send the transmission, etc. In another example, the processor may output a measurement request for transmission to the apparatus. The processor may cause and/or instruct transmission of that measurement request, e.g. prepare the transmission by encoding, etc., instruct the RF chain to send the transmission, etc. The processor may receive (e.g., at the input of the processor) the content from the apparatus. The content may be processed by the processor, e.g. decoded to obtain the information of the content.

An AI model may be determined in any of various ways. In some embodiments, an AI model is determined by an AI management and control block, also referred to herein as an AI management module or an AI block, in a RAN node, in a CN, or outside a CN, and indicated by the network to a UE. In such embodiments a UE directly uses the AI model as determined and indicated by the network.

A network-determined AI model may be predefined for a UE. Another possible solution involves download of information associated with an AI model to a UE. For example, a UE may download an AI/ML module/algorithm/parameters (e.g., structures, weights, activation function, etc.)/input and output features from a network. Downloaded information may be or include a one-time AI modeling configuration, with or without future updates such as neural network NN updates. An AI model indication may be UE-specific or group-specific, because UEs may have different AI capabilities in respect of computation, storage, and/or power limitations, for example.

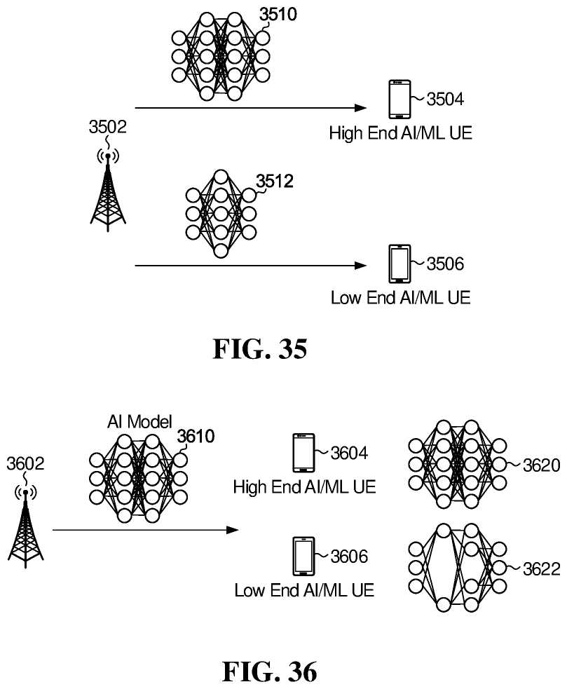

FIG. 35 is a block diagram illustrating AI model determination by a network device and indicating the determined AI model to a UE. In FIG. 35, an AI model determined in a network, by management module or an AI block in a network device 3502 such as a RAN node or a device in a CN or outside a CN for example, is indicated by to a UE 3504, 3506. Individual indications of AI model are illustrated in FIG. 35 at 3510, 3512 for UEs 3504, 3506, respectively, which have different AI capabilities and/or different AI requirements, such as simpler AI model or implementation for UE power saving. A high end AI/ML UE is illustrated at 3504 and a low end AI/ML UE is illustrated at 3506. In this example, the AI model that is indicated to the high end AI/ML UE 3504 is more extensive or complete than the AI model that is indicated to the low end AI/ML UE 3506, because the low end UE 3506 is less AI capable than the high end UE 3504.

FIG. 36 is a block diagram illustrating AI model determination by a network device and indicating the determined AI model to a UE according to another embodiment. Similar to FIG. 35, FIG. 36 illustrates a network device 3602 at which an AI model is determined, and UEs 3604, 3606, which have different AI capabilities, and to which the determined AI model is indicated.

AI model indication is generally represented at 3610 in FIG. 36. In this example the same AI model indication is provided to the UEs 3604, 3606, but to reduce air interface overhead, the network could indicate one or more model compression rules to the UEs. In FIG. 35, the network device 3502 provides indications of two AI models 3510 and 3512 individually to two UEs 3504 and 3506. In FIG. 36, the network device 3602 provides an indication of the same, single AI model 3610 to two UEs 3620 and 3622, and also provides indications of compression rules to the UEs. The indication overhead for compression rules is less than for an AI model indication, and therefore the example in FIG. 36 can save overhead relative to the example in FIG. 35. In addition, for more than two UEs as will often if not always be the case, the overhead reduction is even greater.

Illustrative examples of compression rules include the following:
Pruning rules: for pruning one or more layers, such as hidden layers, from a model for low AI capability UEs;
Quantization rules: to use low-bit quantization for weights/activation function for low AI capability UEs—higher AI capability UEs may restore high-precision values for quantization according to capabilities and/or requirements;
Hierarchical NN rules or hierarchy rules: the network may indicate a base AI model, and one or more AI sub-models. High AI capability UEs may then construct a complex AI model from the base AI model and sub-model(s), and low capability UEs use the base AI model to reduce implementation complexity.

The end result of different AI models for UEs with different capabilities is represented at 3620, 3622 in FIG. 36, with pruning as a compression example. In the example shown, the network device informs or indicates to the UEs 3604, 3606 an AI model and one or more pruning rules (e.g., which NN nodes and/or connections are to be pruned) at 3610. The high end and higher AI/ML capability UE 3604 uses the AI model without pruning as illustrated at 3620, and the low end lower AI/ML capability UE prunes the AI model according to the pruning rules, to generate a less complex pruned AI model as illustrated at 3622.

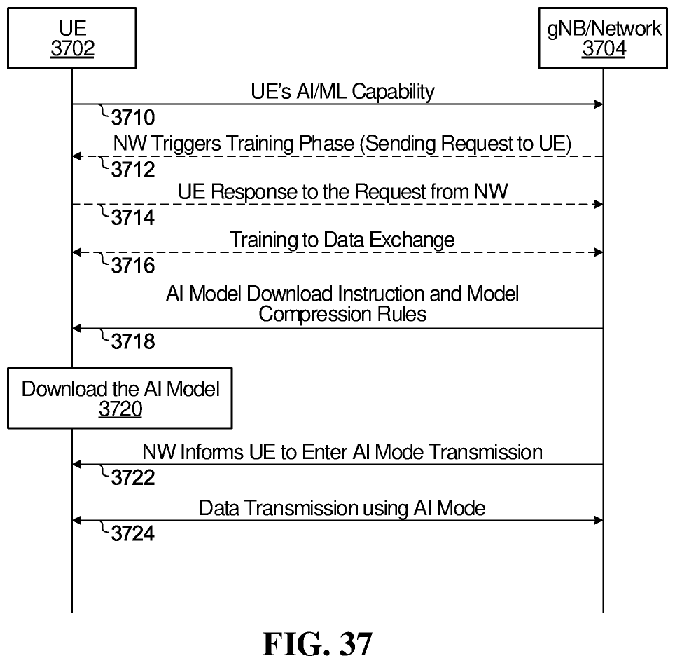

FIG. 37 is a signal flow diagram illustrating a procedure for UE AI model determination by network indication. The procedure illustrated in FIG. 37 is an example, between a UE 3702 and a network device 3704 shown by way of example as a gNB.

The example procedure involves the UE 3702 transmitting to the network device 3704, and the network device receiving, signaling at 3710 that is indicative of an AI/ML capability associated with the UE. AI/ML capability may be indicated by an index or other identifier of a UE feature, UE category, or AI/ML processing capability, for example. UE capability may be indicated in an RRC message carried in PUSCH or uplink control information carried in PUCCH/PUSCH, for example.

The network device 3704 may trigger a training phase, by transmitting to the UE 3702 a request at 3712, which is received by the UE. The UE 3702 may transmit a response to the network device 3704 at 3714, and the network device receives the response. The request at 3712 may be signaled in RRC, MAC CE, or DCI, for example. A start training request may include, for example, the start slots and/or end slots for the training. A response to the request at 3714 may be or include, for example, an ACK or NACK for the request, in PUCCH or PUSCH for example.

Training then proceeds, with exchange of training data at 3716. Training data may include, for example, any one or more of: labeled data, intermediate outputs of an AI module, loss values of AI outputs, AI inputs for a receive side, etc. For uplink, a UE can use PUSCH or PUCCH, for example, to report to a network device. For downlink, a network device can use PDSCH or PDCCH or DL signals, for example, to inform a UE of training data.

When training is complete, the AI model is downloaded to the UE. In the example shown, at 3718 the network device 3704 transmits, and the UE 3702 receives, an AI model download instruction and optionally one or more model compression rules, responsive to which the UE downloads the AI model as shown at 3720. The model download may be from the network device 3704, or from another source such as a model repository in which the AI model is stored. Although not explicitly shown in FIG. 37, any or all model compression rule(s) may be applied by the UE after the model is downloaded at 3720.

The network device 3704 may also inform or instruct the UE 3702 to enter or start AI mode transmission at 3722, by sending an instruction, command, or other information in signaling to the UE for example. A start AI mode instruction, command, or other information at 3722 may be signaled in RRC, MAC CE, or DCI, for example. Data transmission, in either or both directions between the UE 3702 and the network device 3704, is illustrated at 3724.

FIG. 37 is an example, and other embodiments are possible. For example, training may be triggered automatically without a request/response at 3712/3714, or by the UE 3702 instead of by the network device.

Network-side AI model determination is one possible option. Another option involves UE individual AI model determination with network assistance. According to this option, a network device such as a BS may send assistance information, such as a reference AI model, training signals, AI training feedback, distributed learning information, etc., to the UE, and the UE individually determines its AI model.

For example, a BS may send training data (examples of which are provided at least above) to a UE, and/or indicate such information as input/output features and/or a performance metric of the AI model, and the UE trains its AI model. In other embodiments a BS sends a simplified reference AI model, and the UE uses the reference AI model to generate its individual AI model according to its own capabilities and requirements, for example by transfer learning, reinforcement learning, or knowledge distillation. Another possible approach for UE-based AI model determination involves distributed learning, also referred to herein as federated learning (FL).

An AI architecture may involve multiple nodes, where the multiple nodes may possibly be organized in one of two modes, including centralized mode and distributed mode. Both of these modes may be deployed in an access network, a core network, or an edge computing system or third party network. A centralized training and computing architecture is restricted by possibly large communication overhead and strict user data privacy. A distributed training and computing architecture may comprise several frameworks, such as distributed machine learning and federated learning.

Federated learning (FL) enables UEs to collaboratively learn a shared AI model while keeping all the training data at the UE side. For FL in wireless communication, UE selection and scheduling policy for UEs to join FL may be important issues.

Some embodiments provide an innovative scheme for FL. For example, UEs with better/faster learning performance/contribution and/or higher dynamic processing capabilities may be scheduled more often for training result (e.g., gradients) exchange. UEs with poor learning performance/contribution and/or lower dynamic processing capabilities may be scheduled less often, or disabled from online learning, to reduce air interface overhead. Dynamic processing capability in the context of FL refers to current UE capability for FL, including such parameters as UE power and/or baseband and RF processing. For example, if a UE is currently performing sensing and remaining processing capability is limited for FL, then a BS may inform the UE to perform FL less frequently or stop FL.

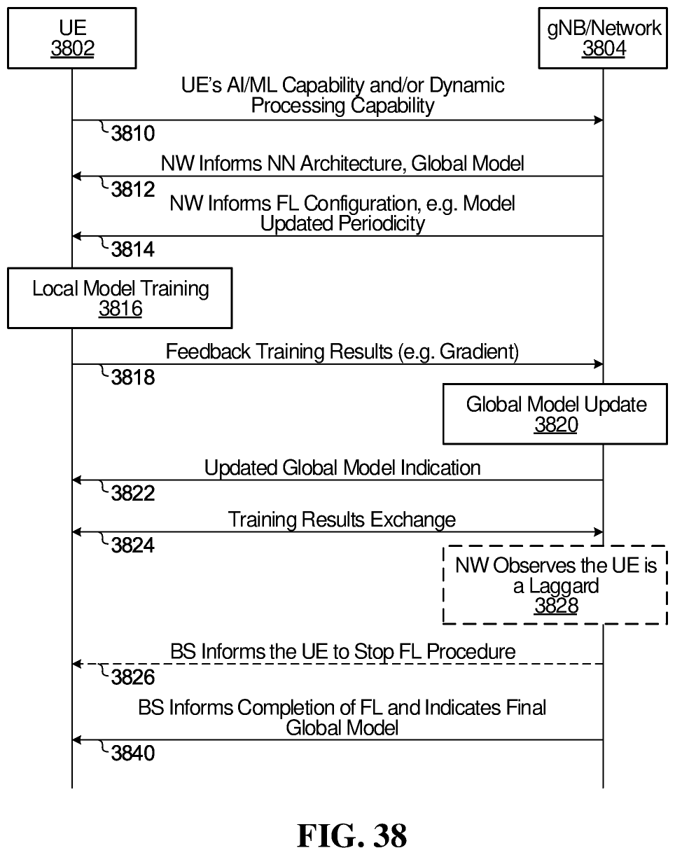

FIG. 38 is a signal flow diagram illustrating a federated learning procedure according to an embodiment. In the example shown, a UE 3802 reports its AI/ML capability and/or dynamic processing capability for AI/ML to a network device 3804, which is shown by way of example as a gNB. The signaling at 3810 that is transmitted by the UE 3802 and received by the network device 3804 may be or include a capability report, for example. Capability reporting in some embodiments relates to current actual capability rather than potential capability in some embodiments. For example, if the UE 3802 is in a power saving mode or performing sensing, then the UE may report low dynamic processing capability for AI/ML.

The network device 3804 selects or otherwise determines, and informs or indicates to the UE 3802 at 3812, a global model (e.g., NN architecture, input and output features of NN, NN algorithms, activation function, loss function), by broadcast, group-cast or unicast signaling.

In the example shown, the network device 3804 also informs the UE 3802 as to FL configuration at 3814, which may include one or more of: feedback configuration, model update periodicity, monitoring occasions for global model indication, etc. Local model training at the UE 3802 is illustrated at 3816.

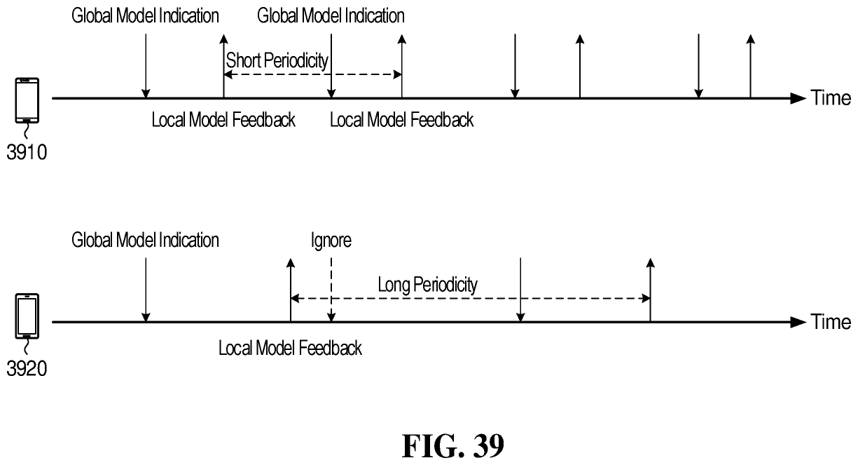

In federated learning, the UE 3802 may feed back training results to the network device 3804 at 3818, the network device 3804 may update the global model at 3820 and broadcast its global model at 3822, and there may be further exchanges of global model indications (e.g., periodically) and/or training results at 3824. FIG. 39 illustrates an example air interface configuration for federated learning for UEs with different capabilities. A UE 3910 with higher capability receives each global model indication (shown by downward arrows) to update its local model, and then reports (shown by upward arrows) its FL training results (e.g., output of a loss function and/or gradient information) to the network device, as illustrated at 3822, 3824 in FIG. 38. For the UE 3920 with lower capability, the network device may indicate to the UE that the UE is to monitor only some of the global model indication signals. In the example shown in FIG. 39 the global model indication shown with a dashed downward arrow is ignored by the UE 3920 and no local model feedback is provided to the network device by the UE in response to that global model indication. In this manner, the lower capability UE 3920 has a longer feedback periodicity for local model feedback than the higher capability UE 3910. An indication to the UE that the UE is to monitor only some of the global model indication signals can also or instead be achieved by configuring monitoring occasions for the global model indication signals. For example, in an embodiment one or more monitoring occasions, one of which is shown by the dashed downward arrow in FIG. 39, might not be configured for the UE 3920.

Returning to FIG. 38, in some embodiments the network device 3804 may monitor local model feedback timing and/or performance contribution to the global model. When the network device 3804 observes or determines at 3828 that the UE 3802 is a laggard, in the sense that the UE is delayed by a certain amount in returning its local model feedback, the network device may inform or indicate to the UE at 3826 that the UE is to stop the FL procedure. In some embodiments, performance contribution may also or instead be considered. If the performance contribution by a UE is small, below a minimum performance contribution threshold for example, then the network device 3804 may stop the UE FL procedure to reduce air interface overhead. Thus, the level of participation of a UE in an FL procedure may change during that procedure.

Either or both of FL configuration based on UE capability and monitoring of local model feedback from UEs may be implemented in embodiments. In this manner, high capability UEs and/or UEs that are more responsive during FL may be scheduled more often to finalize a global AI model faster, and lower capability UEs and/or less responsive UEs may be scheduled less often to reduce air interface overhead.

When the final global model is determined, the network device 3804 indicates completion of FL and the final model to the UE 3802 at 3840, and the UE then uses the final model.

The embodiments discussed with reference to FIGS. 35-39 relate to example AI model determination schemes. Other embodiments for AI model determination are possible.

Similarly, the example procedure related to FL in FIG. 38, and the example intelligent FL scheduling policy to faster finalize the learning procedure and reduce air interface overhead in FIG. 39, are also intended to be illustrative and non-limiting embodiments. Other FL-related embodiments are also possible.

Integrated sensing and AI are discussed by way of example above, with reference to FIG. 24 for example. In some embodiments, sensing information may be used to train and/or update an AI model. For example, sensing-assisted AI may make low-cost and highly accurate beamforming and tracking possible. Sensing could provide high resolution and wide coverage, and generate useful information (such as locations, Doppler, beam directions, and/or images for example) for assisting AI implementation.

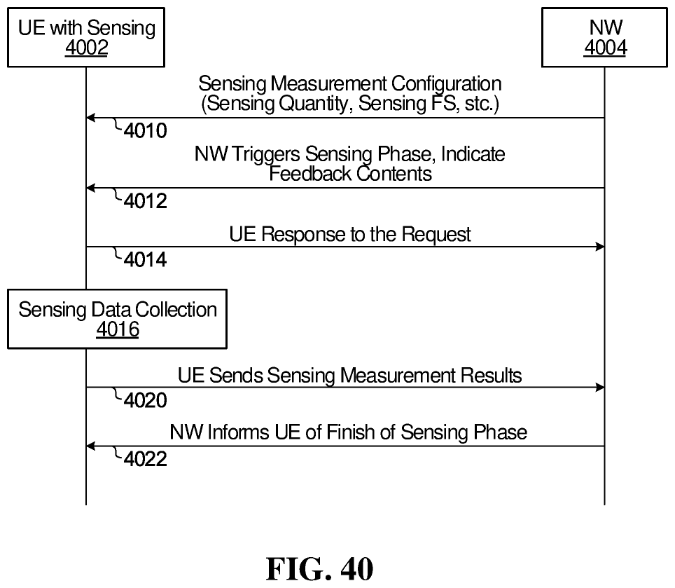

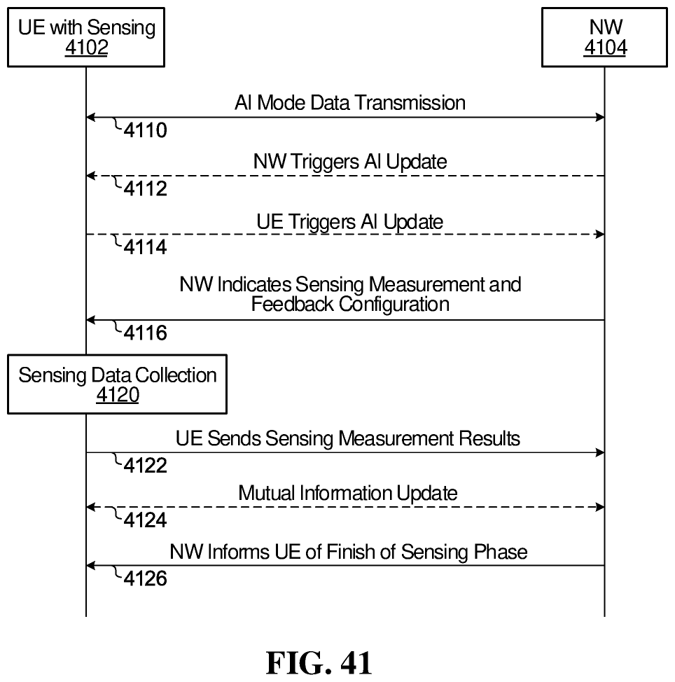

Sensing can be implemented by a network device such as a BS, by a UE, or by both a network device BS and a UE. Examples of air interface procedures for integrated sensing for AI training and update are shown in FIGS. 40 and 41, for a scenario in which a UE is enabled for sensing. Sensing data may include, for example, one or more of: location parameters, object size, object dimensions possibly including 3D dimensions, mobility (e.g., speed, direction), temperature, healthcare information, material type (e.g., wood, bricks, metal, etc.), images, environment data, data from sensors, and/or other sensing data referenced herein or apparent to those skilled in the art.

FIG. 40 is a signal flow diagram illustrating an example procedure for integrated AI/sensing for AI training. Sensing data in this example is for AI training, and may achieve fast and accurate training.

FIG. 40 illustrates a network device (shown as network (NW) 4004) sending, and a UE 4002 with sensing capability receiving, a sensing measurement configuration at 4010, which may include, for example, one or more of: sensing quantity configuration (e.g., specifying a parameter or type of information that is to be sensed), frame structure (FS) configuration (e.g., sensing symbols), sensing periodicity, etc. The illustrated example also includes, at 4012, the network device 4004 triggering a sensing phase and indicating to the UE 4002 feedback contents that are to be fed back to the network device by the UE. In some embodiments, this may involve the network device sending, and the UE 4002 receiving, signaling that includes or indicates a sensing phase command or request and an indication of feedback contents. Based on the request and/or indication received at 4012, the UE 4002 may send a response or confirmation to the network device 4004 at 4014, and collect sensing data at 4016. Sensing measurement results, also referred to herein as sensing data, are transmitted by the UE 4002 and received by the network device 4004 at 4020, in a sensing or measurement report for example. The network device 4004 uses the received sensing data for AI training (not shown), and may transmit to the UE 4002 signaling at 4022 to inform the UE that the sensing phase is finished or completed.

FIG. 40 provides an example for AI training, and FIG. 41 is a signal flow diagram illustrating an example procedure for integrated AI/sensing for AI update. Sensing data in this example is for AI update, to achieve fast and accurate AI update.

In FIG. 41, AI mode data transmission between a sensing-capable UE 4102 and a network device 4104 is shown at 4110. When the network device 4104 (or the UE 4102 in some embodiments) observes or otherwise determines that a current AI model is no longer applicable or appropriate, an AI update is triggered by the network device at 4112 or by the UE at 4114, by transmitting signaling that includes an AI update trigger or request, for example. A sensing measurement and feedback configuration is indicated to the UE 4102 by the network device 4104 at 4116 in the example shown, and sensing data is collected by the UE at 4120 and fed back to the network device at 4122. After the UE 4102 has completed sensing and reports the sensing measurement results to the network device 4104, the network device updates the AI model, as illustrated by a mutual information update 4124 in FIG. 41, and informs UE at 4126 that the sensing phase is finished or completed.

FIGS. 40 and 41 are additional illustrative examples of possible applications of integrated AI/sensing, in AI training and update, respectively. Variations and/or other features disclosed elsewhere herein, with reference to other embodiments for example, may also or instead be applied to either or both of the examples in FIGS. 40 and 41.

Information flows between, to, and/or from different protocol layers through channels in some embodiments. In order to send and/or receive data across an air interface and between different protocol layers, various channels may be used.

Logical channels define what type of information is transferred. Logical channels may be divided into two categories, including control channels and traffic channels. Control channels carry control information and traffic channels carry data, in the user plane for example.

Transport channels define how data is transferred to the physical layer. Data and signaling messages are carried on transport channels between the MAC layer and the physical layer.

Physical channels define where information is sent. A physical channel corresponds to a set of resource elements carrying information originating from higher layers and/or the physical layer.

For an air interface between a network device (such as a BS) and a UE, possible options for AI and sensing-specific channels include the following, for example:
Option 1: Separate AI-dedicated channels and sensing-dedicated channels;
Option 2: Unified channels for AI and sensing.

An AI-dedicated channel can be UE-specific, UE group-common, or cell-specific, for example. That is, an AI-dedicated channel may carry information to a specific UE (UE-specific), a group of UEs (group-common), or UEs within a cell or coverage area (cell-specific).

A sensing-dedicated channel can be UE-specific, UE group-common, or cell-specific, for example. That is, a sensing-dedicated channel may carry information to a specific UE (UE-specific), a group of UEs (group-common), or UEs within a cell or coverage area (cell-specific).

Unified channels may similarly be UE-specific, UE group-common, or cell-specific, for example.

AI information may include one or more of the following, for example: control information for AI training, execution, and/or update; control information for AI data collection; control information for AI-related measurement feedback; output information of AI model for AI training, execution, and/or update; and AI configuration including AI model, input and/or output features, Neural Network structure, Neural Network algorithm and/or Neural Network parameters.

Sensing information may include one or more of the following, for example: control information for sensing (e.g., sensing configuration (e.g., waveform for sensing signals, sensing frame structure), sensing measurement configuration and/or sensing triggering/feedback command(s)); data information for sensing, also referred to herein as sensing data and/or measurement results.

These are illustrative and non-limiting examples of AI information and sensing information. Other examples are provided elsewhere herein and/or may be or become apparent to those skilled in the art.

For AI-dedicated channels under option 1 above, according to one possible scheme or approach that is referred to herein as AI scheme 1, AI information is generated in the physical layer, and carried by a physical channel.

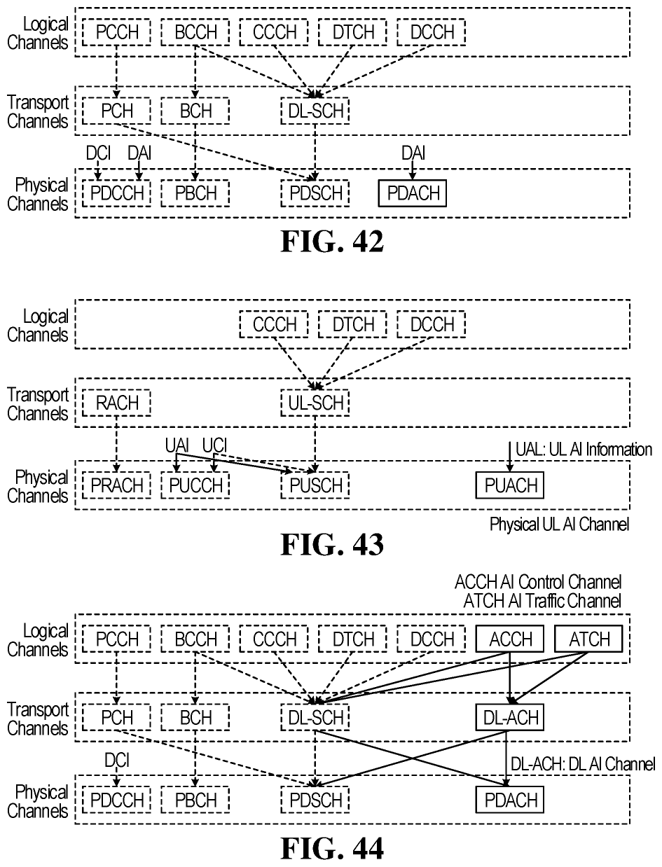

FIG. 42 is a block diagram illustrating a physical layer-based example AI-enabled DL channel or protocol architecture according to an embodiment. FIG. 42 and subsequent similar drawings may also or instead be referred to as illustrating channel mapping according to embodiments. In these drawings, solid lines are used to emphasize components or features that are introduced to provide or support AI-enabled and/or sensing-enabled channel or protocol architectures.

In FIG. 42, logical channels in the RLC layer include the following: PCCH (paging control channel), BCCH (broadcast control channel), CCCH (common control channel), DTCH (dedicated traffic channel), and DCCH (dedicated control channel). Transport channels in the MAC layer include: PCH (paging channel), BCH (broadcast channel), and DL-SCH (Downlink shared channel). Physical channels in the physical layer include: PDCCH (physical downlink control channel), PDSCH (physical downlink shared channel), and PBCH (physical broadcast channel).

PCCH is an example of a channel that is used for paging of devices whose location on a cell level is not known to the network.

BCCH is an example of a channel that is used for transmission of system information from the network to all devices in a cell.

CCCH is an example of a channel that is used for transmission of control information in conjunction with random access.

DTCH is an example of a channel that is used for transmission of user data to/from a device.

DCCH is an example of a channel that is used for transmission of control information to/from a device.

PCH is an example of a channel that is used for transmission of paging information from the PCCH logical channel.

BCH is an example of a channel that is used for transmission of parts of the BCCH system information, e.g. master information block (MIB).

DL-SCH is an example of a channel that is used for transmission of downlink data.

PDCCH is an example of a physical channel that is used for downlink control information.

PBCH is an example of a channel that is used for carrying part of the system information, e.g. MIB.

PDSCH is an example of a physical channel that is used for transmission of paging information, random-access response messages, and parts of system information.

DAI (Downlink AI Information) is carried in a DL physical channel, such as PDCCH and/or an AI-dedicated physical DL channel (Physical DL AI Channel, PDACH) in the example shown, and DAI has no corresponding transport channel or logical channel. PDACH is an example of a physical channel that is used for downlink control information for AI. DCI may also or instead be carried in PDCCH.

FIG. 43 is a block diagram illustrating a physical layer-based example AI-enabled UL channel or protocol architecture according to an embodiment. The example architecture in FIG. 43 includes the following logical channels in the RLC layer: CCCH (common control channel), DTCH (dedicated traffic channel), and DCCH (dedicated control channel); the following transport channels in the MAC layer: RACH (random access channel) and UL-SCH (uplink shared channel); and the following physical channels in the physical layer: PRACH (physical random access channel), PUCCH (physical uplink control channel), and PUSCH (physical uplink shared channel). UAI (Uplink AI Information) is carried in an uplink physical channel, such as PUCCH and/or PUSCH, and also or instead in an AI-dedicated physical UL channel (Physical UL AI Channel, PUACH) in the example shown. UAI has no corresponding transport channel or logical channel in FIG. 43. Uplink control information (UCI) may also or instead be carried in PUCCH and/or PUSCH.

CCCH, DTCH, DCCH are channel examples as described at least above.

RACH is an example of a channel that is used for transmission of random access information.

UL-SCH is an example of an uplink transport channel that is used for transmission of uplink data.

PRACH is an example of a channel that is used for random access to the network, and carries RACH.

PUCCH is an example of a channel that is used by a device to send uplink control information, which may include any one or more of HARQ-ACK, CSI, scheduling request (SR), etc.

PUSCH is an example of a channel that is used for UL data transmission, and/or UL control information.

PUACH is an example of a channel that is used by a device to send UL control information for AI.

According to another possible approach for AI-dedicated channels under option 1 above, referred to herein as AI scheme 2, AI information is generated in or originates from a higher layer (above PHY) and is transferred from that higher layer to the physical layer.

FIG. 44 is a block diagram illustrating a higher layer-based example AI-enabled DL channel or protocol architecture according to an embodiment, in which there are AI-dedicated logical channels, and/or transport channels, and/or physical channels. In the example shown, the RLC layer includes the following AI-dedicated logical channels: ACCH (AI control channel) to carry AI control information and ATCH (AI traffic channel) to carry AI data information.

ACCH is an example of a channel that is used for transmission of control information for AI to a device (in downlink as shown) and/or from a device (in uplink). ATCH is an example of a channel that is used for transmission of user data for AI to a device (in downlink as shown) and/or from a device (in uplink). The other logical channels in FIG. 44 are channel examples as described at least above.

For a mapping between AI logical channels and transport channels, ACCH/ATCH may be mapped to DL-SCH and/or to an AI-dedicated transport channel, such as the DL AI channel (DL-ACH) in the example shown. DL-ACH is an example of a channel that is used for transmission of downlink data for AI. The other transport channels in FIG. 44 are channel examples as described at least above.

For a mapping between AI transport channel(s) and physical channel(s), PDSCH and/or an AI-dedicated physical channel, such as the physical DL AI channel (PDACH) shown, may be used to carry information transferred from DL-SCH and/or DL-ACH transport channel(s). The physical channels in FIG. 44 are channel examples as described at least above.

Other channels shown in FIG. 44 are the same as in FIG. 42, with the exception of DAI carried in PDCCH in FIG. 42 but not in PDCCH in FIG. 44.

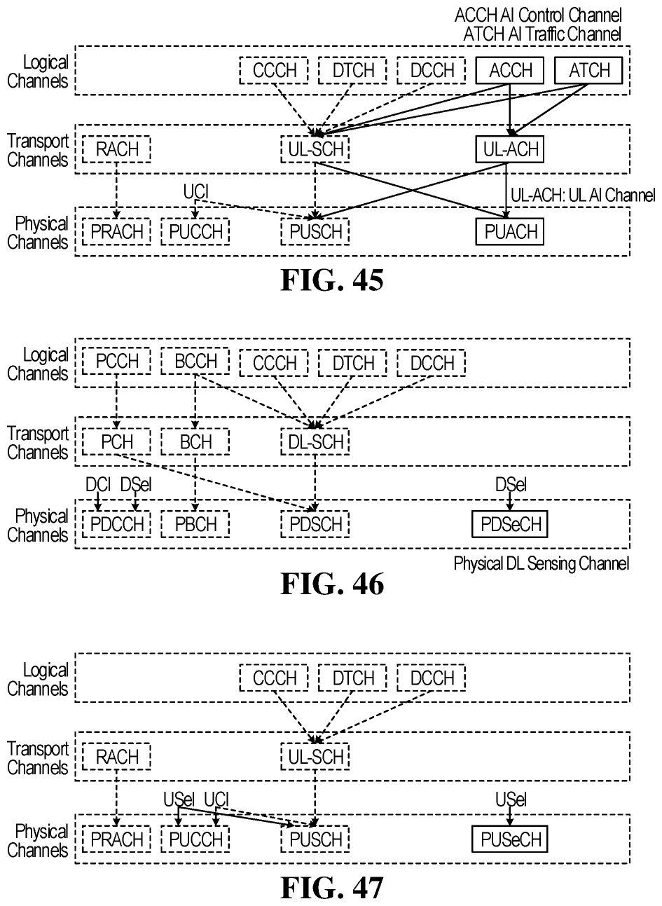

FIG. 45 is a block diagram illustrating a higher layer-based example AI-enabled UL channel or protocol architecture according to an embodiment. In the example shown, AI-dedicated logical channels in the RLC layer include ACCH (AI control channel) to carry AI control information and ATCH (AI traffic channel) to carry AI data information. The logical channels in FIG. 45 are channel examples as described at least above.

For a mapping between AI logical channels and transport channels, ACCH/ATCH can be mapped to UL-SCH and/or to an AI transport channel, such as the UL AI channel (UL-ACH) shown in FIG. 45. UL-ACH is an example of an uplink transport channel that is used for transmission of uplink data for AI. The other logical channels in FIG. 44 are channel examples as described at least above.

For a mapping between AI transport channel(s) and physical channel(s), PUSCH and/or an AI-dedicated physical channel, such as the physical UL AI channel (PUACH) shown in FIG. 45, may be used to carry information transferred from UL-SCH and/or an AI-dedicated transport channel such as UL-ACH. The physical channels in FIG. 44 are channel examples as described at least above.

Other channels shown in FIG. 45 are the same as in FIG. 43, with the exception of UAI carried in PUCCH and PUSCH in FIG. 43 but not in PUCCH and PUSCH in FIG. 45.

Example embodiments for AI-dedicated channels under option 1 above are provided with reference to FIGS. 42 and 43. For sensing-dedicated channels under option 1, according to one possible scheme or approach that is referred to herein as sensing scheme 1, sensing information is generated in the physical layer, and carried by a physical channel.

FIG. 46 is a block diagram illustrating a physical layer-based example sensing-enabled DL channel or protocol architecture according to an embodiment. In FIG. 46, the logical channels in the RLC layer, the transport channels in the MAC layer, and the physical channels in the physical layer are substantially as shown in FIG. 42, with the exception that in FIG. 46, DSeI (Downlink Sensing Information) is carried in a DL physical channel, such as PDCCH and/or a sensing-dedicated physical DL channel (Physical DL Sensing Channel, PDSeCH). DSeI has no corresponding transport channel or logical channel in FIG. 46.

PDSeCH is an example of a channel that is used for downlink control information for sensing. The other channels in FIG. 46 are channel examples as described at least above.

FIG. 47 is a block diagram illustrating a physical layer-based example sensing-enabled UL channel or protocol architecture according to an embodiment. The logical channels in the RLC layer, the transport channels in the MAC layer, and the physical channels in the physical layer in FIG. 47 are substantially as shown in FIG. 43, with the exception that USeI (Uplink sensing Information) is carried in an uplink physical channel, such as PUCCH and/or PUSCH, and also or instead in a sensing-dedicated physical UL channel (Physical UL sensing Channel, PUSeCH) in FIG. 47. USeI has no corresponding transport channel or logical channel in FIG. 47.

PUSeCH is an example of a channel that is used to send uplink control information for sensing. The other channels in FIG. 47 are channel examples as described at least above.

In another possible approach for sensing-dedicated channels under option 1 above, referred to herein as sensing scheme 2, sensing information is generated in or originates from a higher layer (above PHY) and is transferred from that higher layer to the physical layer.

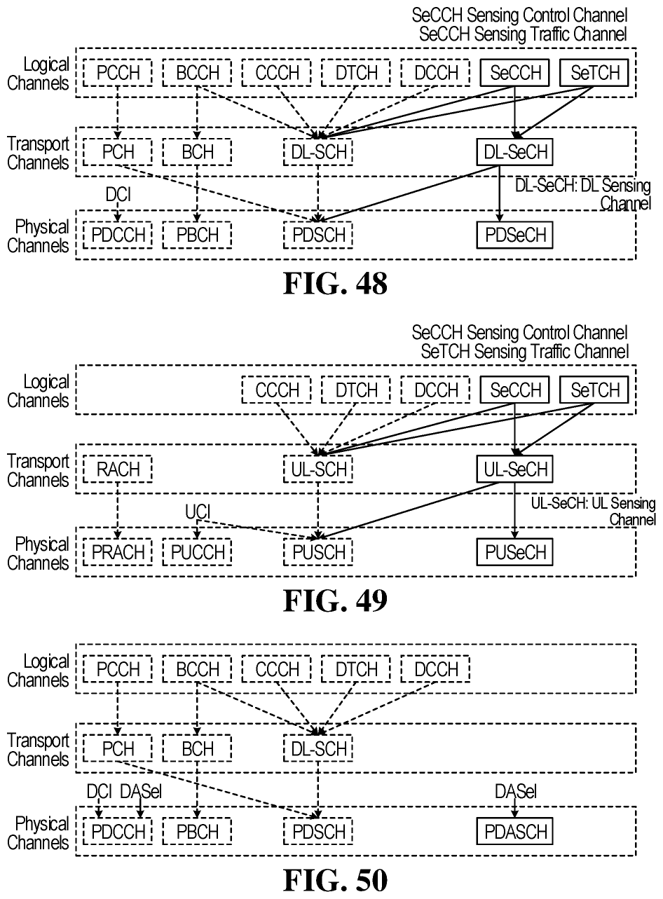

FIG. 48 is a block diagram illustrating a higher layer-based example sensing-enabled DL channel or protocol architecture according to an embodiment, in which there are sensing-dedicated logical channels, and/or transport channels, and/or physical channels. In the example shown, the RLC layer includes the following sensing-dedicated logical channels: SeCCH (sensing control channel) to carry sensing control information and SeTCH (sensing traffic channel) to carry sensing data information.

SeCCH is an example of a transport channel that is used for transmission of control information for sensing to a device (in downlink as shown) and/or from a device (in uplink). SeTCH is an example of a channel that is used for transmission of user data for sensing to a device (in downlink as shown) and/or from a device (in uplink). The other logical channels in FIG. 48 are channel examples as described at least above.

For a mapping between sensing logical channels and transport channels, SeCCH/SeTCH may be mapped to DL-SCH and/or to a sensing-dedicated transport channel, such as the DL sensing channel (DL-SeCH) in the example shown. DL-SeCH is an example of a channel that is used for transmission of downlink data for sensing. The other transport channels in FIG. 48 are channel examples as described at least above.

For a mapping between sensing transport channel(s) and physical channel(s), PDSCH and/or a sensing-dedicated physical channel, such as the physical DL sensing channel (PDSeCH) shown, may be used to carry information transferred from DL-SCH and/or DL-SeCH transport channel(s). The physical channels in FIG. 48 are channel examples as described at least above.

Other channels shown in FIG. 48 are the same as in FIG. 46, with the exception of DSeI carried in PDCCH in FIG. 46 but not in PDCCH in FIG. 48.

FIG. 49 is a block diagram illustrating a higher layer-based example sensing-enabled UL channel or protocol architecture according to an embodiment. In the example shown, sensing-dedicated logical channels in the RLC layer include SeCCH (sensing control channel) to carry sensing control information and SeTCH (sensing traffic channel) to carry sensing data information. The logical channels in FIG. 49 are channel examples as described at least above.

For a mapping between sensing logical channels and transport channels, SeCCH/SeTCH can be mapped to UL-SCH and/or to a sensing transport channel, such as the UL sensing channel (UL-SeCH) shown in FIG. 49. UL-SeCH is an example of an uplink transport channel used for transmission of uplink data for sensing. The other transport channels in FIG. 49 are channel examples as described at least above.

For a mapping between sensing transport channel(s) and physical channel(s), PUSCH and/or a sensing-dedicated physical channel, such as the physical UL sensing channel (PUSeCH) shown in FIG. 49, may be used to carry information transferred from UL-SCH and/or a sensing-dedicated transport channel such as UL-SeCH. The physical channels in FIG. 49 are channel examples as described at least above.

Other channels shown in FIG. 49 are the same as in FIG. 47, with the exception of USeI carried in PUCCH and PUSCH in FIG. 47 but not in PUCCH and PUSCH in FIG. 45.

Option 2 above refers to unified channels for AI and sensing. Several example approaches or schemes under option 1 are provided at least above, and similarly any of several possible approaches may be taken to support or implement AI and sensing information carried on the same channels. Illustrative examples are provided at least below.

In a unified scheme 1, AI and sensing information are generated in the physical layer, and carried by a physical channel. FIG. 50 is a block diagram illustrating a physical layer-based example unified AI and sensing-enabled DL channel or protocol architecture according to an embodiment. In FIG. 50, the logical channels in the RLC layer, the transport channels in the MAC layer, and the physical channels in the physical layer are substantially as shown in FIGS. 42 and 46, with the exception that in FIG. 50, DASeI (Downlink AI and Sensing Information) is carried in a DL physical channel, such as PDCCH and/or an AI/sensing-dedicated physical DL channel (Physical DL Sensing Channel, PDASCH). DASeI has no corresponding transport channel or logical channel in FIG. 50.

PDASCH is an example of a channel that is used for downlink control information for AI and sensing. The other channels in FIG. 50 are channel examples as described at least above.

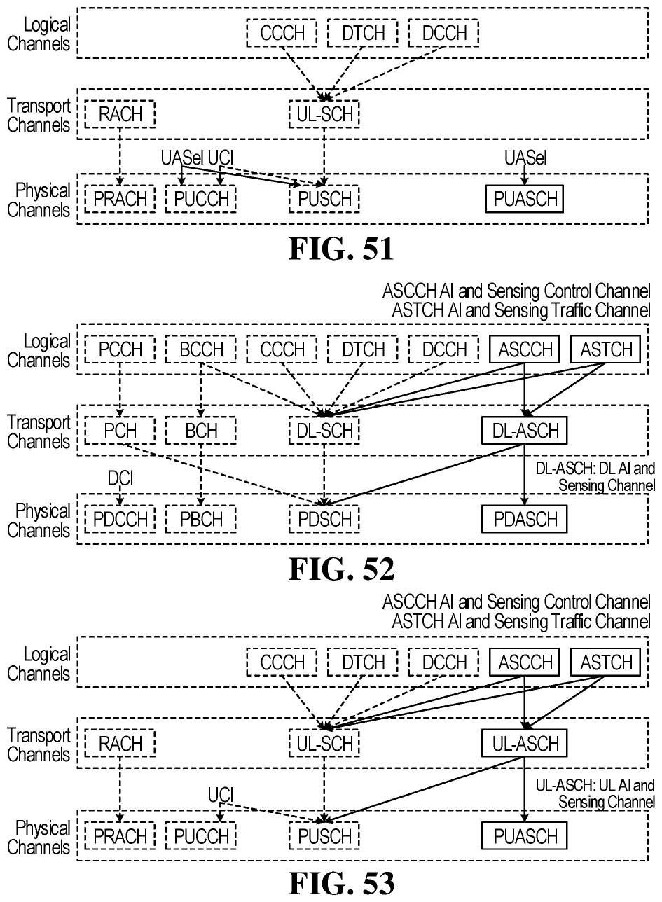

FIG. 51 is a block diagram illustrating a physical layer-based example unified AI and sensing-enabled UL channel or protocol architecture according to an embodiment. The logical channels in the RLC layer, the transport channels in the MAC layer, and the physical channels in the physical layer in FIG. 51 are substantially as shown in FIGS. 43 and 47, with the exception that UASeI (Uplink AI and sensing Information) is carried in an uplink physical channel, such as PUCCH and/or PUSCH, and also or instead in an AI/sensing-dedicated physical UL channel (Physical UL AI and sensing Channel, PUASCH) in FIG. 51. UASeI has no corresponding transport channel or logical channel in FIG. 51.

PUASCH is an example of a channel that is used by a device to send uplink control information for AI and sensing. The other channels in FIG. 51 are channel examples as described at least above.

In another possible approach for sensing-dedicated channels under option 2 above, referred to herein as unified scheme 2, AI and sensing information is generated in or originates from a higher layer (above PHY) and is transferred from that higher layer to the physical layer.

FIG. 52 is a block diagram illustrating a higher layer-based example unified AI and sensing-enabled DL channel or protocol architecture according to an embodiment, in which there are AI/sensing-dedicated logical channels, and/or transport channels, and/or physical channels. In the example shown, the RLC layer includes the following sensing-dedicated logical channels: ASCCH (AI and sensing control channel) to carry AI/sensing control information, and ASTCH (AI and sensing traffic channel) to carry AI/sensing data information.

ASCCH is an example of a channel used for transmission of control information for AI and sensing to a device (in downlink as shown) and/or from a device (in uplink). ASTCH is an example of a channel used for transmission of user data for AI and sensing to a device (in downlink as shown) and/or from a device (in uplink). The other logical channels in FIG. 52 are channel examples as described at least above.

For a mapping between AI/sensing logical channels and transport channels, ASCCH/ASTCH may be mapped to DL-SCH and/or to an AI/sensing-dedicated transport channel, such as the DL AI/sensing channel (DL-ASCH) in the example shown. DL-ASCH is an example of a channel used for transmission of downlink data for AI and sensing to a device. The other transport channels in FIG. 52 are channel examples as described at least above.

For a mapping between sensing transport channel(s) and physical channel(s), PDSCH and/or an AI/sensing-dedicated physical channel, such as the physical DL AI and sensing channel (PDASCH) shown, may be used to carry information transferred from DL-SCH and/or DL-ASCH transport channel(s). The physical channels in FIG. 52 are channel examples as described at least above.

Other channels shown in FIG. 52 are the same as in FIG. 50, with the exception of DASeI carried in PDCCH in FIG. 50 but not in PDCCH in FIG. 52.

FIG. 53 is a block diagram illustrating a higher layer-based example unified AI and sensing-enabled UL channel or protocol architecture according to an embodiment. In the example shown, AI/sensing-dedicated logical channels in the RLC layer include ASCCH (AI and sensing control channel) to carry AI/sensing control information and ASTCH (AI and sensing traffic channel) to carry AI/sensing data information. The logical channels in FIG. 53 are channel examples as described at least above.

For a mapping between AI/sensing logical channels and transport channels, ASCCH/ASTCH can be mapped to UL-SCH and/or to an AI/sensing-dedicated transport channel, such as the UL AI/sensing channel (UL-ASCH) shown in FIG. 53. UL-ASCH is an example of an uplink transport channel used for transmission of uplink data for AI and sensing. The other transport channels in FIG. 53 are channel examples as described at least above.

For a mapping between AI/sensing transport channel(s) and physical channel(s), PUSCH and/or an AI/sensing-dedicated physical channel, such as the physical UL AI and sensing channel (PUASCH) shown in FIG. 53, may be used to carry information transferred from UL-SCH and/or an AI/sensing-dedicated transport channel such as UL-ASCH. The physical channels in FIG. 53 are channel examples as described at least above.

Other channels shown in FIG. 53 are the same as in FIG. 51, with the exception of UASeI carried in PUCCH and PUSCH in FIG. 51 but not in PUCCH and PUSCH in FIG. 53.

Illustrative UL and DL channel examples are provided in FIGS. 42-53. Other embodiments are possible, including AI-enabled, sensing-enabled, or unified AI and sensing-enabled sidelink protocol architectures, for example.

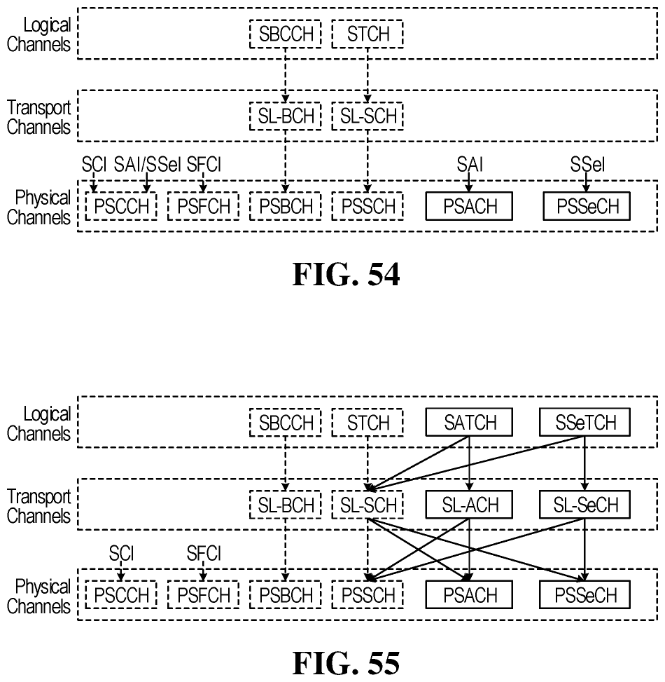

An option 1 for sidelink channel design involves separate logical channel(s), transport channel(s), and/or physical channel(s) for AI and sensing. Within option 1, a sidelink approach or scheme 1 may involve a separate channel for AI and/or a separate channel for sensing, with AI and/or sensing information being generated in the physical layer and carried by a physical channel. FIG. 54 is a block diagram illustrating physical layer-based examples of AI-enabled and sensing-enabled SL channel or protocol architectures according to an embodiment.

In FIG. 54, logical channels include the following: SBCCH (sidelink broadcast control channel) and STCH (sidelink traffic channel); transport channels include: SL-BCH (sidelink broadcast channel) and SL-SCH (sidelink shared channel), and physical channels include: PSCCH (physical sidelink control channel), PSFCH (physical sidelink feedback channel), PSBCH (physical sidelink broadcast channel), and PSSCH (physical sidelink shared channel).

SBCCH is an example of a channel that is used for broadcasting sidelink system information from one UE to other UE(s).

STCH is an example of a channel that is used for transmission of user data to and/or from a device for sidelink.

SL-BCH is an example of a channel that is used for transmission and/or reception sidelink system information.

SL-SCH is an example of a transport channel that is used for transmission and/or reception of UE data for sidelink.

PSCCH is an example of a physical channel that is used for data transmission for sidelink.

PSFCH is an example of a channel that is used for transmission and/or reception of feedback information, e.g. sidelink HARQ feedback.

PSBCH is an example of a channel that is used for transmission and/or reception sidelink system information in the physical layer.

PSSCH is an example of a physical channel that is used for data transmission for sidelink.

FIG. 54 encompasses several embodiments. SAI (Sidelink AI Information) and/or SSeI (Sidelink Sensing Information) may be carried in a sidelink physical channel, such as PSCCH and/or PSSCH. SAI may also or instead be carried in an AI-dedicated physical sidelink channel such as Physical Sidelink AI Channel (PSACH) in the example shown. SSeI may also or instead be carried in a sensing-dedicated physical sidelink channel such as Physical Sidelink Sensing Channel (PSSeCH) in the example shown. PSACH is an example of a physical channel that is used for sidelink control information for AI, and PSSeCH is an example of a physical channel that is used for sidelink control information for sensing. Neither SAI nor SSeI has a corresponding transport channel or logical channel. Thus, the embodiments encompassed by FIG. 54 include any one or more of the following:
SAI carried in PSCCH;
SSeI carried in PSCCH;
SAI carried in PSACH; and
SSeI carried in PSSeCH.

Other embodiments are also possible. For example, although not explicitly shown in FIG. 54, SAI and/or SSeI may be carried in PSSCH.

SAI and/or SSeI do not preclude other types of information being carried by various channels, such as sidelink control information (SCI) in PSCCH and/or sidelink feedback control information (SFCI) in PSFCH in the example shown.

AI-enabled and sensing-enabled channel or protocol architectures are shown separately in other drawings that are described above, for example, but are shown in a single drawing in FIG. 54. The single-drawing representation in FIG. 54 is not intended to indicate or imply that AI-dedicated channels and sensing-dedicated channels must always be implemented together. Embodiments may include either or both of AI-dedicated channels and sensing-dedicated channels.

Another approach within sidelink option 1, which may be referred to as a sidelink approach or scheme 2, may involve separate channels for AI and/or separate channels for sensing, with AI and/or sensing information being generated in or otherwise originating from a higher layer (above PHY) and transferred from that higher layer to the physical layer. FIG. 55 is a block diagram illustrating higher layer-based examples of AI-enabled and sensing-enabled SL channel or protocol architectures according to an embodiment.

In sidelink scheme 2, there are separate AI-dedicated and/or sensing-dedicated logical channels, and/or transport channels, and/or physical channels. FIG. 55 includes SATCH (Sidelink AI traffic channel) and SSeTCH (Sidelink sensing traffic channel) as examples of a separate AI-dedicated logical channel and a separate sensing-dedicated logical channel, respectively, for carrying AI information and sensing information. More generally, SATCH is an example of a channel that is used for transmission of user data for AI to and/or from a device in sidelink, and SSeTCH is an example of a channel that is used for transmission of user data for sensing to and/or from a device in sidelink.

The other logical channels in FIG. 55 are channel examples as described at least above.

For mapping(s) between an AI-dedicated logical channel and one or more transport channels and/or between a sensing-dedicated logical channel and one or more transport channels, SATCH and/or SSeTCH may be mapped to SL-SCH, SATCH may also or instead be mapped to an AI-dedicated transport channel such as sidelink AI channel (SL-ACH) as shown, and SSeTCH may also or instead be mapped to a sensing-dedicated transport channel such as sidelink sensing channel (SL-SeCH) as shown. SL-ACH is an example of a transport channel that is used for transmission and/or reception of UE data for AI in sidelink, and SL-SeCH is an example of a transport channel that is used for transmission and/or reception of UE data for sensing in sidelink. The other transport channels in FIG. 55 are channel examples as described at least above.

It should be noted that FIG. 55 encompasses several embodiments, including any one or more of the following logical/transport channel mappings:
SATCH mapped to SL-SCH;
SATCH mapped to SL-ACH;
SSeTCH mapped to SL-SCH; and
SSeTCH mapped to SL-SeCH.

For mapping(s) between an AI-dedicated transport channel and one or more physical channels and/or between a sensing-dedicated transport channel and one or more physical channels, any of multiple physical channels may be mapped to any of multiple transport channels. This is illustrated by way of example in FIG. 55, in which any of PSSCH, an AI-dedicated physical channel such as physical Sidelink AI channel (PSACH), and a sensing-dedicated physical channel such as physical Sidelink Sensing channel (PSSeCH), may be used to carry information transferred from any of SL-SCH, an AI-dedicated physical channel such as SL-ACH, and/or a sensing-dedicated physical channel such as SL-SeCH.

Other channels shown in FIG. 55 are the same as in FIG. 54, with the exception of SAI/SSeI carried in PSCCH in FIG. 54 but not in PSCCH in FIG. 55.

Higher layer AI-enabled and sensing-enabled channel or protocol architectures are shown separately in other drawings that are described above, for example, but are shown in a single drawing in FIG. 55. As noted above at least for FIG. 54, the single-drawing representation in FIG. 55 is not intended to indicate or imply that AI-dedicated channels and sensing-dedicated channels must always be implemented together. Embodiments may include either or both of AI-dedicated channels and sensing-dedicated channels.

Unified channels for AI and sensing, identified above as option 2 for an air interface between a network device and a UE, may also or instead be applied to sidelink embodiments. One or more of unified logical channel(s), unified transport channel(s), and unified physical channel(s) may be implemented. Similar to sidelink option 1, in sidelink option 2 (unified channel(s)), AI/sensing information may be generated in the physical layer (sidelink unified scheme 1) or a higher layer (sidelink unified scheme 2).

In one example of sidelink unified scheme 1, with reference to FIG. 54 for general architecture, SASeI (sidelink AI and sensing Information), instead of separate AI and sensing information as shown in FIG. 54, may be carried in a sidelink physical channel, such as PSCCH and/or PUSCH, and also or instead in an AI/sensing-dedicated physical sidelink channel (Physical SL AI and sensing Channel, PSASCH) instead of SAI carried in PSACH and SSeI carried in PSSeCH in FIG. 54. UASeI would have no corresponding transport channel or logical channel in sidelink unified scheme 1. PSASCH is an example of a physical channel that is used for data transmission for AI and sensing in sidelink.

Sidelink unified scheme 2 could be implemented in an architecture similar to the example shown in FIG. 55, but with a unified AI/sensing-dedicated logical channel (e.g., sidelink AI and sensing traffic channel, SASTCH), a unified AI/sensing-dedicated transport channel (e.g., sidelink AI and sensing channel, SL-ASCH), and a unified AI/sensing-dedicated physical channel (e.g., physical sidelink AI and sensing channel, PSASCH). SASTCH is an example of a logical channel that is used for transmission of user data to and/or from a device for AI and sensing in sidelink, SL-ASCH is an example of a transport channel that is used for transmission and/or reception of UE data for AI and sensing in sidelink, and PSASCH is an example of a physical channel that is used for data transmission for AI and sensing in sidelink. Any of multiple channel mappings between unified dedicated channels and non-dedicated channels may be possible, as in other embodiments disclosed herein.

FIGS. 42 to 55 are illustrative and non-limiting examples. Other channel and protocol embodiments are possible. For example, these drawings illustrate physical layer embodiments, as well as higher layer embodiments using logical channels at the RLC layer as an example. Other higher layer embodiments may involve transport channels at the MAC layer but not logical channels at the RLC layer, and/or channels and layers above the RLC layer. Mixed-layer embodiments are also possible, in which AI-dedicated and sensing-dedicated channels are implemented at different layers from each other.

Any of various design criteria, targets, or constraints may be considered in channel or protocol design. In an example provided above, uplink transmission for sensing and learning information input from the physical world to the cyber world may require very large data transmission capability with very low latency, and downlink transmission from the cyber world to the physical world as inferencing may be of high reliability without delay. As a result, super-high data rates with low latency constraints may be desirable for UL transmission, and low latency with high reliability may be desirable for DL transmission in such an application.

For example, an uplink sensing and learning channel (USLCH) and/or a sidelink sensing and learning channel may be used to transmit learning and/or sensing information for AI, which may involve quite a large amount of information and with a preference for low latency. USLCH and a sidelink sensing and learning channel are examples of channels that may be used to transmit learning and/or sensing information for AI. Such a channel may be characterized by one or more of the following properties or characteristics:
include one or more (i.e., a combination) of sensing and AI UL (or SL) physical, transport, and/or logical channels, examples of which are provided at least above;
include separate UL (or SL) sensing and AI channels, with each of these separate channels possibly comprising one or more (i.e., a combination) of UL (or SL) physical, transport, and/or logical channels, examples of which are also provided at least above;
include one or more (i.e., a combination) of wireless communication channels such as logical, transport, and/or physical channels, examples of which are also provided at least above;
support grant-based and/or grant-free transmissions;
shared AI and sensing protocol stacks for control and user planes, examples of which are also provided at least above;
separate AI or sensing protocol stacks for control and user planes, examples of which are also provided at least above;
legacy Uu link or SL protocol stacks for control and user planes;
any of multiple waveforms and/or channel coding schemes for its physical channel(s).

A downlink inferencing channel (DIFCH) and/or a sidelink inferencing channel are examples of channels that may be used to transmit AI output and recommendation as inferencing for actions, where the transmission is of high reliability with low latency. Examples disclosed herein with reference to FIGS. 42-55 do not explicitly refer to inferencing, but information associated with inferencing may be communicated in the same or a similar manner as other AI information in those and/or other examples herein. An inferencing channel may be characterized by one or more of the following properties or characteristics:
include one or more (i.e., a combination) of sensing and AI DL (or SL) physical, transport, and/or logical channels, examples of which are provided at least above;
include separate DL (or SL) sensing and AI channels, with each of these separate channels possibly comprising one or more (i.e., a combination) of DL (or SL) physical, transport, and/or logical channels, examples of which are also provided at least above;
include one or more (i.e., a combination) of wireless communication channels such as logical, transport, and/or physical channels, examples of which are also provided at least above;
support grant-based and/or grant-free transmissions;
shared AI and sensing protocol stacks for control and user planes, examples of which are also provided at least above;
separate AI or sensing protocol stacks for control and user planes, examples of which are also provided at least above;
legacy Uu link or SL protocol stacks for control and user planes;
any of multiple waveforms and/or channel coding schemes for its physical channel(s).

USLCH and DIFSCH are additional channel examples that are consistent with the detailed examples and disclosure provided herein, and illustrate that channel or protocol architectures consistent with the present disclosure may be referenced by different names than those specifically referenced herein.

The present disclosure encompasses integrated sensing and communication capabilities. Empowered by AI, network nodes and UEs may cooperate to provide powerful sensing capabilities and make the network aware of its surroundings and situation.

Situation awareness (SA) is an emerging communication paradigm, wherein network equipment makes decisions based on knowledge of such conditions or characteristics as propagation environment, UE traffic patterns, UE mobility behavior, and/or weather conditions. If the network equipment knows the location, orientation, size, and fabric of the main cluster of components interacting with the electromagnetic wave in the environment, it can deduce a more accurate picture of channel conditions, such as beam direction, attenuation and propagation loss, interference level, source, and shadow fading, in order to potentially enhance network capacity and/or robustness. For example, an RF map can be used to perform beam management and/or CSI acquisition with significantly less resources and power than aimless and exhaustive beam sweeping. The following paragraphs consider, by way of example, how sensing can potentially help CSI acquisition and beam management.

Regarding real-time CSI acquisition, a significant challenge for a MIMO framework in future networks is how to provide or support fast and accurate CSI acquisition. Traditional CSI acquisition methods utilized in 4G and 5G, for example, pose overheads on time/frequency resources. The overhead increases further as the number of antennas increases. Using traditional methods, increasing the number of antennas also increases measurement delay and CSI aging. This can be a significant issue, because it can render acquired CSI useless due to excessive aging for example, especially with the presence of narrow beam communication, which is more sensitive to CSI error. Without a smart and real-time CSI acquisition scheme, CSI measurement and feedback may consume all or a majority of time/frequency resources. One solution is to use sensing and positioning techniques to assist in determining the channel sub-space and identifying candidate beams. Such a solution can potentially reduce the beam search space while lowering energy consumption for either or both of user equipment and network equipment. Sensing may also or instead enable real-time tracking and prediction of wireless channels, which may result in lower beam search and CSI acquisition overheads. Moreover, it may be preferable to generalize CSI feedback in future networks to be agnostic to antenna structure by quantizing underlying wireless channels.

Furthermore, it may be desirable for CSI acquisition in future networks to utilize channel characteristics of THz links, as well as available sensory data, in order to potentially be more efficient and less costly. The THz channel is even more sparse than the mmWave channel in angular and temporal domains, while available bandwidth and antenna arrays may further enhance temporal and angular resolutions. As a result, THz angles of arrival (AoAs) are capable of distinguishing and differentiating different paths with fewer measurements than mmWave AoAs, relative to the number of antenna elements. Sensing data may also or instead be used to compensate for the impact of movement and rotation, and/or to predict possible directions of incoming waves. Such prediction is enabled by knowledge of locations and orientations of access points and end UEs, as well as locations of possible reflectors such as walls, ceilings, and furniture.

Proactive UE-centric beam management is another feature that may benefit from sensing. MIMO in future networks may utilize and/or otherwise rely on an increased number of antenna elements for transmission and reception, which makes the air interface predominantly beam-based in future networks. A reliable, agile, proactive and low-overhead beam management system may be preferred to facilitate deployment of MIMO technologies, and a beam management system that follows certain design principles may be particularly useful.

A proactive beam management system detects and predicts beam failure, and subsequently mitigates it. Such a system may also facilitate agile beam recovery while autonomously tracking, refining and adjusting beams. To achieve this proactivity, intelligent and data-driven beam selection may be assisted with sensory and localization data gathered through air interfaces. Other sensors may also or instead be supported by future networks to enable further features, such as handover-free mobility through UE-centric beams for example.

Some embodiments may provide or support controllable radio channels and/or topology. The ability to control a network environment and network topology through strategic deployment of RISs, UAVs, and/or other non-terrestrial and controllable nodes may provide new MIMO features or functions in future networks such as 6G networks. Such controllability is in contrast to a more traditional communication paradigm, in which transmitters and receivers adapt their communication methods in attempts to achieve capacity predicted by information theory for a given wireless channel. Instead, by controlling the environment and network topology, MIMO may potentially be able to change the wireless channel and adapt to network conditions, in order to increase network capacity.

One way to control a network environment is to adapt to the network topology as such parameters as UE distribution and/or traffic pattern change over time. This may involve utilizing HAPSs and UAVs, for example.

RIS-assisted MIMO utilizes RISs to potentially enhance MIMO performance by creating smart radio channels. New system architectures and/or more efficient schemes or algorithms may be useful in extracting the full potential of RIS-assisted MIMO. Compared with traditional beamforming, at both transmit and receiver sides RIS-assisted MIMO may have greater flexibility when realizing beamforming gain. RIS-assisted MIMO may also or instead help to avoid blockage fading between a transmitter and receiver. The link between a TRP and RIS is common for all served UEs in some deployments, and according condition of the link may significantly impact overall performance of RIS-assisted MIMO. It may therefore be desirable to optimize RIS deployment strategy and RIS groups.

Moreover, RIS beamforming gain may rely on CSI acquisition between UEs and networks. Typically, measurement overhead increases with the number of RIS units. The distance between two adjacent RIS units may be relatively short (from one-eighth to half a wavelength), and therefore there may be many RIS units, especially in high-frequency bands, in any given array area. Using traditional CSI acquisition to optimize RIS parameters may cause a very high measurement overhead for single-user RIS-assisted MIMO, and perhaps even more so for multi-user RIS-assisted MIMO. Hybrid CSI acquisition schemes supporting partially active RISs, for example, may be useful in addressing these challenges.

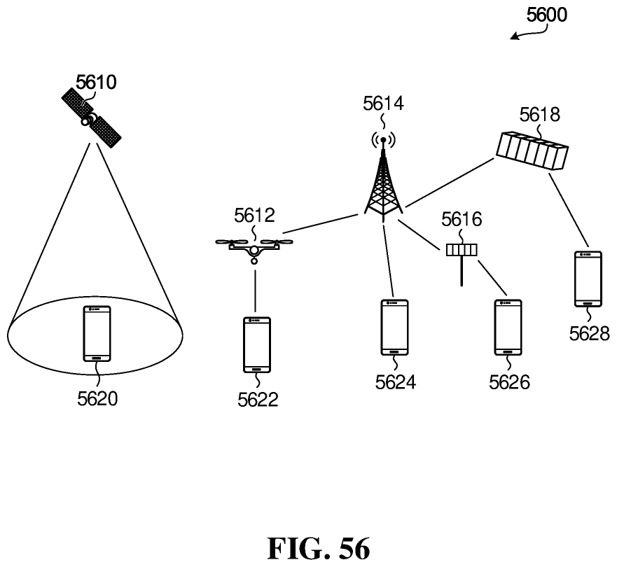

FIG. 56 is a block diagram illustrating another example communication system. The example communication system 5600 includes different types of TRPs, such as terrestrial TRPs (shown by way of example as a gNB 5614 and a relay 5616, but may also or instead include other grounded TRPs) and non-terrestrial TRPs (shown by way of examples as a satellite 5610 and a drone 5612, but may also or instead include other types of non-terrestrial TRPs such as HAPS (High-altitude platform systems), etc.). UEs 5620, 5622, 5624, 5626, 5628 are also shown, and may be of the same type or different types. A RIS is also shown at 5618. A RIS is a controllable surface which is deployed to improve wireless communication channel condition for some UEs.

Examples of terrestrial and non-terrestrial TRPs and examples of UEs are provided elsewhere herein. In FIGS. 2-4, examples of TRPs are shown at 170, 172. The UEs 5620, 5622, 5624, 5626, 5628 in FIG. 56 can be (or be implemented within) an ED 110 as shown by way of example in FIGS. 2-4. Other examples of networks, network devices, and terminals such as UEs are shown in other drawings as well, and features that are disclosed herein as potentially being applicable to the embodiments shown in FIGS. 2-4 and/or other drawings or embodiments may also or instead apply to the embodiment shown in FIG. 56.

The communication system 5600 is an example of a multi-layer massive MIMO system. In such a system, different TRPs and/or different types of TRPs may operate in different frequency ranges, from sub-6G to THz for example. Different TRPs and/or different types of TRPs may apply different beamforming technologies and have different coverage ranges.

To create more favorable radio propagation conditions, a RIS can be applied to extend coverage of one or more TRPs or create more favorable radio propagation conditions for UEs to be served. As disclosed elsewhere herein, flying TRPs such as drones can also or instead be applied to provide on-demand based service to hot spots and provide certain types of UEs (such as moving UEs or vehicles) with better channel conditions. The example system 5600 illustrates both of these options, including a RIS 5618 and a drone 5612.

A RIS and a drone can be considered as moving distributed antennas, which can be flexibly deployed based on current targets and/or requirements.

Ultra-massive MIMO may be deployed or implemented in some embodiments to provide or support various features, such as any one or more of the following:
Multi-layer Beamforming
Antenna array extension
   Active antennas plus passive antennas
   Fixed antennas plus moving antennas
Controlled radio channel
   On-demand based RIS and drone deployment
   Moving distributed antennas
   LoS dominated
Sensing/positioning assisted beam direction acquisition
   Combined with positioning
   CSI-RS and sounding reference signal (SRS)-free
Sensing assisted channel reconstruction
UE specific beam indication without beam sweeping
Powered by AI.

As noted elsewhere herein, in future wireless networks the number of devices could be increased exponentially and provide diverse functionalities, and more new applications and use cases than those associated with 5G may emerge with more diverse quality of service demands.

AI/ML technologies may be applied to communication systems, and various examples are provided herein. Such technologies may be applied to communication in the physical layer and/or to communication in the MAC layer, for example.

For the physical layer, AI/ML technologies may be employed for any of various features or purposes, such as to optimize component design and/or improve algorithm performance. For example, AI/ML technologies may be applied to one or more of: channel coding, channel modelling, channel estimation, channel decoding, modulation, demodulation, MIMO, waveform, multiple access, PHY element parameter optimization and update, beamforming and tracking and sensing and positioning, etc.

For the MAC layer, AI/ML technologies may be utilized in the context of learning, predicting and/or making decisions to solve complicated optimization problems with better strategy and optimal solution. As an example, AI/ML technologies may be utilized to optimize the functionality in MAC for, e.g., intelligent TRP management, intelligent beam management, intelligent channel resource allocation, intelligent power control, intelligent spectrum utilization, intelligent modulation and coding scheme selection, intelligent HARQ strategy, intelligent transmit/receive mode adaptation, etc.

Further terrestrial and non-terrestrial networks can enable a new range of services and applications such as earth monitoring, remote sensing, passive sensing and positioning, navigation, tracking, autonomous delivery and mobility. Terrestrial network-based sensing and non-terrestrial network-based sensing could provide intelligent context-aware networks to enhance UE experience. For example, terrestrial network-based sensing and non-terrestrial network-based sensing may be shown to provide opportunities for localization applications and sensing applications based on new sets of features and service capabilities. Applications such as THz imaging and spectroscopy may have potential to provide continuous, real-time physiological information via dynamic, non-invasive, contactless measurements for future digital health technologies. Simultaneous localization and mapping (SLAM) methods may not only enable advanced cross reality (XR) applications but also or instead enhance the navigation of autonomous objects such as vehicles and/or drones. Further in terrestrial networks and in non-terrestrial networks, measured channel data and sensing and positioning data can be obtained by large bandwidth, new spectrum, dense network and more light-of-sight (LOS) links. Based on these data, a radio environmental map may be drawn using AI/ML methods, where channel information is linked, in the map, to its corresponding positioning, or environmental information, to thereby provide an enhanced physical layer design based on this map.

Integrated sensing and communication capabilities in future networks may enable new features or benefits. For example, as noted elsewhere herein, knowledge of an RF map can be used to perform beam management and/or CSI acquisition, with significantly less resource and power overhead. Purposeful MIMO subspace selection, for example, may help provide or support such benefits by avoiding aimless and exhaustive beam sweeping. Other features such as interference management, interference avoidance, and/or handover may also or instead be provided or supported, by predicting beam failures, shadowing, and/or mobility for example.

The rapid development of sensing technology is expected to provide devices in future networks with detailed awareness of the environment in which the devices are operating. By processing received sensing signals that have echoed off a given ED 110 (FIG. 2) for example, a TRP 170 may determine a location for the given ED 110.

In overview, some aspects of the present application relate to coordinate-based beam indication. On the basis of location information, for a given ED such as a UE, obtained by a network device such as a TRP through the use of sensing signals, the TRP may provide a coordinate-based beam indication to the given UE. A coordinate system for use in such a coordinate-based beam indication may be predefined. In view of the predefined coordinate system, the TRP may broadcast location coordinates of the TRP. The TRP may also or instead use the coordinate system to indicate, to the given UE, a beam direction, e.g., for a physical channel. Some aspects of the present application relate to beam management using an absolute beam indication, while other aspects of the present application relate to a differential beam indication.

Initially, a global coordinate system (GCS) and multiple local coordinate systems (LCSs) may be defined. The GCS may be a global unified geographical coordinate system or a coordinate system comprising of only some TRPs and UEs for example, defined by a RAN. From another perspective, the GCS may be UE-specific or common to a group of UEs. An antenna array for a TRP or a UE can be defined in a Local Coordinate System (LCS). An LCS is used as a reference to define the vector far-field that is pattern and polarization, of each antenna element in an array. The placement of an antenna array within the GCS is defined by the translation between the GCS and an LCS. The orientation of the antenna array with respect to the GCS is defined in general by a sequence of rotations. The sequence of rotations may be represented by the set of angles α, β and γ. The set of angles {α, β, γ} can also be termed as the orientation of the antenna array with respect to the GCS. The angle α is called the bearing angle, β is called the downtilt angle and γ is called the slant angle.

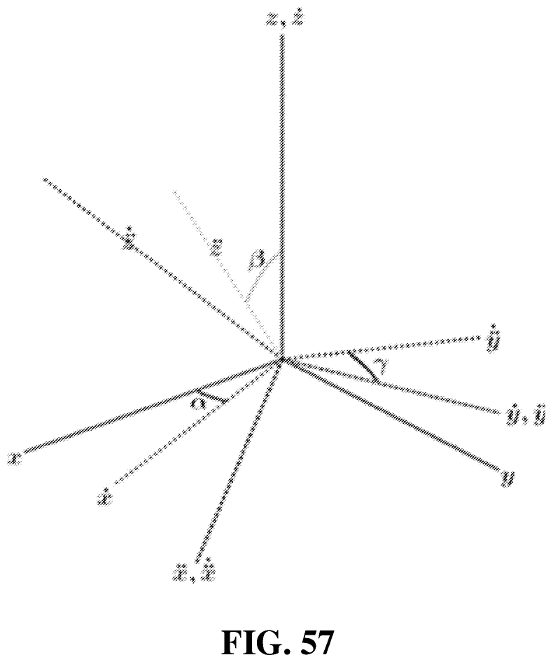

FIG. 57 illustrates the sequence of rotations that relate the GCS and the LCS. In FIG. 57, an arbitrary 3D-rotation of the LCS is contemplated with respect to the GCS given by the set of angles {α, β, γ}. The set of angles {α, β, γ} can also be termed as the orientation of the antenna array with respect to the GCS. Any arbitrary 3-D rotation can be specified by at most three elemental rotations and, following the framework of FIG. 57, a series of rotations about the z, \dot{y} and \ddot{x} axes are assumed here, in that order. The dotted and double-dotted marks indicate that the rotations are intrinsic, which means that they are the result of one (⋅) or two (⋅⋅) intermediate rotations. In other words, the \dot{y} axis is the original y axis after the first rotation about the z axis and the \ddot{x} axis is the original x axis after a first rotation about the z axis and a second rotation about the \dot{y} axis. A first rotation of α about the z axis sets the antenna bearing angle (i.e., the sector pointing direction for a TRP antenna element). The second rotation of β about the \dot{y} axis sets the antenna downtilt angle.

Finally, the third rotation of γ about the \ddot{x} axis sets the antenna slant angle. The orientation of the x, y and z axes after all three rotations can be denoted as [symbol] , [symbol] and [symbol] . These triple-dotted axes represent the final orientation of the LCS and, for notational purposes, may be denoted as the x′, y′ and z′ axes (local or “primed” coordinate system).

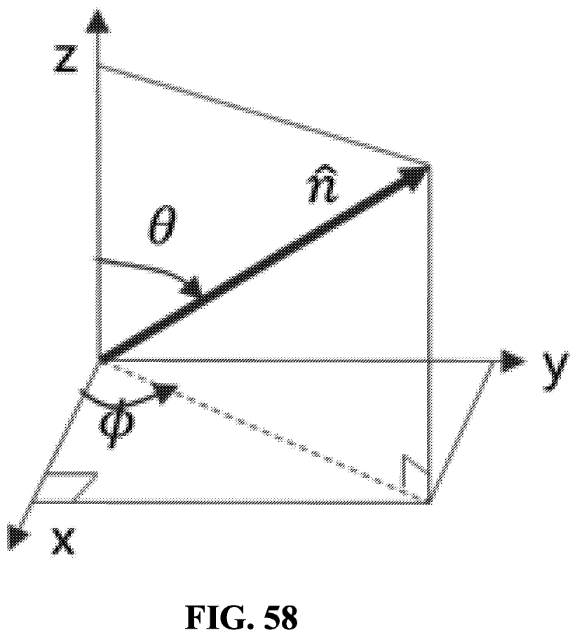

A local coordinate system defined by the x, y and z axes, spherical angles, and spherical unit vectors is illustrated in FIG. 58. The representation in FIG. 58 defines a zenith angle θ and the azimuth angle ϕ in a Cartesian coordinate system. \hat{n} is the given direction and the zenith angle, θ, and the azimuth angle, ϕ, may be used as the relative physical angle of the given direction. Note that θ=0 points to the zenith and ϕ=0 points to the horizon.

A method of converting the spherical angles (θ,ϕ) of the example GCS into the spherical angles (θ′,ϕ′) of the example LCS according to the rotation operation defined by the angles α, β and γ is given by way of example below.

To establish the equations for transformation of the coordinate system between the GCS and the LCS, a composite rotation matrix is determined that describes the transformation of point (x,y,z), in the GCS, into point (x′,y′,z′), in the LCS. This rotation matrix is computed as the product of three elemental rotation matrices. The matrix to describe rotations about the z, \dot{y} and \ddot{x} axes by the angles α, β and γ, respectively and in that order is defined in equation (1), as follows:

$$\begin{matrix}R = {R}_{Z} ( α ) ( {R}_{Y} ( β ) {R}_{X} ( γ ) \\ = ( \begin{matrix}+ cos α & - sin α & 0 \\ + sin α & + cos α & 0 \\ 0 & 0 & 1\end{matrix} ) ( \begin{matrix}+ cos β & 0 & + sin β \\ 0 & 1 & 0 \\ - sin β & 0 & + cos β\end{matrix} ) ( \begin{matrix}1 & 0 & 0 \\ 0 & + cos γ & - sin γ \\ 0 & + sin γ & + cos γ\end{matrix} )\end{matrix} \qquad ( 1 )$$

The reverse transformation is given by the inverse of R. The inverse of R is equal to the transpose of R, since R is orthogonal.

R⁻¹=R_{X}(−γ)R_{Y}(−β)R_{Z}(−α)=R^{T} (2)

The simplified forward and reverse composite rotation matrices are given in equations (3) and (4).

$$\begin{matrix}R = ( \begin{matrix}cos α cos β & cos α sin β sin γ - sin α cos γ & cos α sin β cos γ + sin α sin γ \\ sin α cos β & sin α sin β sin γ + cos α cos γ & sin α sin β cos γ - cos α sin γ \\ - sin γ & cos β sin γ & cos β cos γ\end{matrix} ) & ( 3 ) \\ {R}^{- 1} = ( \begin{matrix}cos α cos β & sin α cos β & - sin β \\ cos α sin β sin γ - sin α cos γ & sin α sin β sin γ + cos α cos γ & cos β sin γ \\ cos α sin β cos γ + sin α sin γ & cos α sin β cos γ - cos α sin γ & cos β cos γ\end{matrix} ) & ( 4 )\end{matrix}$$

These transformations can be used to derive the angular and polarization relationships between the two coordinate systems.

In order to establish the angular relationships, consider a point (x, y, z) on the unit sphere defined by the spherical coordinates (ρ=1, θ, ϕ), where p is the unit radius, θ is the zenith angle measured from the +z-axis and ϕ is the azimuth angle measured from the +x-axis in the x-y plane. The Cartesian representation of that point is given by

$$\hat{ρ} = ( \begin{matrix}x \\ y \\ z\end{matrix} ) = ( \begin{matrix}sin θ cos φ \\ sin θ sin φ \\ cos θ\end{matrix} ) \qquad ( 5 )$$

The zenith angle is computed as arccos(\hat{ρ}·\hat{z}) and the azimuth angle as arg(\hat{x},\hat{p}+jŷ·\hat{ρ}), where \hat{x}, ŷ and \hat{z} are the Cartesian unit vectors. If this point represents a location in the GCS defined by θ and ϕ, the corresponding position in the LCS is given by R⁻¹\hat{ρ}, from which local angles θ′ and ϕ′ can be computed. The results are given in equations (6) and (7)

$$\begin{matrix}\begin{matrix}{θ}^{′} ( α , β , γ ; θ , φ ) = {cos}^{- 1} ( {[ \begin{matrix}0 \\ 0 \\ 1\end{matrix} ]}^{T} {R}^{- 1} \hat{ρ} ) \\ = {cos}^{- 1} ( cos β cos γ cos α + ( sin β cos γ cos ( φ - α ) - sin γ sin ( φ - α ) ) sin θ )\end{matrix} & ( 6 ) \\ \begin{matrix}{ϕ}^{′} ( α , β , γ ; θ , φ ) = arg ( {[ \begin{matrix}1 \\ j \\ 0\end{matrix} ]}^{T} {R}^{- 1} \hat{ρ} ) \\ = arg ( \begin{matrix}( cos β sin θ cos ( φ - α ) - sin β cos θ ) + \\ j ( cos β sin γ cos θ + ( sin β sin γ cos ( φ - α ) + cos γ sin ( φ - α ) ) sin θ )\end{matrix} )\end{matrix} & ( 7 )\end{matrix}$$

A beam link between a TRP and a given UE may be defined using various parameters. In the context of the local coordinate system, having the TRP at the origin, the parameters may be defined to include a relative physical angle and an orientation between the TRP and the given UE. The relative physical angle, or beam direction “ξ,” may be used as one or two of the coordinates for the beam indication. The TRP may use conventional sensing signals to obtain the beam direction, ξ, to associate with the given UE.

If the coordinate system is defined by the x, y and z axes, then the location “(x, y, z),” of the TRP or the UE, may be used as one or two or three of the coordinates for beam indication. The location “(x, y, z)” may be obtained through the use of sensing signals.

The beam direction may contain a value representative of a zenith of an angle of arrival, a value representative of a zenith of an angle of departure, a value representative of an azimuth of an angle of arrival or an azimuth of an angle of departure.

A boresight orientation may be used as one or two of the coordinates for the beam indication. Additionally, a width may be used as one or two of the coordinates for the beam indication.

Location information and orientation information for the TRP may be broadcast to all UEs in communication of the TRP. In particular, the location information for the TRP may be included in the known System Information Block 1 (SIB1). Alternatively, the location information for the TRP may be included as part of a configuration of the given UE.

According to absolute beam indication, when providing a beam indication to the given UE, the TRP may indicate the beam direction, ξ, as defined in the local coordinate system.

In contrast, according to differential beam indication, when providing a beam indication to the given UE, the TRP may indicate the beam direction using differential coordinates, Δξ, relative to a reference beam direction. Of course, this approach relies on both the TRP and the given UE having been configured with the reference beam direction.

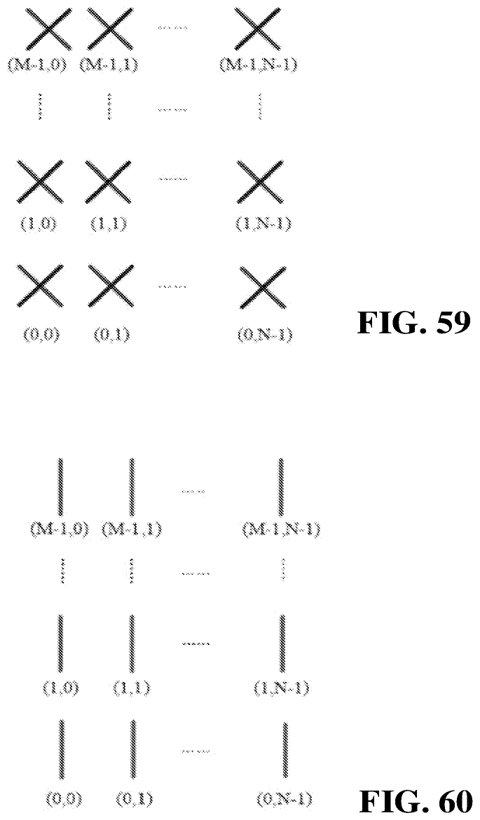

The beam direction could be defined according to predefined spatial grids. FIG. 59 illustrates a two-dimensional planar antenna array structure of a dual polarized antenna. FIG. 60 illustrates a two-dimensional planar antenna array structure of a single polarized antenna. Antenna elements may be placed in vertical and horizontal directions as illustrated in FIGS. 59 and 60, where N is the number of columns and M is the number of antenna elements with the same polarization in each column. The radio channel between a TRP and a UE may be segmented into multiple zones. Alternatively, the physical space between the TRP and the UE may be segmented into 3D zones, wherein multiple spatial zones include the zones in vertical and horizontal directions.

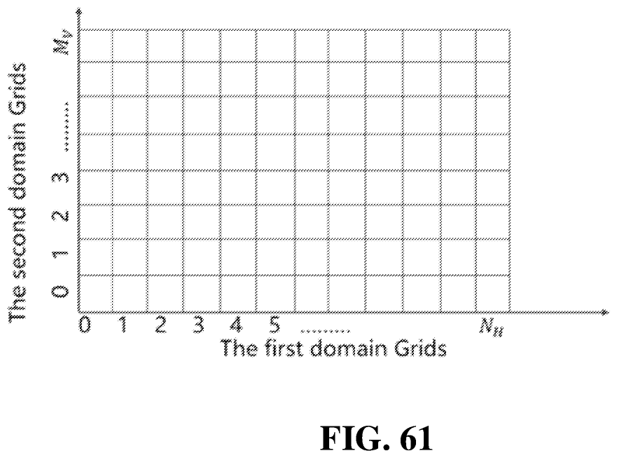

With reference to a grid of spatial zones illustrated in FIG. 61, a beam indication may be an index of a spatial zone, such as the index of the grids for example. Here N_{H} can be same or different as the N of the antenna array, and M_{V} could be same or different as the M of the antenna array. For an X-pol antenna array, the beam direction of the two-polarization antenna array can be indicated independently or by a single indication. Each of the grids is corresponding to a vector in a column and a vector in row, which are generated by a part of the antenna array or the full antenna array. Such beam indication in spatial domain may be indicated by the combination of a spatial domain beam and a frequency domain vector. Further, beam indication may be a one-dimensional index of the spatial zone (X-pol antenna array or Y-pol antenna array). In addition, a beam indication may be the three-dimension index of the spatial zone (X-pol antenna array and Y-pol antenna array and Z-pol antenna array).

Various features and embodiments are described in detail above. Disclosed embodiments include, for example, a method that involves communicating, by a first sensing agent, a first signal with a first UE using a first sensing mode through a first link. Sensing agents are disclosed by way of example elsewhere herein, and SAF is one example of a sensing agent. Examples of sensing modes are also disclosed herein, at least with reference to FIGS. 25 and 31C-D.

Such a method may also involve communicating, by a first AI agent, a second signal with a second UE using a first AI mode through a second link. Regarding an AI agent, the present disclosure provides various examples, including AIEF/AICF in several of the drawings. Examples of AI modes are also disclosed herein, at least with reference to FIGS. 25 and 31A-B.

In an embodiment, the first sensing mode is one of multiple sensing modes, and the first AI mode is one of multiple AI modes. For example, the first UE may support multiple sensing modes and the first sensing mode may then be one of those multiple sensing modes. Similarly, the second UE may support multiple AI modes, and the first AI mode may be one of those multiple AI modes.

Many examples of links are provided herein. An air interface, for example, can enable communication between a sensing agent and a UE and/or between an AI agent and a UE through a link. In the context of the current example method, disclosed link examples include, among others, the first link being one of: a non-sensing-based link such as a conventional Uu link, and a sensing-based link; and the second link being one of: a non-AI-based link such as a conventional Uu link, and an AI-based link.

In some embodiments, the first sensing agent and/or the first AI agent may have some sort of relationship with one or more RAN nodes. For example, the first sensing agent and the first AI agent may be located in RAN node, which may be a TN node or an NTN node. The T-TRPs 170 and NT-TRP 172 in FIGS. 2 to 4, for example, are illustrative of TN and NTN nodes. Other drawings, such as FIG. 6A and other drawings that illustrate example communication networks or systems, include RAN nodes that include AI agents and/or sensing agents. See the RAN nodes 612, 622 in FIG. 6A, for example, which include AI agents 613, 623 and sensing agents 614, 624.

Disclosed RAN implementations or deployments include a first sensing agent located in a first RAN node and a first AI agent located in a second RAN node. Any one of the first RAN node and the second RAN node may be a TN node or an NTN node. As described elsewhere herein, RAN nodes may support AI, sensing, both AI and sensing, or neither AI nor sensing, and therefore a RAN node may include an AI agent, a sensing agent, both, or neither.

In some disclosed embodiments, a RAN node has no built-in AI agent or sensing agent but can connect with an external device that supports AI and/or sensing. Thus, one of the first sensing agent and the first AI agent in the current example method may be located in a RAN node and the other of the first sensing agent and the first AI agent is not located in a RAN node, but the first sensing agent and the first AI agent may connect with each other.

In another external device embodiment, the first sensing agent and the first AI agent are located in one or more external devices that can connect with a RAN node.

The first sensing agent may connect to a first sensing block in a core network through a third link. This is shown by way of example in FIG. 6B, in which a sensing agent SAF 614 communicates with one or more UEs 630, 636, and with a sensing block SensMF 608 in a core network 706 through respective links.

The first sensing agent may also or instead connect to a first sensing block that is outside a core network through a third (or further) link to an external network that is outside the core network. See FIGS. 20, 21, and 23, for example.

The first AI agent may connect to a first AI block in a core network through a fourth link. This is shown by way of example in FIG. 6B, in which an AI agent 613, 623 communicates with one or more UEs 630, 636, and with an AI block 610 in a core network 706 through respective links.

The first AI agent may also or instead connect to a first AI block that is outside a core network through a fourth (or further) link to an external network that is outside the core network. See FIGS. 21 to 23, for example.

Some embodiments may involve configuration and/or signaling between an AI block and a sensing block. For example, the first sensing agent may connect to a first sensing block through a third link and the first AI agent may connect to a first AI block through a fourth link, and a method may involve communicating, by the first AI block, a sensing request with the first sensing block. A sensing request is an example of signaling or an indication of sensing requirements. A method in this type of deployment may also involve communicating, by the first sensing block, a sensing configuration for AI training, based on the sensing request, with the first sensing agent. An example is shown in FIG. 24, with a request and configuration being communicated at 2420, 2422, respectively.

With continued reference to FIG. 24 as an example, in an embodiment in which the first sensing agent connects to a first sensing block through a third link, a method may involve receiving, by the first sensing agent (at the BS 2412 for example) from the first sensing block 2414, a sensing configuration for AI training at 2422. In this context, the first AI agent may connect to a first AI block 2416 through a fourth link, and the sensing configuration is based on a sensing request that is communicated by the first AI block with the first sensing agent 2414 at 2420.

One or both of the first link and the second link may support an uplink channel, such as an uplink sensing and learning channel, to communicate learning and/or sensing information for AI in an application to electronic world and physical world interaction. USLCH is provided herein as an example of such a channel, and other channels may also or instead be used for this purpose.

In some embodiments, the second link supports a downlink channel to communicate information associated with inferencing for AI in an application to electronic world and physical world interaction. DIFCH is provided herein as an example of such a channel, and other channels such as PDSCH may also or instead be used for this purpose.

Many other channel examples are provided herein, such as those shown in FIGS. 42 to 55. In an embodiment, the second link supports one or more AI-dedicated channels to communicate AI information. The one or more AI-dedicated channels may be or include either or both of: one or more physical channels; and one or more higher-layer channels. Similarly, the first link may support one or more sensing-dedicated channels to communicate sensing information. The one or more sensing-dedicated channels may be or include either or both of: one or more physical channels; and one or more higher-layer channels. Unified channels are also possible, and one or both of the first link and the second link may support one or more dedicated channels to communicate AI and sensing information. The one or more dedicated channels may be or include either or both of: one or more physical channels; and one or more higher-layer channels.

One embodiment of communicating the second signal with the second UE in the current method example involves indicating an AI model to the second UE. A method may also involve sending, by the first AI agent to the second UE, one or more model compression rules associated with the AI model. Examples of model compression rules disclosed elsewhere herein include pruning rules, quantization rules, and Hierarchical NN rules or hierarchy rules. FIGS. 35 to 37 provide illustrative and non-limiting examples of indicating AI models and compression rules to a UE.

Communicating the second signal with the second UE may involve sending assistance information to the second UE to enable the second UE to determine an AI model. Assistance information may include, for example, any one or more of a reference AI model, training signals or data, AI training feedback, and distributed learning information. An example is shown at 3812 in FIG. 38.

In some embodiments, shown by way of example at 3812, 3814 in FIG. 38, communicating the second signal with the second UE involves indicating a global model and a federated learning configuration to the second UE, to enable the second UE to train an AI model. The second UE may locally train an AI model. In other embodiments, the second UE may be a cloud UE, and at least some functions may be performed by a cloud server. Cloud and/or cloud server embodiments may also or instead be applicable to other features disclosed herein.

A method may involve receiving, by the first AI agent from the second UE, signaling indicative of a capability of the second UE. An example is shown at 3810 in FIG. 38. A capability may be or include AI capability and/or UE dynamic processing capability, for example. A federated learning configuration that is indicated to the second UE, at 3814 for example, may then be based on the capability of the second UE.

Some embodiments may include receiving, by the first AI agent from the second UE, training results of training of the AI model; and indicating, by the first AI agent, an updated global model to the second UE. These steps are shown by way of example at 3818, 3822 in FIG. 38. The results may, but need not necessarily, be results of local training by the second UE. As shown by way of example at 3826, a method may involve indicating, by the first AI agent to the second UE, that the second UE is to stop sending to the first AI agent, or change how often the second UE is to send to the first AI agent, training results of training of the AI model.

A method may involve indicating, by the first AI agent to the second UE, a global AI model on completion of federated learning to train the global AI model, as shown at 3822 and 3840 in FIG. 38, for example.

As shown by way of example in FIG. 39, a method may involve indicating, by the first AI agent to a third UE, the global model and a further federated learning configuration, to enable the third UE to train a further AI model, and the further federated learning configuration indicated to the third UE may be different from the federated learning configuration indicated to the second UE. Different federated learning configurations for the UEs 3910, 3920 in FIG. 39 are apparent from the different periodicities of UE model feedback by the UEs.

The current example method refers to first and second UEs. The first UE is a same UE as the second UE in some embodiments, in which an AI agent and a sensing agent communicate with the same UE. Other embodiments are also possible. For example, the first UE may be different from the second UE in a scenario in which the UEs are operating in different modes, or only one of the UEs supports or is currently using AI and only one of the UEs supports or is currently using sensing.

Similarly, an AI agent and a sensing agent may be implemented separately or integrated together. For example, the first sensing agent and the first AI agent may be implemented separately using different functions to perform or otherwise provide features or operations of the first sensing agent and the first AI agent, or integrated together using one function to perform or otherwise provide features or operations of the first sensing agent and the first AI agent.

The method example above is illustrative of non-limiting embodiments disclosed herein. Other embodiments are also possible, including apparatus and non-transitory computer readable storage media, for example.

A non-transitory computer readable storage medium, for example, may store programming for execution by one or more processors. Such a storage medium may comprise a computer program product, or be implemented in an apparatus that also includes at least one processor coupled to the storage medium.

Examples of processors 210, 260, 276 and storage media in the form of memory 208, 258, 278 are shown in FIG. 3. Thus, apparatus embodiments may include an ED as shown by way of example at 110 in FIG. 3, a T-TRP as shown by way of example at 170 in FIG. 3, and/or an NT-TRP as shown by way of example at 172 in FIG. 3. In some embodiments, an apparatus may include other components, such as components that enable communications, to which a processor is coupled. Elements such as those shown at 201/203/204, 252/254/256, and/or 272/274/280 in FIG. 3 are examples of other components that may be provided in some embodiments.

These are illustrative examples of apparatus, and other apparatus embodiments are possible. Features disclosed herein may be embodied in any of various means for performing operations or functions. Operational and function descriptions herein provide basis and support for such means, and such means include, but are not limited to, processor-based apparatus embodiments. Units, modules, and/or means for performing operations or functions include processor-based implementations, but also include other implementations as well, which may or may not necessarily involve a processor. Although means-based embodiments are described by way of example below, apparatus features may also or instead be extended to embodiments that involve units or modules.

In an embodiment, programming stored in a computer readable storage medium, whether implemented as a computer program product or in an apparatus, may cause a processor or apparatus to: communicate, by a first sensing agent, a first signal with a first UE using a first sensing mode through a first link; and communicate, by a first AI agent, a second signal with a second UE using a first AI mode through a second link. In a means-based embodiment, an apparatus may include means for communicating the first signal and means for communicating the second signal. The first sensing mode is one of multiple sensing modes, and the first AI mode is one of multiple AI modes. The first link is or includes one of: a non-sensing-based link and a sensing-based link, and the second link is or includes one of: a non-AI-based link and an AI-based link.

Features disclosed elsewhere herein may be implemented in such apparatus embodiments and/or computer program product embodiments. These features include, for example, any of the following, alone or in any of various combinations:
the first sensing agent and the first AI agent are located in a RAN node, and the RAN node is a TN node or an NTN node;
the first sensing agent is located in a first RAN node and the first AI agent is located in a second RAN node, and any one of the first RAN node and the second RAN node is a TN node or an NTN node;
one of the first sensing agent and the first AI agent is located in a RAN node, the other of the first sensing agent and the first AI agent is not located in a RAN node, and the first sensing agent and the first AI agent connect with each other;
the first sensing agent and the first AI agent are located in one or more external devices that can connect with a RAN node;
the first sensing agent connects to a first sensing block in a core network through a third link;
the first sensing agent connects to a first sensing block that is outside a core network through a third interface link to an external network that is outside the core network;
the first AI agent connects to a first AI block in a core network through a fourth link;
the first AI agent connects to a first AI block that is outside a core network through a fourth link to an external network that is outside the core network;
the first sensing agent connects to a first sensing block through a third link and the first AI agent connects to a first AI block through a fourth link, in which case the programming may cause the apparatus or processor to communicate, by the first AI block, a sensing request with the first sensing block; and communicate, by the first sensing block, a sensing configuration for AI training, based on the sensing request, with the first sensing agent—or the apparatus may further include means for communicating, by the first AI block, a sensing request with the first sensing block; and means for communicating, by the first sensing block, a sensing configuration for AI training, based on the sensing request, with the first sensing agent;
the first sensing agent connects to a first sensing block through a third link, in which case the programming may cause the apparatus or processor to receive, by the first sensing agent from the first sensing block, a sensing configuration for AI training—or the apparatus may further include means for receiving, by the first sensing agent from the first sensing block, a sensing configuration for AI training;
the first AI agent connects to a first AI block through a fourth link, wherein the sensing configuration is based on a sensing request that is communicated by the first AI block with the first sensing agent;
one or both of the first link and the second link support an uplink channel to communicate learning and/or sensing information for AI in an application to electronic world and physical world interaction;
the second link supports a downlink channel to communicate information associated with inferencing for AI in an application to electronic world and physical world interaction;
the second link supports one or more AI-dedicated channels to communicate AI information, and the one or more AI-dedicated channels is or includes either or both of: one or more physical channels; and one or more higher-layer channels;
the first link supports one or more sensing-dedicated channels to communicate sensing information, the one or more sensing-dedicated channels is or includes either or both of: one or more physical channels; and one or more higher-layer channels;
one or both of the first link and the second link support one or more dedicated channels to communicate AI and sensing information, the one or more dedicated channels comprising either or both of: one or more physical channels; and one or more higher-layer channels;
the second signal may indicate an AI model to the second UE, and thus communicating the second signal with the second UE may involve indicating an AI model to the second UE;
the programming for execution by the at least one processor may further cause the processor or apparatus to send, by the first AI agent to the second UE, a model compression rule associated with the AI model—or the apparatus may further include means for sending, by the first AI agent to the second UE, a model compression rule associated with the AI model;
the second signal may include assistance information to enable the second UE to determine an AI model, and thus communicating the second signal with the second UE may involve sending assistance information to the second UE to enable the second UE to determine an AI model;
the second signal may indicate a global model and a federated learning configuration to the second UE, to enable the second UE to train an AI model—thus, communicating the second signal with the second UE may involve indicating a global model and a federated learning configuration to the second UE, to enable the second UE to train an AI model;
the programming for execution by the at least one processor may further cause the apparatus or processor to: receive, by the first AI agent from the second UE, signaling indicative of a capability of the second UE—or the apparatus may further include means for receiving, by the first AI agent from the second UE, signaling indicative of a capability of the second UE;
the federated learning configuration is based on the capability of the second UE;
the programming for execution by the at least one processor may further cause the apparatus or processor to: receive, by the first AI agent from the second UE, training results of training of the AI model; and indicate, by the first AI agent, an updated global model to the second UE—or the apparatus may further include means for receiving, by the first AI agent from the second UE, training results of training of the AI model; and means for indicating, by the first AI agent, an updated global model to the second UE;
the programming for execution by the at least one processor may further cause the apparatus or processor to: indicate, by the first AI agent to the second UE, that the second UE is to stop sending to the first AI agent, or change how often the second UE is to send to the first AI agent, training results of training of the AI model—or the apparatus may include means for indicating, by the first AI agent to the second UE, that the second UE is to stop sending to the first AI agent, or change how often the second UE is to send to the first AI agent, training results of training of the AI model;
the programming for execution by the at least one processor may further cause the apparatus or processor to: indicate, by the first AI agent to the second UE, a global AI model on completion of federated learning to train the global AI model—or the apparatus may include means for indicating, by the first AI agent to the second UE, a global AI model on completion of federated learning to train the global AI model;
the programming for execution by the at least one processor may further cause the apparatus or processor to: indicate, by the first AI agent to a third UE, the global model and a further federated learning configuration, to enable the third UE to train a further AI model—or the apparatus may include means for indicating, by the first AI agent to a third UE, the global model and a further federated learning configuration, to enable the third UE to train a further AI model;
the further federated learning configuration indicated to the third UE is different from the federated learning configuration indicated to the second UE;
the first UE is a same UE as the second UE;
the first UE is a different UE from the second UE;
the first sensing agent and first AI agent are integrated together;
the first sensing agent and first AI agent are implemented separately.

Examples of these and other features are disclosed elsewhere herein, at least above with reference to an example method.

Embodiments disclosed herein also encompass a method that involves communicating, by a first sensing agent for a first UE, a first signal with a first node using a first sensing mode through a first link. Sensing agents for UEs are disclosed by way of example elsewhere herein, and SAF is one example of a sensing agent. FIG. 6B, for example, illustrates a sensing agent 634, 637 for each of two UEs 630, 636. Examples of sensing modes are also disclosed herein, at least with reference to FIGS. 25 and 31C-D.

Such a method may also involve communicating, by a first AI agent for the first UE, a second signal with a second node using a first AI mode through a second link. Regarding an AI agent, the present disclosure provides various examples, including AIEF/AICF 633, 643 for UEs 630, 640 in FIG. 6B. Examples of AI modes are also disclosed herein, at least with reference to FIGS. 25 and 31A-B.

A method in the current example may be a UE counterpart of another example method discussed in detail above, and include UE-side counterpart operations or features related to network-side operations or features disclosed herein.

In an embodiment, the first sensing mode is one of multiple sensing modes, and the first AI mode is one of multiple AI modes. For example, the first UE may support multiple sensing modes and the first sensing mode may then be one of those multiple sensing modes. Similarly, the first UE may support multiple AI modes, and the first AI mode may be one of those multiple AI modes.

Many examples of links are provided herein. An air interface, for example, can enable communication between a sensing agent and a UE and/or between an AI agent and a UE through a link. In the context of the current example method, disclosed link examples include, among others, the first link being one of: a non-sensing-based link such as a conventional Uu link, and a sensing-based link; and the second link being one of: a non-AI-based link such as a conventional Uu link, and an AI-based link.

The first UE may connect to a second UE using one or more AI-dedicated sidelink channels to communicate AI information. The one or more AI-dedicated sidelink channels may be or include either or both of: one or more physical channels; and one or more higher-layer channels. The first UE may also or instead connect to a second UE using one or more sensing-dedicated sidelink channels to communicate sensing information. The one or more sensing-dedicated sidelink channels may be or include either or both of: one or more physical channels; and one or more higher-layer channels. According to another possible option, the first UE connects to a second UE using one or more AI/sensing-dedicated sidelink channels, also referred to herein as unified channels, to communicate AI and sensing information, and the one or more AI/sensing-dedicated sidelink channels may be or include either or both of: one or more physical channels; and one or more higher-layer channels. At least these channel options are disclosed by way of example elsewhere herein, with reference to FIGS. 54 to 55 for example.

Any one of the first node and the second node may be a TN node or an NTN node. The T-TRPs 170 and NT-TRP 172 in FIGS. 2 to 4, for example, are illustrative of TN and NTN nodes. Other drawings, such as FIG. 6B and other drawings that illustrate example communication networks or systems, include nodes with which UE-based AI agents and/or sensing agents may communicate. See the RAN nodes 612, 622 in FIG. 6A, for example, which include AI agents 613, 623 and sensing agents 614, 624.

One or both of the first link and the second link may support an uplink channel, such as an uplink sensing and learning channel, to communicate learning and/or sensing information for AI in an application to electronic world and physical world interaction. USLCH is provided herein as an example of such a channel, and other channels may also or instead be used for this purpose.

In some embodiments, the second link supports a downlink channel to communicate information associated with inferencing for AI in an application to electronic world and physical world interaction. DIFCH is provided herein as an example of such a channel, and other channels such as PDSCH may also or instead be used for this purpose.

Sidelink channel examples are referenced above. Many other channel examples are provided herein, such as those shown in FIGS. 42 to 53. In an embodiment, the second link supports one or more AI-dedicated channels to communicate AI information. The one or more AI-dedicated channels may be or include either or both of: one or more physical channels; and one or more higher-layer channels. Similarly, the first link may support one or more sensing-dedicated channels to communicate sensing information. The one or more sensing-dedicated channels may be or include either or both of: one or more physical channels; and one or more higher-layer channels. Unified channels are also possible, and one or both of the first link and the second link may support one or more dedicated channels to communicate AI and sensing information. The one or more dedicated channels may be or include either or both of: one or more physical channels; and one or more higher-layer channels.

One embodiment of communicating the second signal with the second node in the current method example involves receiving signaling indicating an AI model. A method may also involve receiving, by the first AI agent from the second node, one or more model compression rules associated with the AI model. Examples of model compression rules disclosed elsewhere herein include pruning rules, quantization rules, and Hierarchical NN rules or hierarchy rules. FIGS. 35 to 37 provide illustrative and non-limiting examples of indicating AI models and compression rules to a UE.

Communicating the second signal with the second node may involve receiving assistance information from the second node to enable the first UE to determine an AI model. Assistance information may include, for example, any one or more of a reference AI model, training signals or data, AI training feedback, and distributed learning information. An example is shown at 3812 in FIG. 38.

In some embodiments, shown by way of example at 3812, 3814 in FIG. 38, communicating the second signal with the second node involves receiving signaling indicating a global model and a federated learning configuration from the second node, to enable the first UE to train an AI model. The first UE may locally train an AI model. In other embodiments, the first UE may be a cloud UE, and at least some functions may be performed by a cloud server. Cloud and/or cloud server embodiments may also or instead be applicable to other features disclosed herein.

A method may involve sending, by the first AI agent to the second node, signaling indicative of a capability of the first UE. An example is shown at 3810 in FIG. 38. A capability may be or include AI capability and/or UE dynamic processing capability, for example. A federated learning configuration that is indicated to the first UE, at 3814 for example, may then be based on the capability of the first UE.

Some embodiments may include sending, by the first AI agent to the second node, training results of training of the AI model; and receiving, by the first AI agent, an updated global model from the second node. These steps are shown by way of example at 3818, 3822 in FIG. 38. The results may, but need not necessarily, be results of local training by the first UE. As shown by way of example at 3826, a method may involve receiving, by the first AI agent from the second node, signaling indicating that the first UE is to stop sending to the first AI agent, or change how often the first UE is to send, training results of training of the AI model.

A method may involve receiving, by the first AI agent from the second node, a global AI model on completion of federated learning to train the global AI model, as shown at 3822 and 3840 in FIG. 38, for example.

As shown by way of example in FIG. 39, a method may involve indicating, by the first AI agent to another UE, the global model and a further federated learning configuration, to enable the other UE to train a further AI model, and the federated learning configuration indicated to the first UE may be different from the further federated learning configuration indicated to the other UE. Different federated learning configurations for the UEs 3910, 3920 in FIG. 39 are apparent from the different periodicities of UE model feedback by the UEs.

The current example method refers to first and second nodes. The first node is a same node as the second node in some embodiments, in which an AI agent and a sensing agent for a UE communicate with the same node. Other embodiments are also possible. For example, the first node may be different from the second node in a scenario in which the only one of the nodes supports or is currently using AI and only one of the nodes supports or is currently using sensing.

The method example above is illustrative of non-limiting embodiments disclosed herein. Other embodiments are also possible, including apparatus and non-transitory computer readable storage media, for example. Apparatus embodiments may include, for example, processor-based embodiments and/or other embodiments, which may be generally defined in terms of means for performing any of various operations or functions in some embodiments.

According to disclosed embodiments, programming stored in a computer readable storage medium, whether implemented as a computer program product or in an apparatus, may cause a processor or apparatus to: communicate, by a first sensing agent for a first UE, a first signal with a first node using a first sensing mode through a first link; and communicate, by a first AI agent for the first UE, a second signal with a second node using a first AI mode through a second link. In a means-based embodiment, an apparatus may include means for communicating the first signal and means for communicating the second signal. The first sensing mode is one of multiple sensing modes, and the first AI mode is one of multiple AI modes. The first link is or includes one of: a non-sensing-based link and a sensing-based link, and the second link is or includes one of: a non-AI-based link and an AI-based link.

Features disclosed elsewhere herein may be implemented in apparatus embodiments and/or computer program product embodiments. These features include, for example, any of the following, alone or in any of various combinations:
the first UE connects to a second UE using one or more AI-dedicated sidelink channels to communicate AI information, and the one or more AI-dedicated sidelink channels may be or include either or both of: one or more physical channels; and one or more higher-layer channels;
the first UE connects to a second UE using one or more sensing-dedicated sidelink channels to communicate sensing information, and the one or more sensing-dedicated sidelink channels may be or include either or both of: one or more physical channels; and one or more higher-layer channels;
the first UE connects to a second UE using one or more AI/sensing-dedicated sidelink channels to communicate AI and sensing information, and the one or more AI/sensing-dedicated sidelink channels may be or include either or both of: one or more physical channels; and one or more higher-layer channels;
any one of the first node and the second node may be a TN node or an NTN node;
one or both of the first link and the second link support an uplink channel to communicate learning and/or sensing information for AI in an application to electronic world and physical world interaction;
the second link supports a downlink channel to communicate information associated with inferencing for AI in an application to electronic world and physical world interaction;
the second link supports one or more AI-dedicated channels to communicate AI information, and the one or more AI-dedicated channels may be or include either or both of: one or more physical channels; and one or more higher-layer channels;
the first link supports one or more sensing-dedicated channels to communicate sensing information, and the one or more sensing-dedicated channels may be or include either or both of: one or more physical channels; and one or more higher-layer channels;
one or both of the first link and the second link support one or more dedicated channels to communicate AI and sensing information, and the one or more dedicated channels may be or include either or both of: one or more physical channels; and one or more higher-layer channels;
the second signal may indicate an AI model, and thus communicating the second signal with the second node may involve receiving signaling indicating an AI model;
the programming for execution by the at least one processor may further cause the apparatus or processor to receive, by the first AI agent from the second node, a model compression rule associated with the AI model—or the apparatus may further include means for receiving, by the first AI agent from the second node, a model compression rule associated with the AI model;
the second signal may include assistance information to enable the first UE to determine an AI model based on the assistance information, and thus communicating the second signal with the second node may involve receiving assistance information from the second node to enable the first UE to determine an AI model based on the assistance information;
the second signal may indicate a global model and a federated learning configuration to enable the first UE to train an AI model, and thus communicating the second signal with the second node may involve receiving signaling indicating a global model and a federated learning configuration from the second node, to enable the first UE to train an AI model;
the programming for execution by the at least one processor may further cause the apparatus or processor to send, by the first AI agent to the second node, signaling indicative of a capability of the first UE—or the apparatus may further include means for sending, by the first AI agent to the second node, signaling indicative of a capability of the first UE;
the federated learning configuration is based on the capability of the first UE;
the programming for execution by the at least one processor may further cause the apparatus or processor to: send, by the first AI agent to the second node, training results of training of the AI model; and receive, by the first AI agent, an updated global model from the second node—or the apparatus may further include means for sending, by the first AI agent to the second node, training results of training of the AI model; and means for receiving, by the first AI agent, an updated global model from the second node;
the programming for execution by the at least one processor may further cause the apparatus or processor to receive, by the first AI agent from the second node, signaling indicating that the first UE is to stop sending, or change how often the first UE is to send, training results of training of the AI model—or the apparatus may further include means for receiving, by the first AI agent from the second node, signaling indicating that the first UE is to stop sending, or change how often the first UE is to send, training results of training of the AI model;
the programming for execution by the at least one processor may further cause the apparatus or processor to receive, by the first AI agent from the second node, a global AI model on completion of federated learning to train the global AI model—or the apparatus may further include means for receiving, by the first AI agent from the second node, a global AI model on completion of federated learning to train the global AI model;
the federated learning configuration indicated to the first UE is different from a further federated learning configuration indicated to a further UE;
the first node is a same node as the second node;
the first node is a different node from the second node.

Examples of these and other features are disclosed elsewhere herein, at least above with reference to an example method.

Embodiments disclosed herein also encompass, for example, a method that involves sending, by a first AI block, a sensing service request to a first sensing block. A sensing service request, also referenced herein as a sensing request, is an example of signaling or an indication of sensing requirements. An example is shown in FIG. 24, with a sensing service request being sent by an AI block 2416 to a sensing block 2414 at 2420.

A method may also involve obtaining, by the first AI block, sensing data from the first sensing block. In the example shown in FIG. 24, sensing data is collected by the BS 2412 and/or the UE 2410, and obtaining the sensing data by the AI block 2416 from the sensing block 2414 involves the AI block receiving the sensing data from the sensing block as shown at 2442.

Some embodiments may also involve generating, by the first AI block, an AI training configuration or an AI update configuration based on the sensing data. As described at least above with reference to FIG. 23 as an example, an AI block 2310 may need input data, such as data regarding UE and traffic maps in one or more RANs, to complete a request or a task associated with a request. Collecting that input data may involve assistance from sensing, through a sensing service for example. The AI block 2310 may send a request, via the CN 2306 in the example shown in FIG. 23, to the sensing block 2308, for such input data. Sensing activities can then be performed to collect sensing data, and the sensing block 2308 may process the sensing data to determine the information that is needed by the AI block 2310. The AI block 2310 may then identify or determine, based on calculation requirements and the received sensing data for example, one or more AI models to train for computing configurations. The AI block 2310 may produce sets of configurations on, for example, antenna orientation, beam direction, and/or frequency resource allocation.

One or more configurations may therefore be produced by an AI block, and such configuration(s) may also or instead be referred to as being generated by an AI block, based on sensing data. This is an example of how sensing an AI may work together in some embodiments.

A configuration that is produced or generated by an AI block may be referred to as an AI training configuration, or as an AI update configuration in the case of re-training for example. Any of various types of configurations may be produced or generated using AI. For example, an AI training configuration or an AI update configuration may include at least one of the following: an antenna orientation for one or more RAN nodes in one RAN or among multiple RANs; beam direction for one or more RAN nodes in one RAN or among multiple RANs; and frequency resource allocation for one or more RAN nodes in one RAN or among multiple RANs.

Various examples in respect of how an AI block may connect with a sensing block are provided elsewhere herein. In some embodiments, in the context of the current example method for example, the first AI block may connect to the first sensing block via one of the following: a connection (which may be a direct connection or an indirect connection) based on an API that is common to the first AI block and the first sensing block (and possibly also common to one or more other blocks in a core network or an SBA for example); a specific AI-sensing interface; and a wireline or wireless connection interface. As described above with reference to FIG. 19, for example, an AI block 1910 may have a connection interface with a CN 1906, and thus a sensing block 1908, and this connection interface may be wireline or wireless. A wireline CN interface can use an API that is the same as or similar to an API between CN functionalities, for example, and a wireless CN interface may be the same as or similar to a Uu link or interface. The description of FIG. 21 further notes that an AI block 2110 and a sensing block 2108 may have a direct connection, based on an API in a CN 2106 or based on a specific AI-sensing interface. With reference to FIG. 24, the description above also discloses that an AI block 2416 and a sensing block 2414 can communicate with each other, through a common interface such as a CN functionality API or specific AI-sensing interface for example, and the AI-sensing connection can be wireline or wireless.

In some embodiments, the first sensing block and the first AI block are located in a core network, as shown by way of example is several drawings, including FIGS. 6A and 6B.

The first sensing block may be located in a core network that operates with a RAN, and the first AI block may instead be located outside the core network and connect (directly or indirectly) with the RAN via an AI-specific link. See FIG. 19 for one example.

The first AI block may be located in a core network that operates with a RAN, and the first sensing block may instead be located outside the core network and connect (directly or indirectly) with the RAN via an AI-specific link. See FIG. 20 for one example.

In another embodiment, the first AI block and the first sensing block are both located outside a core network that operates with a RAN, and the first AI block and the first sensing block connect (directly or indirectly) with the RAN and a third party network that is outside the core network and the RAN. An example is shown in FIG. 21.

The first sensing block may connect to a first sensing agent through a first interface link, as discussed in detail elsewhere herein.

A method may also involve communicating, by the first sensing block with the first sensing agent, a sensing configuration for collecting sensing data. Examples of such configurations and interactions between a sensing block and a sensing agent are also provided elsewhere herein.

The first link may support one or more sensing-dedicated channels to communicate sensing information, and the one or more sensing-dedicated channels may be or include either or both of: one or more physical channels; and one or more higher-layer channels. Many channel examples are provided, for example in FIGS. 42 to 55.

As in other embodiments, in the current method example the first AI block may connect to a first AI agent through a second link. In embodiments that involve an AI agent, a method may include communicating, by the first AI block to the first AI agent, the AI training configuration or AI update configuration. The second link may support one or more AI-dedicated channels to communicate AI information, and the one or more AI-dedicated channels may be or include either or both of: one or more physical channels; and one or more higher-layer channels, as illustrated by way of example elsewhere herein, such as with reference to FIGS. 42 to 55.

Channel examples that are provided herein also encompass unified channels, also referred to herein as AI/sensing-dedicated channels. The first link and the second link may support one or more dedicated channels to communicate AI and sensing information, and the one or more dedicated channels may be or include either or both of: one or more physical channels; and one or more higher-layer channels.

The method example above is illustrative of non-limiting embodiments disclosed herein. Other embodiments are also possible, including apparatus and non-transitory computer readable storage media, for example. Apparatus embodiments may include, for example, processor-based embodiments and/or other embodiments, which may be generally defined in terms of means for performing any of various operations or functions in some embodiments.

According to disclosed embodiments, programming stored in a computer readable storage medium, whether implemented as a computer program product or in an apparatus, may cause a processor or apparatus to: send, by a first AI block, a sensing service request to a first sensing block; obtain, by the first AI block, sensing data from the first sensing block; and generate, by the first AI block, an AI training configuration or an AI update configuration based on the sensing data. In a means-based embodiment, an apparatus may include means for sending, by a first AI block, a sensing service request to a first sensing block; means for obtaining, by the first AI block, sensing data from the first sensing block; and means for generating, by the first AI block, an AI training configuration or an AI update configuration based on the sensing data.

The first AI block connects with the first sensing block via one of the following: a connection based on an API that is common to the first AI block and the first sensing block; a specific AI-sensing interface; a wireline or wireless connection interface.

Features disclosed elsewhere herein may be implemented in apparatus embodiments and/or computer program product embodiments. These features include, for example, any of the following, alone or in any of various combinations:
the first sensing block and the first AI block are located in a core network;
the first sensing block is located in a core network that operates with a RAN, and the first AI block is located outside the core network and connects with the RAN via an AI-specific link;
the first AI block is located in a core network that operates with a RAN, and the first sensing bock located outside the core network and connects with the RAN via a sensing-specific link;
the first AI block and the first sensing block are both located outside a core network that operates with a RAN, and the first AI block and the first sensing block connect with the RAN and a third party network that is outside the core network and the RAN;
the first sensing block connects to a first sensing agent through a first link;
the programming for execution by the at least one processor may further cause the apparatus or processor to communicate, by the first sensing block with the first sensing agent, a sensing configuration for collecting sensing data—or the apparatus may further include means for communicating, by the first sensing block with the first sensing agent, a sensing configuration for collecting sensing data;
the first link supports one or more sensing-dedicated channels to communicate sensing information, and the one or more sensing-dedicated channels may be or include either or both of: one or more physical channels; and one or more higher-layer channels;
the first AI block connects to a first AI agent through a second link;
the programming for execution by the at least one processor to further cause the apparatus or processor to communicate, by the first AI block to the first AI agent, the AI training configuration or AI update configuration—or the apparatus may further include means for communicating, by the first AI block to the first AI agent, the AI training configuration or AI update configuration;
the second link supports one or more AI-dedicated channels to communicate AI information, and the one or more AI-dedicated channels may be or include either or both of: one or more physical channels; and one or more higher-layer channels;
one or both of the first link and the second link support one or more dedicated channels to communicate AI and sensing information, and the one or more dedicated channels may be or include either or both of: one or more physical channels; and one or more higher-layer channels;
the AI training configuration or AI update configuration includes at least one of the following: antenna orientation for RAN nodes among multiple RANs; beam direction for RAN nodes among multiple RANs; frequency resource allocation for RAN nodes among multiple RANs.

Examples of these and other features are disclosed elsewhere herein, at least above with reference to an example method.

Various aspects of intelligent networking are considered herein.

For example, disclosed embodiments encompass intelligent network architecture, which may support or include features such as any of the following:
AI and sensing operations, including either or both of the following in some embodiments:
   individual AI or sensing,
   integrated AI/sensing and communication;
TN and NTN based RAN functionalities, to support possible third party NTN nodes in some embodiments;
Intelligent air interfacing types, including any of the following in some embodiments:
   AI-based Uu, sensing-based Uu, and conventional Uu,
   AI-based SL, sensing-based SL, and conventional SL.

Disclosed embodiments also encompass air interface operation framework, which may support or include features such as any of the following:
over the air integrated AI and sensing procedures;
AI model configurations, such as any of the following in some embodiments:
   AI model determination by network devices, with or without compression,
   AI model determination cooperatively by network devices and UEs, potentially including approaches such as distillation and/or federated learning;
Framework on AI-specific and/or sensing-specific channels, including any of the following in some embodiments:
   separate AI and sensing channels for Uu and SL,
   unified AI and sensing channels for Uu and SL.

Some embodiments may provide or support mechanisms to enable integrated AI and sensing air interface procedures, including sensing for AI training and AI model update.

AI model configurations may provide or support such features as any of: UE-specific or common AI model indication, model compression to reduce air interface overhead, and intelligent FL procedures, according to which UEs with better or faster learning performance or contribution, and/or higher dynamic processing capability for FL, are scheduled more often for training results (e.g., gradients) exchange.

Frameworks for AI-dedicated (also referred to AI-specific) and/or sensing-dedicated (also referred to as sensing-specific) logical channels, transport channels, and/or physical channels are also disclosed.

What has been described is merely illustrative of the application of principles of embodiments of the present disclosure. Other arrangements and methods can be implemented by those skilled in the art.

For example, although a combination of features is shown in the illustrated embodiments, not all of them need to be combined to realize the benefits of various embodiments of this disclosure. In other words, a system or method designed according to an embodiment of this disclosure will not necessarily include all of the features shown in any one of the drawings or all of the portions schematically shown in the drawings. Moreover, selected features of one example embodiment could be combined with selected features of other example embodiments.

While this disclosure has been described with reference to illustrative embodiments, this description is not intended to be construed in a limiting sense. Various modifications and combinations of the illustrative embodiments, as well as other embodiments of the disclosure, will be apparent to persons skilled in the art upon reference to the description. It is therefore intended that the appended claims encompass any such modifications or embodiments.

Although aspects of the present invention have been described with reference to specific features and embodiments thereof, various modifications and combinations can be made thereto without departing from the invention. The description and drawings are, accordingly, to be regarded simply as an illustration of some embodiments of the invention as defined by the appended claims, and are contemplated to cover any and all modifications, variations, combinations or equivalents that fall within the scope of the present invention. Therefore, although embodiments and potential advantages have been described in detail, various changes, substitutions and alterations can be made herein without departing from the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

In general, features disclosed in the context of any embodiment are not necessarily exclusive to that particular embodiment, and may also or instead be applied to other embodiments. In this disclosure, “a plurality of” means two or more. “and/or” indicates that there may be three relationships. For example, A and/or B may indicate that only A exists, both A and B exist, and only B exists. The character “/” generally indicates that the associated objects are in an or relationship. Terms such as “first”, “second” and the like are used to distinguish similar objects, but do not intend to describe a specific order or sequence.

In addition, although described primarily in the context of methods and apparatus, other implementations are also contemplated, as instructions stored on a non-transitory computer-readable medium, for example. Such media could store programming or instructions to perform any of various methods consistent with the present disclosure.

Moreover, any module, component, or device exemplified herein that executes instructions may include or otherwise have access to a non-transitory computer readable or processor readable storage medium or media for storage of information, such as computer readable or processor readable instructions, data structures, program modules, and/or other data. A non-exhaustive list of examples of non-transitory computer readable or processor readable storage media includes magnetic cassettes, magnetic tape, magnetic disk storage or other magnetic storage devices, optical disks such as compact disc read-only memory (CD-ROM), digital video discs or digital versatile disc (DVDs), Blu-ray Disc™, or other optical storage, volatile and non-volatile, removable and nonremovable media implemented in any method or technology, random-access memory (RAM), read-only memory (ROM), electrically erasable programmable read-only memory (EEPROM), flash memory or other memory technology. Any such non-transitory computer readable or processor readable storage media may be part of a device or accessible or connectable thereto. Any application or module herein described may be implemented using instructions that are readable and executable by a computer or processor may be stored or otherwise held by such non-transitory computer readable or processor readable storage media.

1. A method comprising:
communicating, by a first sensing agent, a first signal with a first user equipment (UE) using a first sensing mode through a first link;
communicating, by a first artificial intelligence (AI) agent, a second signal with a second UE using a first AI mode through a second link,
wherein the first sensing mode comprises one of multiple sensing modes, and the first AI mode comprises one of multiple AI modes;
wherein the first link comprises one of: a non-sensing-based link and a sensing-based link, and the second link comprises one of: a non-AI-based link and an AI-based link.

2. The method of claim 1, wherein the first sensing agent and the first AI agent are located in a radio access network (RAN) node, the RAN node comprising a terrestrial network (TN) node or a non-terrestrial network (NTN) node.

3. The method of claim 1, wherein the first sensing agent is located in a first radio access network (RAN) node and the first AI agent is located in a second RAN node, any one of the first RAN node and the second RAN node comprising a terrestrial network (TN) node or a non-terrestrial network (NTN) node.

4. The method of claim 1, wherein one of the first sensing agent and the first AI agent is located in a radio access network (RAN) node and the other of the first sensing agent and the first AI agent is not located in a RAN node, wherein the first sensing agent and the first AI agent connect with each other.

5. The method of claim 1, wherein the first sensing agent and the first AI agent are located in one or more external devices that can connect with a radio access network (RAN) node.

6. The method of claim 1, wherein the first sensing agent connects to a first sensing block in a core network through a third link.

7. The method of claim 1, wherein the first sensing agent connects to a first sensing block that is outside a core network through a third link to an external network that is outside the core network.

8. An apparatus comprising:
at least one processor;
a non-transitory computer readable storage medium, coupled to the at least one processor, storing programming for execution by the at least one processor, to cause the apparatus to: communicate a first signal with a first user equipment (UE) using a first sensing mode through a first link; and communicate, by a first artificial intelligence (AI) agent, a second signal with a second UE using a first AI mode through a second link,
wherein the first sensing mode comprises one of multiple sensing modes, and the first AI mode comprises one of multiple AI modes;
wherein the first link comprises one of: a non-sensing-based link and a sensing-based link, and the second link comprises one of: a non-AI-based link and an AI-based link.

9. The apparatus of claim 8, wherein the first sensing agent and the first AI agent are located in a radio access network (RAN) node, the RAN node comprising a terrestrial network (TN) node or a non-terrestrial network (NTN) node.

10. The apparatus of claim 8, wherein the first sensing agent is located in a first radio access network (RAN) node and the first AI agent is located in a second RAN node, any one of the first RAN node and the second RAN node comprising a terrestrial network (TN) node or a non-terrestrial network (NTN) node.

11. The apparatus of claim 8, wherein one of the first sensing agent and the first AI agent is located in a radio access network (RAN) node and the other of the first sensing agent and the first AI agent is not located in a RAN node, wherein the first sensing agent and the first AI agent connect with each other.

12. The apparatus of claim 8, wherein the first sensing agent and the first AI agent are located in one or more external devices that can connect with a radio access network (RAN) node.

13. The apparatus claim 8, wherein the first sensing agent connects to a first sensing block in a core network through a third link.

14. The apparatus of claim 8, wherein the first sensing agent connects to a first sensing block that is outside a core network through a third interface link to an external network that is outside the core network.

15. A method comprising:
communicating, by a first sensing agent for a first user equipment (UE), a first signal with a first node using a first sensing mode through a first link;
communicating, by a first AI agent for the first UE, a second signal with a second node using a first AI mode through a second link;
wherein the first sensing mode comprises one of multiple sensing modes, and the first AI mode comprises one of multiple AI modes;
wherein the first link comprises one of: a non-sensing-based link and a sensing-based link, and the second link comprises one of: a non-AI-based link and an AI-based link.

16. The method of claim 15, wherein the first UE connects to a second UE using one or more AI-dedicated sidelink channels to communicate AI information, the one or more AI-dedicated sidelink channels comprising either or both of: one or more physical channels; and one or more higher-layer channels.

17. The method of claim 15, wherein the first UE connects to a second UE using one or more sensing-dedicated sidelink channels to communicate sensing information, the one or more sensing-dedicated sidelink channels comprising either or both of: one or more physical channels; and one or more higher-layer channels.

18. The method of claim 15, wherein the first UE connects to a second UE using one or more AI/sensing-dedicated sidelink channels to communicate AI and sensing information, the one or more AI/sensing-dedicated sidelink channels comprising either or both of: one or more physical channels; and one or more higher-layer channels.

19. The method of claim 15, wherein any one of the first node and the second node comprises a terrestrial network (TN) node or a non-terrestrial network (NTN) node.

20. The method of claim 15, wherein one or both of the first link and the second link support an uplink channel to communicate learning and/or sensing information for AI in an application to electronic world and physical world interaction.
